(19) United States
(12) Patent Application Publication
(10) Pub. No.: US 2026/0367748 A1
(43) Pub. Date: Nov. 19, 2026

(54) DEVICES, METHODS, AND GRAPHICAL USER INTERFACES FOR SHARING CONTENT BETWEEN DEVICES

(71) Applicant: Apple Inc., Cupertino, CA (US)

(72) Inventors: David LUI, San Jose, CA (US); Xiao Jin YU, Sunnyvale, CA (US); Lorena S. PAZMINO, San Francisco, CA (US); Christopher D. MCKENZIE, Burlingame, CA (US); Zoey C. TAYLOR, San Francisco, CA (US); Jay MOON, San Francisco, CA (US)

(21) Appl. No.: 19/571,368

(22) Filed: Mar. 18, 2026

Related U.S. Application Data
(60) Provisional application No. 63/805,233, filed on May 13, 2025.

(51) Int. Cl. G06F 3/04815; G06F 3/0482; G06F 3/04845; G06F 3/14

(52) U.S. Cl. CPC G06F 3/04815; G06F 3/0482; G06F 3/04845; G06F 3/1454

(57) ABSTRACT

Some examples are directed to systems and methods in which a first computer system and a second computer system share and display representations of a three-dimensional virtual object. Some examples are directed to systems and methods for presenting three-dimensional content and a virtual window. Some examples are directed to system and methods for sharing content between devices after communicating sharing information.

### CROSS REFERENCE TO RELATED APPLICATIONS

This application claims the benefit of U.S. Provisional Application No. 63/805,233, filed May 13, 2025, the content of which is herein incorporated by reference in its entirety for all purposes.

### TECHNICAL FIELD

The present disclosure relates generally to computer systems that provide computer-generated experiences, including, but not limited to, electronic devices that provide virtual reality and mixed reality experiences via a display.

### BACKGROUND

The development of computer systems for augmented reality has increased significantly in recent years. Example augmented reality environments include at least some virtual elements that replace or augment the physical world. Input devices, such as cameras, controllers, joysticks, touch-sensitive surfaces, and touch-screen displays for computer systems and other electronic computing devices are used to interact with virtual/augmented reality environments. Example virtual elements include virtual objects, such as digital images, video, text, icons, and control elements such as buttons and other graphics.

### SUMMARY

Some methods and interfaces for interacting with environments that include at least some virtual elements (e.g., applications, augmented reality environments, mixed reality environments, and virtual reality environments) are cumbersome, inefficient, and limited. For example, systems that provide insufficient feedback for performing actions associated with virtual objects, systems that require a series of inputs to achieve a desired outcome in an augmented reality environment, and systems in which manipulation of virtual objects are complex, tedious, and error-prone, create a significant cognitive burden on a user, and detract from the experience with the virtual/augmented reality environment. In addition, these methods take longer than necessary, thereby wasting energy of the computer system. This latter consideration is particularly important in battery-operated devices.

Accordingly, there is a need for computer systems with improved methods and interfaces for providing computer-generated experiences to users that make interaction with the computer systems more efficient and intuitive for a user. Such methods and interfaces optionally complement or replace conventional methods for providing extended reality experiences to users. Such methods and interfaces reduce the number, extent, and/or nature of the inputs from a user by helping the user to understand the connection between provided inputs and device responses to the inputs, thereby creating a more efficient human-machine interface.

The above deficiencies and other problems associated with user interfaces for computer systems are reduced or eliminated by the disclosed systems. In some embodiments, the computer system is a desktop computer with an associated display. In some embodiments, the computer system is portable device (e.g., a notebook computer, tablet computer, or handheld device). In some embodiments, the computer system is a personal electronic device (e.g., a wearable electronic device, such as a watch, or a head-mounted device). In some embodiments, the computer system has a touchpad. In some embodiments, the computer system has one or more cameras. In some embodiments, the computer system has (e.g., includes or is in communication with) a display generation component (e.g., a display device such as a head-mounted device (HMD), a display, a projector, a touch-sensitive display (also known as a “touch screen” or “touch-screen display”), or other device or component that presents visual content to a user, for example on or in the display generation component itself or produced from the display generation component and visible elsewhere). In some embodiments, the computer system has one or more eye-tracking components. In some embodiments, the computer system has one or more hand-tracking components. In some embodiments, the computer system has one or more output devices in addition to the display generation component, the output devices including one or more tactile output generators and/or one or more audio output devices. In some embodiments, the computer system has a graphical user interface (GUI), one or more processors, memory and one or more modules, programs or sets of instructions stored in the memory for performing multiple functions. In some embodiments, the user interacts with the GUI through a stylus and/or finger contacts and gestures on the touch-sensitive surface, movement of the user's eyes and hand in space relative to the GUI (and/or computer system) or the user's body as captured by cameras and other movement sensors, and/or voice inputs as captured by one or more audio input devices. In some embodiments, the functions performed through the interactions optionally include image editing, drawing, presenting, word processing, spreadsheet making, game playing, telephoning, video conferencing, e-mailing, instant messaging, workout support, digital photographing, digital videoing, web browsing, digital music playing, note taking, and/or digital video playing. Executable instructions for performing these functions are, optionally, included in a transitory and/or non-transitory computer readable storage medium or other computer program product configured for execution by one or more processors.

There is a need for electronic devices with improved methods and interfaces for interacting with a three-dimensional environment. Such methods and interfaces may complement or replace conventional methods for interacting with a three-dimensional environment. Such methods and interfaces reduce the number, extent, and/or the nature of the inputs from a user and produce a more efficient human-machine interface. For battery-operated computing devices, such methods and interfaces conserve power and increase the time between battery charges.

In some embodiments, a computer system initiates a process to display a representation of a three-dimensional virtual object via one or more head-mounted display generation components of a second computer system. In some embodiments, the computer system detects a first event corresponding to interaction with a first representation of the three-dimensional virtual object on the computer system and initiates a process to display a second representation of the three-dimensional virtual object on the second computer system.

In some embodiments, a computer system displays a virtual window. In some embodiments, a computer system is in communication with a respective computer system, and configured to display a virtual window associated with one or more user interfaces displayed at the respective computer system. In some embodiments, in response to detecting a sequence of one or more inputs included in a request, a computer system initiates display of three-dimensional content in a three-dimensional environment.

In some embodiments, a first electronic device displays a user interface. In some embodiments, a first electronic device updates a user interface in accordance with a determination that a second electronic device, different from the first electronic device, is prepared to share content with the first electronic device. In some embodiments, a first electronic device displays sharing information associated with a second electronic device. In some embodiments, a first electronic device does not display sharing information in accordance with a determination that an unidentified device prepared associated with the sharing information is in proximity of the first electronic device.

Note that the various embodiments described above can be combined with any other embodiments described herein. The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE DRAWINGS

For a better understanding of the various described embodiments, reference should be made to the Description of Embodiments below, in conjunction with the following drawings in which like reference numerals refer to corresponding parts throughout the figures.

FIG. 1A is a block diagram illustrating an operating environment of a computer system for providing XR experiences in accordance with some embodiments.

FIGS. 1B-1P are examples of a computer system for providing XR experiences in the operating environment of FIG. 1A.

FIG. 2 is a block diagram illustrating a controller of a computer system that is configured to manage and coordinate a XR experience for the user in accordance with some embodiments.

FIG. 3A is a block diagram illustrating a display generation component of a computer system that is configured to provide a visual component of the XR experience to the user in accordance with some embodiments.

FIGS. 3B-3G illustrate the use of Application Programming Interfaces (APIs) to perform operations.

FIG. 4 is a block diagram illustrating a hand tracking unit of a computer system that is configured to capture gesture inputs of the user in accordance with some embodiments.

FIG. 5 is a block diagram illustrating an eye tracking unit of a computer system that is configured to capture gaze inputs of the user in accordance with some embodiments.

FIG. 6 is a flow diagram illustrating a glint-assisted gaze tracking pipeline in accordance with some embodiments.

FIGS. 7A-7R illustrate exemplary ways in which a computer system initiates a process to display a representation of a three-dimensional virtual object via one or more head-mounted display generation components of a second computer system, in accordance with some embodiments of the disclosure.

FIG. 8 illustrates a flow diagram illustrating a method in which a computer system initiates a process to display a representation of a three-dimensional virtual object via one or more head-mounted display generation components of a second computer system, in accordance with some embodiments of the disclosure.

FIGS. 9A-9O illustrate exemplary ways in which a computer system displays virtual windows and three-dimensional content in accordance with some embodiments of the disclosure.

FIG. 10 illustrates a flow diagram illustrating a method in which a computer system displays virtual windows and three-dimensional content in accordance with some embodiments of the disclosure.

FIGS. 11A-11EE illustrate exemplary ways in which a first electronic device displays a user interface associated with sharing information in accordance with some embodiments of the disclosure.

FIG. 12 illustrates a flow diagram illustrating a method in which a first electronic device displays a user interface associated with sharing information in accordance with some embodiments of the disclosure.

### DESCRIPTION OF EMBODIMENTS

The present disclosure relates to user interfaces for providing an extended reality (XR) experience to a user, in accordance with some embodiments.

The systems, methods, and GUIs described herein improve user interface interactions with virtual/augmented reality environments in multiple ways.

In some embodiments, a computer system initiates a process to display a representation of a three-dimensional virtual object via one or more head-mounted display generation components of a second computer system. In some embodiments, the computer system detects a first event corresponding to interaction with a first representation of the three-dimensional virtual object on the computer system and initiates a process to display a second representation of the three-dimensional virtual object on the second computer system. In some embodiments, the first computer system and the second computer system share and display representations of a three-dimensional virtual object.

In some embodiments, a computer system displays a virtual window. In some embodiments, a computer system is in communication with a respective computer system, and configured to display a virtual window associated with one or more user interfaces displayed at the respective computer system. In some embodiments, in response to detecting a sequence of one or more inputs included in a request, a computer system initiates display of three-dimensional content in a three-dimensional environment.

In some embodiments, a first electronic device displays a user interface. In some embodiments, a first electronic device updates a user interface in accordance with a determination that a second electronic device, different from the first electronic device, is prepared to share content with the first electronic device. In some embodiments, a first electronic device displays sharing information associated with a second electronic device. In some embodiments, a first electronic device does not display sharing information in accordance with a determination that an unidentified device prepared associated with the sharing information is in proximity of the first electronic device.

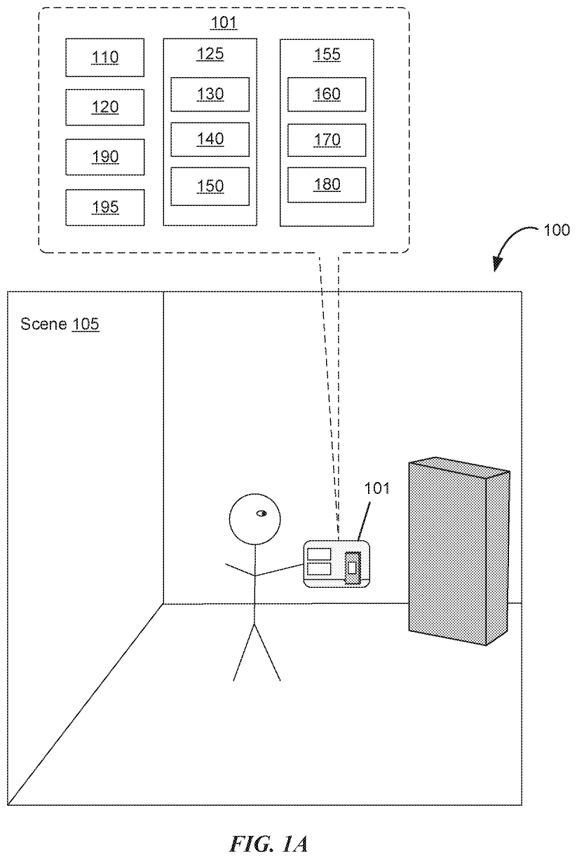

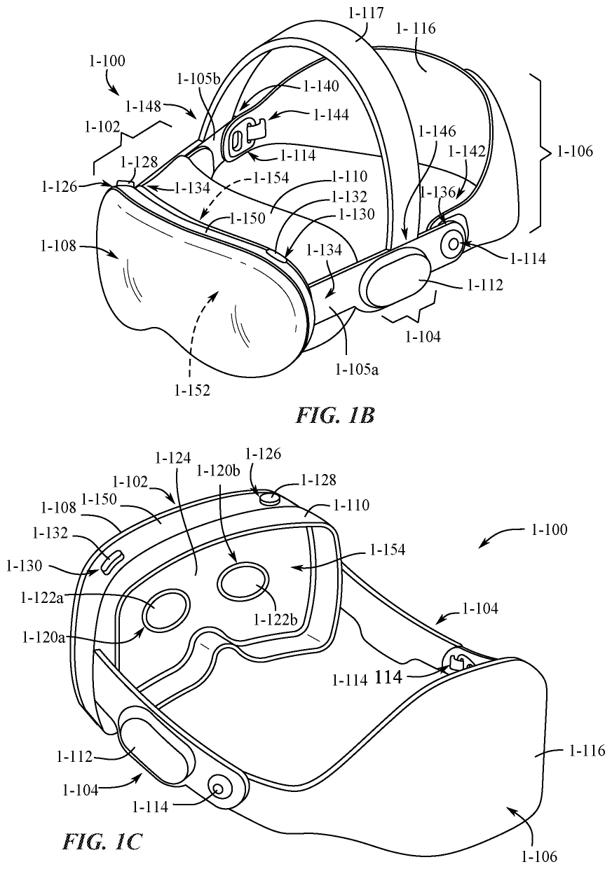

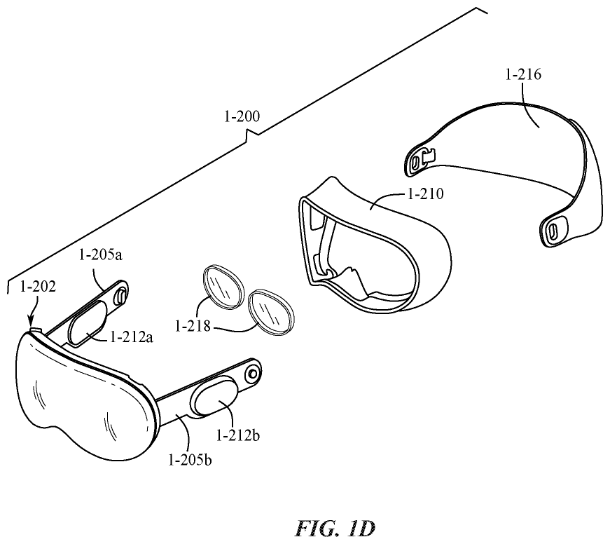

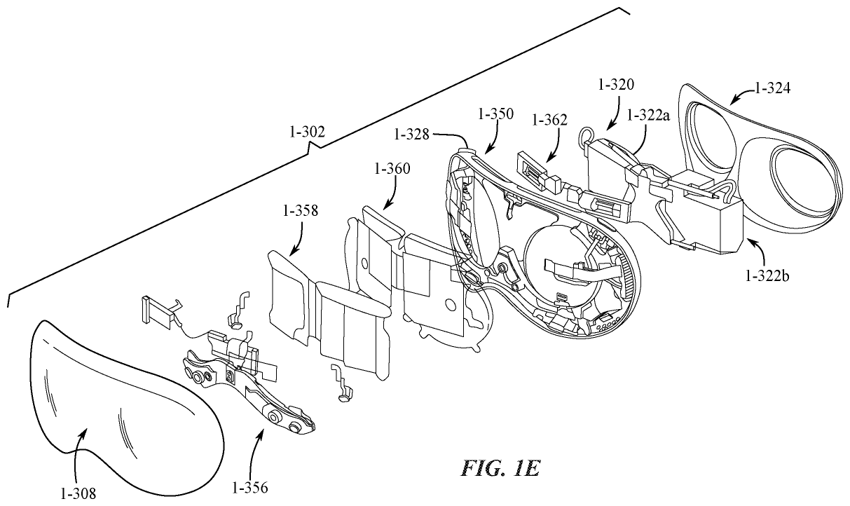

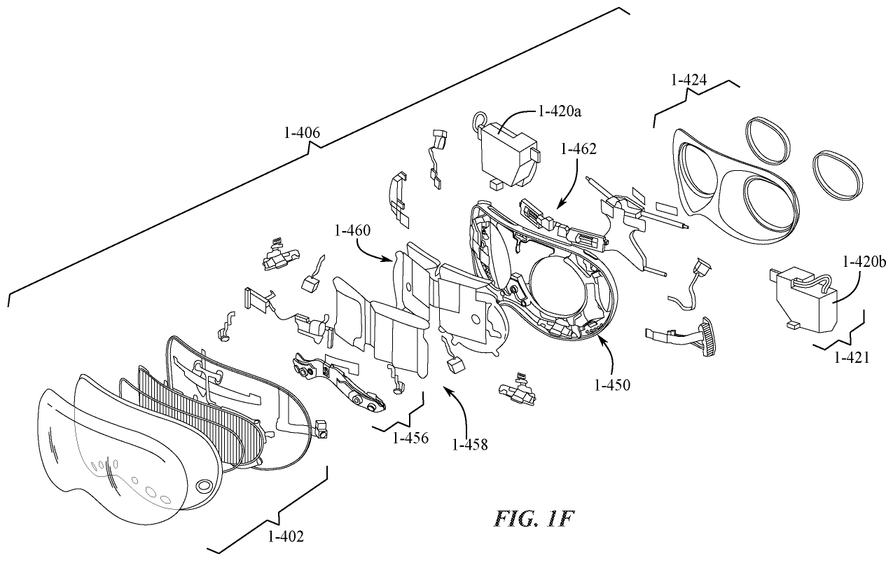

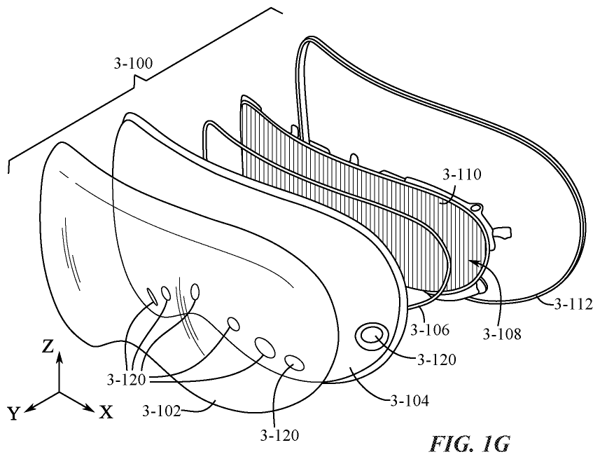

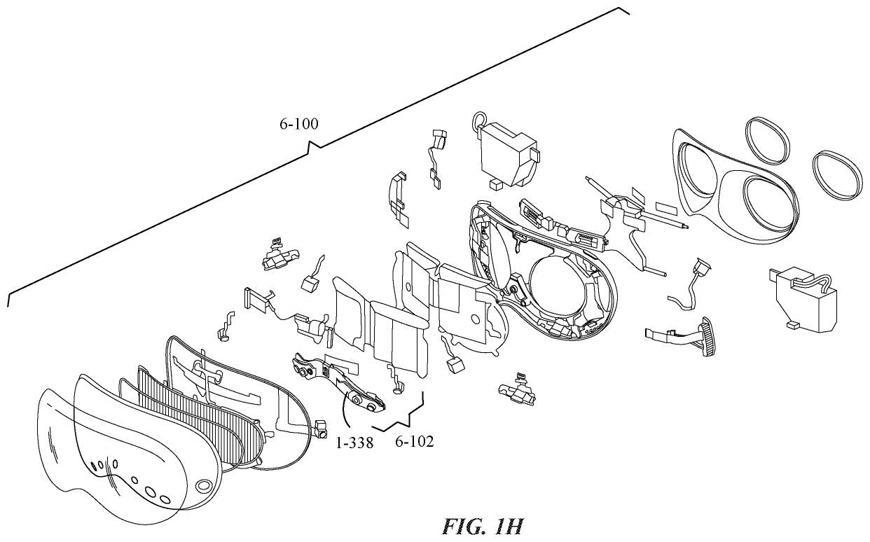

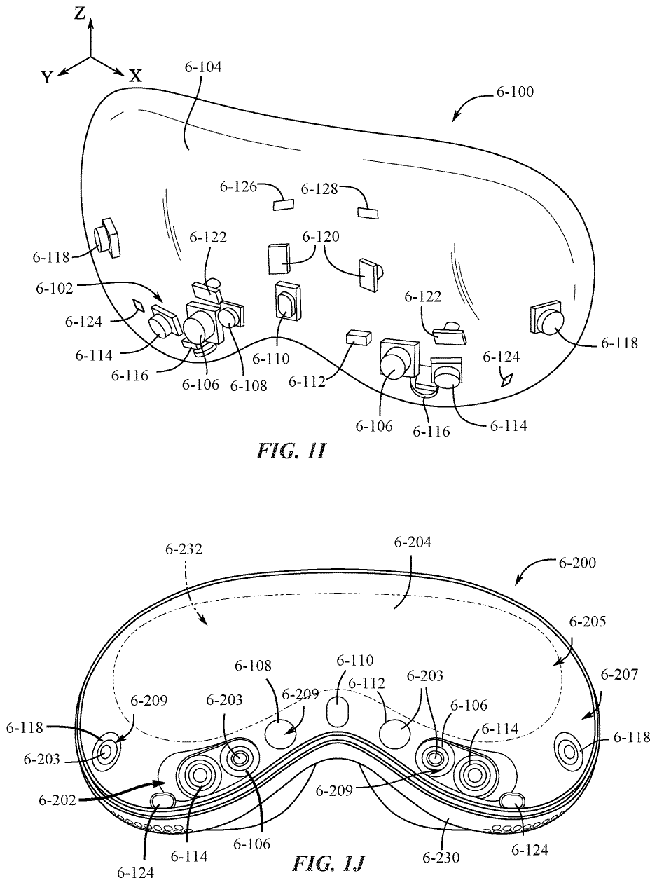

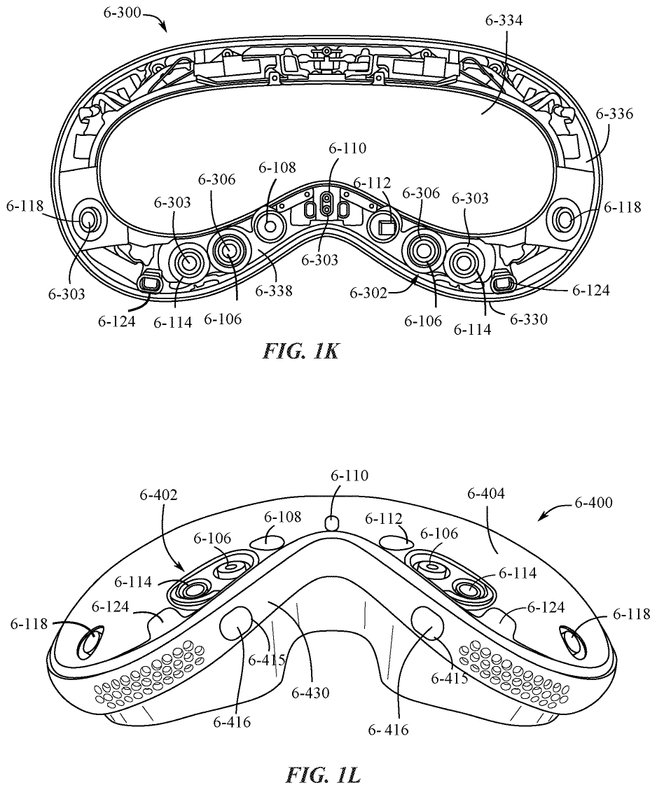

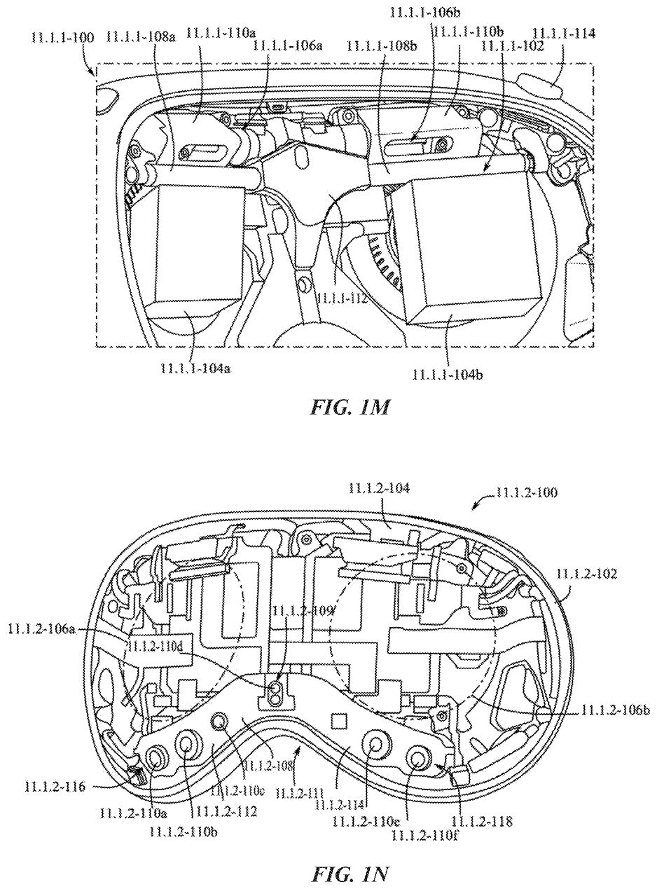

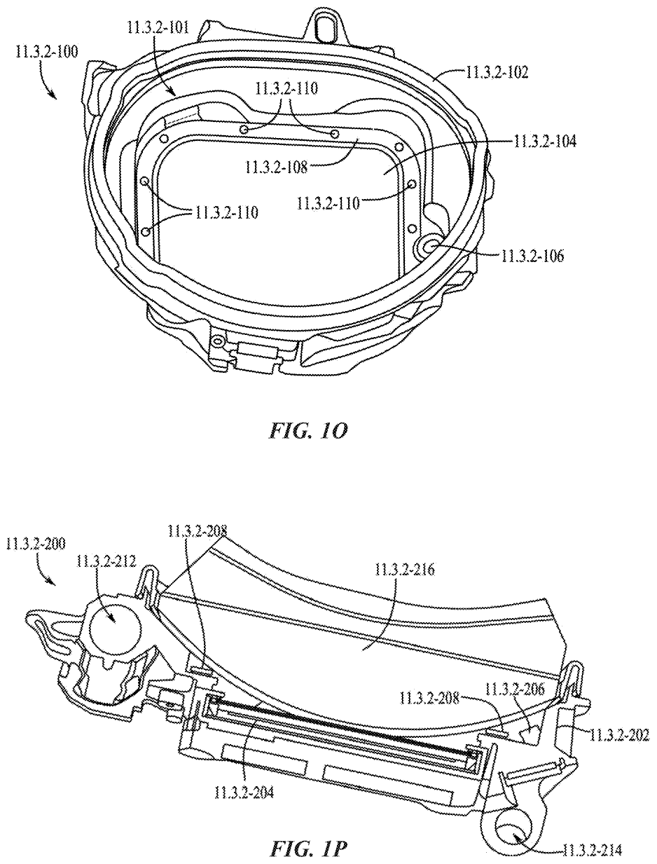

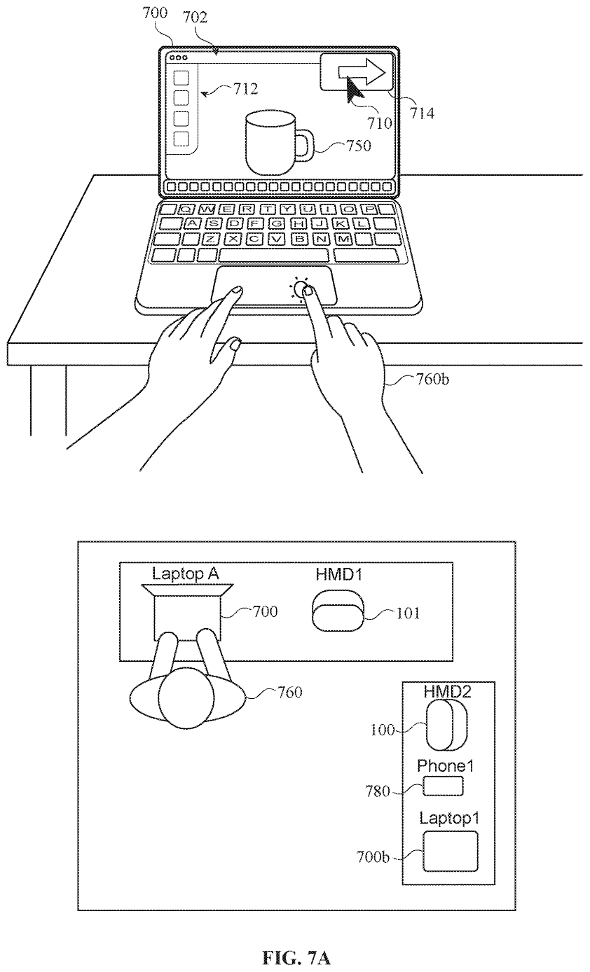

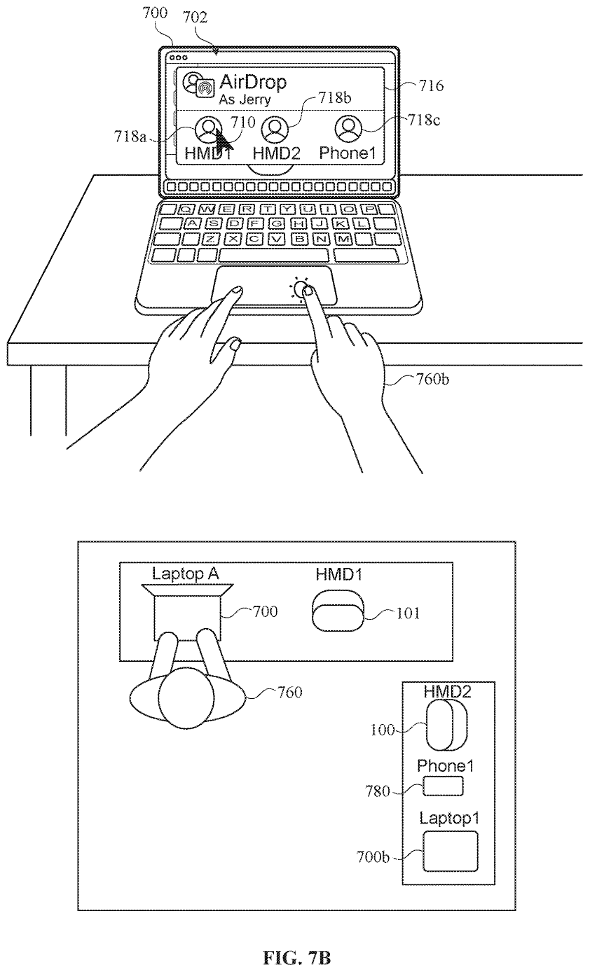

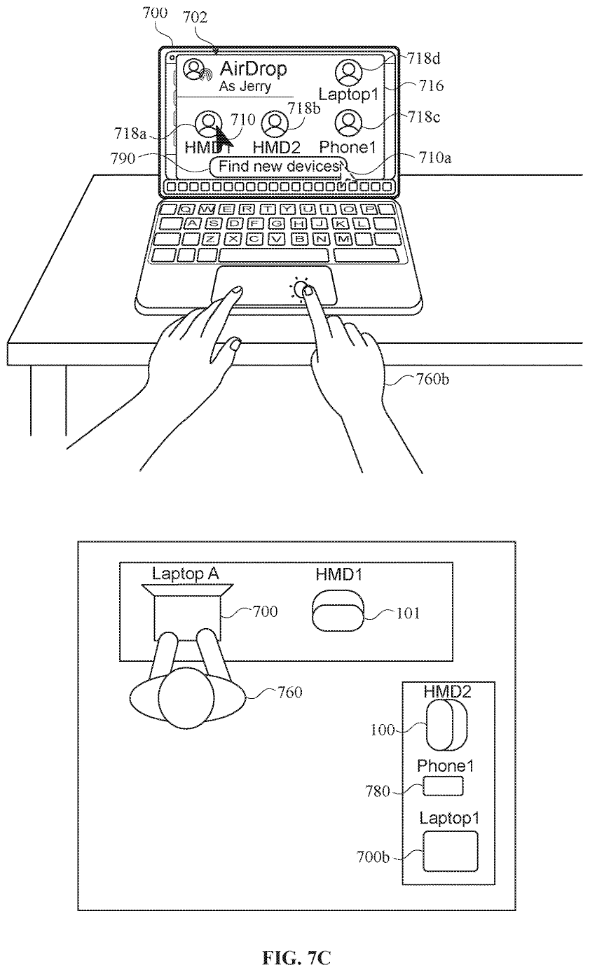

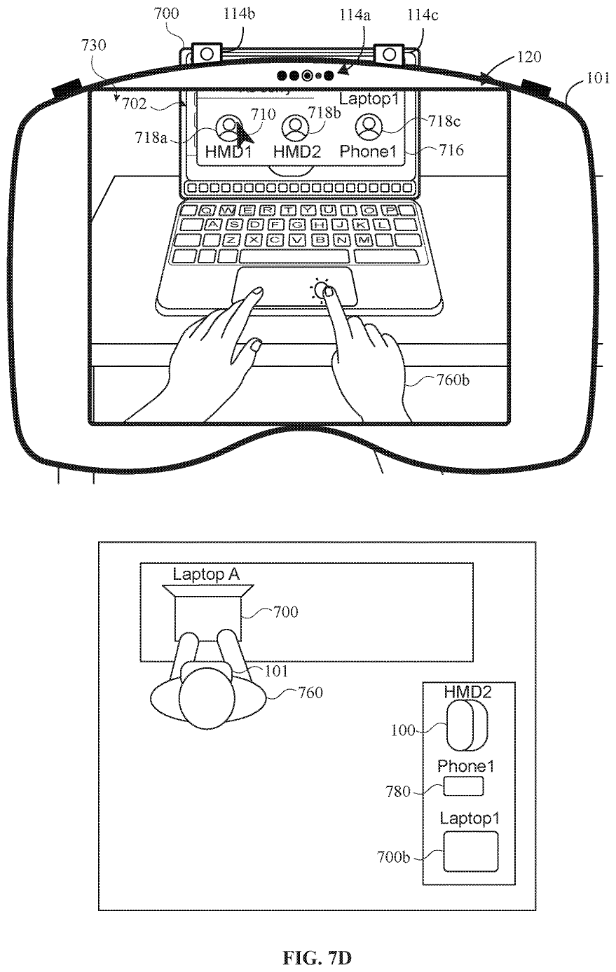

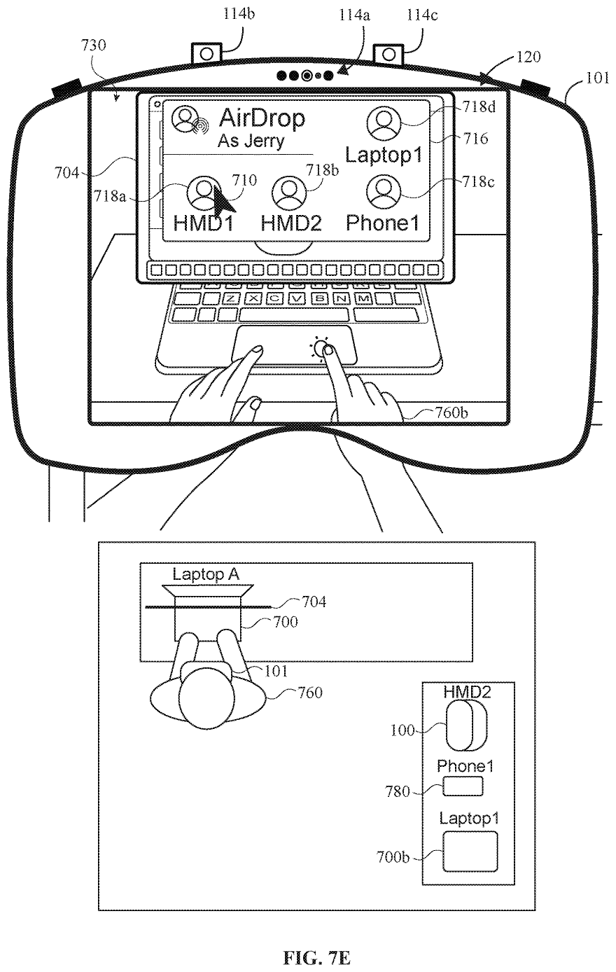

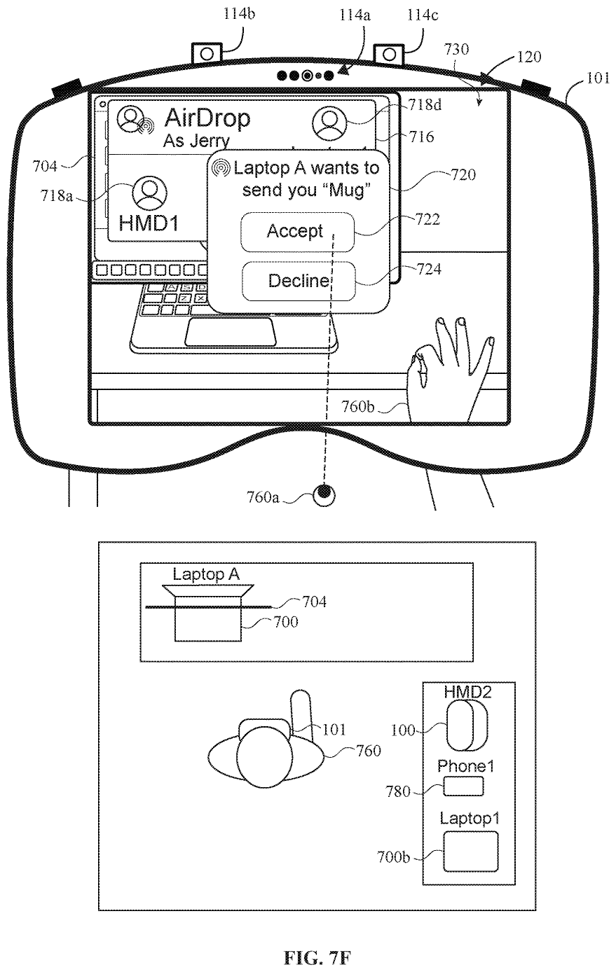

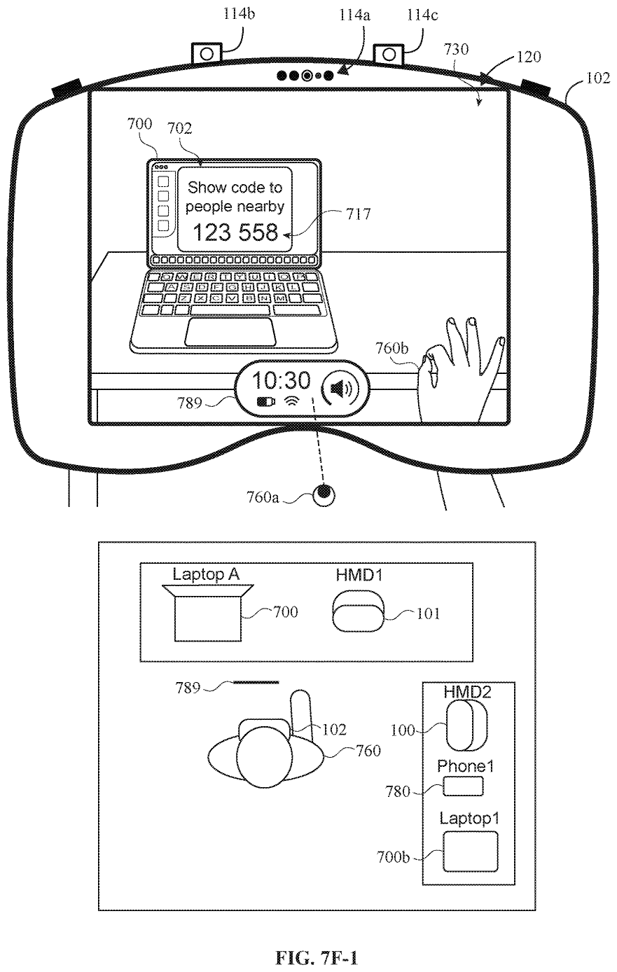

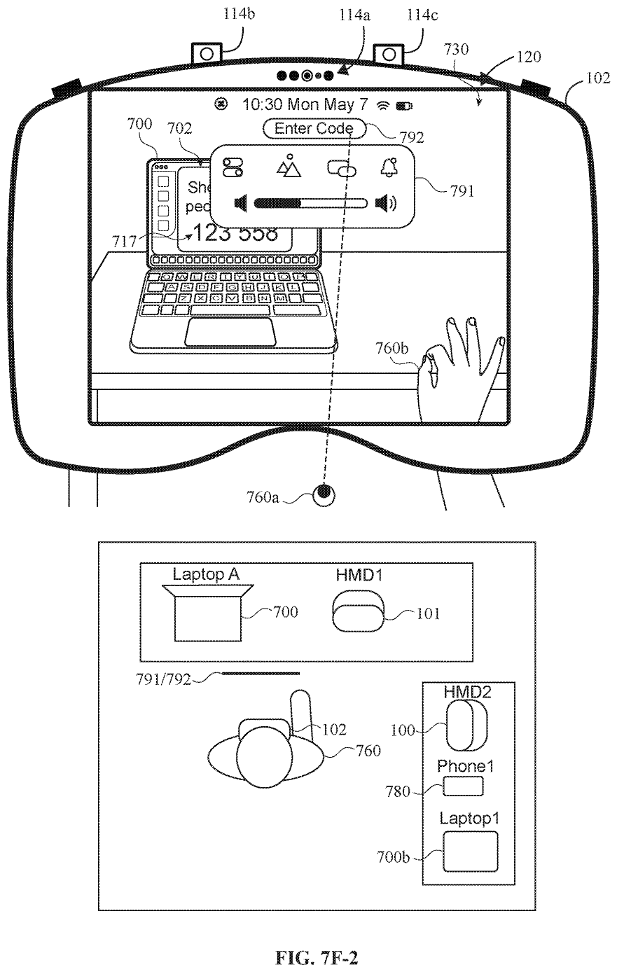

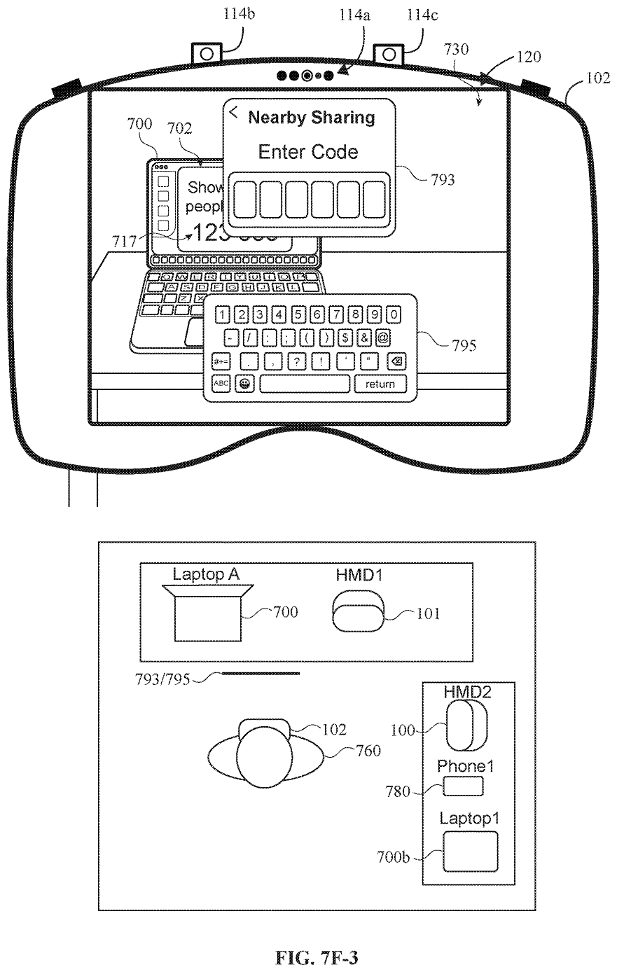

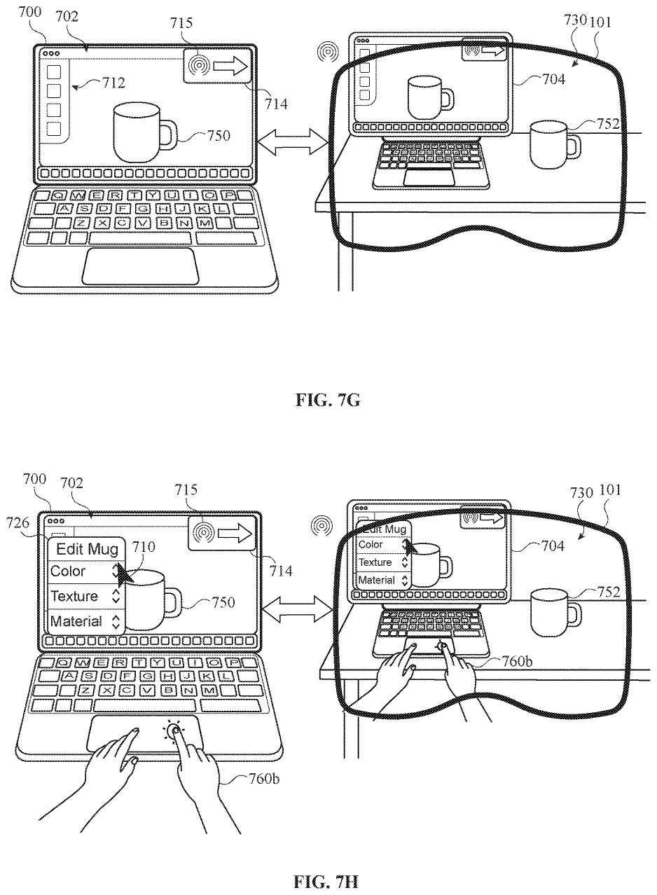

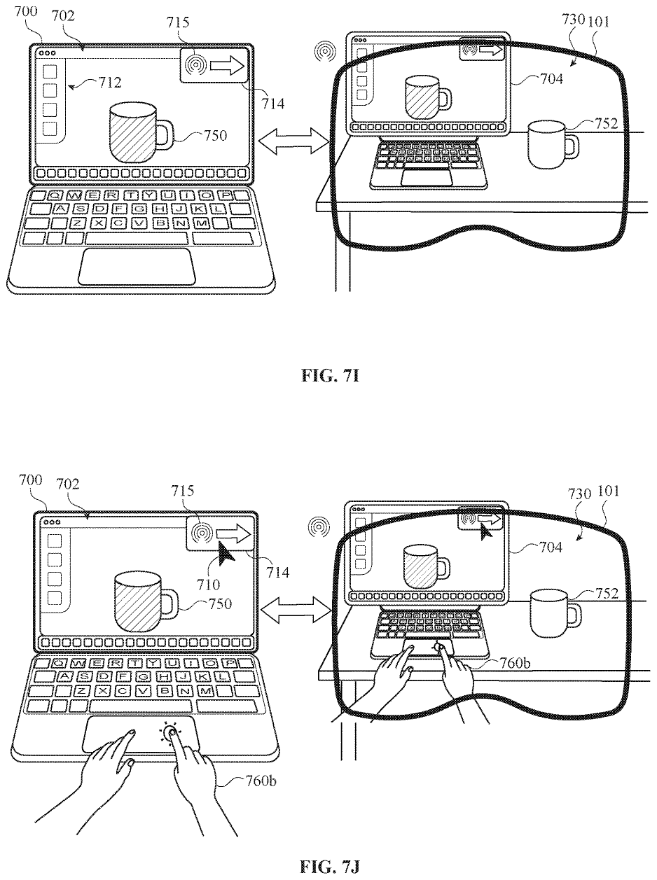

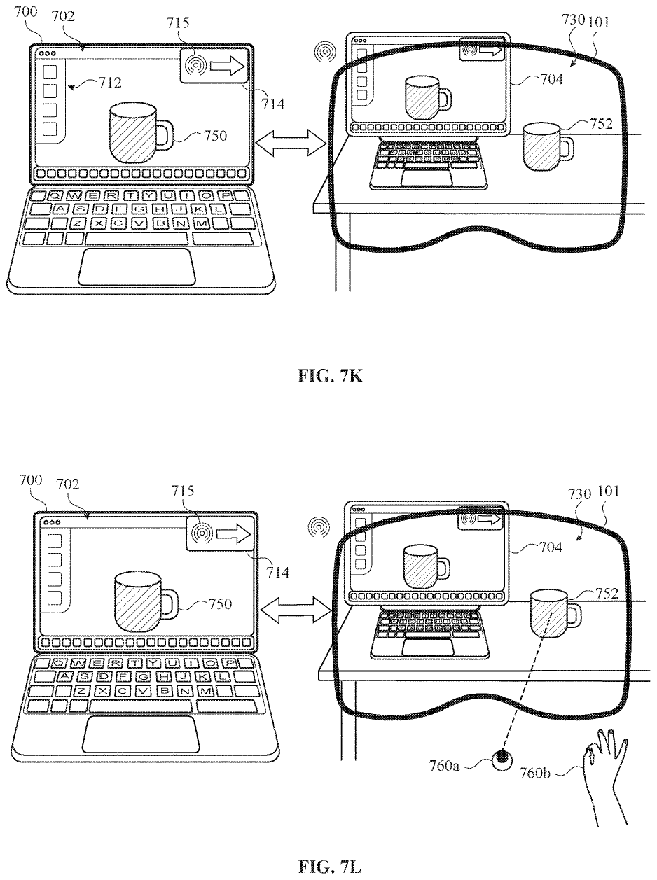

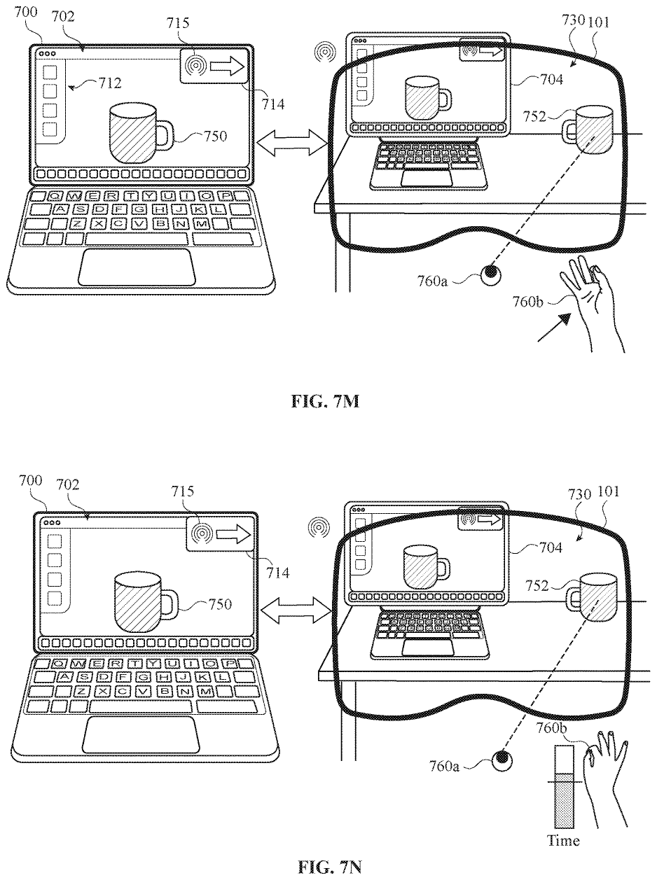

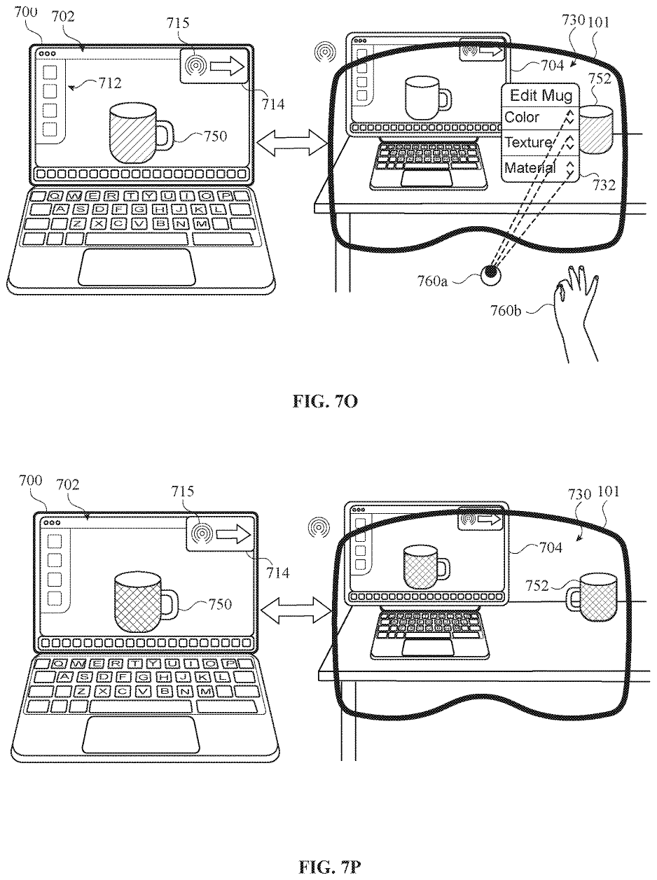

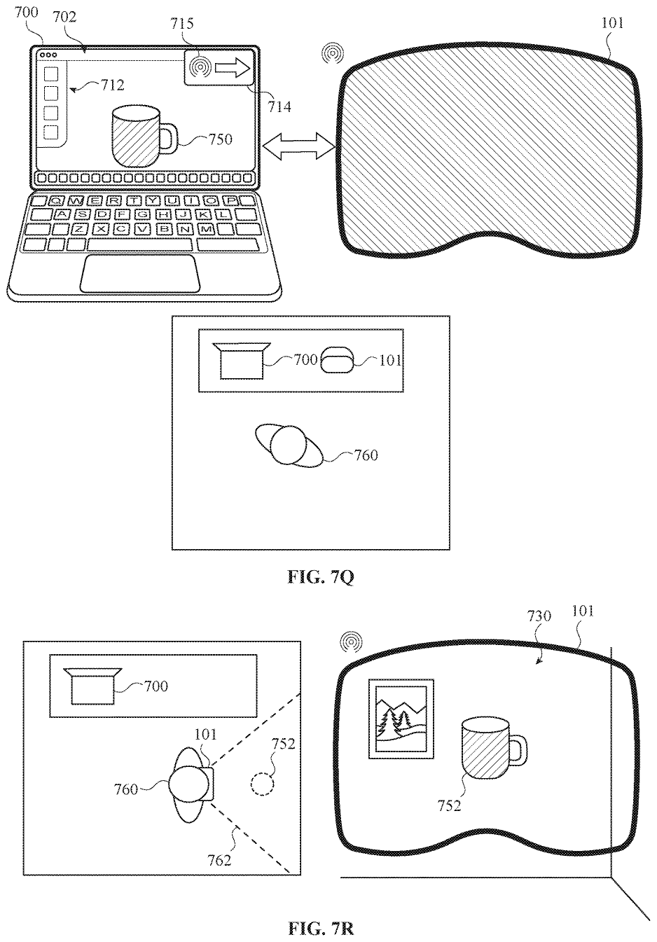

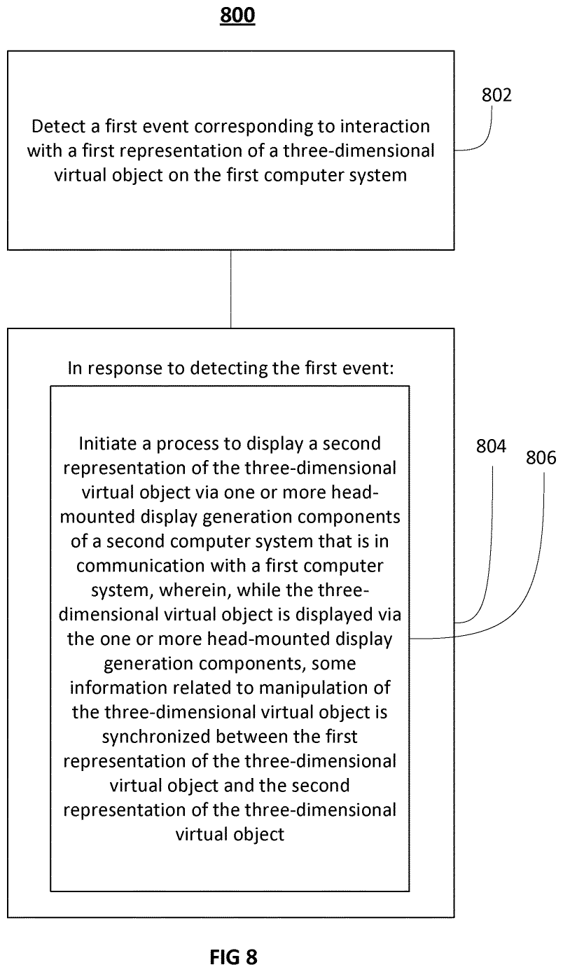

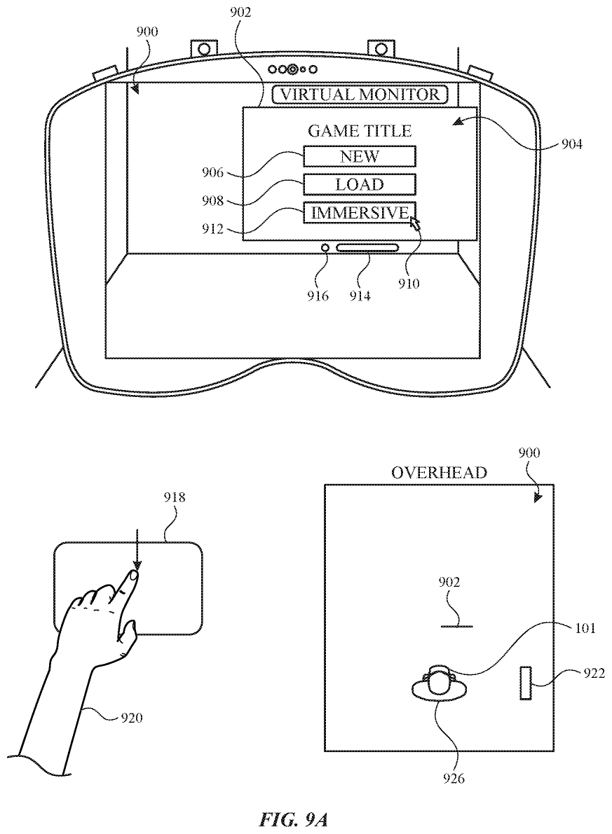

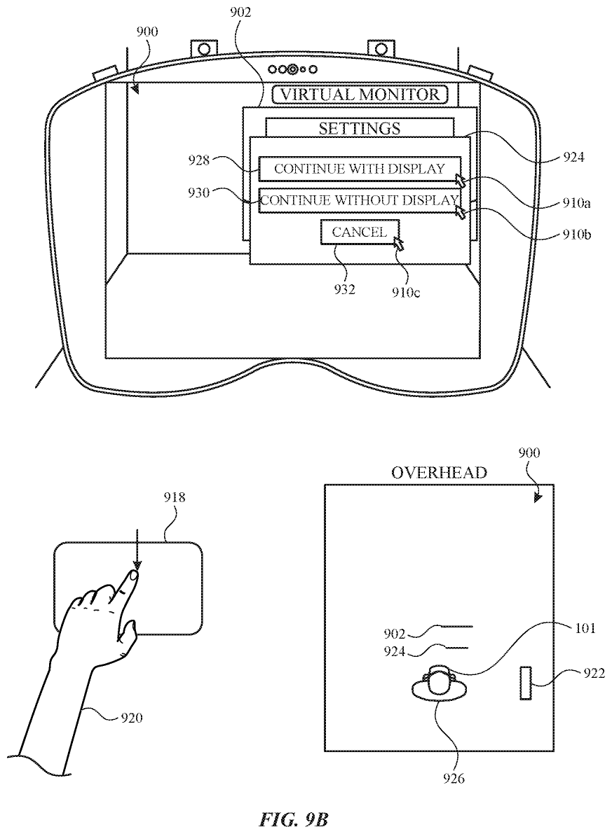

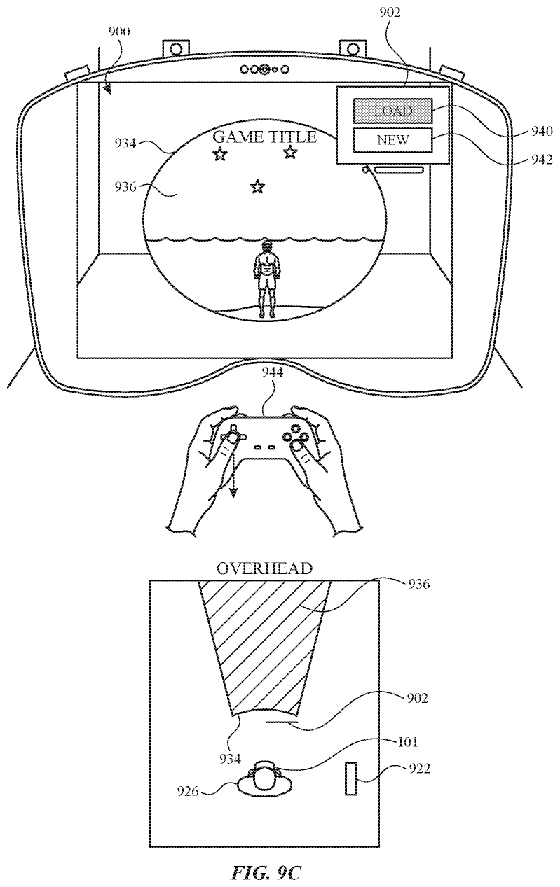

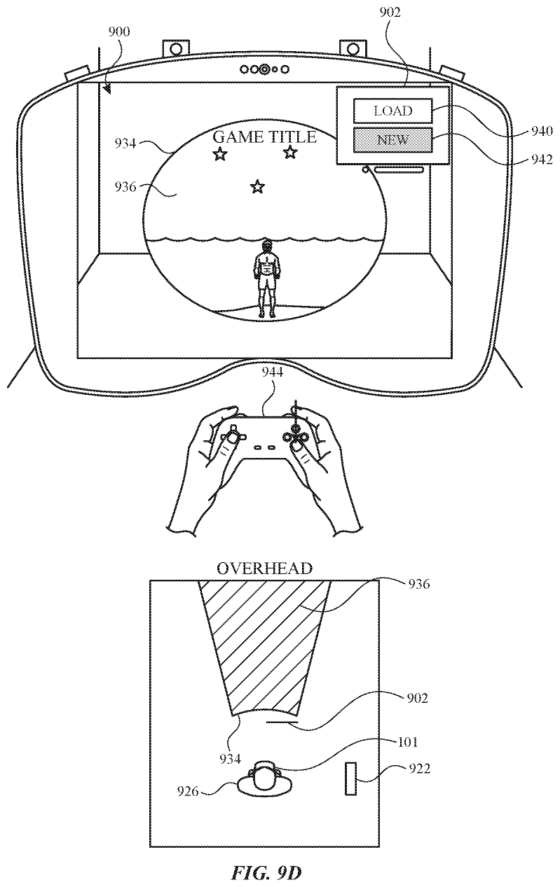

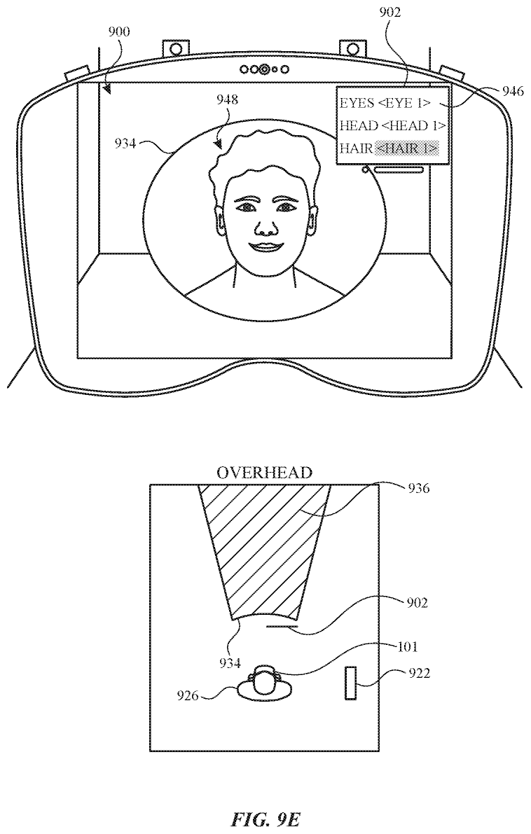

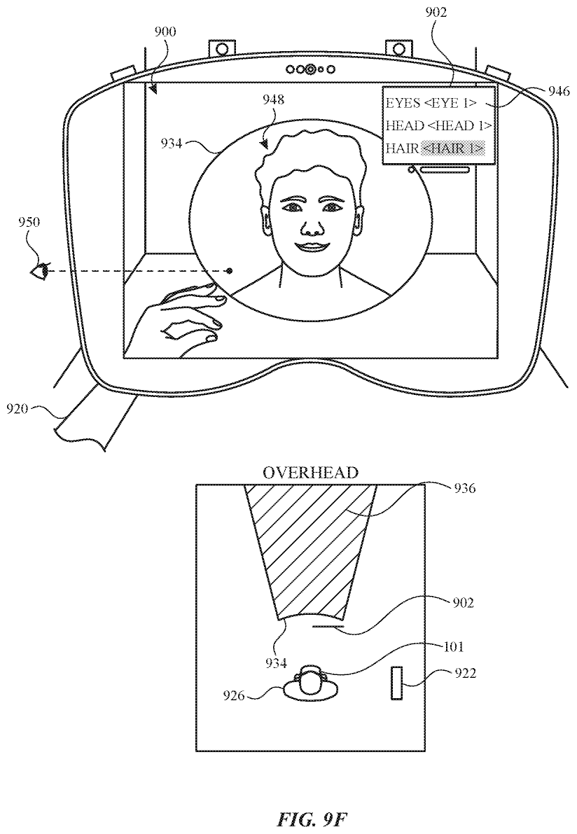

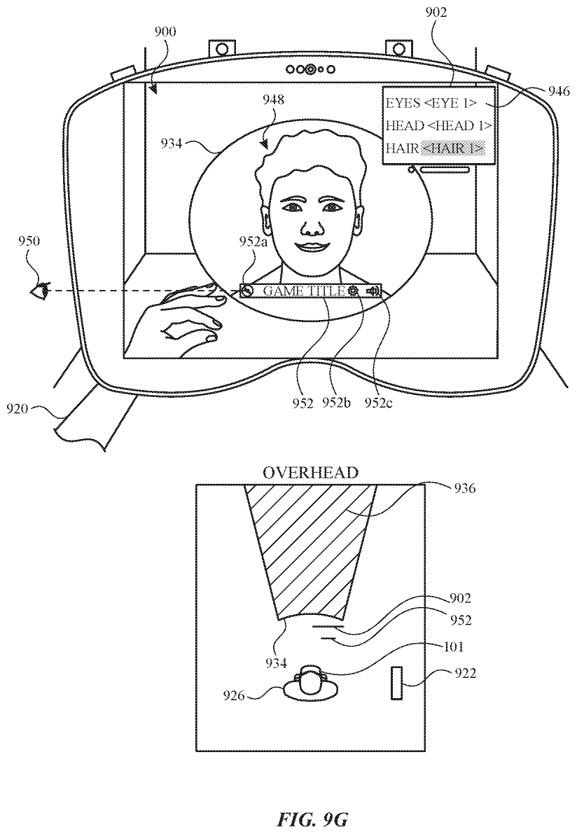

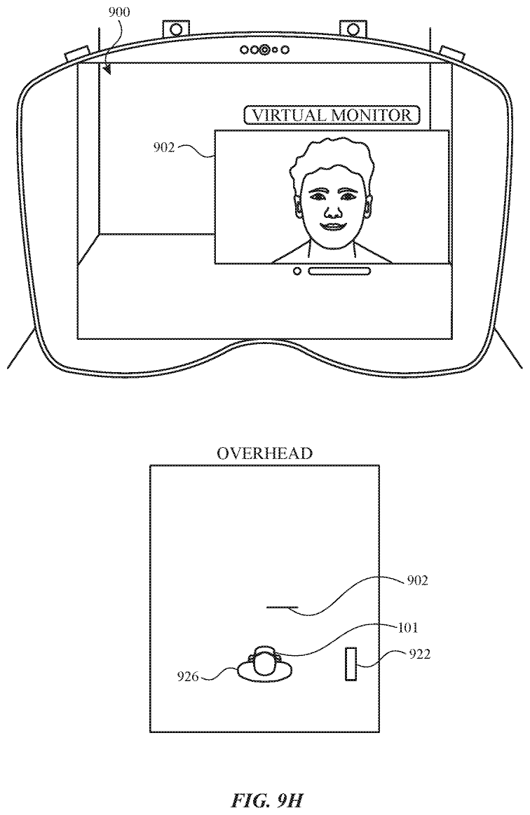

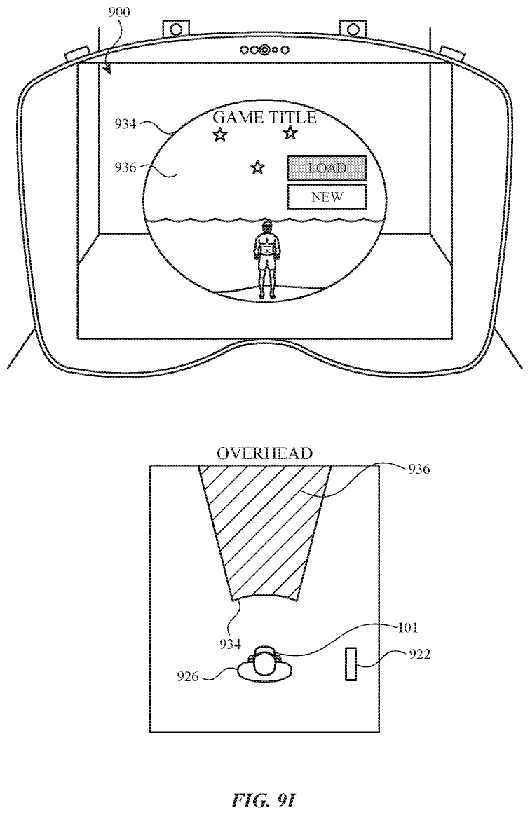

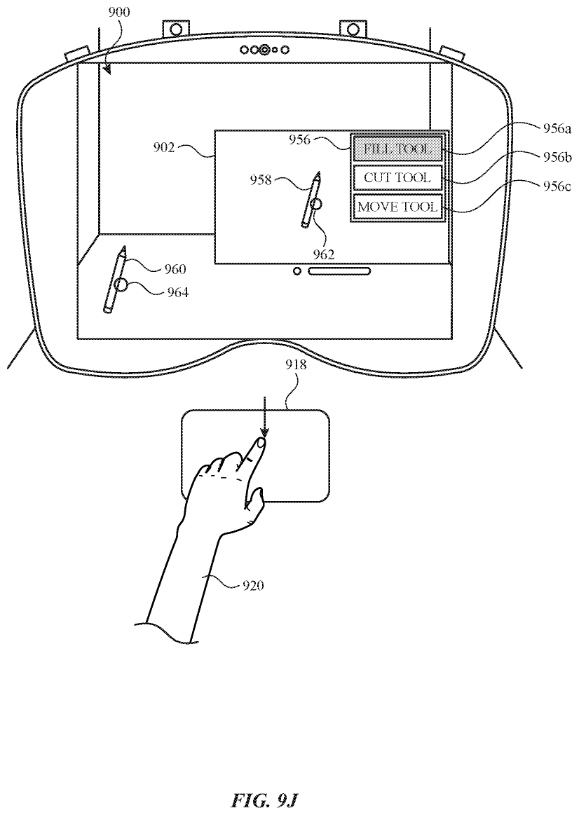

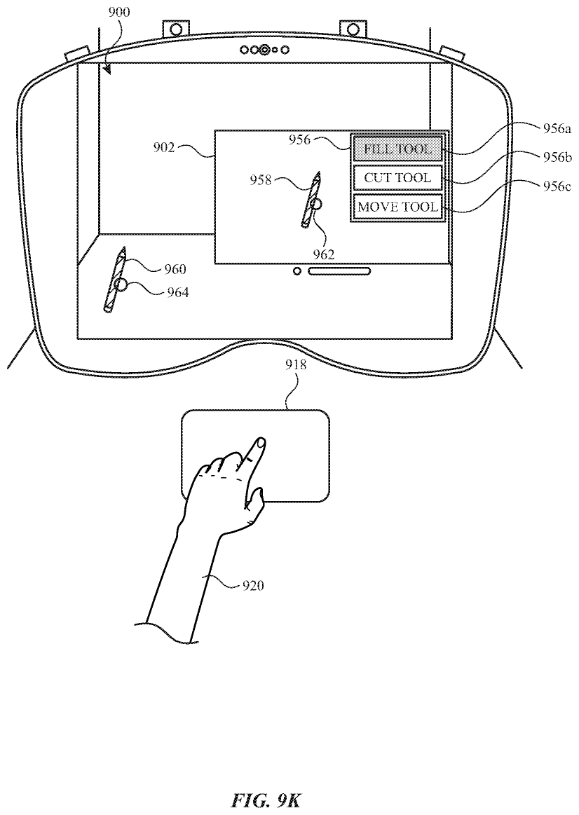

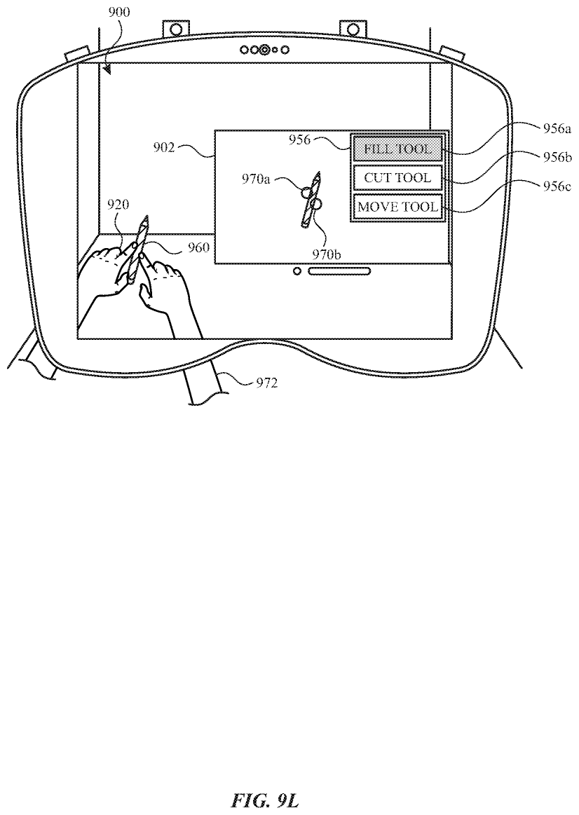

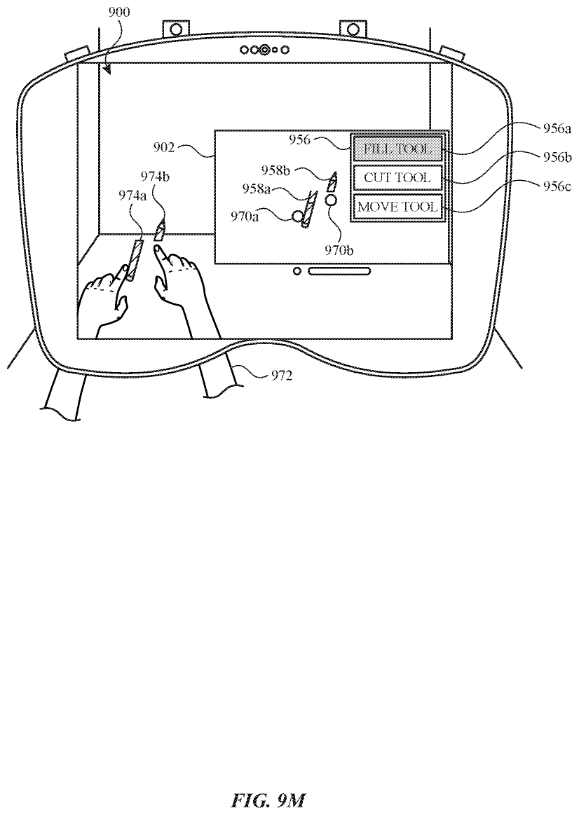

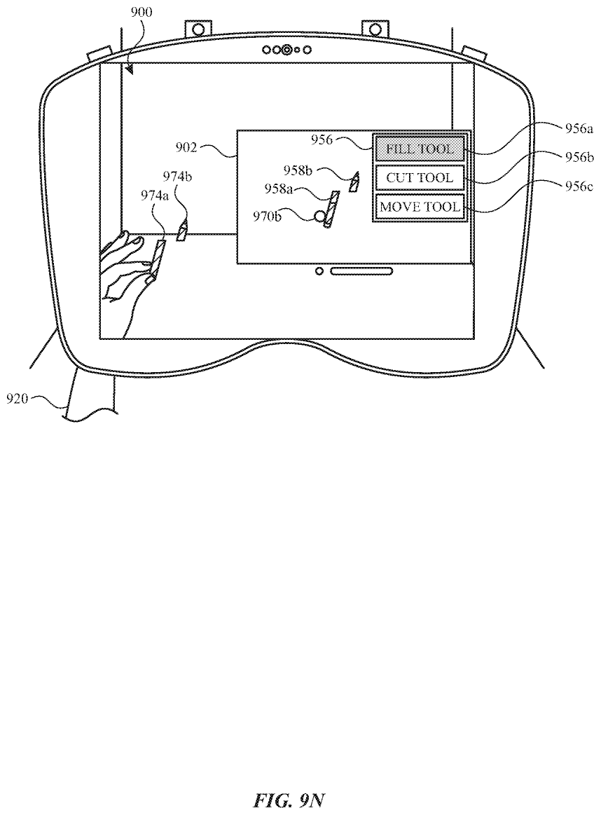

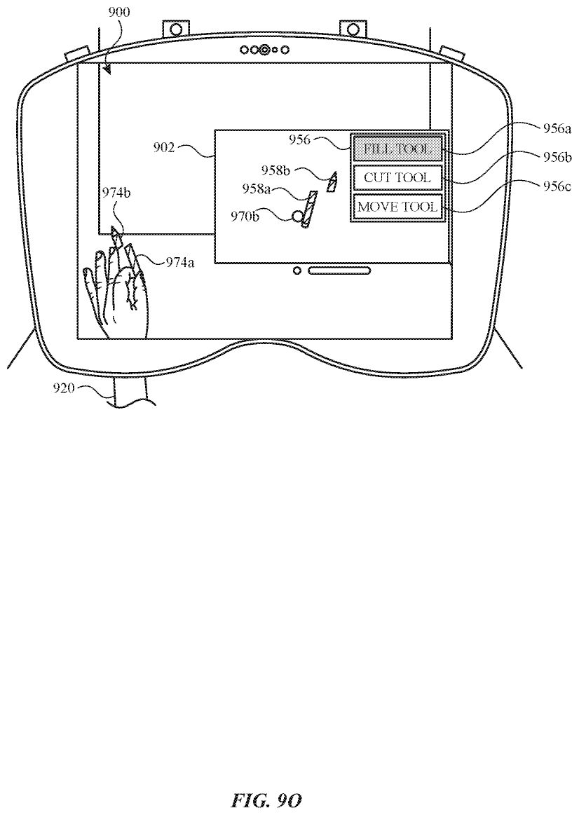

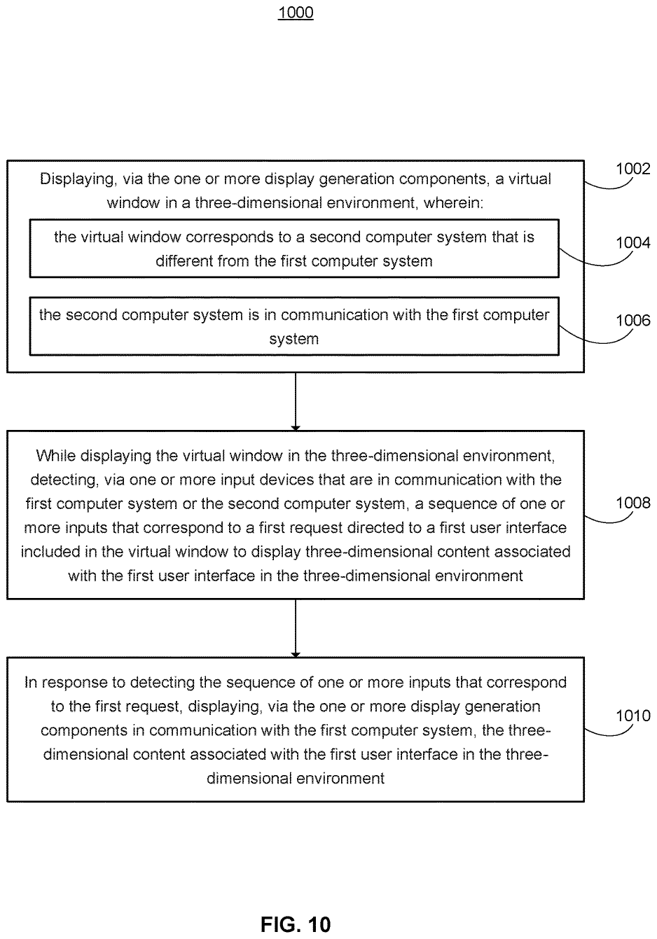

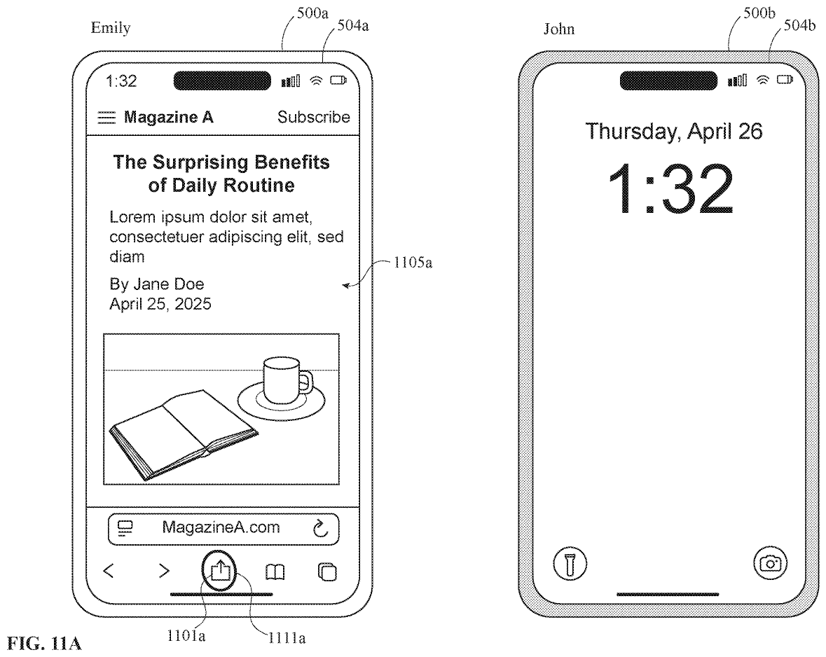

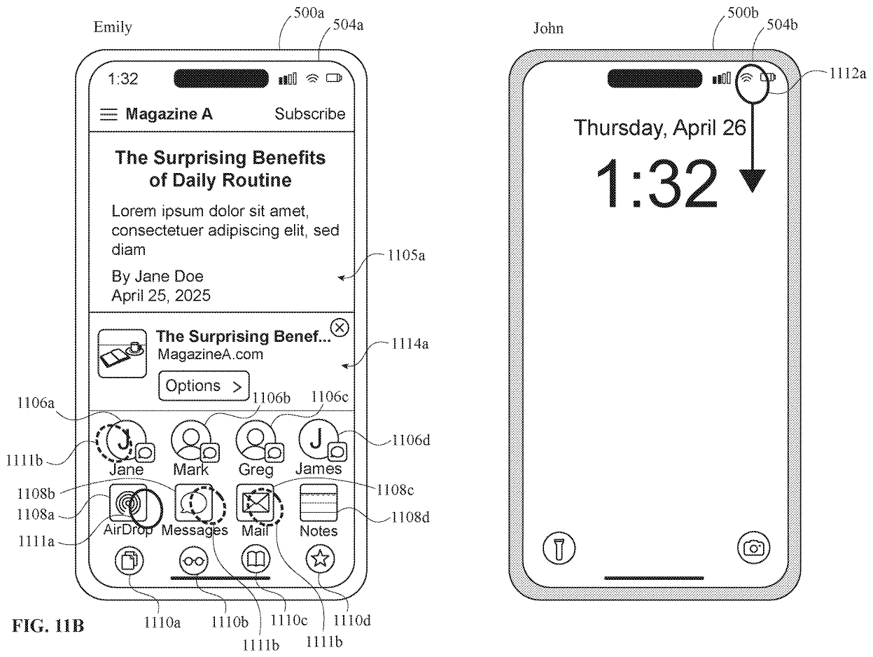

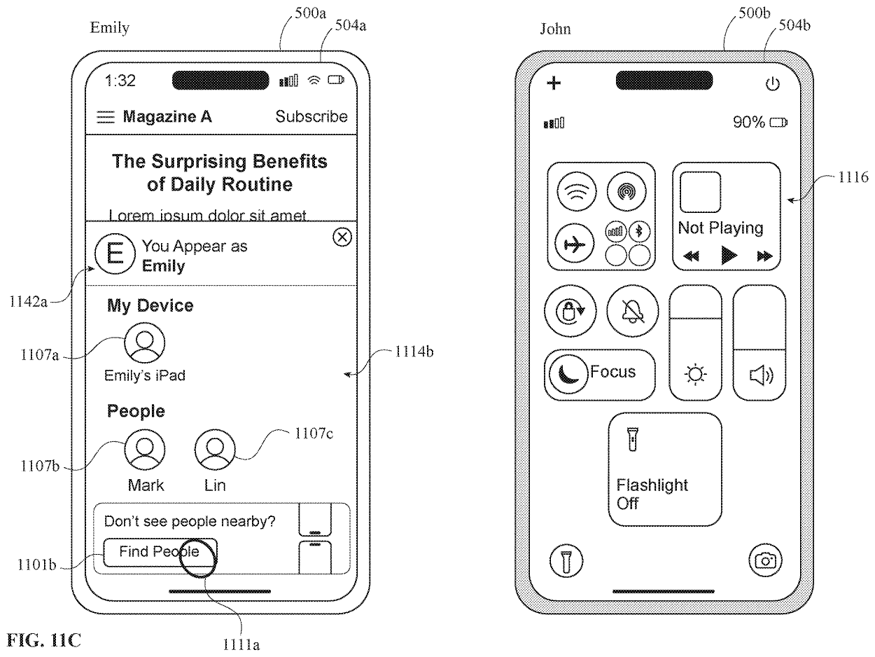

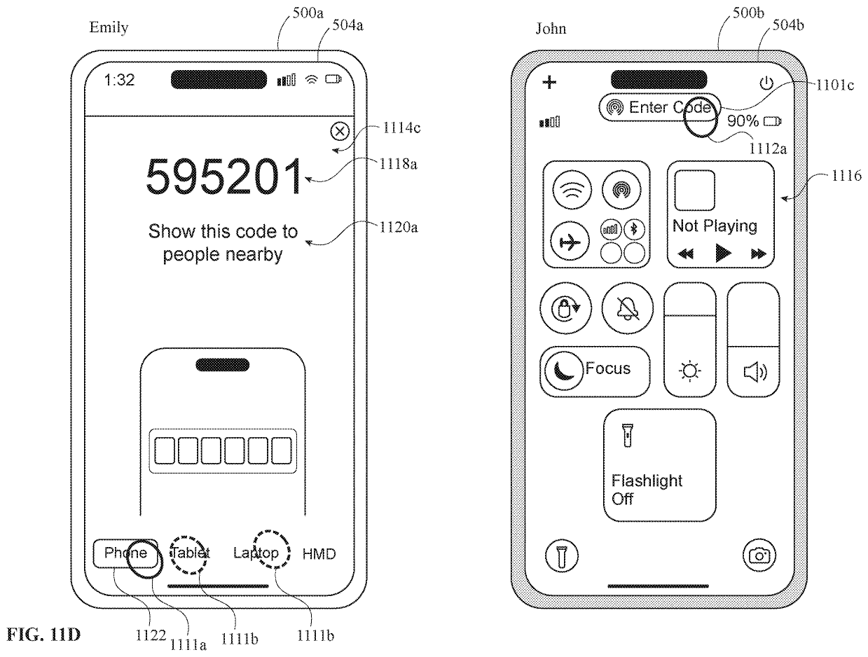

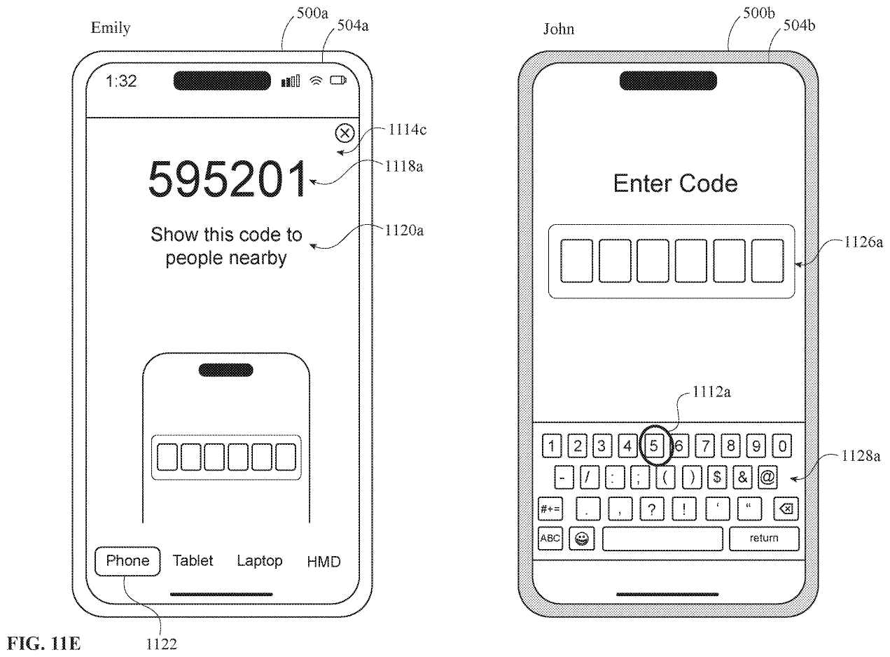

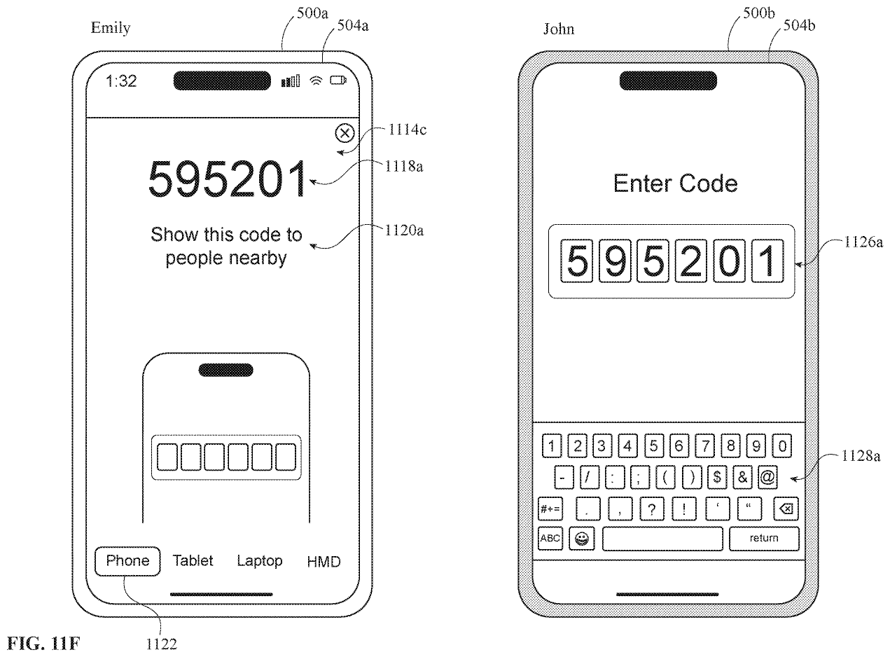

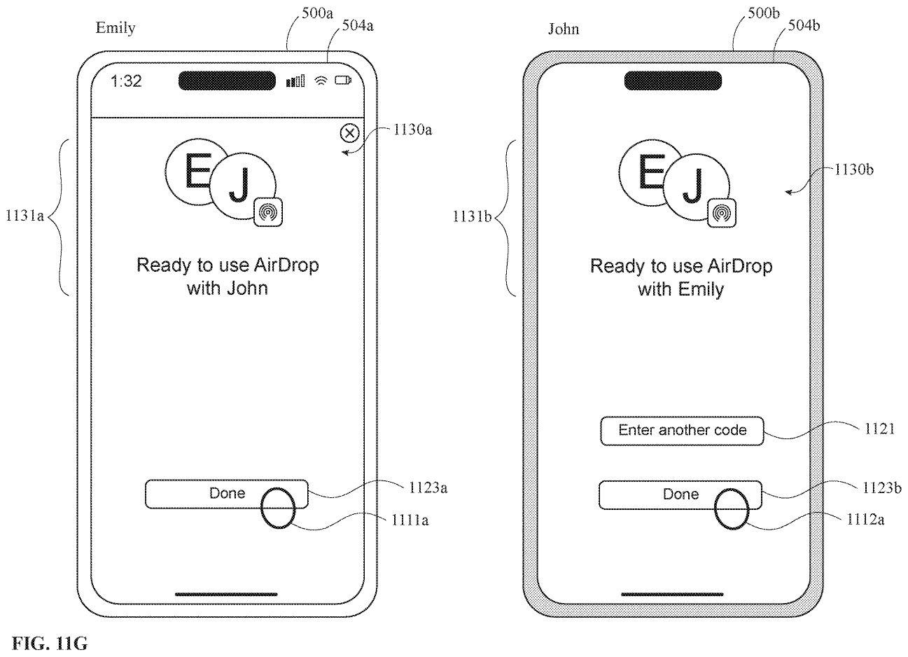

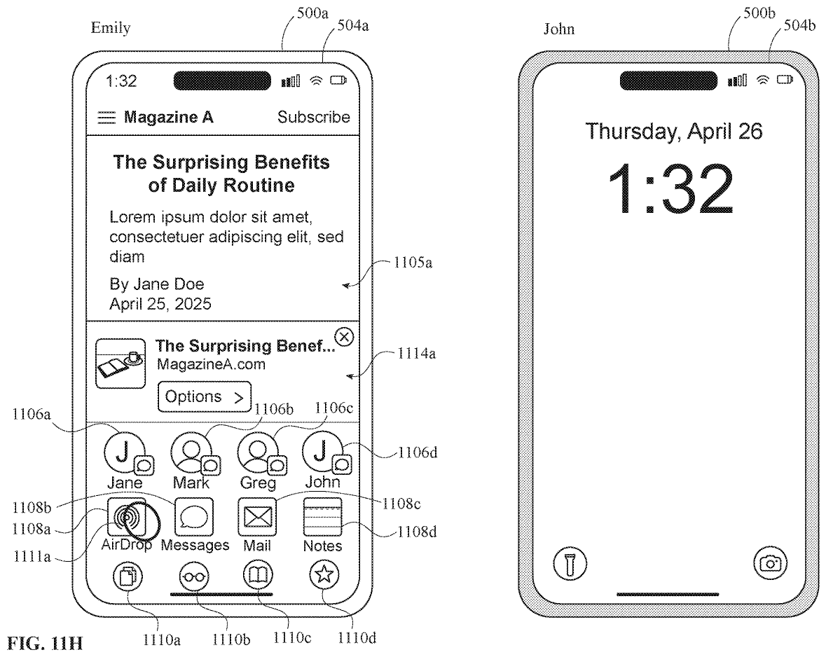

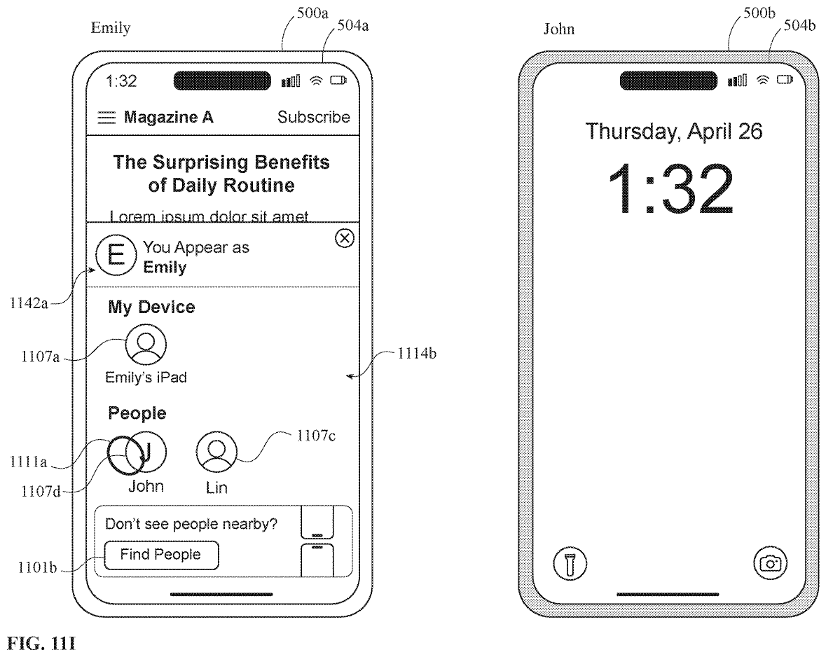

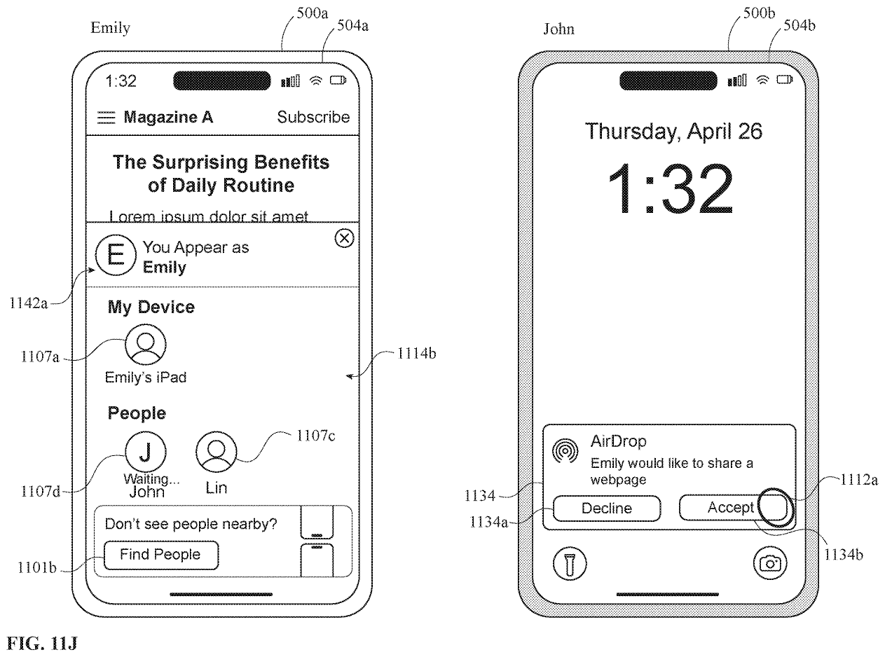

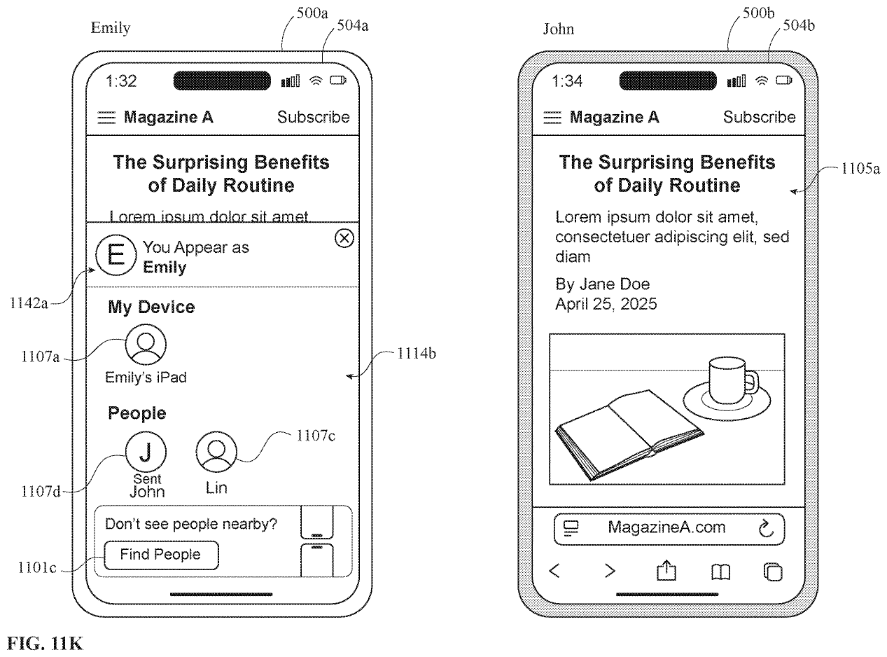

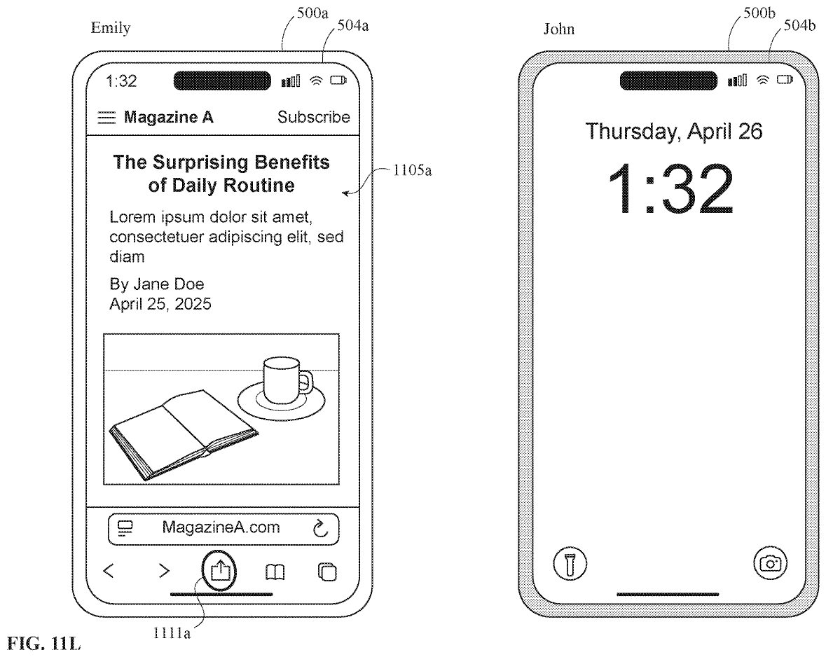

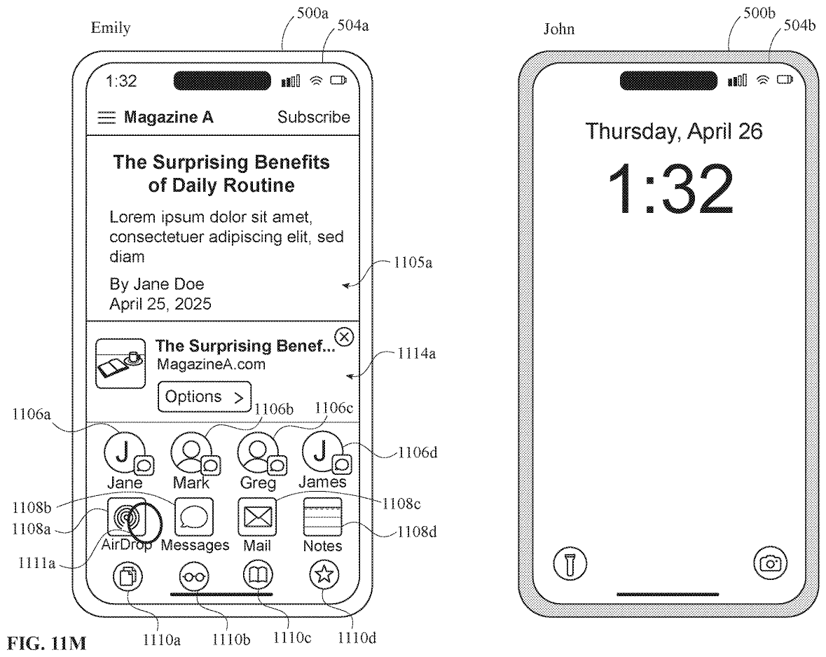

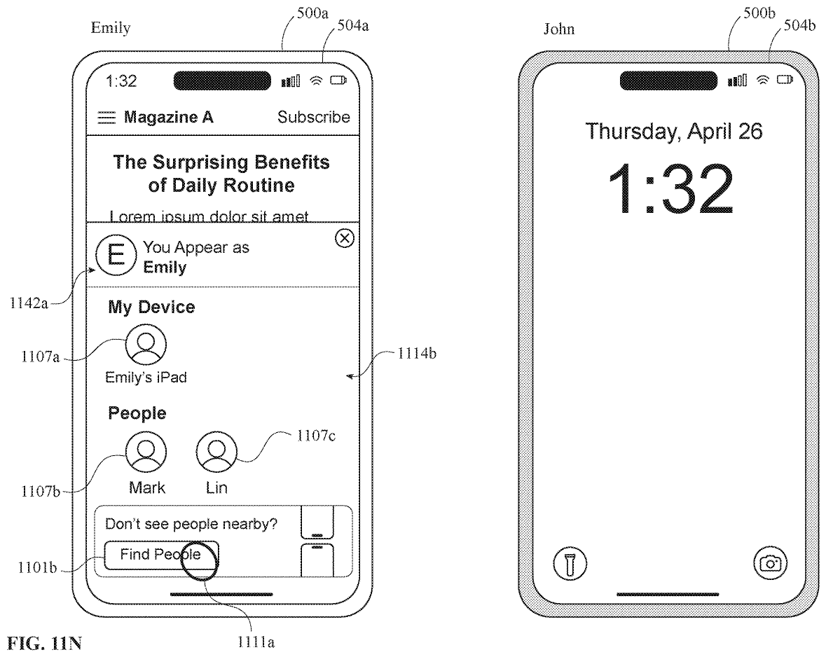

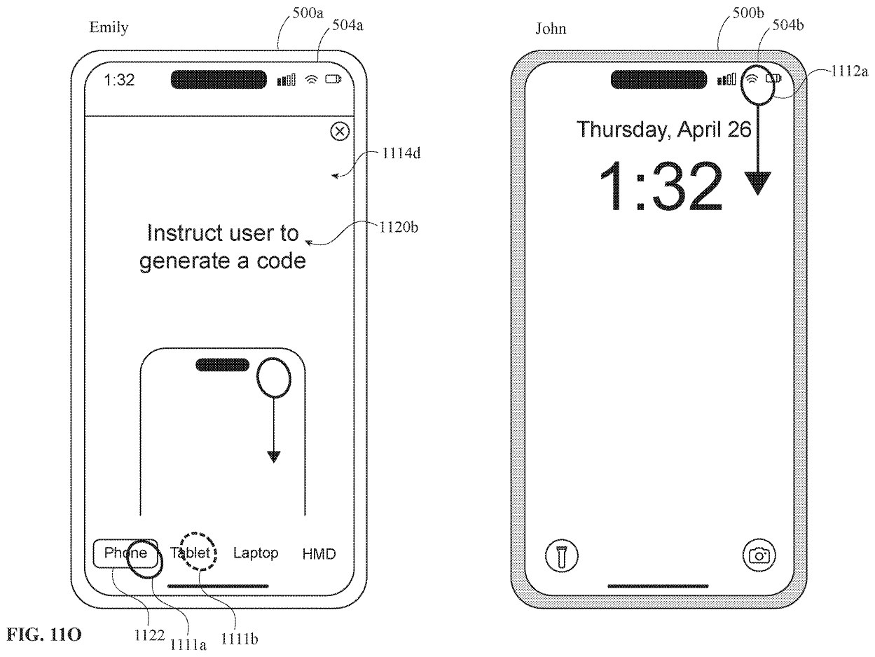

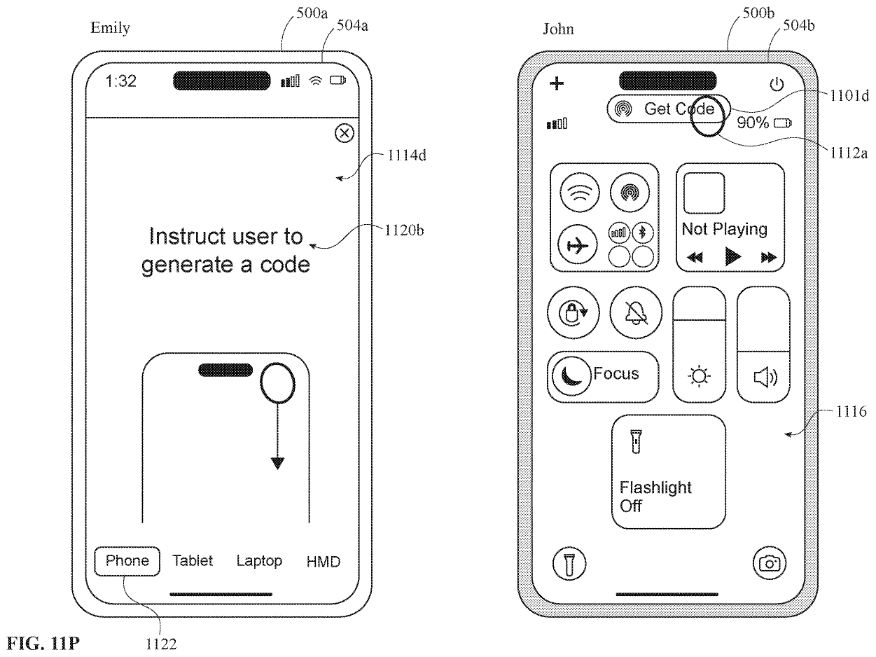

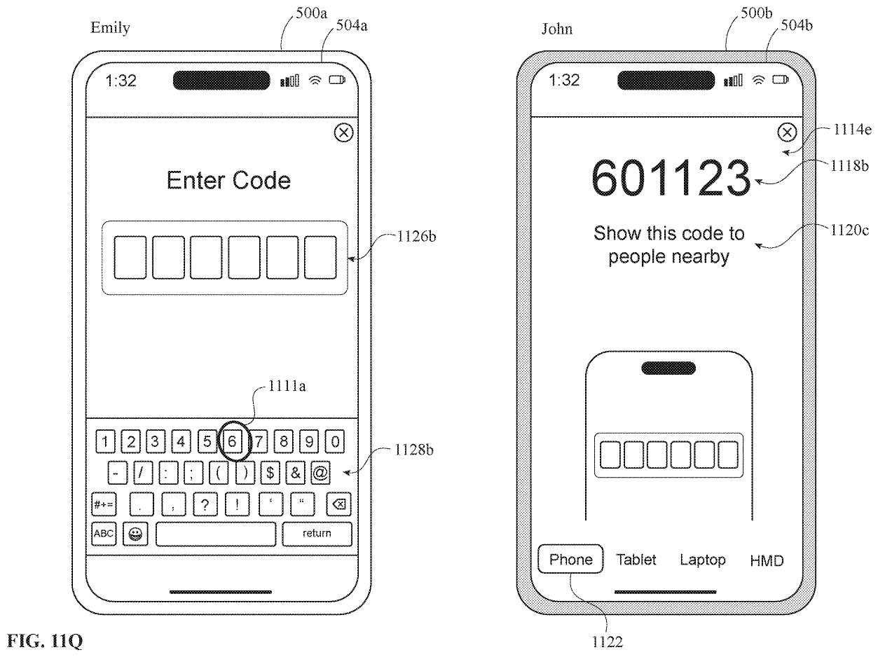

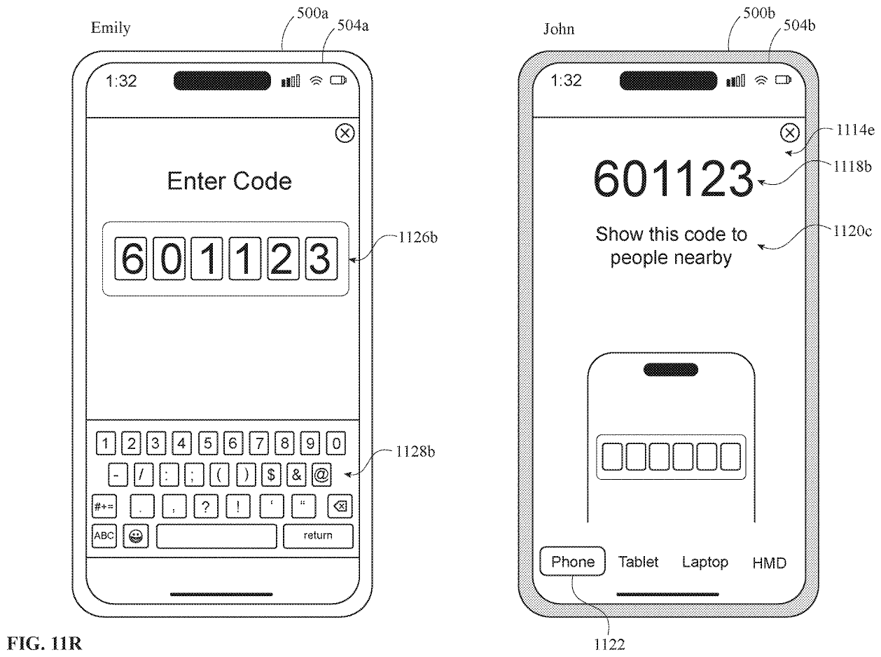

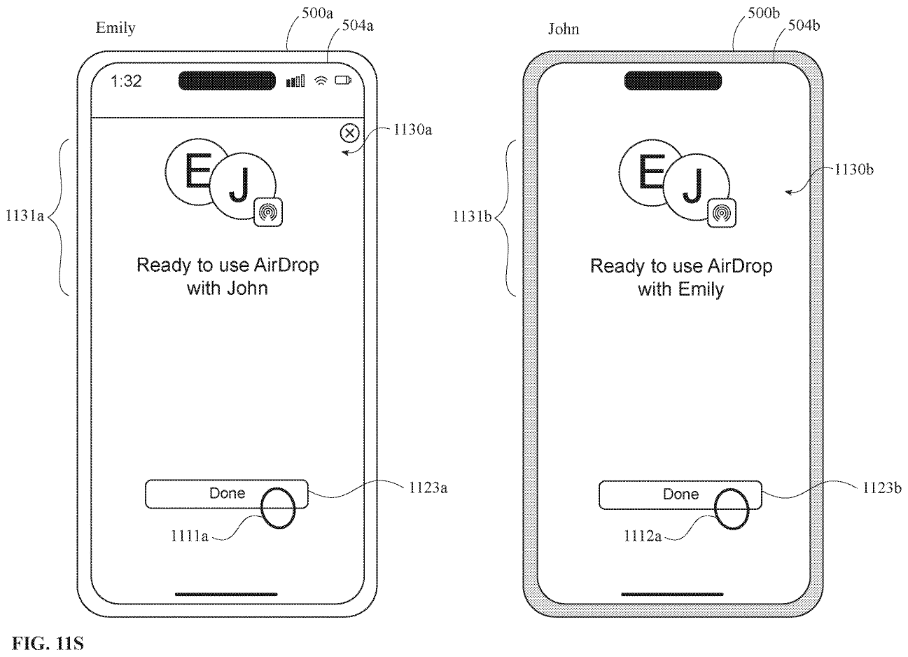

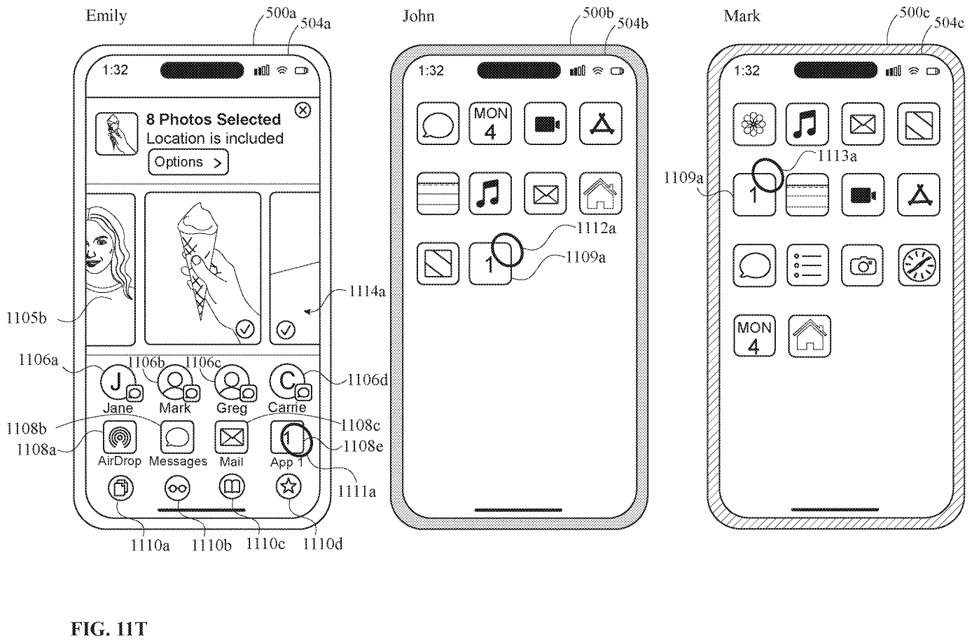

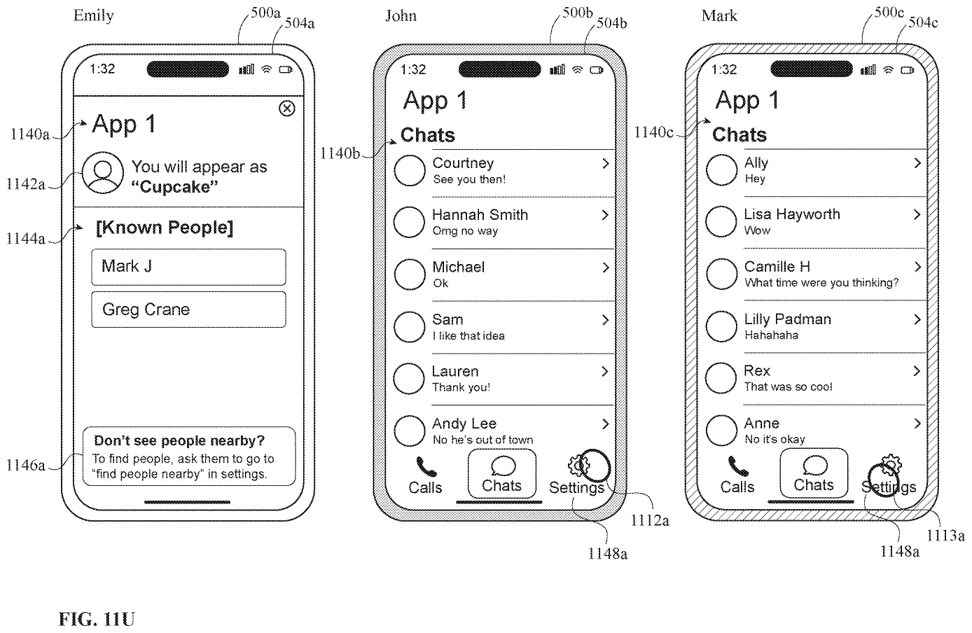

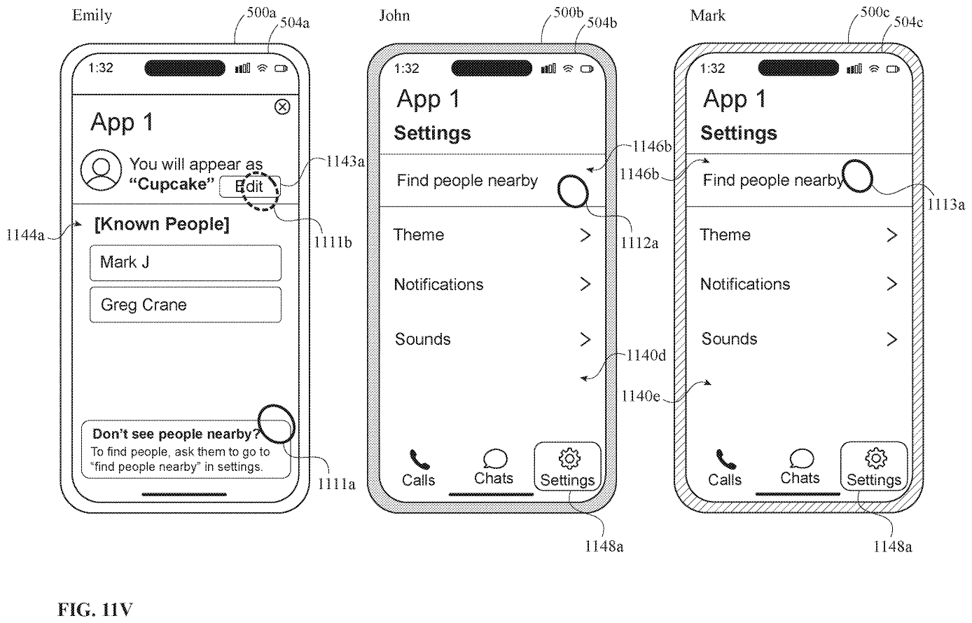

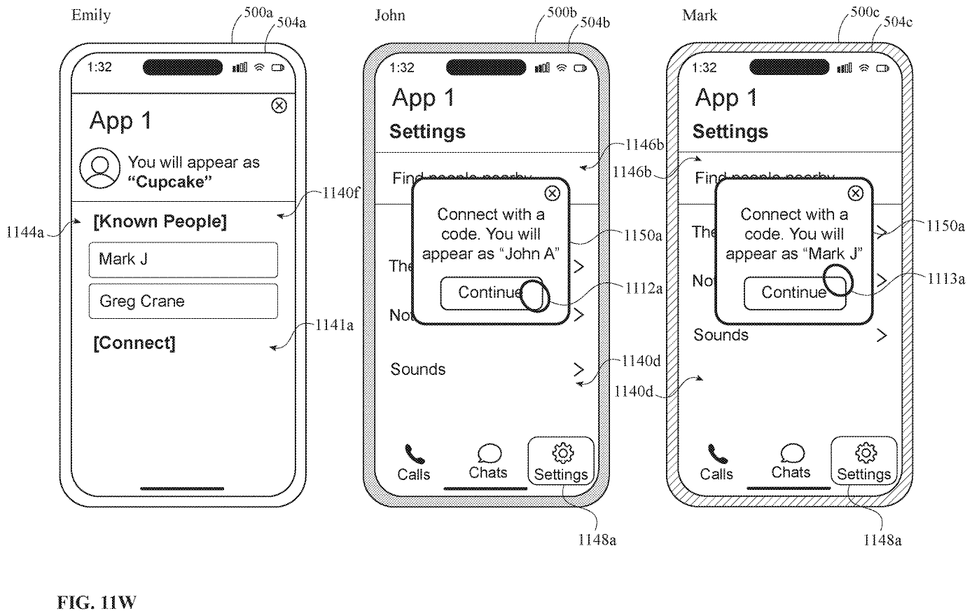

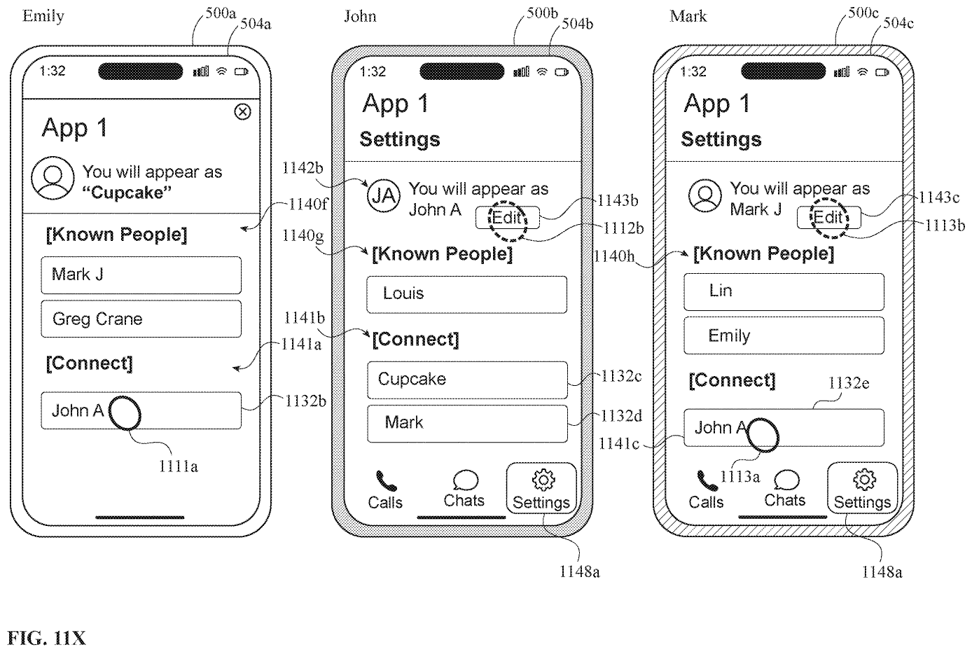

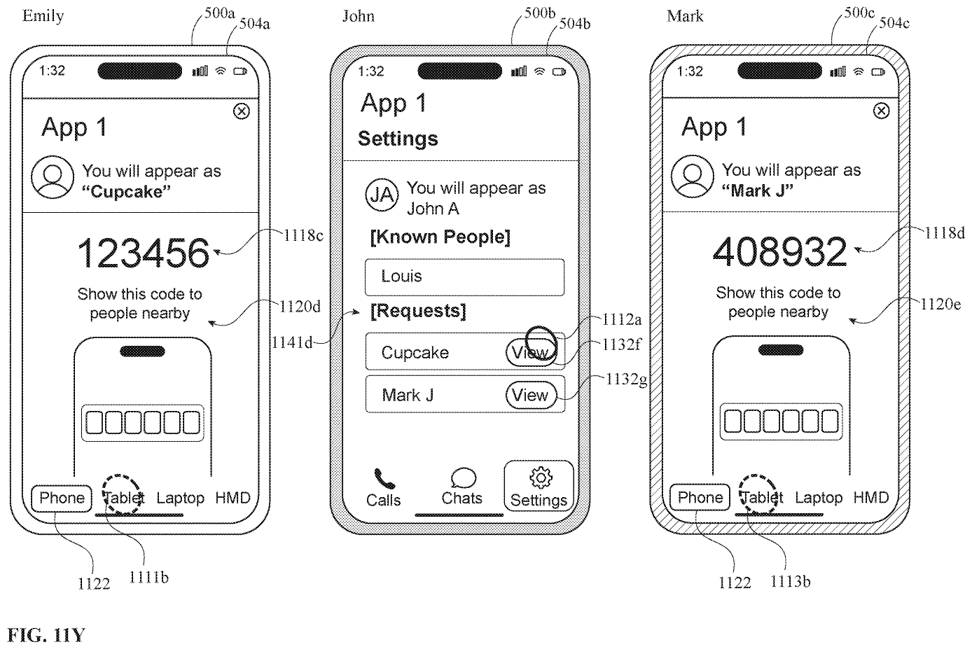

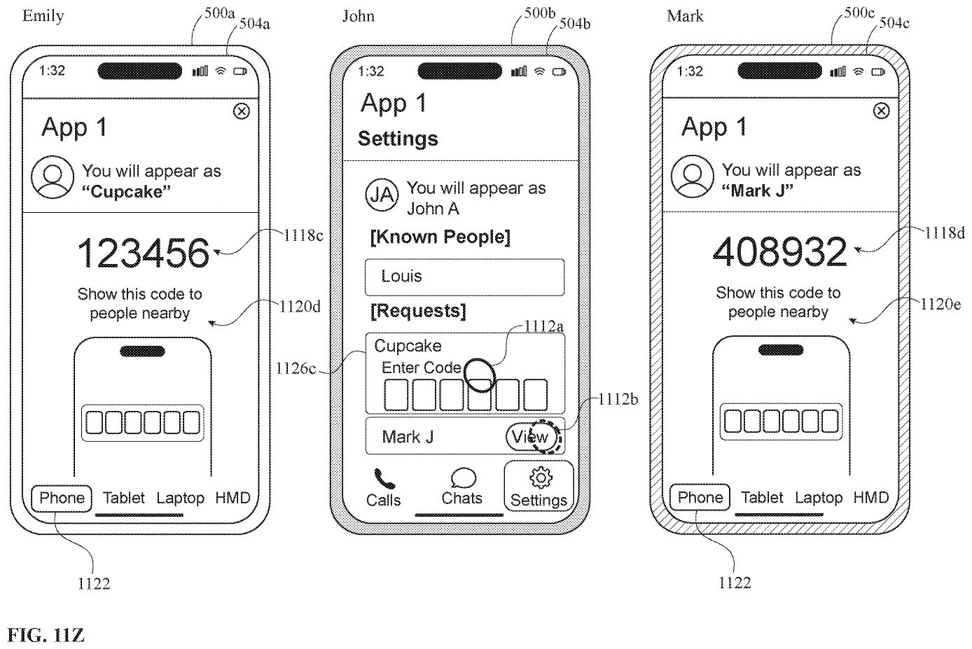

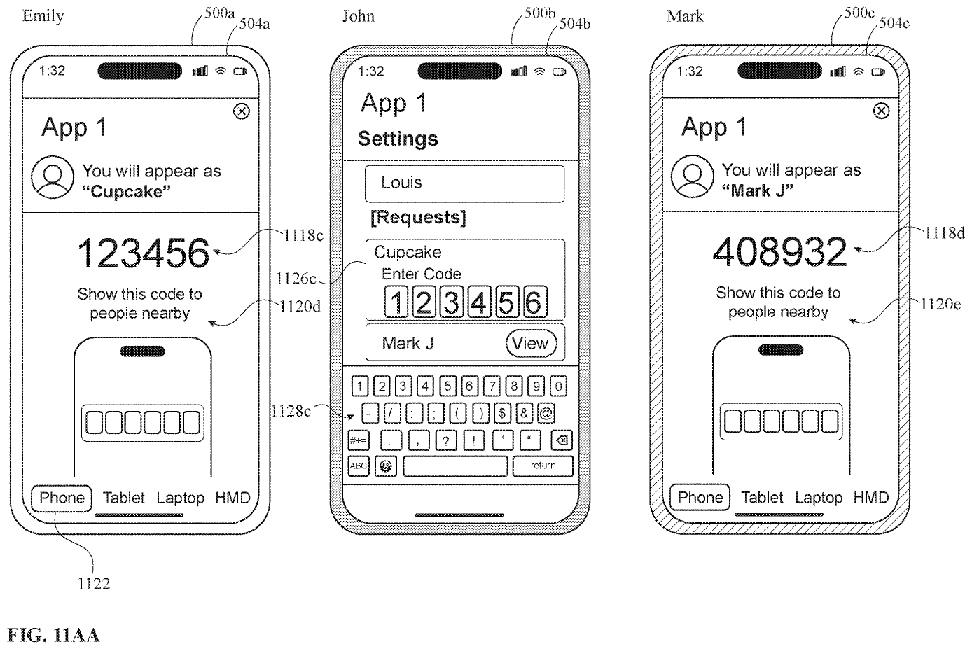

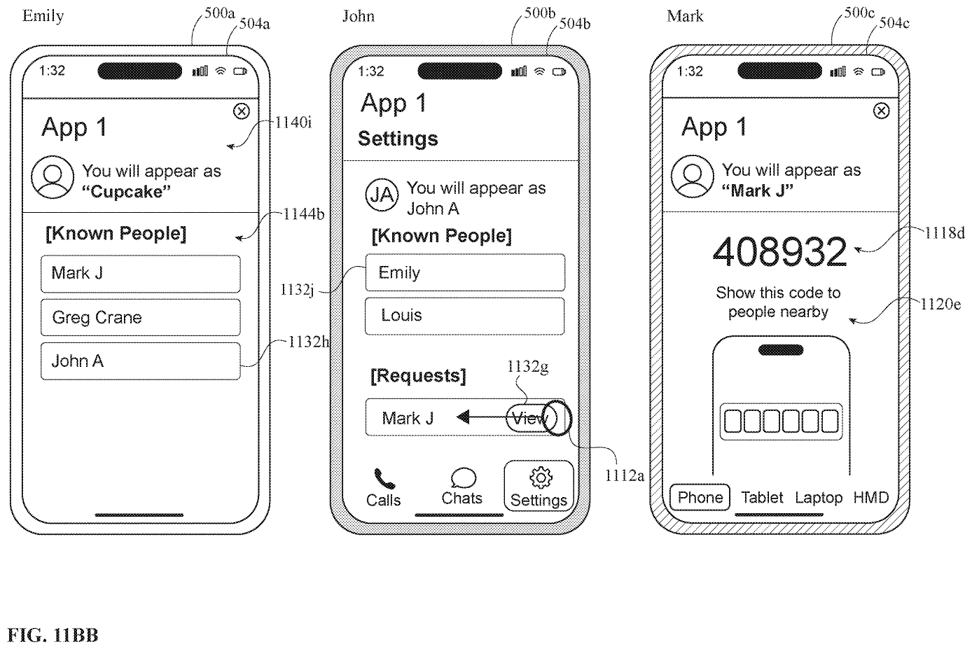

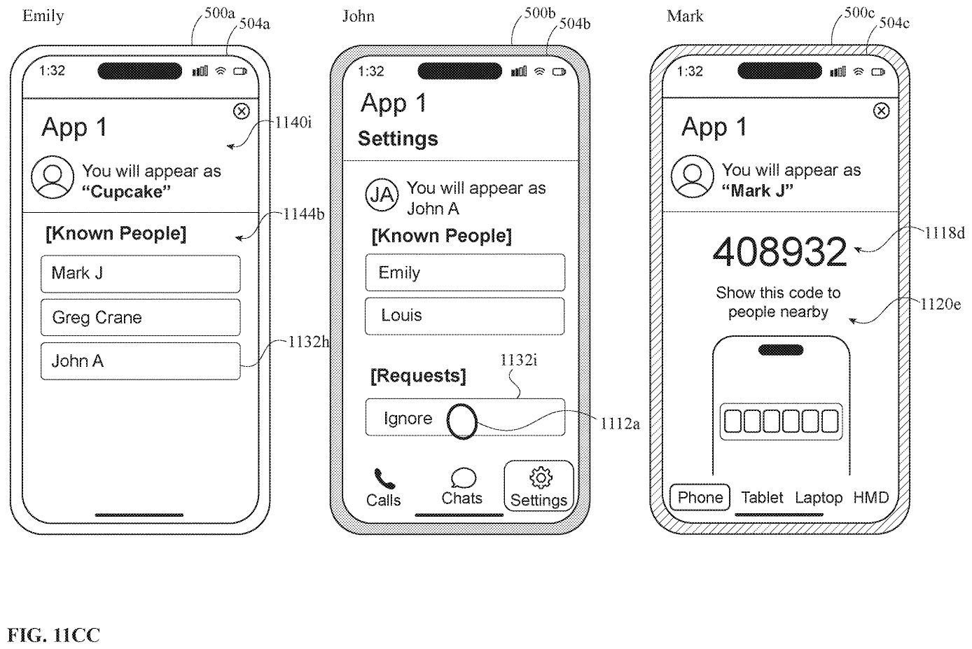

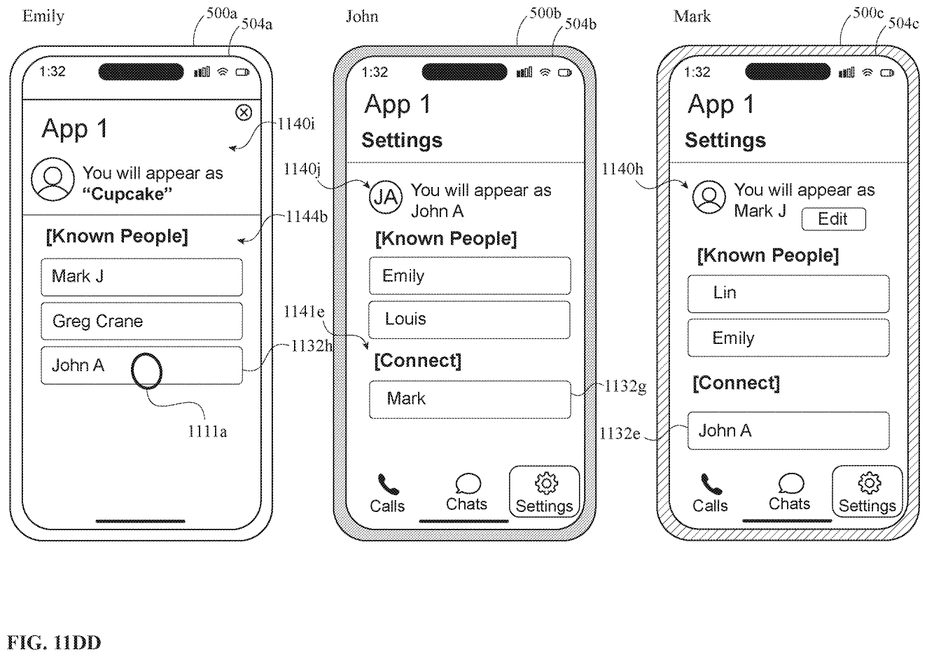

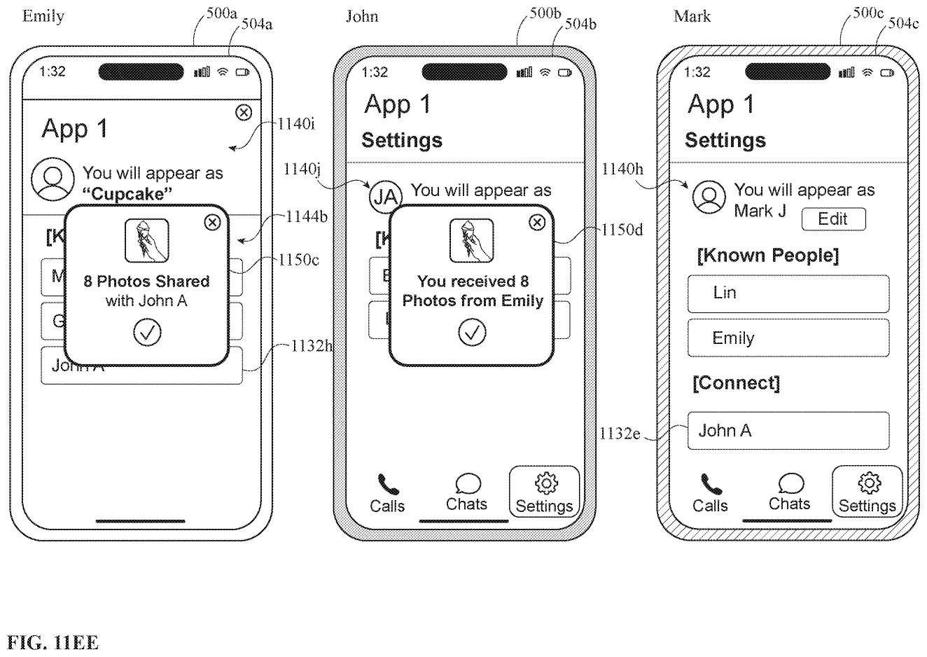

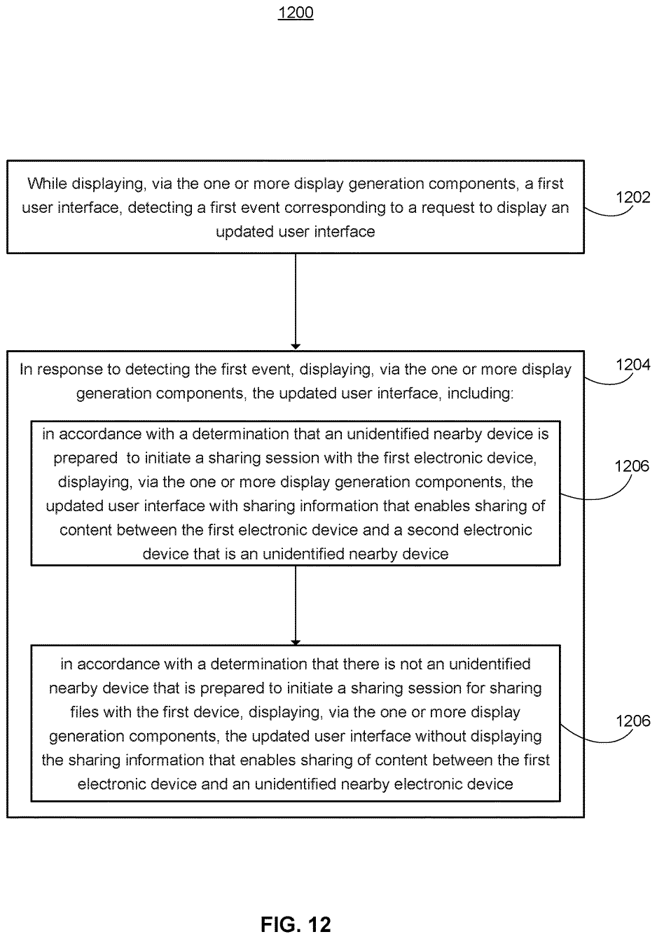

FIGS. 1A-6 provide a description of example computer systems for providing XR experiences to users (such as described below with respect to methods 800, 1000, and/or 1200). FIGS. 7A-7R illustrate example techniques in which a computer system initiates a process to display a representation of a three-dimensional virtual object via one or more head-mounted display generation components of a second computer system., in accordance with some embodiments. FIG. 8 illustrates a flow diagram of methods in which a computer system initiates a process to display a representation of a three-dimensional virtual object via one or more head-mounted display generation components of a second computer system, in accordance with some embodiments. The user interfaces in FIGS. 7A-7R are used to illustrate the processes in FIG. 8. FIGS. 9A-9O illustrate exemplary ways in which a computer system displays virtual windows and three-dimensional content in accordance with some embodiments of the disclosure. FIG. 10 illustrates a flow diagram illustrating a method in which a computer system in accordance with some embodiments of the disclosure. The user interfaces in FIGS. 9A-9O are used to illustrate the processes in FIG. 10. FIGS. 11A-11EE illustrate exemplary ways in which a first electronic device displays a user interface associated with sharing information in accordance with some embodiments of the disclosure. FIG. 12 illustrates a flow diagram illustrating a method in which a first electronic device displays a user interface associated with sharing information in accordance with some embodiments of the disclosure. The user interfaces in FIGS. 11A-11EE are used to illustrate the processes in FIG. 12.

The processes described below enhance the operability of the devices and make the user-device interfaces more efficient (e.g., by helping the user to provide proper inputs and reducing user mistakes when operating/interacting with the device) through various techniques, including by providing improved visual feedback to the user, reducing the number of inputs needed to perform an operation, providing additional control options without cluttering the user interface with additional displayed controls, performing an operation when a set of conditions has been met without requiring further user input, improving privacy and/or security, providing a more varied, detailed, and/or realistic user experience while saving storage space, and/or additional techniques. These techniques also reduce power usage and improve battery life of the device by enabling the user to use the device more quickly and efficiently. Saving on battery power, and thus weight, improves the ergonomics of the device. These techniques also enable real-time communication, allow for the use of fewer and/or less-precise sensors resulting in a more compact, lighter, and cheaper device, and enable the device to be used in a variety of lighting conditions. These techniques reduce energy usage, thereby reducing heat emitted by the device, which is particularly important for a wearable device where a device well within operational parameters for device components can become uncomfortable for a user to wear if it is producing too much heat.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

In some embodiments, as shown in FIG. 1A, the XR experience is provided to the user via an operating environment 100 that includes a computer system 101. The computer system 101 includes a controller 110 (e.g., processors of a portable electronic device or a remote server), a display generation component 120 (e.g., a head-mounted device (HMD), a display, a projector, a touch-screen, etc.), one or more input devices 125 (e.g., an eye tracking device 130, a hand tracking device 140, other input devices 150), one or more output devices 155 (e.g., speakers 160, tactile output generators 170, and other output devices 180), one or more sensors 190 (e.g., image sensors, light sensors, depth sensors, tactile sensors, orientation sensors, proximity sensors, temperature sensors, location sensors, motion sensors, velocity sensors, etc.), and optionally one or more peripheral devices 195 (e.g., home appliances, wearable devices, etc.). In some embodiments, one or more of the input devices 125, output devices 155, sensors 190, and peripheral devices 195 are integrated with the display generation component 120 (e.g., in a head-mounted device or a handheld device).

When describing an XR experience, various terms are used to differentially refer to several related but distinct environments that the user may sense and/or with which a user may interact (e.g., with inputs detected by a computer system 101 generating the XR experience that cause the computer system generating the XR experience to generate audio, visual, and/or tactile feedback corresponding to various inputs provided to the computer system 101). The following is a subset of these terms:

Physical environment: A physical environment refers to a physical world that people can sense and/or interact with without aid of electronic systems. Physical environments, such as a physical park, include physical articles, such as physical trees, physical buildings, and physical people. People can directly sense and/or interact with the physical environment, such as through sight, touch, hearing, taste, and smell.

Extended reality: In contrast, an extended reality (XR) environment refers to a wholly or partially simulated environment that people sense and/or interact with via an electronic system. In XR, a subset of a person's physical motions, or representations thereof, are tracked, and, in response, one or more characteristics of one or more virtual objects simulated in the XR environment are adjusted in a manner that comports with at least one law of physics. For example, a×R system may detect a person's head turning and, in response, adjust graphical content and an acoustic field presented to the person in a manner similar to how such views and sounds would change in a physical environment. In some situations (e.g., for accessibility reasons), adjustments to characteristic(s) of virtual object(s) in a XR environment may be made in response to representations of physical motions (e.g., vocal commands). A person may sense and/or interact with a XR object using any one of their senses, including sight, sound, touch, taste, and smell. For example, a person may sense and/or interact with audio objects that create a 3D or spatial audio environment that provides the perception of point audio sources in 3D space. In another example, audio objects may enable audio transparency, which selectively incorporates ambient sounds from the physical environment with or without computer-generated audio. In some XR environments, a person may sense and/or interact only with audio objects.

Examples of XR include virtual reality and mixed reality.

Virtual reality: A virtual reality (VR) environment refers to a simulated environment that is designed to be based entirely on computer-generated sensory inputs for one or more senses. A VR environment comprises a plurality of virtual objects with which a person may sense and/or interact. For example, computer-generated imagery of trees, buildings, and avatars representing people are examples of virtual objects. A person may sense and/or interact with virtual objects in the VR environment through a simulation of the person's presence within the computer-generated environment, and/or through a simulation of a subset of the person's physical movements within the computer-generated environment.

Mixed reality: In contrast to a VR environment, which is designed to be based entirely on computer-generated sensory inputs, a mixed reality (MR) environment refers to a simulated environment that is designed to incorporate sensory inputs from the physical environment, or a representation thereof, in addition to including computer-generated sensory inputs (e.g., virtual objects). On a virtuality continuum, a mixed reality environment is anywhere between, but not including, a wholly physical environment at one end and virtual reality environment at the other end. In some MR environments, computer-generated sensory inputs may respond to changes in sensory inputs from the physical environment. Also, some electronic systems for presenting an MR environment may track location and/or orientation with respect to the physical environment to enable virtual objects to interact with real objects (that is, physical articles from the physical environment or representations thereof). For example, a system may account for movements so that a virtual tree appears stationary with respect to the physical ground.

Examples of mixed realities include augmented reality and augmented virtuality.

Augmented reality: An augmented reality (AR) environment refers to a simulated environment in which one or more virtual objects are superimposed over a physical environment, or a representation thereof. For example, an electronic system for presenting an AR environment may have a transparent or translucent display through which a person may directly view the physical environment. The system may be configured to present virtual objects on the transparent or translucent display, so that a person, using the system, perceives the virtual objects superimposed over the physical environment. Alternatively, a system may have an opaque display and one or more imaging sensors that capture images or video of the physical environment, which are representations of the physical environment. The system composites the images or video with virtual objects, and presents the composition on the opaque display. A person, using the system, indirectly views the physical environment by way of the images or video of the physical environment, and perceives the virtual objects superimposed over the physical environment. As used herein, a video of the physical environment shown on an opaque display is called “pass-through video,” meaning a system uses one or more image sensor(s) to capture images of the physical environment, and uses those images in presenting the AR environment on the opaque display. Further alternatively, a system may have a projection system that projects virtual objects into the physical environment, for example, as a hologram or on a physical surface, so that a person, using the system, perceives the virtual objects superimposed over the physical environment. An augmented reality environment also refers to a simulated environment in which a representation of a physical environment is transformed by computer-generated sensory information. For example, in providing pass-through video, a system may transform one or more sensor images to impose a select perspective (e.g., viewpoint) different than the perspective captured by the imaging sensors. As another example, a representation of a physical environment may be transformed by graphically modifying (e.g., enlarging) portions thereof, such that the modified portion may be representative but not photorealistic versions of the originally captured images. As a further example, a representation of a physical environment may be transformed by graphically eliminating or obfuscating portions thereof.

Augmented virtuality: An augmented virtuality (AV) environment refers to a simulated environment in which a virtual or computer-generated environment incorporates one or more sensory inputs from the physical environment. The sensory inputs may be representations of one or more characteristics of the physical environment. For example, an AV park may have virtual trees and virtual buildings, but people with faces photorealistically reproduced from images taken of physical people. As another example, a virtual object may adopt a shape or color of a physical article imaged by one or more imaging sensors. As a further example, a virtual object may adopt shadows consistent with the position of the sun in the physical environment.

In an augmented reality, mixed reality, or virtual reality environment, a view of a three-dimensional environment is visible to a user. The view of the three-dimensional environment is typically visible to the user via one or more display generation components (e.g., a display or a pair of display modules that provide stereoscopic content to different eyes of the same user) through a virtual viewport that has a viewport boundary that defines an extent of the three-dimensional environment that is visible to the user via the one or more display generation components. In some embodiments, the region defined by the viewport boundary is smaller than a range of vision of the user in one or more dimensions (e.g., based on the range of vision of the user, size, optical properties or other physical characteristics of the one or more display generation components, and/or the location and/or orientation of the one or more display generation components relative to the eyes of the user). In some embodiments, the region defined by the viewport boundary is larger than a range of vision of the user in one or more dimensions (e.g., based on the range of vision of the user, size, optical properties or other physical characteristics of the one or more display generation components, and/or the location and/or orientation of the one or more display generation components relative to the eyes of the user). The viewport and viewport boundary typically move as the one or more display generation components move (e.g., moving with a head of the user for a head-mounted device or moving with a hand of a user for a handheld device such as a tablet or smartphone). A viewpoint of a user determines what content is visible in the viewport, a viewpoint generally specifies a location and a direction relative to the three-dimensional environment, and as the viewpoint shifts, the view of the three-dimensional environment will also shift in the viewport. For a head-mounted device, a viewpoint is typically based on a location an direction of the head, face, and/or eyes of a user to provide a view of the three-dimensional environment that is perceptually accurate and provides an immersive experience when the user is using the head-mounted device. For a handheld or stationed device, the viewpoint shifts as the handheld or stationed device is moved and/or as a position of a user relative to the handheld or stationed device changes (e.g., a user moving toward, away from, up, down, to the right, and/or to the left of the device). For devices that include display generation components with virtual passthrough, portions of the physical environment that are visible (e.g., displayed, and/or projected) via the one or more display generation components are based on a field of view of one or more cameras in communication with the display generation components which typically move with the display generation components (e.g., moving with a head of the user for a head-mounted device or moving with a hand of a user for a handheld device such as a tablet or smartphone) because the viewpoint of the user moves as the field of view of the one or more cameras moves (and the appearance of one or more virtual objects displayed via the one or more display generation components is updated based on the viewpoint of the user (e.g., displayed positions and poses of the virtual objects are updated based on the movement of the viewpoint of the user)). For display generation components with optical passthrough, portions of the physical environment that are visible (e.g., optically visible through one or more partially or fully transparent portions of the display generation component) via the one or more display generation components are based on a field of view of a user through the partially or fully transparent portion(s) of the display generation component (e.g., moving with a head of the user for a head-mounted device or moving with a hand of a user for a handheld device such as a tablet or smartphone) because the viewpoint of the user moves as the field of view of the user through the partially or fully transparent portions of the display generation components moves (and the appearance of one or more virtual objects is updated based on the viewpoint of the user).

In some embodiments a representation of a physical environment (e.g., displayed via virtual passthrough or optical passthrough) can be partially or fully obscured by a virtual environment. In some embodiments, the amount of virtual environment that is displayed (e.g., the amount of physical environment that is not displayed) is based on an immersion level for the virtual environment (e.g., with respect to the representation of the physical environment). For example, increasing the immersion level optionally causes more of the virtual environment to be displayed, replacing and/or obscuring more of the physical environment, and reducing the immersion level optionally causes less of the virtual environment to be displayed, revealing portions of the physical environment that were previously not displayed and/or obscured. In some embodiments, at a particular immersion level, one or more first background objects (e.g., in the representation of the physical environment) are visually de-emphasized (e.g., dimmed, blurred, and/or displayed with increased transparency) more than one or more second background objects, and one or more third background objects cease to be displayed. In some embodiments, a level of immersion includes an associated degree to which the virtual content displayed by the computer system (e.g., the virtual environment and/or the virtual content) obscures background content (e.g., content other than the virtual environment and/or the virtual content) around/behind the virtual content, optionally including the number of items of background content displayed and/or the visual characteristics (e.g., colors, contrast, and/or opacity) with which the background content is displayed, the angular range of the virtual content displayed via the display generation component (e.g., 60 degrees of content displayed at low immersion, 120 degrees of content displayed at medium immersion, or 180 degrees of content displayed at high immersion), and/or the proportion of the field of view displayed via the display generation component that is consumed by the virtual content (e.g., 33% of the field of view consumed by the virtual content at low immersion, 66% of the field of view consumed by the virtual content at medium immersion, or 100% of the field of view consumed by the virtual content at high immersion). In some embodiments, the background content is included in a background over which the virtual content is displayed (e.g., background content in the representation of the physical environment). In some embodiments, the background content includes user interfaces (e.g., user interfaces generated by the computer system corresponding to applications), virtual objects (e.g., files or representations of other users generated by the computer system) not associated with or included in the virtual environment and/or virtual content, and/or real objects (e.g., pass-through objects representing real objects in the physical environment around the user that are visible such that they are displayed via the display generation component and/or a visible via a transparent or translucent component of the display generation component because the computer system does not obscure/prevent visibility of them through the display generation component). In some embodiments, at a low level of immersion (e.g., a first level of immersion), the background, virtual and/or real objects are displayed in an unobscured manner. For example, a virtual environment with a low level of immersion is optionally displayed concurrently with the background content, which is optionally displayed with full brightness, color, and/or translucency. In some embodiments, at a higher level of immersion (e.g., a second level of immersion higher than the first level of immersion), the background, virtual and/or real objects are displayed in an obscured manner (e.g., dimmed, blurred, or removed from display). For example, a respective virtual environment with a high level of immersion is displayed without concurrently displaying the background content (e.g., in a full screen or fully immersive mode). As another example, a virtual environment displayed with a medium level of immersion is displayed concurrently with darkened, blurred, or otherwise de-emphasized background content. In some embodiments, the visual characteristics of the background objects vary among the background objects. For example, at a particular immersion level, one or more first background objects are visually de-emphasized (e.g., dimmed, blurred, and/or displayed with increased transparency) more than one or more second background objects, and one or more third background objects cease to be displayed. In some embodiments, a null or zero level of immersion corresponds to the virtual environment ceasing to be displayed and instead a representation of a physical environment is displayed (optionally with one or more virtual objects such as application, windows, or virtual three-dimensional objects) without the representation of the physical environment being obscured by the virtual environment. Adjusting the level of immersion using a physical input element provides for quick and efficient method of adjusting immersion, which enhances the operability of the computer system and makes the user-device interface more efficient.

Viewpoint-locked virtual object: A virtual object is viewpoint-locked when a computer system displays the virtual object at the same location and/or position in the viewpoint of the user, even as the viewpoint of the user shifts (e.g., changes). In embodiments where the computer system is a head-mounted device, the viewpoint of the user is locked to the forward facing direction of the user's head (e.g., the viewpoint of the user is at least a portion of the field-of-view of the user when the user is looking straight ahead); thus, the viewpoint of the user remains fixed even as the user's gaze is shifted, without moving the user's head. In embodiments where the computer system has a display generation component (e.g., a display screen) that can be repositioned with respect to the user's head, the viewpoint of the user is the augmented reality view that is being presented to the user on a display generation component of the computer system. For example, a viewpoint-locked virtual object that is displayed in the upper left corner of the viewpoint of the user, when the viewpoint of the user is in a first orientation (e.g., with the user's head facing north) continues to be displayed in the upper left corner of the viewpoint of the user, even as the viewpoint of the user changes to a second orientation (e.g., with the user's head facing west). In other words, the location and/or position at which the viewpoint-locked virtual object is displayed in the viewpoint of the user is independent of the user's position and/or orientation in the physical environment. In embodiments in which the computer system is a head-mounted device, the viewpoint of the user is locked to the orientation of the user's head, such that the virtual object is also referred to as a “head-locked virtual object.”

Environment-locked virtual object: A virtual object is environment-locked (alternatively, “world-locked”) when a computer system displays the virtual object at a location and/or position in the viewpoint of the user that is based on (e.g., selected in reference to and/or anchored to) a location and/or object in the three-dimensional environment (e.g., a physical environment or a virtual environment). As the viewpoint of the user shifts, the location and/or object in the environment relative to the viewpoint of the user changes, which results in the environment-locked virtual object being displayed at a different location and/or position in the viewpoint of the user. For example, an environment-locked virtual object that is locked onto a tree that is immediately in front of a user is displayed at the center of the viewpoint of the user. When the viewpoint of the user shifts to the right (e.g., the user's head is turned to the right) so that the tree is now left-of-center in the viewpoint of the user (e.g., the tree's position in the viewpoint of the user shifts), the environment-locked virtual object that is locked onto the tree is displayed left-of-center in the viewpoint of the user. In other words, the location and/or position at which the environment-locked virtual object is displayed in the viewpoint of the user is dependent on the position and/or orientation of the location and/or object in the environment onto which the virtual object is locked. In some embodiments, the computer system uses a stationary frame of reference (e.g., a coordinate system that is anchored to a fixed location and/or object in the physical environment) in order to determine the position at which to display an environment-locked virtual object in the viewpoint of the user. An environment-locked virtual object can be locked to a stationary part of the environment (e.g., a floor, wall, table, or other stationary object) or can be locked to a moveable part of the environment (e.g., a vehicle, animal, person, or even a representation of portion of the users body that moves independently of a viewpoint of the user, such as a user's hand, wrist, arm, or foot) so that the virtual object is moved as the viewpoint or the portion of the environment moves to maintain a fixed relationship between the virtual object and the portion of the environment.

In some embodiments a virtual object that is environment-locked or viewpoint-locked exhibits lazy follow behavior which reduces or delays motion of the environment-locked or viewpoint-locked virtual object relative to movement of a point of reference which the virtual object is following. In some embodiments, when exhibiting lazy follow behavior the computer system intentionally delays movement of the virtual object when detecting movement of a point of reference (e.g., a portion of the environment, the viewpoint, or a point that is fixed relative to the viewpoint, such as a point that is between 5-300 cm from the viewpoint) which the virtual object is following. For example, when the point of reference (e.g., the portion of the environment or the viewpoint) moves with a first speed, the virtual object is moved by the device to remain locked to the point of reference but moves with a second speed that is slower than the first speed (e.g., until the point of reference stops moving or slows down, at which point the virtual object starts to catch up to the point of reference). In some embodiments, when a virtual object exhibits lazy follow behavior the device ignores small amounts of movement of the point of reference (e.g., ignoring movement of the point of reference that is below a threshold amount of movement such as movement by 0-5 degrees or movement by 0-50 cm). For example, when the point of reference (e.g., the portion of the environment or the viewpoint to which the virtual object is locked) moves by a first amount, a distance between the point of reference and the virtual object increases (e.g., because the virtual object is being displayed so as to maintain a fixed or substantially fixed position relative to a viewpoint or portion of the environment that is different from the point of reference to which the virtual object is locked) and when the point of reference (e.g., the portion of the environment or the viewpoint to which the virtual object is locked) moves by a second amount that is greater than the first amount, a distance between the point of reference and the virtual object initially increases (e.g., because the virtual object is being displayed so as to maintain a fixed or substantially fixed position relative to a viewpoint or portion of the environment that is different from the point of reference to which the virtual object is locked) and then decreases as the amount of movement of the point of reference increases above a threshold (e.g., a “lazy follow” threshold) because the virtual object is moved by the computer system to maintain a fixed or substantially fixed position relative to the point of reference. In some embodiments the virtual object maintaining a substantially fixed position relative to the point of reference includes the virtual object being displayed within a threshold distance (e.g., 1, 2, 3, 5, 15, 20, 50 cm) of the point of reference in one or more dimensions (e.g., up/down, left/right, and/or forward/backward relative to the position of the point of reference).

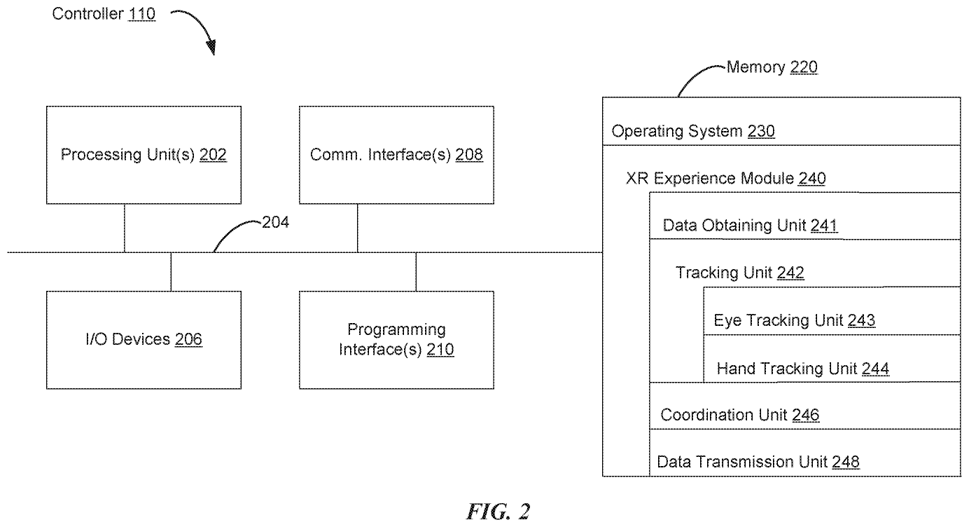

Hardware: There are many different types of electronic systems that enable a person to sense and/or interact with various XR environments. Examples include head-mounted systems, projection-based systems, heads-up displays (HUDs), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head-mounted system may have one or more speaker(s) and an integrated opaque display. Alternatively, a head-mounted system may be configured to accept an external opaque display (e.g., a smartphone). The head-mounted system may incorporate one or more imaging sensors to capture images or video of the physical environment, and/or one or more microphones to capture audio of the physical environment. Rather than an opaque display, a head-mounted system may have a transparent or translucent display. The transparent or translucent display may have a medium through which light representative of images is directed to a person's eyes. The display may utilize digital light projection, OLEDs, LEDs, uLEDs, liquid crystal on silicon, laser scanning light source, or any combination of these technologies. The medium may be an optical waveguide, a hologram medium, an optical combiner, an optical reflector, or any combination thereof. In one embodiment, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface. In some embodiments, the controller 110 is configured to manage and coordinate a XR experience for the user. In some embodiments, the controller 110 includes a suitable combination of software, firmware, and/or hardware. The controller 110 is described in greater detail below with respect to FIG. 2. In some embodiments, the controller 110 is a computing device that is local or remote relative to the scene 105 (e.g., a physical environment). For example, the controller 110 is a local server located within the scene 105. In another example, the controller 110 is a remote server located outside of the scene 105 (e.g., a cloud server, central server, etc.). In some embodiments, the controller 110 is communicatively coupled with the display generation component 120 (e.g., an HMD, a display, a projector, a touch-screen, etc.) via one or more wired or wireless communication channels 144 (e.g., BLUETOOTH, IEEE 802.11x, IEEE 802.16x, IEEE 802.3x, etc.). In another example, the controller 110 is included within the enclosure (e.g., a physical housing) of the display generation component 120 (e.g., an HMD, or a portable electronic device that includes a display and one or more processors, etc.), one or more of the input devices 125, one or more of the output devices 155, one or more of the sensors 190, and/or one or more of the peripheral devices 195, or share the same physical enclosure or support structure with one or more of the above.

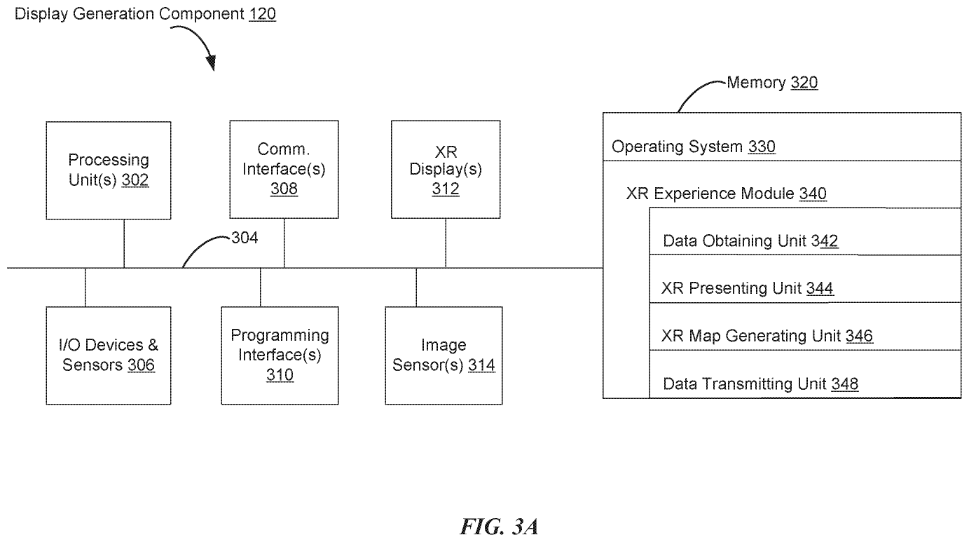

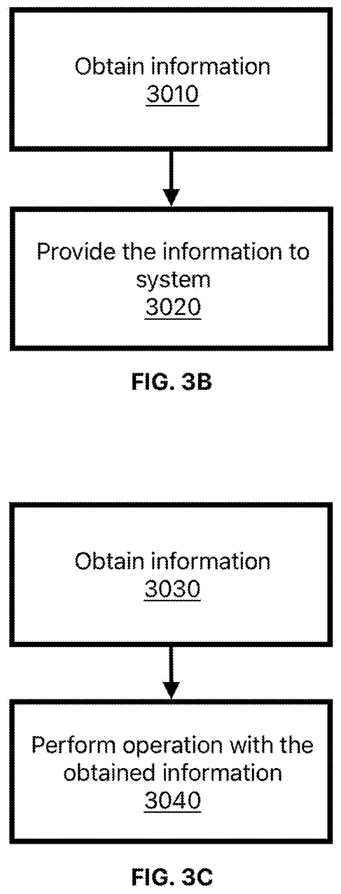

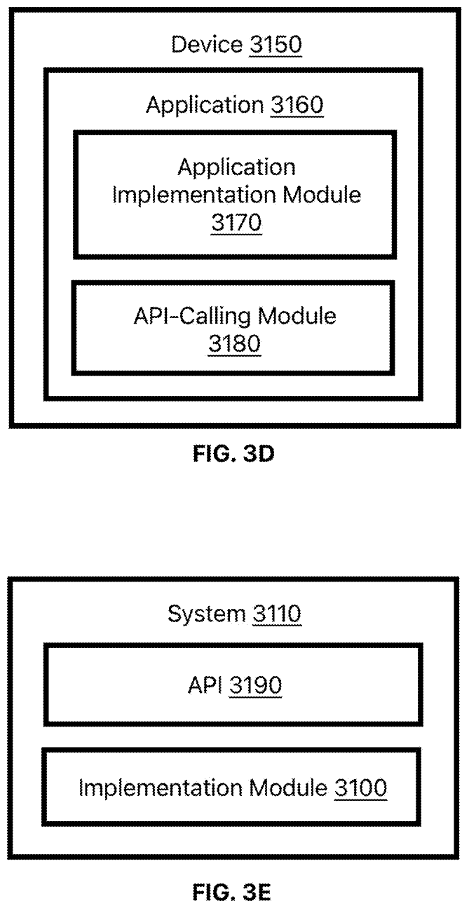

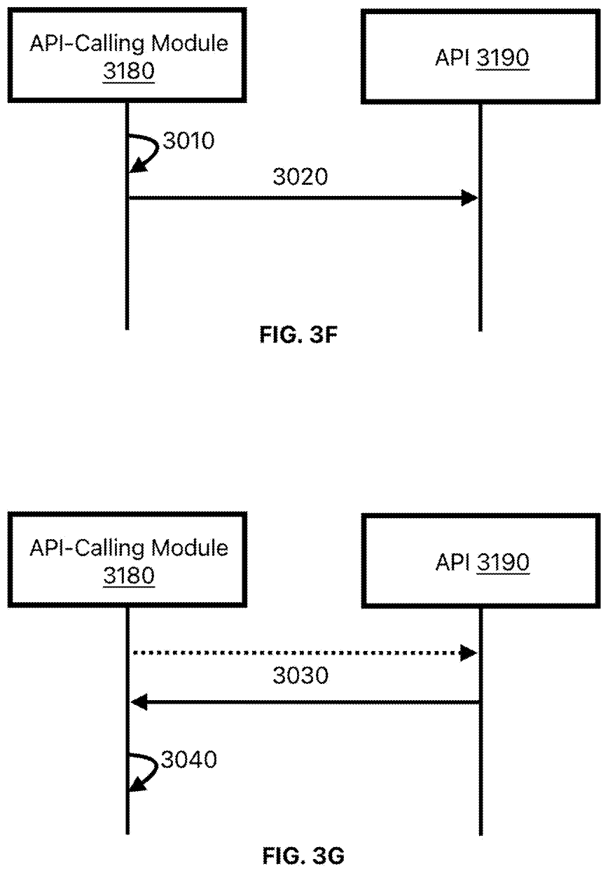

In some embodiments, the display generation component 120 is configured to provide the XR experience (e.g., at least a visual component of the XR experience) to the user. In some embodiments, the display generation component 120 includes a suitable combination of software, firmware, and/or hardware. The display generation component 120 is described in greater detail below with respect to FIG. 3A. In some embodiments, the functionalities of the controller 110 are provided by and/or combined with the display generation component 120.

According to some embodiments, the display generation component 120 provides an XR experience to the user while the user is virtually and/or physically present within the scene 105.

In some embodiments, the display generation component is worn on a part of the user's body (e.g., on his/her head, on his/her hand, etc.). As such, the display generation component 120 includes one or more XR displays provided to display the XR content. For example, in various embodiments, the display generation component 120 encloses the field-of-view of the user. In some embodiments, the display generation component 120 is a handheld device (such as a smartphone or tablet) configured to present XR content, and the user holds the device with a display directed towards the field-of-view of the user and a camera directed towards the scene 105. In some embodiments, the handheld device is optionally placed within an enclosure that is worn on the head of the user. In some embodiments, the handheld device is optionally placed on a support (e.g., a tripod) in front of the user. In some embodiments, the display generation component 120 is a XR chamber, enclosure, or room configured to present XR content in which the user does not wear or hold the display generation component 120. Many user interfaces described with reference to one type of hardware for displaying XR content (e.g., a handheld device or a device on a tripod) could be implemented on another type of hardware for displaying XR content (e.g., an HMD or other wearable computing device). For example, a user interface showing interactions with XR content triggered based on interactions that happen in a space in front of a handheld or tripod mounted device could similarly be implemented with an HMD where the interactions happen in a space in front of the HMD and the responses of the XR content are displayed via the HMD. Similarly, a user interface showing interactions with XR content triggered based on movement of a handheld or tripod mounted device relative to the physical environment (e.g., the scene 105 or a part of the user's body (e.g., the user's eye(s), head, or hand)) could similarly be implemented with an HMD where the movement is caused by movement of the HMD relative to the physical environment (e.g., the scene 105 or a part of the user's body (e.g., the user's eye(s), head, or hand)).

While pertinent features of the operating environment 100 are shown in FIG. 1A, those of ordinary skill in the art will appreciate from the present disclosure that various other features have not been illustrated for the sake of brevity and so as not to obscure more pertinent aspects of the example embodiments disclosed herein.

FIGS. 1A-1P illustrate various examples of a computer system that is used to perform the methods and provide audio, visual and/or haptic feedback as part of user interfaces described herein. In some embodiments, the computer system includes one or more display generation components (e.g., first and second display assemblies 1-120a, 1-120b and/or first and second optical modules 11.1.1-104a and 11.1.1-104b) for displaying virtual elements and/or a representation of a physical environment to a user of the computer system, optionally generated based on detected events and/or user inputs detected by the computer system. User interfaces generated by the computer system are optionally corrected by one or more corrective lenses 11.3.2-216 that are optionally removably attached to one or more of the optical modules to enable the user interfaces to be more easily viewed by users who would otherwise use glasses or contacts to correct their vision. While many user interfaces illustrated herein show a single view of a user interface, user interfaces in a HMD are optionally displayed using two optical modules (e.g., first and second display assemblies 1-120a, 1-120b and/or first and second optical modules 11.1.1-104a and 11.1.1-104b), one for a user's right eye and a different one for a user's left eye, and slightly different images are presented to the two different eyes to generate the illusion of stereoscopic depth, the single view of the user interface would typically be either a right-eye or left-eye view and the depth effect is explained in the text or using other schematic charts or views. In some embodiments, the computer system includes one or more external displays (e.g., display assembly 1-108) for displaying status information for the computer system to the user of the computer system (when the computer system is not being worn) and/or to other people who are near the computer system, optionally generated based on detected events and/or user inputs detected by the computer system. In some embodiments, the computer system includes one or more audio output components (e.g., electronic component 1-112) for generating audio feedback, optionally generated based on detected events and/or user inputs detected by the computer system. In some embodiments, the computer system includes one or more input devices for detecting input such as one or more sensors (e.g., one or more sensors in sensor assembly 1-356, and/or FIG. 1I) for detecting information about a physical environment of the device which can be used (optionally in conjunction with one or more illuminators such as the illuminators described in FIG. 1I) to generate a digital passthrough image, capture visual media corresponding to the physical environment (e.g., photos and/or video), or determine a pose (e.g., position and/or orientation) of physical objects and/or surfaces in the physical environment so that virtual objects ban be placed based on a detected pose of physical objects and/or surfaces. In some embodiments, the computer system includes one or more input devices for detecting input such as one or more sensors for detecting hand position and/or movement (e.g., one or more sensors in sensor assembly 1-356, and/or FIG. 1I) that can be used (optionally in conjunction with one or more illuminators such as the illuminators 6-124 described in FIG. 1I) to determine when one or more air gestures have been performed. In some embodiments, the computer system includes one or more input devices for detecting input such as one or more sensors for detecting eye movement (e.g., eye tracking and gaze tracking sensors in FIG. 1I) which can be used (optionally in conjunction with one or more lights such as lights 11.3.2-110 in FIG. 10) to determine attention or gaze position and/or gaze movement which can optionally be used to detect gaze-only inputs based on gaze movement and/or dwell. A combination of the various sensors described above can be used to determine user facial expressions and/or hand movements for use in generating an avatar or representation of the user such as an anthropomorphic avatar or representation for use in a real-time communication session where the avatar has facial expressions, hand movements, and/or body movements that are based on or similar to detected facial expressions, hand movements, and/or body movements of a user of the device. Gaze and/or attention information is, optionally, combined with hand tracking information to determine interactions between the user and one or more user interfaces based on direct and/or indirect inputs such as air gestures or inputs that use one or more hardware input devices such as one or more buttons (e.g., first button 1-128, button 11.1.1-114, second button 1-132, and or dial or button 1-328), knobs (e.g., first button 1-128, button 11.1.1-114, and/or dial or button 1-328), digital crowns (e.g., first button 1-128 which is depressible and twistable or rotatable, button 11.1.1-114, and/or dial or button 1-328), trackpads, touch screens, keyboards, mice and/or other input devices. One or more buttons (e.g., first button 1-128, button 11.1.1-114, second button 1-132, and or dial or button 1-328) are optionally used to perform system operations such as recentering content in three-dimensional environment that is visible to a user of the device, displaying a home user interface for launching applications, starting real-time communication sessions, or initiating display of virtual three-dimensional backgrounds. Knobs or digital crowns (e.g., first button 1-128 which is depressible and twistable or rotatable, button 11.1.1-114, and/or dial or button 1-328) are optionally rotatable to adjust parameters of the visual content such as a level of immersion of a virtual three-dimensional environment (e.g., a degree to which virtual-content occupies the viewport of the user into the three-dimensional environment) or other parameters associated with the three-dimensional environment and the virtual content that is displayed via the optical modules (e.g., first and second display assemblies 1-120a, 1-120b and/or first and second optical modules 11.1.1-104a and 11.1.1-104b).

FIG. 1B illustrates a front, top, perspective view of an example of a head-mountable display (HMD) device 1-100 configured to be donned by a user and provide virtual and altered/mixed reality (VR/AR) experiences. The HMD 1-100 can include a display unit 1-102 or assembly, an electronic strap assembly 1-104 connected to and extending from the display unit 1-102, and a band assembly 1-106 secured at either end to the electronic strap assembly 1-104. The electronic strap assembly 1-104 and the band 1-106 can be part of a retention assembly configured to wrap around a user's head to hold the display unit 1-102 against the face of the user.

In at least one example, the band assembly 1-106 can include a first band 1-116 configured to wrap around the rear side of a user's head and a second band 1-117 configured to extend over the top of a user's head. The second strap can extend between first and second electronic straps 1-105a, 1-105b of the electronic strap assembly 1-104 as shown. The strap assembly 1-104 and the band assembly 1-106 can be part of a securement mechanism extending rearward from the display unit 1-102 and configured to hold the display unit 1-102 against a face of a user.

In at least one example, the securement mechanism includes a first electronic strap 1-105a including a first proximal end 1-134 coupled to the display unit 1-102, for example a housing 1-150 of the display unit 1-102, and a first distal end 1-136 opposite the first proximal end 1-134. The securement mechanism can also include a second electronic strap 1-105b including a second proximal end 1-138 coupled to the housing 1-150 of the display unit 1-102 and a second distal end 1-140 opposite the second proximal end 1-138. The securement mechanism can also include the first band 1-116 including a first end 1-142 coupled to the first distal end 1-136 and a second end 1-144 coupled to the second distal end 1-140 and the second band 1-117 extending between the first electronic strap 1-105a and the second electronic strap 1-105b. The straps 1-105a-b and band 1-116 can be coupled via connection mechanisms or assemblies 1-114. In at least one example, the second band 1-117 includes a first end 1-146 coupled to the first electronic strap 1-105a between the first proximal end 1-134 and the first distal end 1-136 and a second end 1-148 coupled to the second electronic strap 1-105b between the second proximal end 1-138 and the second distal end 1-140.

In at least one example, the first and second electronic straps 1-105a-b include plastic, metal, or other structural materials forming the shape the substantially rigid straps 1-105a-b. In at least one example, the first and second bands 1-116, 1-117 are formed of elastic, flexible materials including woven textiles, rubbers, and the like. The first and second bands 1-116, 1-117 can be flexible to conform to the shape of the user' head when donning the HMD 1-100.

In at least one example, one or more of the first and second electronic straps 1-105a-b can define internal strap volumes and include one or more electronic components disposed in the internal strap volumes. In one example, as shown in FIG. 1B, the first electronic strap 1-105a can include an electronic component 1-112. In one example, the electronic component 1-112 can include a speaker. In one example, the electronic component 1-112 can include a computing component such as a processor.

In at least one example, the housing 1-150 defines a first, front-facing opening 1-152. The front-facing opening is labeled in dotted lines at 1-152 in FIG. 1B because the display assembly 1-108 is disposed to occlude the first opening 1-152 from view when the HMD 1-100 is assembled. The housing 1-150 can also define a rear-facing second opening 1-154. The housing 1-150 also defines an internal volume between the first and second openings 1-152, 1-154. In at least one example, the HMD 1-100 includes the display assembly 1-108, which can include a front cover and display screen (shown in other figures) disposed in or across the front opening 1-152 to occlude the front opening 1-152. In at least one example, the display screen of the display assembly 1-108, as well as the display assembly 1-108 in general, has a curvature configured to follow the curvature of a user's face. The display screen of the display assembly 1-108 can be curved as shown to compliment the user's facial features and general curvature from one side of the face to the other, for example from left to right and/or from top to bottom where the display unit 1-102 is pressed.

In at least one example, the housing 1-150 can define a first aperture 1-126 between the first and second openings 1-152, 1-154 and a second aperture 1-130 between the first and second openings 1-152, 1-154. The HMD 1-100 can also include a first button 1-128 disposed in the first aperture 1-126 and a second button 1-132 disposed in the second aperture 1-130. The first and second buttons 1-128, 1-132 can be depressible through the respective apertures 1-126, 1-130. In at least one example, the first button 1-126 and/or second button 1-132 can be twistable dials as well as depressible buttons. In at least one example, the first button 1-128 is a depressible and twistable dial button and the second button 1-132 is a depressible button.

FIG. 1C illustrates a rear, perspective view of the HMD 1-100. The HMD 1-100 can include a light seal 1-110 extending rearward from the housing 1-150 of the display assembly 1-108 around a perimeter of the housing 1-150 as shown. The light seal 1-110 can be configured to extend from the housing 1-150 to the user's face around the user's eyes to block external light from being visible. In one example, the HMD 1-100 can include first and second display assemblies 1-120a, 1-120b disposed at or in the rearward facing second opening 1-154 defined by the housing 1-150 and/or disposed in the internal volume of the housing 1-150 and configured to project light through the second opening 1-154. In at least one example, each display assembly 1-120a-b can include respective display screens 1-122a, 1-122b configured to project light in a rearward direction through the second opening 1-154 toward the user's eyes.

In at least one example, referring to both FIGS. 1B and 1C, the display assembly 1-108 can be a front-facing, forward display assembly including a display screen configured to project light in a first, forward direction and the rear facing display screens 1-122a-b can be configured to project light in a second, rearward direction opposite the first direction. As noted above, the light seal 1-110 can be configured to block light external to the HMD 1-100 from reaching the user's eyes, including light projected by the forward facing display screen of the display assembly 1-108 shown in the front perspective view of FIG. 1B. In at least one example, the HMD 1-100 can also include a curtain 1-124 occluding the second opening 1-154 between the housing 1-150 and the rear-facing display assemblies 1-120a-b. In at least one example, the curtain 1-124 can be elastic or at least partially elastic.

Any of the features, components, and/or parts, including the arrangements and configurations thereof shown in FIGS. 1B and 1C can be included, either alone or in any combination, in any of the other examples of devices, features, components, and parts shown in FIGS. 1D-1F and described herein. Likewise, any of the features, components, and/or parts, including the arrangements and configurations thereof shown and described with reference to FIGS. 1D-1F can be included, either alone or in any combination, in the example of the devices, features, components, and parts shown in FIGS. 1B and 1C.

FIG. 1D illustrates an exploded view of an example of an HMD 1-200 including various portions or parts thereof separated according to the modularity and selective coupling of those parts. For example, the HMD 1-200 can include a band 1-216 which can be selectively coupled to first and second electronic straps 1-205a, 1-205b. The first securement strap 1-205a can include a first electronic component 1-212a and the second securement strap 1-205b can include a second electronic component 1-212b. In at least one example, the first and second straps 1-205a-b can be removably coupled to the display unit 1-202.

In addition, the HMD 1-200 can include a light seal 1-210 configured to be removably coupled to the display unit 1-202. The HMD 1-200 can also include lenses 1-218 which can be removably coupled to the display unit 1-202, for example over first and second display assemblies including display screens. The lenses 1-218 can include customized prescription lenses configured for corrective vision. As noted, each part shown in the exploded view of FIG. 1D and described above can be removably coupled, attached, re-attached, and changed out to update parts or swap out parts for different users. For example, bands such as the band 1-216, light seals such as the light seal 1-210, lenses such as the lenses 1-218, and electronic straps such as the straps 1-205a-b can be swapped out depending on the user such that these parts are customized to fit and correspond to the individual user of the HMD 1-200.

Any of the features, components, and/or parts, including the arrangements and configurations thereof shown in FIG. 1D can be included, either alone or in any combination, in any of the other examples of devices, features, components, and parts shown in FIGS. 1B, 1C, and 1E-1F and described herein. Likewise, any of the features, components, and/or parts, including the arrangements and configurations thereof shown and described with reference to FIGS. 1B, 1C, and 1E-1F can be included, either alone or in any combination, in the example of the devices, features, components, and parts shown in FIG. 1D.

FIG. 1E illustrates an exploded view of an example of a display unit 1-306 of a HMD. The display unit 1-306 can include a front display assembly 1-308, a frame/housing assembly 1-350, and a curtain assembly 1-324. The display unit 1-306 can also include a sensor assembly 1-356, logic board assembly 1-358, and cooling assembly 1-360 disposed between the frame assembly 1-350 and the front display assembly 1-308. In at least one example, the display unit 1-306 can also include a rear-facing display assembly 1-320 including first and second rear-facing display screens 1-322a, 1-322b disposed between the frame 1-350 and the curtain assembly 1-324.

In at least one example, the display unit 1-306 can also include a motor assembly 1-362 configured as an adjustment mechanism for adjusting the positions of the display screens 1-322a-b of the display assembly 1-320 relative to the frame 1-350. In at least one example, the display assembly 1-320 is mechanically coupled to the motor assembly 1-362, with at least one motor for each display screen 1-322a-b, such that the motors can translate the display screens 1-322a-b to match an interpupillary distance of the user's eyes.

In at least one example, the display unit 1-306 can include a dial or button 1-328 depressible relative to the frame 1-350 and accessible to the user outside the frame 1-350. The button 1-328 can be electronically connected to the motor assembly 1-362 via a controller such that the button 1-328 can be manipulated by the user to cause the motors of the motor assembly 1-362 to adjust the positions of the display screens 1-322a-b.

Any of the features, components, and/or parts, including the arrangements and configurations thereof shown in FIG. 1E can be included, either alone or in any combination, in any of the other examples of devices, features, components, and parts shown in FIGS. 1B-1D and 1F and described herein. Likewise, any of the features, components, and/or parts, including the arrangements and configurations thereof shown and described with reference to FIGS. 1B-1D and 1F can be included, either alone or in any combination, in the example of the devices, features, components, and parts shown in FIG. 1E.

FIG. 1F illustrates an exploded view of another example of a display unit 1-406 of a HMD device similar to other HMD devices described herein. The display unit 1-406 can include a front display assembly 1-402, a sensor assembly 1-456, a logic board assembly 1-458, a cooling assembly 1-460, a frame assembly 1-450, a rear-facing display assembly 1-421, and a curtain assembly 1-424. The display unit 1-406 can also include a motor assembly 1-462 for adjusting the positions of first and second display sub-assemblies 1-420a, 1-420b of the rear-facing display assembly 1-421, including first and second respective display screens for interpupillary adjustments, as described above.

The various parts, systems, and assemblies shown in the exploded view of FIG. 1F are described in greater detail herein with reference to FIGS. 1B-1E as well as subsequent figures referenced in the present disclosure. The display unit 1-406 shown in FIG. 1F can be assembled and integrated with the securement mechanisms shown in FIGS. 1B-1E, including the electronic straps, bands, and other components including light seals, connection assemblies, and so forth.

Any of the features, components, and/or parts, including the arrangements and configurations thereof shown in FIG. 1F can be included, either alone or in any combination, in any of the other examples of devices, features, components, and parts shown in FIGS. 1B-1E and described herein. Likewise, any of the features, components, and/or parts, including the arrangements and configurations thereof shown and described with reference to FIGS. 1B-1E can be included, either alone or in any combination, in the example of the devices, features, components, and parts shown in FIG. 1F.

FIG. 1G illustrates a perspective, exploded view of a front cover assembly 3-100 of an HMD device described herein, for example the front cover assembly 3-1 of the HMD 3-100 shown in FIG. 1G or any other HMD device shown and described herein. The front cover assembly 3-100 shown in FIG. 1G can include a transparent or semi-transparent cover 3-102, shroud 3-104 (or “canopy”), adhesive layers 3-106, display assembly 3-108 including a lenticular lens panel or array 3-110, and a structural trim 3-112. The adhesive layer 3-106 can secure the shroud 3-104 and/or transparent cover 3-102 to the display assembly 3-108 and/or the trim 3-112. The trim 3-112 can secure the various components of the front cover assembly 3-100 to a frame or chassis of the HMD device.

In at least one example, as shown in FIG. 1G, the transparent cover 3-102, shroud 3-104, and display assembly 3-108, including the lenticular lens array 3-110, can be curved to accommodate the curvature of a user's face. The transparent cover 3-102 and the shroud 3-104 can be curved in two or three dimensions, e.g., vertically curved in the Z-direction in and out of the Z-X plane and horizontally curved in the X-direction in and out of the Z-X plane. In at least one example, the display assembly 3-108 can include the lenticular lens array 3-110 as well as a display panel having pixels configured to project light through the shroud 3-104 and the transparent cover 3-102. The display assembly 3-108 can be curved in at least one direction, for example the horizontal direction, to accommodate the curvature of a user's face from one side (e.g., left side) of the face to the other (e.g., right side). In at least one example, each layer or component of the display assembly 3-108, which will be shown in subsequent figures and described in more detail, but which can include the lenticular lens array 3-110 and a display layer, can be similarly or concentrically curved in the horizontal direction to accommodate the curvature of the user's face.

In at least one example, the shroud 3-104 can include a transparent or semi-transparent material through which the display assembly 3-108 projects light. In one example, the shroud 3-104 can include one or more opaque portions, for example opaque ink-printed portions or other opaque film portions on the rear surface of the shroud 3-104. The rear surface can be the surface of the shroud 3-104 facing the user's eyes when the HID device is donned. In at least one example, opaque portions can be on the front surface of the shroud 3-104 opposite the rear surface. In at least one example, the opaque portion or portions of the shroud 3-104 can include perimeter portions visually hiding any components around an outside perimeter of the display screen of the display assembly 3-108. In this way, the opaque portions of the shroud hide any other components, including electronic components, structural components, and so forth, of the HMD device that would otherwise be visible through the transparent or semi-transparent cover 3-102 and/or shroud 3-104.

In at least one example, the shroud 3-104 can define one or more apertures transparent portions 3-120 through which sensors can send and receive signals. In one example, the portions 3-120 are apertures through which the sensors can extend or send and receive signals. In one example, the portions 3-120 are transparent portions, or portions more transparent than surrounding semi-transparent or opaque portions of the shroud, through which sensors can send and receive signals through the shroud and through the transparent cover 3-102. In one example, the sensors can include cameras, IR sensors, LUX sensors, or any other visual or non-visual environmental sensors of the HMD device.

Any of the features, components, and/or parts, including the arrangements and configurations thereof shown in FIG. 1G can be included, either alone or in any combination, in any of the other examples of devices, features, components, and parts described herein. Likewise, any of the features, components, and/or parts, including the arrangements and configurations thereof shown and described herein can be included, either alone or in any combination, in the example of the devices, features, components, and parts shown in FIG. 1G.

FIG. 1H illustrates an exploded view of an example of an HMD device 6-100. The HMD device 6-100 can include a sensor array or system 6-102 including one or more sensors, cameras, projectors, and so forth mounted to one or more components of the HMD 6-100. In at least one example, the sensor system 6-102 can include a bracket 1-338 on which one or more sensors of the sensor system 6-102 can be fixed/secured.

FIG. 1I illustrates a portion of an HMD device 6-100 including a front transparent cover 6-104 and a sensor system 6-102. The sensor system 6-102 can include a number of different sensors, emitters, receivers, including cameras, IR sensors, projectors, and so forth. The transparent cover 6-104 is illustrated in front of the sensor system 6-102 to illustrate relative positions of the various sensors and emitters as well as the orientation of each sensor/emitter of the system 6-102. As referenced herein, “sideways,” “side,” “lateral,” “horizontal,” and other similar terms refer to orientations or directions as indicated by the X-axis shown in FIG. 1J. Terms such as “vertical,” “up,” “down,” and similar terms refer to orientations or directions as indicated by the Z-axis shown in FIG. 1J. Terms such as “frontward,” “rearward,” “forward,” backward,” and similar terms refer to orientations or directions as indicated by the Y-axis shown in FIG. 1J.

In at least one example, the transparent cover 6-104 can define a front, external surface of the HMD device 6-100 and the sensor system 6-102, including the various sensors and components thereof, can be disposed behind the cover 6-104 in the Y-axis/direction. The cover 6-104 can be transparent or semi-transparent to allow light to pass through the cover 6-104, both light detected by the sensor system 6-102 and light emitted thereby.

As noted elsewhere herein, the HMD device 6-100 can include one or more controllers including processors for electrically coupling the various sensors and emitters of the sensor system 6-102 with one or more mother boards, processing units, and other electronic devices such as display screens and the like. In addition, as will be shown in more detail below with reference to other figures, the various sensors, emitters, and other components of the sensor system 6-102 can be coupled to various structural frame members, brackets, and so forth of the HMD device 6-100 not shown in FIG. 1I. FIG. 1I shows the components of the sensor system 6-102 unattached and un-coupled electrically from other components for the sake of illustrative clarity.

In at least one example, the device can include one or more controllers having processors configured to execute instructions stored on memory components electrically coupled to the processors. The instructions can include, or cause the processor to execute, one or more algorithms for self-correcting angles and positions of the various cameras described herein overtime with use as the initial positions, angles, or orientations of the cameras get bumped or deformed due to unintended drop events or other events.

In at least one example, the sensor system 6-102 can include one or more scene cameras 6-106. The system 6-102 can include two scene cameras 6-102 disposed on either side of the nasal bridge or arch of the HMD device 6-100 such that each of the two cameras 6-106 correspond generally in position with left and right eyes of the user behind the cover 6-103. In at least one example, the scene cameras 6-106 are oriented generally forward in the Y-direction to capture images in front of the user during use of the HMD 6-100. In at least one example, the scene cameras are color cameras and provide images and content for MR video pass through to the display screens facing the user's eyes when using the HMD device 6-100. The scene cameras 6-106 can also be used for environment and object reconstruction.

In at least one example, the sensor system 6-102 can include a first depth sensor 6-108 pointed generally forward in the Y-direction. In at least one example, the first depth sensor 6-108 can be used for environment and object reconstruction as well as user hand and body tracking. In at least one example, the sensor system 6-102 can include a second depth sensor 6-110 disposed centrally along the width (e.g., along the X-axis) of the HMD device 6-100. For example, the second depth sensor 6-110 can be disposed above the central nasal bridge or accommodating features over the nose of the user when donning the HMD 6-100. In at least one example, the second depth sensor 6-110 can be used for environment and object reconstruction as well as hand and body tracking. In at least one example, the second depth sensor can include a LIDAR sensor.

In at least one example, the sensor system 6-102 can include a depth projector 6-112 facing generally forward to project electromagnetic waves, for example in the form of a predetermined pattern of light dots, out into and within a field of view of the user and/or the scene cameras 6-106 or a field of view including and beyond the field of view of the user and/or scene cameras 6-106. In at least one example, the depth projector can project electromagnetic waves of light in the form of a dotted light pattern to be reflected off objects and back into the depth sensors noted above, including the depth sensors 6-108, 6-110. In at least one example, the depth projector 6-112 can be used for environment and object reconstruction as well as hand and body tracking.

In at least one example, the sensor system 6-102 can include downward facing cameras 6-114 with a field of view pointed generally downward relative to the HDM device 6-100 in the Z-axis. In at least one example, the downward cameras 6-114 can be disposed on left and right sides of the HMD device 6-100 as shown and used for hand and body tracking, headset tracking, and facial avatar detection and creation for display a user avatar on the forward facing display screen of the HMD device 6-100 described elsewhere herein. The downward cameras 6-114, for example, can be used to capture facial expressions and movements for the face of the user below the HMD device 6-100, including the cheeks, mouth, and chin.

In at least one example, the sensor system 6-102 can include jaw cameras 6-116. In at least one example, the jaw cameras 6-116 can be disposed on left and right sides of the HMD device 6-100 as shown and used for hand and body tracking, headset tracking, and facial avatar detection and creation for display a user avatar on the forward facing display screen of the HMD device 6-100 described elsewhere herein. The jaw cameras 6-116, for example, can be used to capture facial expressions and movements for the face of the user below the HMD device 6-100, including the user's jaw, cheeks, mouth, and chin. for hand and body tracking, headset tracking, and facial avatar

In at least one example, the sensor system 6-102 can include side cameras 6-118. The side cameras 6-118 can be oriented to capture side views left and right in the X-axis or direction relative to the HMD device 6-100. In at least one example, the side cameras 6-118 can be used for hand and body tracking, headset tracking, and facial avatar detection and re-creation.

In at least one example, the sensor system 6-102 can include a plurality of eye tracking and gaze tracking sensors for determining an identity, status, and gaze direction of a user's eyes during and/or before use. In at least one example, the eye/gaze tracking sensors can include nasal eye cameras 6-120 disposed on either side of the user's nose and adjacent the user's nose when donning the HMD device 6-100. The eye/gaze sensors can also include bottom eye cameras 6-122 disposed below respective user eyes for capturing images of the eyes for facial avatar detection and creation, gaze tracking, and iris identification functions.

In at least one example, the sensor system 6-102 can include infrared illuminators 6-124 pointed outward from the HMD device 6-100 to illuminate the external environment and any object therein with IR light for IR detection with one or more IR sensors of the sensor system 6-102. In at least one example, the sensor system 6-102 can include a flicker sensor 6-126 and an ambient light sensor 6-128. In at least one example, the flicker sensor 6-126 can detect overhead light refresh rates to avoid display flicker. In one example, the infrared illuminators 6-124 can include light emitting diodes and can be used especially for low light environments for illuminating user hands and other objects in low light for detection by infrared sensors of the sensor system 6-102.

In at least one example, multiple sensors, including the scene cameras 6-106, the downward cameras 6-114, the jaw cameras 6-116, the side cameras 6-118, the depth projector 6-112, and the depth sensors 6-108, 6-110 can be used in combination with an electrically coupled controller to combine depth data with camera data for hand tracking and for size determination for better hand tracking and object recognition and tracking functions of the HMD device 6-100. In at least one example, the downward cameras 6-114, jaw cameras 6-116, and side cameras 6-118 described above and shown in FIG. 1I can be wide angle cameras operable in the visible and infrared spectrums. In at least one example, these cameras 6-114, 6-116, 6-118 can operate only in black and white light detection to simplify image processing and gain sensitivity.

Any of the features, components, and/or parts, including the arrangements and configurations thereof shown in FIG. 1I can be included, either alone or in any combination, in any of the other examples of devices, features, components, and parts shown in FIGS. 1J-1L and described herein. Likewise, any of the features, components, and/or parts, including the arrangements and configurations thereof shown and described with reference to FIGS. 1J-1L can be included, either alone or in any combination, in the example of the devices, features, components, and parts shown in FIG. 1I.

FIG. 1J illustrates a lower perspective view of an example of an HMD 6-200 including a cover or shroud 6-204 secured to a frame 6-230. In at least one example, the sensors 6-203 of the sensor system 6-202 can be disposed around a perimeter of the HDM 6-200 such that the sensors 6-203 are outwardly disposed around a perimeter of a display region or area 6-232 so as not to obstruct a view of the displayed light. In at least one example, the sensors can be disposed behind the shroud 6-204 and aligned with transparent portions of the shroud allowing sensors and projectors to allow light back and forth through the shroud 6-204. In at least one example, opaque ink or other opaque material or films/layers can be disposed on the shroud 6-204 around the display area 6-232 to hide components of the HMD 6-200 outside the display area 6-232 other than the transparent portions defined by the opaque portions, through which the sensors and projectors send and receive light and electromagnetic signals during operation. In at least one example, the shroud 6-204 allows light to pass therethrough from the display (e.g., within the display region 6-232) but not radially outward from the display region around the perimeter of the display and shroud 6-204.

In some examples, the shroud 6-204 includes a transparent portion 6-205 and an opaque portion 6-207, as described above and elsewhere herein. In at least one example, the opaque portion 6-207 of the shroud 6-204 can define one or more transparent regions 6-209 through which the sensors 6-203 of the sensor system 6-202 can send and receive signals. In the illustrated example, the sensors 6-203 of the sensor system 6-202 sending and receiving signals through the shroud 6-204, or more specifically through the transparent regions 6-209 of the (or defined by) the opaque portion 6-207 of the shroud 6-204 can include the same or similar sensors as those shown in the example of FIG. 1I, for example depth sensors 6-108 and 6-110, depth projector 6-112, first and second scene cameras 6-106, first and second downward cameras 6-114, first and second side cameras 6-118, and first and second infrared illuminators 6-124. These sensors are also shown in the examples of FIGS. 1K and 1L. Other sensors, sensor types, number of sensors, and relative positions thereof can be included in one or more other examples of HMDs.

Any of the features, components, and/or parts, including the arrangements and configurations thereof shown in FIG. 1J can be included, either alone or in any combination, in any of the other examples of devices, features, components, and parts shown in FIGS. 1I and 1K-1L and described herein. Likewise, any of the features, components, and/or parts, including the arrangements and configurations thereof shown and described with reference to FIGS. 1I and 1K-1L can be included, either alone or in any combination, in the example of the devices, features, components, and parts shown in FIG. 1J.

FIG. 1K illustrates a front view of a portion of an example of an HID device 6-300 including a display 6-334, brackets 6-336, 6-338, and frame or housing 6-330. The example shown in FIG. 1K does not include a front cover or shroud in order to illustrate the brackets 6-336, 6-338. For example, the shroud 6-204 shown in FIG. 1J includes the opaque portion 6-207 that would visually cover/block a view of anything outside (e.g., radially/peripherally outside) the display/display region 6-334, including the sensors 6-303 and bracket 6-338.

In at least one example, the various sensors of the sensor system 6-302 are coupled to the brackets 6-336, 6-338. In at least one example, the scene cameras 6-306 include tight tolerances of angles relative to one another. For example, the tolerance of mounting angles between the two scene cameras 6-306 can be 0.5 degrees or less, for example 0.3 degrees or less. In order to achieve and maintain such a tight tolerance, in one example, the scene cameras 6-306 can be mounted to the bracket 6-338 and not the shroud. The bracket can include cantilevered arms on which the scene cameras 6-306 and other sensors of the sensor system 6-302 can be mounted to remain un-deformed in position and orientation in the case of a drop event by a user resulting in any deformation of the other bracket 6-226, housing 6-330, and/or shroud.

Any of the features, components, and/or parts, including the arrangements and configurations thereof shown in FIG. 1K can be included, either alone or in any combination, in any of the other examples of devices, features, components, and parts shown in FIGS. 11-1J and 1L and described herein. Likewise, any of the features, components, and/or parts, including the arrangements and configurations thereof shown and described with reference to FIGS. 1I-1J and 1L can be included, either alone or in any combination, in the example of the devices, features, components, and parts shown in FIG. 1K.

FIG. 1L illustrates a bottom view of an example of an HMD 6-400 including a front display/cover assembly 6-404 and a sensor system 6-402. The sensor system 6-402 can be similar to other sensor systems described above and elsewhere herein, including in reference to FIGS. 1I-1K. In at least one example, the jaw cameras 6-416 can be facing downward to capture images of the user's lower facial features. In one example, the jaw cameras 6-416 can be coupled directly to the frame or housing 6-430 or one or more internal brackets directly coupled to the frame or housing 6-430 shown. The frame or housing 6-430 can include one or more apertures/openings 6-415 through which the jaw cameras 6-416 can send and receive signals.

Any of the features, components, and/or parts, including the arrangements and configurations thereof shown in FIG. 1L can be included, either alone or in any combination, in any of the other examples of devices, features, components, and parts shown in FIGS. 1I-1K and described herein. Likewise, any of the features, components, and/or parts, including the arrangements and configurations thereof shown and described with reference to FIGS. 1I-1K can be included, either alone or in any combination, in the example of the devices, features, components, and parts shown in FIG. 1L.

FIG. 1M illustrates a rear perspective view of an inter-pupillary distance (IPD) adjustment system 11.1.1-102 including first and second optical modules 11.1.1-104a-b slidably engaging/coupled to respective guide-rods 11.1.1-108a-b and motors 11.1.1-110a-b of left and right adjustment subsystems 11.1.1-106a-b. The IPD adjustment system 11.1.1-102 can be coupled to a bracket 11.1.1-112 and include a button 11.1.1-114 in electrical communication with the motors 11.1.1-110a-b. In at least one example, the button 11.1.1-114 can electrically communicate with the first and second motors 11.1.1-110a-b via a processor or other circuitry components to cause the first and second motors 11.1.1-110a-b to activate and cause the first and second optical modules 11.1.1-104a-b, respectively, to change position relative to one another.

In at least one example, the first and second optical modules 11.1.1-104a-b can include respective display screens configured to project light toward the user's eyes when donning the HMD 11.1.1-100. In at least one example, the user can manipulate (e.g., depress and/or rotate) the button 11.1.1-114 to activate a positional adjustment of the optical modules 11.1.1-104a-b to match the inter-pupillary distance of the user's eyes. The optical modules 11.1.1-104a-b can also include one or more cameras or other sensors/sensor systems for imaging and measuring the IPD of the user such that the optical modules 11.1.1-104a-b can be adjusted to match the IPD.

In one example, the user can manipulate the button 11.1.1-114 to cause an automatic positional adjustment of the first and second optical modules 11.1.1-104a-b. In one example, the user can manipulate the button 11.1.1-114 to cause a manual adjustment such that the optical modules 11.1.1-104a-b move further or closer away, for example when the user rotates the button 11.1.1-114 one way or the other, until the user visually matches her/his own IPD. In one example, the manual adjustment is electronically communicated via one or more circuits and power for the movements of the optical modules 11.1.1-104a-b via the motors 11.1.1-110a-b is provided by an electrical power source. In one example, the adjustment and movement of the optical modules 11.1.1-104a-b via a manipulation of the button 11.1.1-114 is mechanically actuated via the movement of the button 11.1.1-114.

Any of the features, components, and/or parts, including the arrangements and configurations thereof shown in FIG. 1M can be included, either alone or in any combination, in any of the other examples of devices, features, components, and parts shown in any other figures shown and described herein. Likewise, any of the features, components, and/or parts, including the arrangements and configurations thereof shown and described with reference to any other figure shown and described herein, either alone or in any combination, in the example of the devices, features, components, and parts shown in FIG. 1M.

FIG. 1N illustrates a front perspective view of a portion of an HMD 11.1.2-100, including an outer structural frame 11.1.2-102 and an inner or intermediate structural frame 11.1.2-104 defining first and second apertures 11.1.2-106a, 11.1.2-106b. The apertures 11.1.2-106a-b are shown in dotted lines in FIG. 1N because a view of the apertures 11.1.2-106a-b can be blocked by one or more other components of the HMD 11.1.2-100 coupled to the inner frame 11.1.2-104 and/or the outer frame 11.1.2-102, as shown. In at least one example, the HMD 11.1.2-100 can include a first mounting bracket 11.1.2-108 coupled to the inner frame 11.1.2-104. In at least one example, the mounting bracket 11.1.2-108 is coupled to the inner frame 11.1.2-104 between the first and second apertures 11.1.2-106a-b.

The mounting bracket 11.1.2-108 can include a middle or central portion 11.1.2-109 coupled to the inner frame 11.1.2-104. In some examples, the middle or central portion 11.1.2-109 may not be the geometric middle or center of the bracket 11.1.2-108. Rather, the middle/central portion 11.1.2-109 can be disposed between first and second cantilevered extension arms extending away from the middle portion 11.1.2-109. In at least one example, the mounting bracket 108 includes a first cantilever arm 11.1.2-112 and a second cantilever arm 11.1.2-114 extending away from the middle portion 11.1.2-109 of the mount bracket 11.1.2-108 coupled to the inner frame 11.1.2-104.

As shown in FIG. 1N, the outer frame 11.1.2-102 can define a curved geometry on a lower side thereof to accommodate a user's nose when the user dons the HMD 11.1.2-100. The curved geometry can be referred to as a nose bridge 11.1.2-111 and be centrally located on a lower side of the HMD 11.1.2-100 as shown. In at least one example, the mounting bracket 11.1.2-108 can be connected to the inner frame 11.1.2-104 between the apertures 11.1.2-106a-b such that the cantilevered arms 11.1.2-112, 11.1.2-114 extend downward and laterally outward away from the middle portion 11.1.2-109 to compliment the nose bridge 11.1.2-111 geometry of the outer frame 11.1.2-102. In this way, the mounting bracket 11.1.2-108 is configured to accommodate the user's nose as noted above. The nose bridge 11.1.2-111 geometry accommodates the nose in that the nose bridge 11.1.2-111 provides a curvature that curves with, above, over, and around the user's nose for comfort and fit.

The first cantilever arm 11.1.2-112 can extend away from the middle portion 11.1.2-109 of the mounting bracket 11.1.2-108 in a first direction and the second cantilever arm 11.1.2-114 can extend away from the middle portion 11.1.2-109 of the mounting bracket 11.1.2-10 in a second direction opposite the first direction. The first and second cantilever arms 11.1.2-112, 11.1.2-114 are referred to as “cantilevered” or “cantilever” arms because each arm 11.1.2-112, 11.1.2-114, includes a distal free end 11.1.2-116, 11.1.2-118, respectively, which are free of affixation from the inner and outer frames 11.1.2-102, 11.1.2-104. In this way, the arms 11.1.2-112, 11.1.2-114 are cantilevered from the middle portion 11.1.2-109, which can be connected to the inner frame 11.1.2-104, with distal ends 11.1.2-102, 11.1.2-104 unattached.

In at least one example, the HMD 11.1.2-100 can include one or more components coupled to the mounting bracket 11.1.2-108. In one example, the components include a plurality of sensors 11.1.2-110a-f. Each sensor of the plurality of sensors 11.1.2-110a-f can include various types of sensors, including cameras, IR sensors, and so forth. In some examples, one or more of the sensors 11.1.2-110a-f can be used for object recognition in three-dimensional space such that it is important to maintain a precise relative position of two or more of the plurality of sensors 11.1.2-110a-f. The cantilevered nature of the mounting bracket 11.1.2-108 can protect the sensors 11.1.2-110a-f from damage and altered positioning in the case of accidental drops by the user. Because the sensors 11.1.2-110a-f are cantilevered on the arms 11.1.2-112, 11.1.2-114 of the mounting bracket 11.1.2-108, stresses and deformations of the inner and/or outer frames 11.1.2-104, 11.1.2-102 are not transferred to the cantilevered arms 11.1.2-112, 11.1.2-114 and thus do not affect the relative positioning of the sensors 11.1.2-110a-f coupled/mounted to the mounting bracket 11.1.2-108.

Any of the features, components, and/or parts, including the arrangements and configurations thereof shown in FIG. 1N can be included, either alone or in any combination, in any of the other examples of devices, features, components, and described herein. Likewise, any of the features, components, and/or parts, including the arrangements and configurations thereof shown and described herein can be included, either alone or in any combination, in the example of the devices, features, components, and parts shown in FIG. 1N.

FIG. 10 illustrates an example of an optical module 11.3.2-100 for use in an electronic device such as an HMD, including HDM devices described herein. As shown in one or more other examples described herein, the optical module 11.3.2-100 can be one of two optical modules within an HMD, with each optical module aligned to project light toward a user's eye. In this way, a first optical module can project light via a display screen toward a user's first eye and a second optical module of the same device can project light via another display screen toward the user's second eye.

In at least one example, the optical module 11.3.2-100 can include an optical frame or housing 11.3.2-102, which can also be referred to as a barrel or optical module barrel. The optical module 11.3.2-100 can also include a display 11.3.2-104, including a display screen or multiple display screens, coupled to the housing 11.3.2-102. The display 11.3.2-104 can be coupled to the housing 11.3.2-102 such that the display 11.3.2-104 is configured to project light toward the eye of a user when the HMD of which the display module 11.3.2-100 is a part is donned during use. In at least one example, the housing 11.3.2-102 can surround the display 11.3.2-104 and provide connection features for coupling other components of optical modules described herein.

In one example, the optical module 11.3.2-100 can include one or more cameras 11.3.2-106 coupled to the housing 11.3.2-102. The camera 11.3.2-106 can be positioned relative to the display 11.3.2-104 and housing 11.3.2-102 such that the camera 11.3.2-106 is configured to capture one or more images of the user's eye during use. In at least one example, the optical module 11.3.2-100 can also include a light strip 11.3.2-108 surrounding the display 11.3.2-104. In one example, the light strip 11.3.2-108 is disposed between the display 11.3.2-104 and the camera 11.3.2-106. The light strip 11.3.2-108 can include a plurality of lights 11.3.2-110. The plurality of lights can include one or more light emitting diodes (LEDs) or other lights configured to project light toward the user's eye when the MID is donned. The individual lights 11.3.2-110 of the light strip 11.3.2-108 can be spaced about the strip 11.3.2-108 and thus spaced about the display 11.3.2-104 uniformly or non-uniformly at various locations on the strip 11.3.2-108 and around the display 11.3.2-104.

In at least one example, the housing 11.3.2-102 defines a viewing opening 11.3.2-101 through which the user can view the display 11.3.2-104 when the HMD device is donned. In at least one example, the LEDs are configured and arranged to emit light through the viewing opening 11.3.2-101 and onto the user's eye. In one example, the camera 11.3.2-106 is configured to capture one or more images of the user's eye through the viewing opening 11.3.2-101.

As noted above, each of the components and features of the optical module 11.3.2-100 shown in FIG. 10 can be replicated in another (e.g., second) optical module disposed with the HMD to interact (e.g., project light and capture images) of another eye of the user.

Any of the features, components, and/or parts, including the arrangements and configurations thereof shown in FIG. 10 can be included, either alone or in any combination, in any of the other examples of devices, features, components, and parts shown in FIG. 1P or otherwise described herein. Likewise, any of the features, components, and/or parts, including the arrangements and configurations thereof shown and described with reference to FIG. 1P or otherwise described herein can be included, either alone or in any combination, in the example of the devices, features, components, and parts shown in FIG. 10.

FIG. 1P illustrates a cross-sectional view of an example of an optical module 11.3.2-200 including a housing 11.3.2-202, display assembly 11.3.2-204 coupled to the housing 11.3.2-202, and a lens 11.3.2-216 coupled to the housing 11.3.2-202. In at least one example, the housing 11.3.2-202 defines a first aperture or channel 11.3.2-212 and a second aperture or channel 11.3.2-214. The channels 11.3.2-212, 11.3.2-214 can be configured to slidably engage respective rails or guide rods of an HMD device to allow the optical module 11.3.2-200 to adjust in position relative to the user's eyes for match the user's interpapillary distance (IPD). The housing 11.3.2-202 can slidably engage the guide rods to secure the optical module 11.3.2-200 in place within the HID.

In at least one example, the optical module 11.3.2-200 can also include a lens 11.3.2-216 coupled to the housing 11.3.2-202 and disposed between the display assembly 11.3.2-204 and the user's eyes when the HMD is donned. The lens 11.3.2-216 can be configured to direct light from the display assembly 11.3.2-204 to the user's eye. In at least one example, the lens 11.3.2-216 can be a part of a lens assembly including a corrective lens removably attached to the optical module 11.3.2-200. In at least one example, the lens 11.3.2-216 is disposed over the light strip 11.3.2-208 and the one or more eye-tracking cameras 11.3.2-206 such that the camera 11.3.2-206 is configured to capture images of the user's eye through the lens 11.3.2-216 and the light strip 11.3.2-208 includes lights configured to project light through the lens 11.3.2-216 to the users' eye during use.

Any of the features, components, and/or parts, including the arrangements and configurations thereof shown in FIG. 1P can be included, either alone or in any combination, in any of the other examples of devices, features, components, and parts and described herein. Likewise, any of the features, components, and/or parts, including the arrangements and configurations thereof shown and described herein can be included, either alone or in any combination, in the example of the devices, features, components, and parts shown in FIG. 1P.

FIG. 2 is a block diagram of an example of the controller 110 in accordance with some embodiments. While certain specific features are illustrated, those skilled in the art will appreciate from the present disclosure that various other features have not been illustrated for the sake of brevity, and so as not to obscure more pertinent aspects of the embodiments disclosed herein. To that end, as a non-limiting example, in some embodiments, the controller 110 includes one or more processing units 202 (e.g., microprocessors, application-specific integrated-circuits (ASICs), field-programmable gate arrays (FPGAs), graphics processing units (GPUs), central processing units (CPUs), processing cores, and/or the like), one or more input/output (I/O) devices 206, one or more communication interfaces 208 (e.g., universal serial bus (USB), FIREWIRE, THUNDERBOLT, IEEE 802.3x, IEEE 802.11x, IEEE 802.16x, global system for mobile communications (GSM), code division multiple access (CDMA), time division multiple access (TDMA), global positioning system (GPS), infrared (IR), BLUETOOTH, ZIGBEE, and/or the like type interface), one or more programming (e.g., I/O) interfaces 210, a memory 220, and one or more communication buses 204 for interconnecting these and various other components.

In some embodiments, the one or more communication buses 204 include circuitry that interconnects and controls communications between system components. In some embodiments, the one or more I/O devices 206 include at least one of a keyboard, a mouse, a touchpad, a joystick, one or more microphones, one or more speakers, one or more image sensors, one or more displays, and/or the like.

The memory 220 includes high-speed random-access memory, such as dynamic random-access memory (DRAM), static random-access memory (SRAM), double-data-rate random-access memory (DDR RAM), or other random-access solid-state memory devices. In some embodiments, the memory 220 includes non-volatile memory, such as one or more magnetic disk storage devices, optical disk storage devices, flash memory devices, or other non-volatile solid-state storage devices. The memory 220 optionally includes one or more storage devices remotely located from the one or more processing units 202. The memory 220 comprises a non-transitory computer readable storage medium. In some embodiments, the memory 220 or the non-transitory computer readable storage medium of the memory 220 stores the following programs, modules and data structures, or a subset thereof including an optional operating system 230 and a XR experience module 240.

The operating system 230 includes instructions for handling various basic system services and for performing hardware dependent tasks. In some embodiments, the XR experience module 240 is configured to manage and coordinate one or more XR experiences for one or more users (e.g., a single XR experience for one or more users, or multiple XR experiences for respective groups of one or more users). To that end, in various embodiments, the XR experience module 240 includes a data obtaining unit 241, a tracking unit 242, a coordination unit 246, and a data transmitting unit 248.

In some embodiments, the data obtaining unit 241 is configured to obtain data (e.g., presentation data, interaction data, sensor data, location data, etc.) from at least the display generation component 120 of FIG. 1A, and optionally one or more of the input devices 125, output devices 155, sensors 190, and/or peripheral devices 195. To that end, in various embodiments, the data obtaining unit 241 includes instructions and/or logic therefor, and heuristics and metadata therefor.

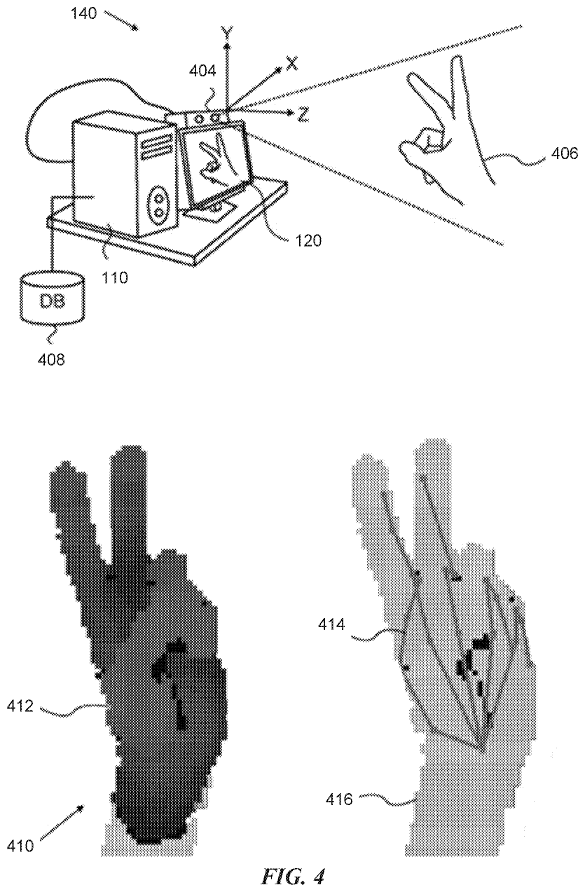

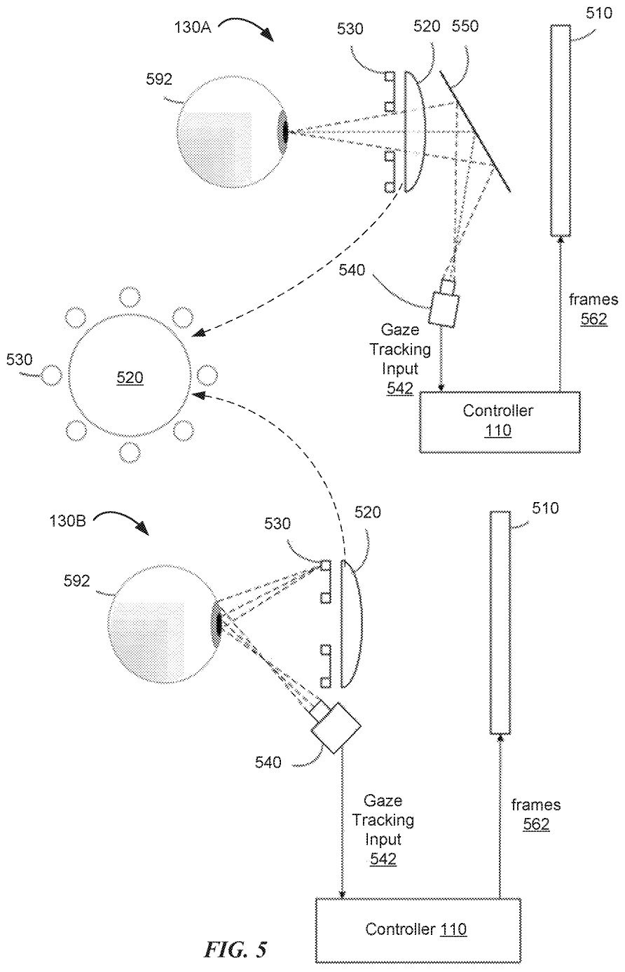

In some embodiments, the tracking unit 242 is configured to map the scene 105 and to track the position/location of at least the display generation component 120 with respect to the scene 105 of FIG. 1A, and optionally, to one or more of the input devices 125, output devices 155, sensors 190, and/or peripheral devices 195. To that end, in various embodiments, the tracking unit 242 includes instructions and/or logic therefor, and heuristics and metadata therefor. In some embodiments, the tracking unit 242 includes hand tracking unit 244 and/or eye tracking unit 243. In some embodiments, the hand tracking unit 244 is configured to track the position/location of one or more portions of the user's hands, and/or motions of one or more portions of the user's hands with respect to the scene 105 of FIG. 1A, relative to the display generation component 120, and/or relative to a coordinate system defined relative to the user's hand. The hand tracking unit 244 is described in greater detail below with respect to FIG. 4. In some embodiments, the eye tracking unit 243 is configured to track the position and movement of the user's gaze (or more broadly, the user's eyes, face, or head) with respect to the scene 105 (e.g., with respect to the physical environment and/or to the user (e.g., the user's hand)) or with respect to the XR content displayed via the display generation component 120. The eye tracking unit 243 is described in greater detail below with respect to FIG. 5.

In some embodiments, the coordination unit 246 is configured to manage and coordinate the XR experience presented to the user by the display generation component 120, and optionally, by one or more of the output devices 155 and/or peripheral devices 195. To that end, in various embodiments, the coordination unit 246 includes instructions and/or logic therefor, and heuristics and metadata therefor.

In some embodiments, the data transmitting unit 248 is configured to transmit data (e.g., presentation data, location data, etc.) to at least the display generation component 120, and optionally, to one or more of the input devices 125, output devices 155, sensors 190, and/or peripheral devices 195. To that end, in various embodiments, the data transmitting unit 248 includes instructions and/or logic therefor, and heuristics and metadata therefor.

Although the data obtaining unit 241, the tracking unit 242 (e.g., including the eye tracking unit 243 and the hand tracking unit 244), the coordination unit 246, and the data transmitting unit 248 are shown as residing on a single device (e.g., the controller 110), it should be understood that in other embodiments, any combination of the data obtaining unit 241, the tracking unit 242 (e.g., including the eye tracking unit 243 and the hand tracking unit 244), the coordination unit 246, and the data transmitting unit 248 may be located in separate computing devices.

Moreover, FIG. 2 is intended more as functional description of the various features that may be present in a particular implementation as opposed to a structural schematic of the embodiments described herein. As recognized by those of ordinary skill in the art, items shown separately could be combined and some items could be separated. For example, some functional modules shown separately in FIG. 2 could be implemented in a single module and the various functions of single functional blocks could be implemented by one or more functional blocks in various embodiments. The actual number of modules and the division of particular functions and how features are allocated among them will vary from one implementation to another and, in some embodiments, depends in part on the particular combination of hardware, software, and/or firmware chosen for a particular implementation.

FIG. 3A is a block diagram of an example of the display generation component 120 in accordance with some embodiments. While certain specific features are illustrated, those skilled in the art will appreciate from the present disclosure that various other features have not been illustrated for the sake of brevity, and so as not to obscure more pertinent aspects of the embodiments disclosed herein. To that end, as a non-limiting example, in some embodiments the display generation component 120 (e.g., HMD) includes one or more processing units 302 (e.g., microprocessors, ASICs, FPGAs, GPUs, CPUs, processing cores, and/or the like), one or more input/output (I/O) devices and sensors 306, one or more communication interfaces 308 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, and/or the like type interface), one or more programming (e.g., I/O) interfaces 310, one or more XR displays 312, one or more optional interior- and/or exterior-facing image sensors 314, a memory 320, and one or more communication buses 304 for interconnecting these and various other components.

In some embodiments, the one or more communication buses 304 include circuitry that interconnects and controls communications between system components. In some embodiments, the one or more I/O devices and sensors 306 include at least one of an inertial measurement unit (IMU), an accelerometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), and/or the like.

In some embodiments, the one or more XR displays 312 are configured to provide the XR experience to the user. In some embodiments, the one or more XR displays 312 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electro-mechanical system (MEMS), and/or the like display types. In some embodiments, the one or more XR displays 312 correspond to diffractive, reflective, polarized, holographic, etc. waveguide displays. For example, the display generation component 120 (e.g., HMD) includes a single XR display. In another example, the display generation component 120 includes a XR display for each eye of the user. In some embodiments, the one or more XR displays 312 are capable of presenting MR and VR content. In some embodiments, the one or more XR displays 312 are capable of presenting MR or VR content.

In some embodiments, the one or more image sensors 314 are configured to obtain image data that corresponds to at least a portion of the face of the user that includes the eyes of the user (and may be referred to as an eye-tracking camera). In some embodiments, the one or more image sensors 314 are configured to obtain image data that corresponds to at least a portion of the user's hand(s) and optionally arm(s) of the user (and may be referred to as a hand-tracking camera). In some embodiments, the one or more image sensors 314 are configured to be forward-facing so as to obtain image data that corresponds to the scene as would be viewed by the user if the display generation component 120 (e.g., HMD) was not present (and may be referred to as a scene camera). The one or more optional image sensors 314 can include one or more RGB cameras (e.g., with a complimentary metal-oxide-semiconductor (CMOS) image sensor or a charge-coupled device (CCD) image sensor), one or more infrared (IR) cameras, one or more event-based cameras, and/or the like.

The memory 320 includes high-speed random-access memory, such as DRAM, SRAM, DDR RAM, or other random-access solid-state memory devices. In some embodiments, the memory 320 includes non-volatile memory, such as one or more magnetic disk storage devices, optical disk storage devices, flash memory devices, or other non-volatile solid-state storage devices. The memory 320 optionally includes one or more storage devices remotely located from the one or more processing units 302. The memory 320 comprises a non-transitory computer readable storage medium. In some embodiments, the memory 320 or the non-transitory computer readable storage medium of the memory 320 stores the following programs, modules and data structures, or a subset thereof including an optional operating system 330 and a XR presentation module 340.

The operating system 330 includes instructions for handling various basic system services and for performing hardware dependent tasks. In some embodiments, the XR presentation module 340 is configured to present XR content to the user via the one or more XR displays 312. To that end, in various embodiments, the XR presentation module 340 includes a data obtaining unit 342, a XR presenting unit 344, a XR map generating unit 346, and a data transmitting unit 348.

In some embodiments, the data obtaining unit 342 is configured to obtain data (e.g., presentation data, interaction data, sensor data, location data, etc.) from at least the controller 110 of FIG. 1A. To that end, in various embodiments, the data obtaining unit 342 includes instructions and/or logic therefor, and heuristics and metadata therefor.

In some embodiments, the XR presenting unit 344 is configured to present XR content via the one or more XR displays 312. To that end, in various embodiments, the XR presenting unit 344 includes instructions and/or logic therefor, and heuristics and metadata therefor.

In some embodiments, the XR map generating unit 346 is configured to generate a XR map (e.g., a 3D map of the mixed reality scene or a map of the physical environment into which computer-generated objects can be placed to generate the extended reality) based on media content data. To that end, in various embodiments, the XR map generating unit 346 includes instructions and/or logic therefor, and heuristics and metadata therefor.

In some embodiments, the data transmitting unit 348 is configured to transmit data (e.g., presentation data, location data, etc.) to at least the controller 110, and optionally one or more of the input devices 125, output devices 155, sensors 190, and/or peripheral devices 195. To that end, in various embodiments, the data transmitting unit 348 includes instructions and/or logic therefor, and heuristics and metadata therefor.

Although the data obtaining unit 342, the XR presenting unit 344, the XR map generating unit 346, and the data transmitting unit 348 are shown as residing on a single device (e.g., the display generation component 120 of FIG. 1A), it should be understood that in other embodiments, any combination of the data obtaining unit 342, the XR presenting unit 344, the XR map generating unit 346, and the data transmitting unit 348 may be located in separate computing devices.

Moreover, FIG. 3A is intended more as a functional description of the various features that could be present in a particular implementation as opposed to a structural schematic of the embodiments described herein. As recognized by those of ordinary skill in the art, items shown separately could be combined and some items could be separated. For example, some functional modules shown separately in FIG. 3A could be implemented in a single module and the various functions of single functional blocks could be implemented by one or more functional blocks in various embodiments. The actual number of modules and the division of particular functions and how features are allocated among them will vary from one implementation to another and, in some embodiments, depends in part on the particular combination of hardware, software, and/or firmware chosen for a particular implementation.

Implementations within the scope of the present disclosure can be partially or entirely realized using a tangible computer-readable storage medium (or multiple tangible computer-readable storage media of one or more types) encoding one or more computer-readable instructions. It should be recognized that computer-readable instructions can be organized in any format, including applications, widgets, processes, software, and/or components.

Implementations within the scope of the present disclosure include a computer-readable storage medium that encodes instructions organized as an application (e.g., application 3160) that, when executed by one or more processing units, control an electronic device (e.g., device 3150) to perform the method of FIG. 3B, the method of FIG. 3C, and/or one or more other processes and/or methods described herein.

It should be recognized that application 3160 (shown in FIG. 3D) can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. In some embodiments, application 3160 is an application that is pre-installed on device 3150 at purchase (e.g., a first-party application). In some embodiments, application 3160 is an application that is provided to device 3150 via an operating system update file (e.g., a first-party application or a second-party application). In some embodiments, application 3160 is an application that is provided via an application store. In some embodiments, the application store can be an application store that is pre-installed on device 3150 at purchase (e.g., a first-party application store). In some embodiments, the application store is a third-party application store (e.g., an application store that is provided by another application store, downloaded via a network, and/or read from a storage device).

Referring to FIG. 3B and FIG. 3F, application 3160 obtains information (e.g., 3010). In some embodiments, at 3010, information is obtained from at least one hardware component of device 3150. In some embodiments, at 3010, information is obtained from at least one software module of device 3150. In some embodiments, at 3010, information is obtained from at least one hardware component external to device 3150 (e.g., a peripheral device, an accessory device, and/or a server). In some embodiments, the information obtained at 3010 includes positional information, time information, notification information, user information, environment information, electronic device state information, weather information, media information, historical information, event information, hardware information, and/or motion information. In some embodiments, in response to and/or after obtaining the information at 3010, application 3160 provides the information to a system (e.g., 3020).

In some embodiments, the system (e.g., 3110 shown in FIG. 3E) is an operating system hosted on device 3150. In some embodiments, the system (e.g., 3110 shown in FIG. 3E) is an external device (e.g., a server, a peripheral device, an accessory, and/or a personal computing device) that includes an operating system.

Referring to FIG. 3C and FIG. 3G, application 3160 obtains information (e.g., 3030). In some embodiments, the information obtained at 3030 includes positional information, time information, notification information, user information, environment information electronic device state information, weather information, media information, historical information, event information, hardware information, and/or motion information. In response to and/or after obtaining the information at 3030, application 3160 performs an operation with the information (e.g., 3040). In some embodiments, the operation performed at 3040 includes: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 3110 based on the information.

In some embodiments, one or more steps of the method of FIG. 3B and/or the method of FIG. 3C is performed in response to a trigger. In some embodiments, the trigger includes detection of an event, a notification received from system 3110, a user input, and/or a response to a call to an API provided by system 3110.

In some embodiments, the instructions of application 3160, when executed, control device 3150 to perform the method of FIG. 3B and/or the method of FIG. 3C by calling an application programming interface (API) (e.g., API 3190) provided by system 3110. In some embodiments, application 3160 performs at least a portion of the method of FIG. 3B and/or the method of FIG. 3C without calling API 3190.

In some embodiments, one or more steps of the method of FIG. 3B and/or the method of FIG. 3C includes calling an API (e.g., API 3190) using one or more parameters defined by the API. In some embodiments, the one or more parameters include a constant, a key, a data structure, an object, an object class, a variable, a data type, a pointer, an array, a list or a pointer to a function or method, and/or another way to reference a data or other item to be passed via the API.

Referring to FIG. 3D, device 3150 is illustrated. In some embodiments, device 3150 is a personal computing device, a smart phone, a smart watch, a fitness tracker, a head-mounted display (HMD) device, a media device, a communal device, a speaker, a television, and/or a tablet. As illustrated in FIG. 3D, device 3150 includes application 3160 and an operating system (e.g., system 3110 shown in FIG. 3E). Application 3160 includes application implementation module 3170 and API-calling module 3180. System 3110 includes API 3190 and implementation module 3100. It should be recognized that device 3150, application 3160, and/or system 3110 can include more, fewer, and/or different components than illustrated in FIGS. 3D and 3E.

In some embodiments, application implementation module 3170 includes a set of one or more instructions corresponding to one or more operations performed by application 3160. For example, when application 3160 is a messaging application, application implementation module 3170 can include operations to receive and send messages. In some embodiments, application implementation module 3170 communicates with API-calling module 3180 to communicate with system 3110 via API 3190 (shown in FIG. 3E).

In some embodiments, API 3190 is a software module (e.g., a collection of computer-readable instructions) that provides an interface that allows a different module (e.g., API-calling module 3180) to access and/or use one or more functions, methods, procedures, data structures, classes, and/or other services provided by implementation module 3100 of system 3110. For example, API-calling module 3180 can access a feature of implementation module 3100 through one or more API calls or invocations (e.g., embodied by a function or a method call) exposed by API 3190 (e.g., a software and/or hardware module that can receive API calls, respond to API calls, and/or send API calls) and can pass data and/or control information using one or more parameters via the API calls or invocations. In some embodiments, API 3190 allows application 3160 to use a service provided by a Software Development Kit (SDK) library. In some embodiments, application 3160 incorporates a call to a function or method provided by the SDK library and provided by API 3190 or uses data types or objects defined in the SDK library and provided by API 3190. In some embodiments, API-calling module 3180 makes an API call via API 3190 to access and use a feature of implementation module 3100 that is specified by API 3190. In such embodiments, implementation module 3100 can return a value via API 3190 to API-calling module 3180 in response to the API call. The value can report to application 3160 the capabilities or state of a hardware component of device 3150, including those related to aspects such as input capabilities and state, output capabilities and state, processing capability, power state, storage capacity and state, and/or communications capability. In some embodiments, API 3190 is implemented in part by firmware, microcode, or other low level logic that executes in part on the hardware component.

In some embodiments, API 3190 allows a developer of API-calling module 3180 (which can be a third-party developer) to leverage a feature provided by implementation module 3100. In such embodiments, there can be one or more API-calling modules (e.g., including API-calling module 3180) that communicate with implementation module 3100. In some embodiments, API 3190 allows multiple API-calling modules written in different programming languages to communicate with implementation module 3100 (e.g., API 3190 can include features for translating calls and returns between implementation module 3100 and API-calling module 3180) while API 3190 is implemented in terms of a specific programming language. In some embodiments, API-calling module 3180 calls APIs from different providers such as a set of APIs from an OS provider, another set of APIs from a plug-in provider, and/or another set of APIs from another provider (e.g., the provider of a software library) or creator of the another set of APIs.

Examples of API 3190 can include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, photos API, camera API, and/or image processing API. In some embodiments, the sensor API is an API for accessing data associated with a sensor of device 3150. For example, the sensor API can provide access to raw sensor data. For another example, the sensor API can provide data derived (and/or generated) from the raw sensor data. In some embodiments, the sensor data includes temperature data, image data, video data, audio data, heart rate data, IMU (inertial measurement unit) data, lidar data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor, and/or biometric sensor.

In some embodiments, implementation module 3100 is a system (e.g., operating system and/or server system) software module (e.g., a collection of computer-readable instructions) that is constructed to perform an operation in response to receiving an API call via API 3190. In some embodiments, implementation module 3100 is constructed to provide an API response (via API 3190) as a result of processing an API call. By way of example, implementation module 3100 and API-calling module 3180 can each be any one of an operating system, a library, a device driver, an API, an application program, or other module. It should be understood that implementation module 3100 and API-calling module 3180 can be the same or different type of module from each other. In some embodiments, implementation module 3100 is embodied at least in part in firmware, microcode, or hardware logic.

In some embodiments, implementation module 3100 returns a value through API 3190 in response to an API call from API-calling module 3180. While API 3190 defines the syntax and result of an API call (e.g., how to invoke the API call and what the API call does), API 3190 might not reveal how implementation module 3100 accomplishes the function specified by the API call. Various API calls are transferred via the one or more application programming interfaces between API-calling module 3180 and implementation module 3100. Transferring the API calls can include issuing, initiating, invoking, calling, receiving, returning, and/or responding to the function calls or messages. In other words, transferring can describe actions by either of API-calling module 3180 or implementation module 3100. In some embodiments, a function call or other invocation of API 3190 sends and/or receives one or more parameters through a parameter list or other structure.

In some embodiments, implementation module 3100 provides more than one API, each providing a different view of or with different aspects of functionality implemented by implementation module 3100. For example, one API of implementation module 3100 can provide a first set of functions and can be exposed to third-party developers, and another API of implementation module 3100 can be hidden (e.g., not exposed) and provide a subset of the first set of functions and also provide another set of functions, such as testing or debugging functions which are not in the first set of functions. In some embodiments, implementation module 3100 calls one or more other components via an underlying API and thus is both an API-calling module and an implementation module. It should be recognized that implementation module 3100 can include additional functions, methods, classes, data structures, and/or other features that are not specified through API 3190 and are not available to API-calling module 3180. It should also be recognized that API-calling module 3180 can be on the same system as implementation module 3100 or can be located remotely and access implementation module 3100 using API 3190 over a network. In some embodiments, implementation module 3100, API 3190, and/or API-calling module 3180 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

An application programming interface (API) is an interface between a first software process and a second software process that specifies a format for communication between the first software process and the second software process. Limited APIs (e.g., private APIs or partner APIs) are APIs that are accessible to a limited set of software processes (e.g., only software processes within an operating system or only software processes that are approved to access the limited APIs). Public APIs that are accessible to a wider set of software processes. Some APIs enable software processes to communicate about or set a state of one or more input devices (e.g., one or more touch sensors, proximity sensors, visual sensors, motion/orientation sensors, pressure sensors, intensity sensors, sound sensors, wireless proximity sensors, biometric sensors, buttons, switches, rotatable elements, and/or external controllers). Some APIs enable software processes to communicate about and/or set a state of one or more output generation components (e.g., one or more audio output generation components, one or more display generation components, and/or one or more tactile output generation components). Some APIs enable particular capabilities (e.g., scrolling, handwriting, text entry, image editing, and/or image creation) to be accessed, performed, and/or used by a software process (e.g., generating outputs for use by a software process based on input from the software process). Some APIs enable content from a software process to be inserted into a template and displayed in a user interface that has a layout and/or behaviors that are specified by the template.

Many software platforms include a set of frameworks that provides the core objects and core behaviors that a software developer needs to build software applications that can be used on the software platform. Software developers use these objects to display content onscreen, to interact with that content, and to manage interactions with the software platform. Software applications rely on the set of frameworks for their basic behavior, and the set of frameworks provides many ways for the software developer to customize the behavior of the application to match the specific needs of the software application. Many of these core objects and core behaviors are accessed via an API. An API will typically specify a format for communication between software processes, including specifying and grouping available variables, functions, and protocols. An API call (sometimes referred to as an API request) will typically be sent from a sending software process to a receiving software process as a way to accomplish one or more of the following: the sending software process requesting information from the receiving software process (e.g., for the sending software process to take action on), the sending software process providing information to the receiving software process (e.g., for the receiving software process to take action on), the sending software process requesting action by the receiving software process, or the sending software process providing information to the receiving software process about action taken by the sending software process. Interaction with a device (e.g., using a user interface) will in some circumstances include the transfer and/or receipt of one or more API calls (e.g., multiple API calls) between multiple different software processes (e.g., different portions of an operating system, an application and an operating system, or different applications) via one or more APIs (e.g., via multiple different APIs). For example, when an input is detected the direct sensor data is frequently processed into one or more input events that are provided (e.g., via an API) to a receiving software process that makes some determination based on the input events, and then sends (e.g., via an API) information to a software process to perform an operation (e.g., change a device state and/or user interface) based on the determination. While a determination and an operation performed in response could be made by the same software process, alternatively the determination could be made in a first software process and relayed (e.g., via an API) to a second software process, that is different from the first software process, that causes the operation to be performed by the second software process. Alternatively, the second software process could relay instructions (e.g., via an API) to a third software process that is different from the first software process and/or the second software process to perform the operation. It should be understood that some or all user interactions with a computer system could involve one or more API calls within a step of interacting with the computer system (e.g., between different software components of the computer system or between a software component of the computer system and a software component of one or more remote computer systems). It should be understood that some or all user interactions with a computer system could involve one or more API calls between steps of interacting with the computer system (e.g., between different software components of the computer system or between a software component of the computer system and a software component of one or more remote computer systems).

In some embodiments, the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application.

In some embodiments, the application is an application that is pre-installed on the first computer system at purchase (e.g., a first-party application). In some embodiments, the application is an application that is provided to the first computer system via an operating system update file (e.g., a first-party application). In some embodiments, the application is an application that is provided via an application store. In some embodiments, the application store is pre-installed on the first computer system at purchase (e.g., a first-party application store) and allows download of one or more applications. In some embodiments, the application store is a third-party application store (e.g., an application store that is provided by another device, downloaded via a network, and/or read from a storage device). In some embodiments, the application is a third-party application (e.g., an app that is provided by an application store, downloaded via a network, and/or read from a storage device). In some embodiments, the application controls the first computer system to perform method 800 (FIG. 8), method 1000 (FIG. 10), and/or method 1200 (FIG. 12) by calling an application programming interface (API) provided by the system process using one or more parameters.

In some embodiments, exemplary APIs provided by the system process include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, a photos API, a camera API, and/or an image processing API.

In some embodiments, at least one API is a software module (e.g., a collection of computer-readable instructions) that provides an interface that allows a different module (e.g., API-calling module) to access and use one or more functions, methods, procedures, data structures, classes, and/or other services provided by an implementation module of the system process. The API can define one or more parameters that are passed between the API-calling module and the implementation module. In some embodiments, API 3190 defines a first API call that can be provided by API-calling module 3180. The implementation module is a system software module (e.g., a collection of computer-readable instructions) that is constructed to perform an operation in response to receiving an API call via the API. In some embodiments, the implementation module is constructed to provide an API response (via the API) as a result of processing an API call. In some embodiments, the implementation module is included in the device (e.g., 3150) that runs the application. In some embodiments, the implementation module is included in an electronic device that is separate from the device that runs the application. FIG. 4 is a schematic, pictorial illustration of an example embodiment of the hand tracking device 140. In some embodiments, hand tracking device 140 (FIG. 1A) is controlled by hand tracking unit 244 (FIG. 2) to track the position/location of one or more portions of the user's hands, and/or motions of one or more portions of the user's hands with respect to the scene 105 of FIG. 1A (e.g., with respect to a portion of the physical environment surrounding the user, with respect to the display generation component 120, or with respect to a portion of the user (e.g., the user's face, eyes, or head), and/or relative to a coordinate system defined relative to the user's hand. In some embodiments, the hand tracking device 140 is part of the display generation component 120 (e.g., embedded in or attached to a head-mounted device). In some embodiments, the hand tracking device 140 is separate from the display generation component 120 (e.g., located in separate housings or attached to separate physical support structures).

In some embodiments, the hand tracking device 140 includes image sensors 404 (e.g., one or more IR cameras, 3D cameras, depth cameras, and/or color cameras, etc.) that capture three-dimensional scene information that includes at least a hand 406 of a human user. The image sensors 404 capture the hand images with sufficient resolution to enable the fingers and their respective positions to be distinguished. The image sensors 404 typically capture images of other parts of the user's body, as well, or possibly all of the body, and may have either zoom capabilities or a dedicated sensor with enhanced magnification to capture images of the hand with the desired resolution. In some embodiments, the image sensors 404 also capture 2D color video images of the hand 406 and other elements of the scene. In some embodiments, the image sensors 404 are used in conjunction with other image sensors to capture the physical environment of the scene 105, or serve as the image sensors that capture the physical environments of the scene 105. In some embodiments, the image sensors 404 are positioned relative to the user or the user's environment in a way that a field of view of the image sensors or a portion thereof is used to define an interaction space in which hand movement captured by the image sensors are treated as inputs to the controller 110.

In some embodiments, the image sensors 404 output a sequence of frames containing 3D map data (and possibly color image data, as well) to the controller 110, which extracts high-level information from the map data. This high-level information is typically provided via an Application Program Interface (API) to an application running on the controller, which drives the display generation component 120 accordingly. For example, the user may interact with software running on the controller 110 by moving his hand 406 and changing his hand posture.

In some embodiments, the image sensors 404 project a pattern of spots onto a scene containing the hand 406 and capture an image of the projected pattern. In some embodiments, the controller 110 computes the 3D coordinates of points in the scene (including points on the surface of the user's hand) by triangulation, based on transverse shifts of the spots in the pattern. This approach is advantageous in that it does not require the user to hold or wear any sort of beacon, sensor, or other marker. It gives the depth coordinates of points in the scene relative to a predetermined reference plane, at a certain distance from the image sensors 404. In the present disclosure, the image sensors 404 are assumed to define an orthogonal set of x, y, z axes, so that depth coordinates of points in the scene correspond to z components measured by the image sensors. Alternatively, the image sensors 404 (e.g., a hand tracking device) may use other methods of 3D mapping, such as stereoscopic imaging or time-of-flight measurements, based on single or multiple cameras or other types of sensors.

In some embodiments, the hand tracking device 140 captures and processes a temporal sequence of depth maps containing the user's hand, while the user moves his hand (e.g., whole hand or one or more fingers). Software running on a processor in the image sensors 404 and/or the controller 110 processes the 3D map data to extract patch descriptors of the hand in these depth maps. The software matches these descriptors to patch descriptors stored in a database 408, based on a prior learning process, in order to estimate the pose of the hand in each frame. The pose typically includes 3D locations of the user's hand joints and finger tips.

The software may also analyze the trajectory of the hands and/or fingers over multiple frames in the sequence in order to identify gestures. The pose estimation functions described herein may be interleaved with motion tracking functions, so that patch-based pose estimation is performed only once in every two (or more) frames, while tracking is used to find changes in the pose that occur over the remaining frames. The pose, motion, and gesture information are provided via the above-mentioned API to an application program running on the controller 110. This program may, for example, move and modify images presented on the display generation component 120, or perform other functions, in response to the pose and/or gesture information.

In some embodiments, a gesture includes an air gesture. An air gesture is a gesture that is detected without the user touching (or independently of) an input element that is part of a device (e.g., computer system 101, one or more input device 125, and/or hand tracking device 140) and is based on detected motion of a portion (e.g., the head, one or more arms, one or more hands, one or more fingers, and/or one or more legs) of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

In some embodiments, input gestures used in the various examples and embodiments described herein include air gestures performed by movement of the user's finger(s) relative to other finger(s) or part(s) of the user's hand) for interacting with an XR environment (e.g., a virtual or mixed-reality environment), in accordance with some embodiments. In some embodiments, an air gesture is a gesture that is detected without the user touching an input element that is part of the device (or independently of an input element that is a part of the device) and is based on detected motion of a portion of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

In some embodiments in which the input gesture is an air gesture (e.g., in the absence of physical contact with an input device that provides the computer system with information about which user interface element is the target of the user input, such as contact with a user interface element displayed on a touchscreen, or contact with a mouse or trackpad to move a cursor to the user interface element), the gesture takes into account the user's attention (e.g., gaze) to determine the target of the user input (e.g., for direct inputs, as described below). Thus, in implementations involving air gestures, the input gesture is, for example, detected attention (e.g., gaze) toward the user interface element in combination (e.g., concurrent) with movement of a user's finger(s) and/or hands to perform a pinch and/or tap input, as described in more detail below.

In some embodiments, input gestures that are directed to a user interface object are performed directly or indirectly with reference to a user interface object. For example, a user input is performed directly on the user interface object in accordance with performing the input gesture with the user's hand at a position that corresponds to the position of the user interface object in the three-dimensional environment (e.g., as determined based on a current viewpoint of the user). In some embodiments, the input gesture is performed indirectly on the user interface object in accordance with the user performing the input gesture while a position of the user's hand is not at the position that corresponds to the position of the user interface object in the three-dimensional environment while detecting the user's attention (e.g., gaze) on the user interface object. For example, for direct input gesture, the user is enabled to direct the user's input to the user interface object by initiating the gesture at, or near, a position corresponding to the displayed position of the user interface object (e.g., within 0.5 cm, 1 cm, 5 cm, or a distance between 0-5 cm, as measured from an outer edge of the option or a center portion of the option). For an indirect input gesture, the user is enabled to direct the user's input to the user interface object by paying attention to the user interface object (e.g., by gazing at the user interface object) and, while paying attention to the option, the user initiates the input gesture (e.g., at any position that is detectable by the computer system) (e.g., at a position that does not correspond to the displayed position of the user interface object).

In some embodiments, input gestures (e.g., air gestures) used in the various examples and embodiments described herein include pinch inputs and tap inputs, for interacting with a virtual or mixed-reality environment, in accordance with some embodiments. For example, the pinch inputs and tap inputs described below are performed as air gestures.

In some embodiments, a pinch input is part of an air gesture that includes one or more of: a pinch gesture, a long pinch gesture, a pinch and drag gesture, or a double pinch gesture. For example, a pinch gesture that is an air gesture includes movement of two or more fingers of a hand to make contact with one another, that is, optionally, followed by an immediate (e.g., within 0-1 seconds) break in contact from each other. A long pinch gesture that is an air gesture includes movement of two or more fingers of a hand to make contact with one another for at least a threshold amount of time (e.g., at least 1 second), before detecting a break in contact with one another. For example, a long pinch gesture includes the user holding a pinch gesture (e.g., with the two or more fingers making contact), and the long pinch gesture continues until a break in contact between the two or more fingers is detected. In some embodiments, a double pinch gesture that is an air gesture comprises two (e.g., or more) pinch inputs (e.g., performed by the same hand) detected in immediate (e.g., within a predefined time period) succession of each other. For example, the user performs a first pinch input (e.g., a pinch input or a long pinch input), releases the first pinch input (e.g., breaks contact between the two or more fingers), and performs a second pinch input within a predefined time period (e.g., within 1 second or within 2 seconds) after releasing the first pinch input.

In some embodiments, a pinch and drag gesture that is an air gesture (e.g., an air drag gesture or an air swipe gesture) includes a pinch gesture (e.g., a pinch gesture or a long pinch gesture) performed in conjunction with (e.g., followed by) a drag input that changes a position of the user's hand from a first position (e.g., a start position of the drag) to a second position (e.g., an end position of the drag). In some embodiments, the user maintains the pinch gesture while performing the drag input, and releases the pinch gesture (e.g., opens their two or more fingers) to end the drag gesture (e.g., at the second position). In some embodiments, the pinch input and the drag input are performed by the same hand (e.g., the user pinches two or more fingers to make contact with one another and moves the same hand to the second position in the air with the drag gesture). In some embodiments, the pinch input is performed by a first hand of the user and the drag input is performed by the second hand of the user (e.g., the user's second hand moves from the first position to the second position in the air while the user continues the pinch input with the user's first hand. In some embodiments, an input gesture that is an air gesture includes inputs (e.g., pinch and/or tap inputs) performed using both of the user's two hands. For example, the input gesture includes two (e.g., or more) pinch inputs performed in conjunction with (e.g., concurrently with, or within a predefined time period of) each other. For example, a first pinch gesture performed using a first hand of the user (e.g., a pinch input, a long pinch input, or a pinch and drag input), and, in conjunction with performing the pinch input using the first hand, performing a second pinch input using the other hand (e.g., the second hand of the user's two hands).

In some embodiments, a tap input (e.g., directed to a user interface element) performed as an air gesture includes movement of a user's finger(s) toward the user interface element, movement of the user's hand toward the user interface element optionally with the user's finger(s) extended toward the user interface element, a downward motion of a user's finger (e.g., mimicking a mouse click motion or a tap on a touchscreen), or other predefined movement of the user's hand. In some embodiments a tap input that is performed as an air gesture is detected based on movement characteristics of the finger or hand performing the tap gesture movement of a finger or hand away from the viewpoint of the user and/or toward an object that is the target of the tap input followed by an end of the movement. In some embodiments the end of the movement is detected based on a change in movement characteristics of the finger or hand performing the tap gesture (e.g., an end of movement away from the viewpoint of the user and/or toward the object that is the target of the tap input, a reversal of direction of movement of the finger or hand, and/or a reversal of a direction of acceleration of movement of the finger or hand).

In some embodiments, attention of a user is determined to be directed to a portion of the three-dimensional environment based on detection of gaze directed to the portion of the three-dimensional environment (optionally, without requiring other conditions). In some embodiments, attention of a user is determined to be directed to a portion of the three-dimensional environment based on detection of gaze directed to the portion of the three-dimensional environment with one or more additional conditions such as requiring that gaze is directed to the portion of the three-dimensional environment for at least a threshold duration (e.g., a dwell duration) and/or requiring that the gaze is directed to the portion of the three-dimensional environment while the viewpoint of the user is within a distance threshold from the portion of the three-dimensional environment in order for the device to determine that attention of the user is directed to the portion of the three-dimensional environment, where if one of the additional conditions is not met, the device determines that attention is not directed to the portion of the three-dimensional environment toward which gaze is directed (e.g., until the one or more additional conditions are met).

In some embodiments, the detection of a ready state configuration of a user or a portion of a user is detected by the computer system. Detection of a ready state configuration of a hand is used by a computer system as an indication that the user is likely preparing to interact with the computer system using one or more air gesture inputs performed by the hand (e.g., a pinch, tap, pinch and drag, double pinch, long pinch, or other air gesture described herein). For example, the ready state of the hand is determined based on whether the hand has a predetermined hand shape (e.g., a pre-pinch shape with a thumb and one or more fingers extended and spaced apart ready to make a pinch or grab gesture or a pre-tap with one or more fingers extended and palm facing away from the user), based on whether the hand is in a predetermined position relative to a viewpoint of the user (e.g., below the user's head and above the user's waist and extended out from the body by at least 15, 20, 25, 30, or 50 cm), and/or based on whether the hand has moved in a particular manner (e.g., moved toward a region in front of the user above the user's waist and below the user's head or moved away from the user's body or leg). In some embodiments, the ready state is used to determine whether interactive elements of the user interface respond to attention (e.g., gaze) inputs.

In scenarios where inputs are described with reference to air gestures, it should be understood that similar gestures could be detected using a hardware input device that is attached to or held by one or more hands of a user, where the position of the hardware input device in space can be tracked using optical tracking, one or more accelerometers, one or more gyroscopes, one or more magnetometers, and/or one or more inertial measurement units and the position and/or movement of the hardware input device is used in place of the position and/or movement of the one or more hands in the corresponding air gesture(s). In scenarios where inputs are described with reference to air gestures, it should be understood that similar gestures could be detected using a hardware input device that is attached to or held by one or more hands of a user. User inputs can be detected with controls contained in the hardware input device such as one or more touch-sensitive input elements, one or more pressure-sensitive input elements, one or more buttons, one or more knobs, one or more dials, one or more joysticks, one or more hand or finger coverings that can detect a position or change in position of portions of a hand and/or fingers relative to each other, relative to the user's body, and/or relative to a physical environment of the user, and/or other hardware input device controls, where the user inputs with the controls contained in the hardware input device are used in place of hand and/or finger gestures such as air taps or air pinches in the corresponding air gesture(s). For example, a selection input that is described as being performed with an air tap or air pinch input could be alternatively detected with a button press, a tap on a touch-sensitive surface, a press on a pressure-sensitive surface, or other hardware input. As another example, a movement input that is described as being performed with an air pinch and drag (e.g., an air drag gesture or an air swipe gesture) could be alternatively detected based on an interaction with the hardware input control such as a button press and hold, a touch on a touch-sensitive surface, a press on a pressure-sensitive surface, or other hardware input that is followed by movement of the hardware input device (e.g., along with the hand with which the hardware input device is associated) through space. Similarly, a two-handed input that includes movement of the hands relative to each other could be performed with one air gesture and one hardware input device in the hand that is not performing the air gesture, two hardware input devices held in different hands, or two air gestures performed by different hands using various combinations of air gestures and/or the inputs detected by one or more hardware input devices that are described above.

In some embodiments, the software may be downloaded to the controller 110 in electronic form, over a network, for example, or it may alternatively be provided on tangible, non-transitory media, such as optical, magnetic, or electronic memory media. In some embodiments, the database 408 is likewise stored in a memory associated with the controller 110. Alternatively or additionally, some or all of the described functions of the computer may be implemented in dedicated hardware, such as a custom or semi-custom integrated circuit or a programmable digital signal processor (DSP). Although the controller 110 is shown in FIG. 4, by way of example, as a separate unit from the image sensors 404, some or all of the processing functions of the controller may be performed by a suitable microprocessor and software or by dedicated circuitry within the housing of the image sensors 404 (e.g., a hand tracking device) or otherwise associated with the image sensors 404. In some embodiments, at least some of these processing functions may be carried out by a suitable processor that is integrated with the display generation component 120 (e.g., in a television set, a handheld device, or head-mounted device, for example) or with any other suitable computerized device, such as a game console or media player. The sensing functions of image sensors 404 may likewise be integrated into the computer or other computerized apparatus that is to be controlled by the sensor output.

FIG. 4 further includes a schematic representation of a depth map 410 captured by the image sensors 404, in accordance with some embodiments. The depth map, as explained above, comprises a matrix of pixels having respective depth values. The pixels 412 corresponding to the hand 406 have been segmented out from the background and the wrist in this map. The brightness of each pixel within the depth map 410 corresponds inversely to its depth value, i.e., the measured z distance from the image sensors 404, with the shade of gray growing darker with increasing depth. The controller 110 processes these depth values in order to identify and segment a component of the image (i.e., a group of neighboring pixels) having characteristics of a human hand. These characteristics, may include, for example, overall size, shape and motion from frame to frame of the sequence of depth maps.

FIG. 4 also schematically illustrates a hand skeleton 414 that controller 110 ultimately extracts from the depth map 410 of the hand 406, in accordance with some embodiments. In FIG. 4, the hand skeleton 414 is superimposed on a hand background 416 that has been segmented from the original depth map. In some embodiments, key feature points of the hand (e.g., points corresponding to knuckles, finger tips, center of the palm, end of the hand connecting to wrist, etc.) and optionally on the wrist or arm connected to the hand are identified and located on the hand skeleton 414. In some embodiments, location and movements of these key feature points over multiple image frames are used by the controller 110 to determine the hand gestures performed by the hand or the current state of the hand, in accordance with some embodiments.

FIG. 5 illustrates an example embodiment of the eye tracking device 130 (FIG. 1A). In some embodiments, the eye tracking device 130 is controlled by the eye tracking unit 243 (FIG. 2) to track the position and movement of the user's gaze with respect to the scene 105 or with respect to the XR content displayed via the display generation component 120. In some embodiments, the eye tracking device 130 is integrated with the display generation component 120. For example, in some embodiments, when the display generation component 120 is a head-mounted device such as headset, helmet, goggles, or glasses, or a handheld device placed in a wearable frame, the head-mounted device includes both a component that generates the XR content for viewing by the user and a component for tracking the gaze of the user relative to the XR content. In some embodiments, the eye tracking device 130 is separate from the display generation component 120. For example, when display generation component is a handheld device or a XR chamber, the eye tracking device 130 is optionally a separate device from the handheld device or XR chamber. In some embodiments, the eye tracking device 130 is a head-mounted device or part of a head-mounted device. In some embodiments, the head-mounted eye-tracking device 130 is optionally used in conjunction with a display generation component that is also head-mounted, or a display generation component that is not head-mounted. In some embodiments, the eye tracking device 130 is not a head-mounted device, and is optionally used in conjunction with a head-mounted display generation component. In some embodiments, the eye tracking device 130 is not a head-mounted device, and is optionally part of a non-head-mounted display generation component.

In some embodiments, the display generation component 120 uses a display mechanism (e.g., left and right near-eye display panels) for displaying frames including left and right images in front of a user's eyes to thus provide 3D virtual views to the user. For example, a head-mounted display generation component may include left and right optical lenses (referred to herein as eye lenses) located between the display and the user's eyes. In some embodiments, the display generation component may include or be coupled to one or more external video cameras that capture video of the user's environment for display. In some embodiments, a head-mounted display generation component may have a transparent or semi-transparent display through which a user may view the physical environment directly and display virtual objects on the transparent or semi-transparent display. In some embodiments, display generation component projects virtual objects into the physical environment. The virtual objects may be projected, for example, on a physical surface or as a holograph, so that an individual, using the system, observes the virtual objects superimposed over the physical environment. In such cases, separate display panels and image frames for the left and right eyes may not be necessary.

As shown in FIG. 5, in some embodiments, eye tracking device 130 (e.g., a gaze tracking device) includes at least one eye tracking camera (e.g., infrared (IR) or near-IR (NIR) cameras), and illumination sources (e.g., IR or NIR light sources such as an array or ring of LEDs) that emit light (e.g., IR or NIR light) towards the user's eyes. The eye tracking cameras may be pointed towards the user's eyes to receive reflected IR or NIR light from the light sources directly from the eyes, or alternatively may be pointed towards “hot” mirrors located between the user's eyes and the display panels that reflect IR or NIR light from the eyes to the eye tracking cameras while allowing visible light to pass. The eye tracking device 130 optionally captures images of the user's eyes (e.g., as a video stream captured at 60-120 frames per second (fps)), analyze the images to generate gaze tracking information, and communicate the gaze tracking information to the controller 110. In some embodiments, two eyes of the user are separately tracked by respective eye tracking cameras and illumination sources. In some embodiments, only one eye of the user is tracked by a respective eye tracking camera and illumination sources.

In some embodiments, the eye tracking device 130 is calibrated using a device-specific calibration process to determine parameters of the eye tracking device for the specific operating environment 100, for example the 3D geometric relationship and parameters of the LEDs, cameras, hot mirrors (if present), eye lenses, and display screen. The device-specific calibration process may be performed at the factory or another facility prior to delivery of the AR/VR equipment to the end user. The device-specific calibration process may be an automated calibration process or a manual calibration process. A user-specific calibration process may include an estimation of a specific user's eye parameters, for example the pupil location, fovea location, optical axis, visual axis, eye spacing, etc. Once the device-specific and user-specific parameters are determined for the eye tracking device 130, images captured by the eye tracking cameras can be processed using a glint-assisted method to determine the current visual axis and point of gaze of the user with respect to the display, in accordance with some embodiments.

As shown in FIG. 5, the eye tracking device 130 (e.g., 130A or 130B) includes eye lens(es) 520, and a gaze tracking system that includes at least one eye tracking camera 540 (e.g., infrared (IR) or near-IR (NIR) cameras) positioned on a side of the user's face for which eye tracking is performed, and an illumination source 530 (e.g., IR or NIR light sources such as an array or ring of NIR light-emitting diodes (LEDs)) that emit light (e.g., IR or NIR light) towards the user's eye(s) 592. The eye tracking cameras 540 may be pointed towards mirrors 550 located between the user's eye(s) 592 and a display 510 (e.g., a left or right display panel of a head-mounted display, or a display of a handheld device, a projector, etc.) that reflect IR or NIR light from the eye(s) 592 while allowing visible light to pass (e.g., as shown in the top portion of FIG. 5), or alternatively may be pointed towards the user's eye(s) 592 to receive reflected IR or NIR light from the eye(s) 592 (e.g., as shown in the bottom portion of FIG. 5).

In some embodiments, the controller 110 renders AR or VR frames 562 (e.g., left and right frames for left and right display panels) and provides the frames 562 to the display 510. The controller 110 uses gaze tracking input 542 from the eye tracking cameras 540 for various purposes, for example in processing the frames 562 for display. The controller 110 optionally estimates the user's point of gaze on the display 510 based on the gaze tracking input 542 obtained from the eye tracking cameras 540 using the glint-assisted methods or other suitable methods. The point of gaze estimated from the gaze tracking input 542 is optionally used to determine the direction in which the user is currently looking.

The following describes several possible use cases for the user's current gaze direction, and is not intended to be limiting. As an example use case, the controller 110 may render virtual content differently based on the determined direction of the user's gaze. For example, the controller 110 may generate virtual content at a higher resolution in a foveal region determined from the user's current gaze direction than in peripheral regions. As another example, the controller may position or move virtual content in the view based at least in part on the user's current gaze direction. As another example, the controller may display particular virtual content in the view based at least in part on the user's current gaze direction. As another example use case in AR applications, the controller 110 may direct external cameras for capturing the physical environments of the XR experience to focus in the determined direction. The autofocus mechanism of the external cameras may then focus on an object or surface in the environment that the user is currently looking at on the display 510. As another example use case, the eye lenses 520 may be focusable lenses, and the gaze tracking information is used by the controller to adjust the focus of the eye lenses 520 so that the virtual object that the user is currently looking at has the proper vergence to match the convergence of the user's eyes 592. The controller 110 may leverage the gaze tracking information to direct the eye lenses 520 to adjust focus so that close objects that the user is looking at appear at the right distance.

In some embodiments, the eye tracking device is part of a head-mounted device that includes a display (e.g., display 510), two eye lenses (e.g., eye lens(es) 520), eye tracking cameras (e.g., eye tracking camera(s) 540), and light sources (e.g., illumination sources 530 (e.g., IR or NIR LEDs), mounted in a wearable housing. The light sources emit light (e.g., IR or NIR light) towards the user's eye(s) 592. In some embodiments, the light sources may be arranged in rings or circles around each of the lenses as shown in FIG. 5. In some embodiments, eight illumination sources 530 (e.g., LEDs) are arranged around each lens 520 as an example. However, more or fewer illumination sources 530 may be used, and other arrangements and locations of illumination sources 530 may be used.

In some embodiments, the display 510 emits light in the visible light range and does not emit light in the IR or NIR range, and thus does not introduce noise in the gaze tracking system. Note that the location and angle of eye tracking camera(s) 540 is given by way of example, and is not intended to be limiting. In some embodiments, a single eye tracking camera 540 is located on each side of the user's face. In some embodiments, two or more NIR cameras 540 may be used on each side of the user's face. In some embodiments, a camera 540 with a wider field of view (FOV) and a camera 540 with a narrower FOV may be used on each side of the user's face. In some embodiments, a camera 540 that operates at one wavelength (e.g., 850 nm) and a camera 540 that operates at a different wavelength (e.g., 940 nm) may be used on each side of the user's face.

Embodiments of the gaze tracking system as illustrated in FIG. 5 may, for example, be used in computer-generated reality, virtual reality, and/or mixed reality applications to provide computer-generated reality, virtual reality, augmented reality, and/or augmented virtuality experiences to the user.

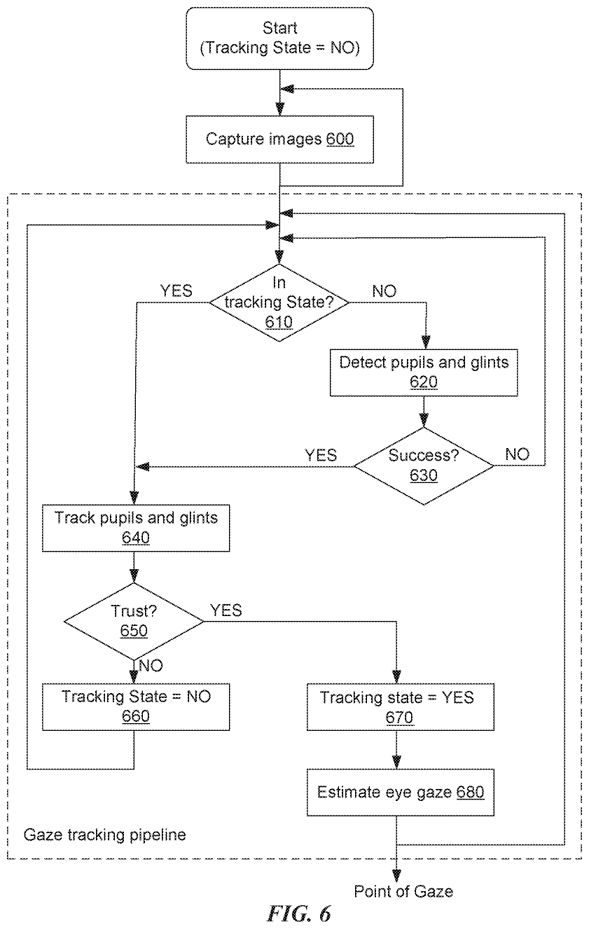

FIG. 6 illustrates a glint-assisted gaze tracking pipeline, in accordance with some embodiments. In some embodiments, the gaze tracking pipeline is implemented by a glint-assisted gaze tracking system (e.g., eye tracking device 130 as illustrated in FIGS. 1A and 5). The glint-assisted gaze tracking system may maintain a tracking state. Initially, the tracking state is off or “NO”. When in the tracking state, the glint-assisted gaze tracking system uses prior information from the previous frame when analyzing the current frame to track the pupil contour and glints in the current frame. When not in the tracking state, the glint-assisted gaze tracking system attempts to detect the pupil and glints in the current frame and, if successful, initializes the tracking state to “YES” and continues with the next frame in the tracking state.

As shown in FIG. 6, the gaze tracking cameras may capture left and right images of the user's left and right eyes. The captured images are then input to a gaze tracking pipeline for processing beginning at 610. As indicated by the arrow returning to element 600, the gaze tracking system may continue to capture images of the user's eyes, for example at a rate of 60 to 120 frames per second. In some embodiments, each set of captured images may be input to the pipeline for processing. However, in some embodiments or under some conditions, not all captured frames are processed by the pipeline.

At 610, for the current captured images, if the tracking state is YES, then the method proceeds to element 640. At 610, if the tracking state is NO, then as indicated at 620 the images are analyzed to detect the user's pupils and glints in the images. At 630, if the pupils and glints are successfully detected, then the method proceeds to element 640. Otherwise, the method returns to element 610 to process next images of the user's eyes.

At 640, if proceeding from element 610, the current frames are analyzed to track the pupils and glints based in part on prior information from the previous frames. At 640, if proceeding from element 630, the tracking state is initialized based on the detected pupils and glints in the current frames. Results of processing at element 640 are checked to verify that the results of tracking or detection can be trusted. For example, results may be checked to determine if the pupil and a sufficient number of glints to perform gaze estimation are successfully tracked or detected in the current frames. At 650, if the results cannot be trusted, then the tracking state is set to NO at element 660, and the method returns to element 610 to process next images of the user's eyes. At 650, if the results are trusted, then the method proceeds to element 670. At 670, the tracking state is set to YES (if not already YES), and the pupil and glint information is passed to element 680 to estimate the user's point of gaze.

FIG. 6 is intended to serve as one example of eye tracking technology that may be used in a particular implementation. As recognized by those of ordinary skill in the art, other eye tracking technologies that currently exist or are developed in the future may be used in place of or in combination with the glint-assisted eye tracking technology describe herein in the computer system 101 for providing XR experiences to users, in accordance with various embodiments.

In some embodiments, the captured portions of real world environment 602 are used to provide a XR experience to the user, for example, a mixed reality environment in which one or more virtual objects are superimposed over representations of real world environment 602.

Thus, the description herein describes some embodiments of three-dimensional environments (e.g., XR environments) that include representations of real world objects and representations of virtual objects. For example, a three-dimensional environment optionally includes a representation of a table that exists in the physical environment, which is captured and displayed in the three-dimensional environment (e.g., actively via cameras and displays of a computer system, or passively via a transparent or translucent display of the computer system). As described previously, the three-dimensional environment is optionally a mixed reality system in which the three-dimensional environment is based on the physical environment that is captured by one or more sensors of the computer system and displayed via a display generation component. As a mixed reality system, the computer system is optionally able to selectively display portions and/or objects of the physical environment such that the respective portions and/or objects of the physical environment appear as if they exist in the three-dimensional environment displayed by the computer system. Similarly, the computer system is optionally able to display virtual objects in the three-dimensional environment to appear as if the virtual objects exist in the real world (e.g., physical environment) by placing the virtual objects at respective locations in the three-dimensional environment that have corresponding locations in the real world. For example, the computer system optionally displays a vase such that it appears as if a real vase is placed on top of a table in the physical environment. In some embodiments, a respective location in the three-dimensional environment has a corresponding location in the physical environment. Thus, when the computer system is described as displaying a virtual object at a respective location with respect to a physical object (e.g., such as a location at or near the hand of the user, or at or near a physical table), the computer system displays the virtual object at a particular location in the three-dimensional environment such that it appears as if the virtual object is at or near the physical object in the physical world (e.g., the virtual object is displayed at a location in the three-dimensional environment that corresponds to a location in the physical environment at which the virtual object would be displayed if it were a real object at that particular location).

In some embodiments, real world objects that exist in the physical environment that are displayed in the three-dimensional environment (e.g., and/or visible via the display generation component) can interact with virtual objects that exist only in the three-dimensional environment. For example, a three-dimensional environment can include a table and a vase placed on top of the table, with the table being a view of (or a representation of) a physical table in the physical environment, and the vase being a virtual object.

In a three-dimensional environment (e.g., a real environment, a virtual environment, or an environment that includes a mix of real and virtual objects), objects are sometimes referred to as having a depth or simulated depth, or objects are referred to as being visible, displayed, or placed at different depths. In this context, depth refers to a dimension other than height or width. In some embodiments, depth is defined relative to a fixed set of coordinates (e.g., where a room or an object has a height, depth, and width defined relative to the fixed set of coordinates). In some embodiments, depth is defined relative to a location or viewpoint of a user, in which case, the depth dimension varies based on the location of the user and/or the location and angle of the viewpoint of the user. In some embodiments where depth is defined relative to a location of a user that is positioned relative to a surface of an environment (e.g., a floor of an environment, or a surface of the ground), objects that are further away from the user along a line that extends parallel to the surface are considered to have a greater depth in the environment, and/or the depth of an object is measured along an axis that extends outward from a location of the user and is parallel to the surface of the environment (e.g., depth is defined in a cylindrical or substantially cylindrical coordinate system with the position of the user at the center of the cylinder that extends from a head of the user toward feet of the user). In some embodiments where depth is defined relative to viewpoint of a user (e.g., a direction relative to a point in space that determines which portion of an environment that is visible via a head-mounted device or other display), objects that are further away from the viewpoint of the user along a line that extends parallel to the direction of the viewpoint of the user are considered to have a greater depth in the environment, and/or the depth of an object is measured along an axis that extends outward from a line that extends from the viewpoint of the user and is parallel to the direction of the viewpoint of the user (e.g., depth is defined in a spherical or substantially spherical coordinate system with the origin of the viewpoint at the center of the sphere that extends outwardly from a head of the user). In some embodiments, depth is defined relative to a user interface container (e.g., a window or application in which application and/or system content is displayed) where the user interface container has a height and/or width, and depth is a dimension that is orthogonal to the height and/or width of the user interface container. In some embodiments, in circumstances where depth is defined relative to a user interface container, the height and or width of the container are typically orthogonal or substantially orthogonal to a line that extends from a location based on the user (e.g., a viewpoint of the user or a location of the user) to the user interface container (e.g., the center of the user interface container, or another characteristic point of the user interface container) when the container is placed in the three-dimensional environment or is initially displayed (e.g., so that the depth dimension for the container extends outward away from the user or the viewpoint of the user). In some embodiments, in situations where depth is defined relative to a user interface container, depth of an object relative to the user interface container refers to a position of the object along the depth dimension for the user interface container. In some embodiments, multiple different containers can have different depth dimensions (e.g., different depth dimensions that extend away from the user or the viewpoint of the user in different directions and/or from different starting points). In some embodiments, when depth is defined relative to a user interface container, the direction of the depth dimension remains constant for the user interface container as the location of the user interface container, the user and/or the viewpoint of the user changes (e.g., or when multiple different viewers are viewing the same container in the three-dimensional environment such as during an in-person collaboration session and/or when multiple participants are in a real-time communication session with shared virtual content including the container). In some embodiments, for curved containers (e.g., including a container with a curved surface or curved content region), the depth dimension optionally extends into a surface of the curved container. In some situations, z-separation (e.g., separation of two objects in a depth dimension), z-height (e.g., distance of one object from another in a depth dimension), z-position (e.g., position of one object in a depth dimension), z-depth (e.g., position of one object in a depth dimension), or simulated z dimension (e.g., depth used as a dimension of an object, dimension of an environment, a direction in space, and/or a direction in simulated space) are used to refer to the concept of depth as described above.

In some embodiments, a user is optionally able to interact with virtual objects in the three-dimensional environment using one or more hands as if the virtual objects were real objects in the physical environment. For example, as described above, one or more sensors of the computer system optionally capture one or more of the hands of the user and display representations of the hands of the user in the three-dimensional environment (e.g., in a manner similar to displaying a real world object in three-dimensional environment described above), or in some embodiments, the hands of the user are visible via the display generation component via the ability to see the physical environment through the user interface due to the transparency/translucency of a portion of the display generation component that is displaying the user interface or due to projection of the user interface onto a transparent/translucent surface or projection of the user interface onto the user's eye or into a field of view of the user's eye. Thus, in some embodiments, the hands of the user are displayed at a respective location in the three-dimensional environment and are treated as if they were objects in the three-dimensional environment that are able to interact with the virtual objects in the three-dimensional environment as if they were physical objects in the physical environment. In some embodiments, the computer system is able to update display of the representations of the user's hands in the three-dimensional environment in conjunction with the movement of the user's hands in the physical environment.

In some of the embodiments described below, the computer system is optionally able to determine the “effective” distance between physical objects in the physical world and virtual objects in the three-dimensional environment, for example, for the purpose of determining whether a physical object is directly interacting with a virtual object (e.g., whether a hand is touching, grabbing, holding, etc. a virtual object or within a threshold distance of a virtual object). For example, a hand directly interacting with a virtual object optionally includes one or more of a finger of a hand pressing a virtual button, a hand of a user grabbing a virtual vase, two fingers of a hand of the user coming together and pinching/holding a user interface of an application, and any of the other types of interactions described here. For example, the computer system optionally determines the distance between the hands of the user and virtual objects when determining whether the user is interacting with virtual objects and/or how the user is interacting with virtual objects. In some embodiments, the computer system determines the distance between the hands of the user and a virtual object by determining the distance between the location of the hands in the three-dimensional environment and the location of the virtual object of interest in the three-dimensional environment. For example, the one or more hands of the user are located at a particular position in the physical world, which the computer system optionally captures and displays at a particular corresponding position in the three-dimensional environment (e.g., the position in the three-dimensional environment at which the hands would be displayed if the hands were virtual, rather than physical, hands). The position of the hands in the three-dimensional environment is optionally compared with the position of the virtual object of interest in the three-dimensional environment to determine the distance between the one or more hands of the user and the virtual object. In some embodiments, the computer system optionally determines a distance between a physical object and a virtual object by comparing positions in the physical world (e.g., as opposed to comparing positions in the three-dimensional environment). For example, when determining the distance between one or more hands of the user and a virtual object, the computer system optionally determines the corresponding location in the physical world of the virtual object (e.g., the position at which the virtual object would be located in the physical world if it were a physical object rather than a virtual object), and then determines the distance between the corresponding physical position and the one of more hands of the user. In some embodiments, the same techniques are optionally used to determine the distance between any physical object and any virtual object. Thus, as described herein, when determining whether a physical object is in contact with a virtual object or whether a physical object is within a threshold distance of a virtual object, the computer system optionally performs any of the techniques described above to map the location of the physical object to the three-dimensional environment and/or map the location of the virtual object to the physical environment.

In some embodiments, the same or similar technique is used to determine where and what the gaze of the user is directed to and/or where and at what a physical stylus held by a user is pointed. For example, if the gaze of the user is directed to a particular position in the physical environment, the computer system optionally determines the corresponding position in the three-dimensional environment (e.g., the virtual position of the gaze), and if a virtual object is located at that corresponding virtual position, the computer system optionally determines that the gaze of the user is directed to that virtual object. Similarly, the computer system is optionally able to determine, based on the orientation of a physical stylus, to where in the physical environment the stylus is pointing. In some embodiments, based on this determination, the computer system determines the corresponding virtual position in the three-dimensional environment that corresponds to the location in the physical environment to which the stylus is pointing, and optionally determines that the stylus is pointing at the corresponding virtual position in the three-dimensional environment.

Similarly, the embodiments described herein may refer to the location of the user (e.g., the user of the computer system) and/or the location of the computer system in the three-dimensional environment. In some embodiments, the user of the computer system is holding, wearing, or otherwise located at or near the computer system. Thus, in some embodiments, the location of the computer system is used as a proxy for the location of the user. In some embodiments, the location of the computer system and/or user in the physical environment corresponds to a respective location in the three-dimensional environment. For example, the location of the computer system would be the location in the physical environment (and its corresponding location in the three-dimensional environment) from which, if a user were to stand at that location facing a respective portion of the physical environment that is visible via the display generation component, the user would see the objects in the physical environment in the same positions, orientations, and/or sizes as they are displayed by or visible via the display generation component of the computer system in the three-dimensional environment (e.g., in absolute terms and/or relative to each other). Similarly, if the virtual objects displayed in the three-dimensional environment were physical objects in the physical environment (e.g., placed at the same locations in the physical environment as they are in the three-dimensional environment, and having the same sizes and orientations in the physical environment as in the three-dimensional environment), the location of the computer system and/or user is the position from which the user would see the virtual objects in the physical environment in the same positions, orientations, and/or sizes as they are displayed by the display generation component of the computer system in the three-dimensional environment (e.g., in absolute terms and/or relative to each other and the real world objects).

In the present disclosure, various input methods are described with respect to interactions with a computer system. When an example is provided using one input device or input method and another example is provided using another input device or input method, it is to be understood that each example may be compatible with and optionally utilizes the input device or input method described with respect to another example. Similarly, various output methods are described with respect to interactions with a computer system. When an example is provided using one output device or output method and another example is provided using another output device or output method, it is to be understood that each example may be compatible with and optionally utilizes the output device or output method described with respect to another example. Similarly, various methods are described with respect to interactions with a virtual environment or a mixed reality environment through a computer system. When an example is provided using interactions with a virtual environment and another example is provided using mixed reality environment, it is to be understood that each example may be compatible with and optionally utilizes the methods described with respect to another example. As such, the present disclosure discloses embodiments that are combinations of the features of multiple examples, without exhaustively listing all features of an embodiment in the description of each example embodiment.

### User Interfaces and Associated Processes

Attention is now directed towards embodiments of user interfaces (“UI”) and associated processes that may be implemented on a computer system, such as portable multifunction device or a head-mounted device, with a display generation component, one or more input devices, and (optionally) one or cameras.

FIGS. 7A-7R illustrate exemplary ways in which a first computer system and a second computer system share and display representations of a three-dimensional virtual object.

FIG. 7A illustrates a laptop 700 (e.g., a first computer system) being operated and interacted with by user 760. As illustrated in the top-down view of FIG. 7A, the room that laptop 700 is being operated in includes a plurality of computer systems of various types, including a computer system 101 as described above (e.g., HMD 101), a second HMD device 100 (which shares one or more characteristics with HMD 101 described with respect to FIG. 1), a smart phone device 780, and a second laptop 700b. While a laptop is used as one example, it should be understood that computer system 700 could be any of a variety of different computer systems.

As illustrated in FIG. 7A, user 760 interacts with laptop 700, and particularly an application running on laptop 700, by providing one or more inputs with hand 760b to one or more input devices of laptop 700 included a trackpad and/or a keyboard (or optionally towards a mouse connected to the laptop, not pictured). In the example of FIG. 7A, laptop 700 displays on laptop screen 702 content associated with an application that is executed by laptop 700. For instance, laptop 700 runs/executes a computer-aided design (CAD) application 712, and displays content on display 702 (e.g., the screen of laptop 700) that is associated with the application. The illustrated CAD application illustrated in FIG. 7A is an application for viewing and/or editing three-dimensional virtual objects. In some embodiments, a first representation 750 of a three-dimensional virtual object (e.g., a mug) is displayed by the CAD application on display 702. However, because display 702 is a two-dimensional display, the displayed first representation 750 of the three-dimensional virtual object is a two-dimensional representation of a three-dimensional object. In some embodiments, and as described in further detail below, the first representation 750 can be manipulated (e.g., rotated, translated, and/or modified) within the CAD application to view and/or modify different portions of the three-dimensional virtual object.

In some embodiments, and due to the limitations of a two-dimensional display being unable to display three-dimensional content in three dimensions, the CAD application (and/or optionally the operating system that operates laptop 700) includes functionality to share content with other external device which include display capabilities that are compatible with three-dimensional content. As illustrated in FIG. 7A CAD application 712 includes a transfer button 714. Transfer button 714 is a selectable affordance/user interface element that when selected initiates a process for transferring data associated with the first representation 750 of the three-dimensional virtual object to another computer system for display. In the illustrated example of FIG. 7A, the user selects the transfer button 714 via moving a cursor 710 over the transfer button and clicking the trackpad of laptop 700, while the first representation 750 of the three-dimensional virtual object is actively displayed within the CAD application.

FIGS. 7B-7G illustrate a process of sharing representations of three-dimensional content with an external computer system. In the example of FIG. 7B laptop 700 displays transfer window 716 in response to detecting an input at transfer button 714 in FIG. 7A. Transfer window 716 is a user interface that facilitates selection of an external computer system to share content with. As illustrated in FIG. 7B, transfer window 716 includes three destination computer system icons 718a, 718b, and 718c, all of which are eligible for displaying a representation associated with the three-dimensional virtual object (e.g., capable of displaying and/or suitable for receiving the data that is being displayed by CAD application 712) in a three-dimensional environment 730. In some embodiments, a device in addition to be capable of receiving the data being displayed by application is also required to be within a threshold distance of the device in order to be displayed on transfer window 716. As illustrated in FIG. 7B, three-devices, HMD1, HMD1, and Phone1 are displayed on transfer window 716. The second laptop in the room (Laptop1, 700b) is not displayed within the transfer window 716 as this laptop is not capable of displaying a representation of a virtual object within a three-dimensional environment 730 (e.g., the laptop 700b does not have three-dimensional display capabilities). As another example, FIG. 7C illustrates a transfer window showing all four of the available destination computer systems as icons 718a, 718b, 718c, and 718d to the user. In FIGS. 7B and 7C, laptop 700 detects the user moving cursor 710 over icon 718a (e.g., that is associated with HMD 101) to select the HMD 101 as the second computer system to share three-dimensional content with. In response to detecting selection of HMD 101 as the second computer system via receiving a selection at transfer window 716, laptop 700 transfers data associated with the first representation 750 to HMD 101.

In some embodiments, HMD 101 displays, via a display generation component 120 (e.g., display generation components 1-122a and 1-122b of FIG. 1), a three-dimensional environment 730 from a viewpoint of a user of the second computer system (HMD 101). In some embodiments, the three-dimensional environment 730 includes a representation of the physical room that surrounds the HMD 101. In FIG. 7B, the HMD 101 includes one or more internal image sensors 114a oriented towards the face of the user (e.g., eye tracking cameras 540 described with reference to FIG. 5). In some embodiments, internal image sensors 114a are used for eye tracking (e.g., detecting a gaze of the user). Internal image sensors 114a are optionally arranged on the left and right portions of display generation component 120 to enable eye tracking of the user's left and right eyes. Second computer system (HMD 101) also includes external image sensors 114b and 114c facing outwards from the user to detect and/or capture the physical environment and/or movements of the user's hands.

As shown in FIG. 7B, HMD 101 captures one or more images of the physical environment around HMD 101 (e.g., operating environment 100 of FIG. 1), including one or more objects in the physical environment around HMD 101. In some embodiments, HMD 101 displays representations of the physical environment in three-dimensional environment 730. For example, three-dimensional environment 730 includes representations of rear and side walls of a room in which the second computer system (HMD 101) is located.

As discussed in more detail below, in FIG. 7B, display generation component 120 is illustrated as displaying one or more virtual objects in the three-dimensional environment 730. In some embodiments, the one or more virtual objects are displayed by a single display (e.g., display 510 of FIG. 5) included in display generation component 120. In some embodiments, display generation component 120 includes two or more displays (e.g., left and right display panels for the left and right eyes of the user, respectively, as described with reference to FIG. 5) having displayed outputs that are merged (e.g., by the user's brain) to create the view of the virtual objects shown in FIGS. 7C-7Q.

Display generation component 120 has a field of view (e.g., a field of view captured by external image sensors 114b and 114c and/or visible to the user via display generation component 120) that corresponds to the virtual objects shown in FIG. 7C. Because display generation component 120 is optionally a head-mounted device, the field of view of display generation component 120 is optionally the same as or similar to the field of view of the user.

In some embodiments, a user interface illustrated and described below could also be implemented on a head-mounted display that includes the display generation component 120 that displays the user interface or three-dimensional environment 730 to the user, and sensors to detect the physical environment and/or movements of the user's hands (e.g., external sensors facing outwards from the user), and/or attention (e.g., based on gaze) of the user (e.g., internal sensors facing inwards towards the face of the user) such as movements that are interpreted by the second computer system as gestures such as air gestures. Additionally, in some embodiments, input to second computer system (HMD 101) is provided via air gestures from hand (e.g., hand 406 of FIG. 4) and/or attention of the user (e.g., as described in more detail with reference to method 800), or via a trackpad from hand 406, and inputs described herein are optionally received via the trackpad or via air gestures/attention.

As depicted in FIGS. 7D and 7E, the interactions with the laptop as depicted in FIGS. 7A to 7C (where the user is not wearing an HMD) are also possible when the user is wearing an HMD. That is, as shown in FIG. 7D, the display 702 of laptop 700 is visible via the one or more display generation components 120 of the HMD. In FIG. 7D, the user 760 is wearing HMD 101 and interacting with the laptop 700 when the transfer window 716 is active, and the user selects destination computer system icon 718a, in the same manner as with respect to FIGS. 7B and 7C. As shown in FIG. 7E, HMD 101 worn by the user 760 displays a virtual display 704 of the laptop 700 in response to detecting that the HMD 101 is being worn by the user 760 and that the laptop 700 is visible in the viewport of the user. In some embodiments, the virtual display 704 mirrors the display 702 of laptop 700. In some embodiments, the virtual display 704 is displayed in front of the display 702. As illustrated in FIG. 7E, the user 760 is wearing HMD 101 while interacting with laptop 700 (via virtual display 704) when the transfer window 716 is active, and the user selects destination computer system icon 718a, in the same manner as with respect to FIGS. 7B and 7C.

In the subsequent figures, a virtual display 704 is displayed by HMD 101 for visualizing the contents on the display 702 of laptop 700, but it is to be understood that the user could also look directly at the display 702 (e.g., without any virtual display present) via the one or more display generation components 120 of the HMD, as is depicted in FIG. 7D.

FIG. 7F illustrates a receive window 720 displayed by the one or more display generation components 120 of the HMD, for accepting the transfer from laptop 700. In some embodiments, the receive window 720 is displayed on the second computer system (HMD 101) regardless of whether the second computer system (HMD 101) was worn at the time that the transfer button 714 was pressed and/or the destination computer system icon was selected. In some embodiments, in response to selecting a destination computer system in FIG. 7C, the user puts on HMD 101, at which point the receive window 720 is automatically displayed. In some embodiments, in response to detecting a selection of a destination computer system in FIG. 7D or 7E (where the HMD 101 is already worn), HMD 101 displays the receive window 720 automatically.

In some embodiments, as illustrated in FIG. 7F, the receive window 720 is overlaid on top of the display of the three-dimensional environment 730. In other embodiments, the receive window is displayed in a peripheral region of the display (e.g., in a top-banner). FIG. 7E illustrates a receive window 720 having two affordances (“Accept” button 722 and “Decline” button 724). In response to detecting an input directed towards “Accept” button 722, the second computer system (HMD 101) enables the transfer of data associated with the first representation of the three-dimensional virtual object (and optionally maintains a communication link between laptop 700 and HMD 101 after the transfer). In response to detecting an input directed towards “Decline” button 724, the second computer system (HMD 101) rejects the transfer of data from laptop 700.

In FIG. 7F, the second computer system (HMD 101) detects an input provided by the user 706 corresponding to a request to accept the transfer. For example, as shown in FIG. 7F, the HMD 101 detects that the hand 706B of the user 706 has provided an air pinch gesture while also detecting the gaze 760a of the user 706 is directed towards the “Accept” button 722. In response to detecting the air pinch, the HMD 101 enables receiving and processing the data from the laptop 700.

Returning to the example of FIG. 7C, transfer window 716 also includes a selectable affordance for discovering new destination computer systems via a code-sharing method, such as “Find New Devices” button 790, where such destination computer systems are optionally unknown and/or unspecified computer systems, such as described with reference to method 1200. Although button 790 is displayed in FIG. 7C, it is also to be understood that such an affordance may be displayed in any of the transfer widows 716 displayed in FIGS. 7B to 7F. In FIG. 7C, in response to detecting an input 710a directed to button 790, laptop 700 initiates a process to discover new destination computer systems. For instance, in response to detecting selection of button 790, laptop 700 displays a code 717, as illustrated in FIG. 7F-1, which can be entered onto an external computer system for allowing the laptop 700 to recognize the external computer system as a destination computer system. In some embodiments, the code 717 and the process for sharing the code with a destination computer system share one or more characteristics with the code sharing method described with respect to method 1200 and/or the discussion of FIGS. 11C-11G.

FIGS. 7F-1 to 7F-3 illustrate a method for entering code 717 onto an external computer system, such as HMD 102. In FIG. 7F-1, while user is wearing HMD 102, the HMD 102 displays control panel 789 in response to detecting an input from hand 760b, such as raising hand 760b in an open hand shape into the viewport of HMD 102. As illustrated in FIG. 7F-1, the HMD 102 detects that the hand 760B of the user 760 has provided an air pinch gesture optionally along with a gaze 760a directed to the first view of the control panel 789, to display an expanded control panel 791 of HMD 102 in FIG. 7F-2. As illustrated in FIG. 7F-2, the expanded control panel 791 includes an affordance for entering a code associated with laptop 700, such as “Enter Code” button 792. In some embodiments, expanded control panel 791 includes button 792, because laptop 700 detected the input selecting button 790 in FIG. 7C. Enter code button 792 optionally has characteristics of selectable options that are selectable to enter sharing codes, as described with reference to method 1200. In FIG. 7F-2, the HMD 102 detects that the hand 760B of the user 760 has provided an air pinch gesture along with gaze 760a directed towards the button 792. In response, HMD 102 displays a code entering user interface 793, as displayed in FIG. 7F-3. The code entering user interface 793 provides an interface for entering the code that is being displayed by laptop 700. In some embodiments, code entering user interface 793 has one or more characteristics of user interfaces described with reference to FIGS. 11E and 11Q, such as a user interface including input field 1126a, and one or more input elements for inputting the characters (e.g., numbers and/or letters) that make up the code such as a physical or virtual keyboard or keypad (e.g., virtual keyboard 795 in FIG. 7F-3). In response to detecting that a correct code has been entered into the code entering user interface 793 (e.g., by a sequence of one or more user inputs, such as air pinch gestures while attention is directed to different keys in the virtual keyboard 795 or air tap gestures directed to different keys in the virtual keyboard 795), laptop 700 determines that a correct code was entered on HMD 102 and updates the display of the transfer window 716 in FIG. 7C to include a destination computer system icon associated the newly discovered HMD 102. Therefore, laptop 700 is now able to share content with a destination computer system that was not previously discovered and/or linked to laptop 700 at the time that transfer window 716 was initially displayed in FIG. 7C. Code-based sharing of content between laptop 700 and HMD 102 can optionally be accomplished using any of the methods of content sharing described with reference to method 1200.

FIGS. 7G to 7P depict the displays of a laptop 700 (e.g., a first computer system) and HMD 101 (e.g., a second computer system) while data is being shared between them regarding a same three-dimensional virtual object. FIG. 7G illustrates a second representation 752 of the three-dimensional virtual object within the three-dimensional environment 730 displayed via the one or more display generation components 120 of the HMD 101. In some embodiments, the second representation 752 of the three-dimensional virtual object is a three-dimensional representation displayed in the three-dimensional environment 730. As illustrated, the second representation 752 and first representation 750 are each representations of a mug (e.g., the three-dimensional virtual object).

As depicted in FIG. 7G, in response to accepting the transfer of the data from the laptop 700, HMD 101 displays the second representation 752 in the three-dimensional environment 730. In FIG. 7G, the second representation 752 is displayed on a surface of a table within the three-dimensional environment 730 displayed by the HMD 101. Whereas the first representation 750 is displayed as a two-dimensional representation (e.g., due to the display constraints of laptop 700), second representation 752 is a three-dimensional representation whose display is enabled by the display capabilities of HMD 101.

In FIG. 7G, the transfer button 714 displayed within the CAD application 712 is updated with an established connection icon 715, indicating that there is an active communication link between the laptop 700 and HMD 101. For the purposes of illustration, the corresponding icon shown outside the HMD 101 indicates that the communication link is established. In some embodiments, a corresponding established connection icon is also displayed by the one or more display generation components of the HMD 101.

FIGS. 7H to 7K illustrate a process for making edits to the first representation of the three-dimensional virtual object on a first computer system and synchronizing the edits to a second representation of the three-dimensional virtual object being displayed by a second computer system. As shown in FIG. 7H, the user 760 interacts with CAD application 712 running on laptop 700 (e.g., CAD application 712 displaying the first representation 750) to edit the first representation 750. The user provides one or more user inputs (e.g., interacting with the first representation and/or selecting one or more items from a toolbar of the CAD application 712) to display an edit menu 726 within the CAD application 712. As illustrated in FIG. 7H, the user interacts with the edit menu 726 to control one or more parameters of the first representation 750 (e.g., color, texture, and/or material). In this example, the user selects a new color of the first representation by navigating through the edit menu 726. In the example of FIG. 7H, edit menu 726 is depicted with a finite amount of control options, it is to be understood that any number of modifications can be made to the first representation 750 via an edit menu 726 (e.g., including a change in shape of the object by adjusting a sizing parameter of the virtual object).

As shown in FIG. 7I, in response to selecting the new color of the first representation 750 in FIG. 7H, the display of the first representation 750 is updated to reflect the selected color. However, in this example, although a communication link has been established between laptop 700 and HMD 101, the changes to the first representation 750 are not automatically transferred to the HMD 101. In order to update the second representation, and as shown in FIG. 7J, the user selects transfer button 714, as described previously in relation to FIG. 7A. In response to detecting selection of transfer button 714, laptop 700 transmits a communication to the HMD101, and in response to receiving the communication, HMD 101 updates the second representation 752 of the mug to reflect the changes to the first representation 750 of the mug. That is, the color of the second representation 752 of the mug is updated to reflect the color of the first representation 750 of the mug. As the connection link is active (e.g., previously established between laptop 700 and HMD101), in this example, no additional confirmation of the transfer is required between FIGS. 7I and 7K, unlike was required previously as shown in FIGS. 7B to 7E.

FIGS. 7L to 7P illustrate a method for making edits to the second representation of the three-dimensional virtual object on a second computer system and synchronizing the edits to a first representation of the three-dimensional virtual object being displayed by a first computer system.

FIGS. 7L and 7M depict changes to the second representation 752 that are not synchronized with the display of the first representation 750. For example, as shown in FIG. 7L, the HMD 101 detects that the hand 706B of the user 706 has provided a pinching gesture while the gaze 760a of the user 706 is directed towards the second representation 752. In response to the pinching gesture, HMD 101 selects the second representation. As shown in FIG. 7M, HMD 101 detects that the hand 706B of the user 706 has maintained the pinching gesture, that the user has maintained the gaze 760a towards the second representation, and that the user has rotated the hand providing the air pinch. In response to detecting this rotation, HMD 101 rotates the second representation 752 of the mug in accordance with the rotation of the hand 760b. As shown in FIG. 7M, this rotation of the second representation 752 is not synchronized with the laptop 700, and accordingly, the display of the first representation 750 is not updated in response to this change (even when the HMD 101 detects that the pinching gesture is released). Thus, in some examples, changes to the orientation and/or location of the second representation 752 are not reflected in the display of representation 750 at laptop 700.

FIGS. 7N to 7P illustrate changes to the second representation 752 that are synchronized with the display of the first representation 750. As shown in FIG. 7N, HMD 101 detects that the hand 706B of the user 706 has provided an air pinch while the gaze 760a of the user 706 is directed towards the second representation 752, and has maintained the pinching gesture without any movement of the hand 706b for a certain time duration. In response to detecting this input, the HMD 101 displays a second edit menu 732.

As illustrated in FIG. 7O, HMD 101 detects user interactions with the second edit menu 732 to control one or more parameters of the second representation 752 (e.g., color, texture, and/or material). In this example, the HMD1 detects one or more air pinches directed towards the edit menu in accordance with the gaze 706a of the user to navigate the second edit menu 732. Thus, in this example, the user selects a new color of the second representation 752 by navigating through the second edit menu 732. While the edit menu is depicted with a finite amount of control options in the example of FIG. 7O, it is to be understood that any number of modifications can be made to the second representation 752 via a second edit menu 732 (e.g., including a change in shape of the object by adjusting a sizing parameter of the virtual object). However, in some embodiments, the number of modifications to the second representation available via the second edit menu 732 is less than the modifications to the first representation available via the edit menu 726 of the CAD application 712.

In FIG. 7P, in response to detecting one or more user inputs towards the second edit menu 732 for selecting a new color of the second representation 752, HMD 101 updates the display of the second representation 752 accordingly. However, in contrast to the rotation of the mug described in relation to FIGS. 7L to 7M, this change to the color of the second representation 752 is synchronized with the laptop 700. Accordingly, as depicted in FIG. 7P, the change is automatically (e.g., without further user input) synchronized with the laptop 700 and the display of the first representation 750 is modified to reflect the change in the color of the second representation 752.

FIGS. 7Q and 7R depict arrangements where data associated with the first representation 750 is transferred to HMD 101 that is in an idle state. As illustrated in FIG. 7Q, a communication link exists between the laptop 700 and HMD 101. As shown in FIG. 7R, when the user puts the HMD on, the HMD automatically turns on and, because an existing communication link had been previously established, the HMD automatically displays a second representation 752 of the three-dimensional virtual object in accordance with the first representation 750, as described previously. FIG. 7R also illustrates an embodiment where the second representation 752 is displayed within the center of the display of the HMD 101 (as there is no horizontal surface onto which the second representation can be aligned to).

FIG. 8 is a flowchart illustrating a method 800 in which a computer system initiates a process to display a representation of a three-dimensional virtual object via one or more head-mounted display generation components of a second computer system, in accordance with some embodiments. In some embodiments, the method 800 is performed at a computer system (e.g., computer system 101 in FIG. 1A such as a tablet, smartphone, wearable computer, or head-mounted device) including a display generation component (e.g., display generation component 120 in FIGS. 1, 3, and 4) (e.g., a heads-up display, a display, a touchscreen, and/or a projector) and one or more cameras (e.g., a camera (e.g., color sensors, infrared sensors, and other depth-sensing cameras) that points downward at a user's hand or a camera that points forward from the user's head). In some embodiments, the method 800 is governed by instructions that are stored in a non-transitory computer-readable storage medium and that are executed by one or more processors of a computer system, such as the one or more processors 202 of computer system 101 (e.g., control unit 110 in FIG. 1A). Some operations in method 800 are, optionally, combined and/or the order of some operations is, optionally, changed.

The devices, methods, and/or computer-readable storage mediums described below enhance the operability of the device and makes the user-device interface more efficient (e.g., by helping the user to provide proper inputs and reducing user mistakes when operating/interacting with the device) which, additionally, reduces power usage and/or improves battery life of the device by enabling the user to use the device more quickly and efficiently. By initiating a process to display a second representation of the three-dimensional virtual object (e.g., corresponding to a first representation) via one or more head-mounted display generation components of a second computer system that is in communication with the first computer system, interactions from a first computer system with respect to a three-dimensional virtual object to are transferred or synchronized with a computer-system. This process results in a more efficient operation of the first computer system and/or the second computer system, which reduces energy use and saves battery life.

This method further allows for more simple visualization of three-dimensional virtual objects at a second computer system, and provides a more convenient method (e.g., editing a three-dimensional virtual object on a first computer system and then transferring to a separate second computer system) for visualizing the three-dimensional virtual object, thus improving visualization of a three-dimensional virtual object. Furthermore, such a process enables more efficient interactions with the three-dimensional virtual object in a three-dimensional environment, by relying on changes transferred from a first computer system rather than making the same changes locally on a second computer system. This is because there may be a greater amount of control enabled by editing or manipulating the three-dimensional virtual object from a first computer system as opposed to controlling directly from a second computer system. Thus, such a process can compensate for any limitations in object manipulation present on a second computer system. For analogous reasons, such a process can also ensure fewer errors and more time-efficient edits to the object.

In some embodiments, a method 800 is performed at a first computer system such as laptop 700 in FIG. 7A, in communication with one or more display generation components, such as display 702, and one or more input devices. For example, a mobile device (e.g., a tablet, a smartphone, a media player, or a wearable device), or a computer or other electronic device. In some embodiments, the one or more display generation components is a display integrated with the computer system (optionally a touch screen display), external display such as a monitor, projector, television, and/or a hardware component (optionally integrated or external) for projecting a user interface or causing a user interface to be visible to one or more users. In some embodiments, the one or more input devices include an electronic device or component capable of receiving a user input (e.g., capturing a user input, and/or detecting a user input) and transmitting information associated with the user input to the computer system. Examples of input devices include a touch screen, mouse (e.g., external), trackpad (optionally integrated or external), touchpad (optionally integrated or external), remote control device (e.g., external), another mobile device (e.g., separate from the computer system), a handheld device (e.g., external), a controller (e.g., external), a camera, a depth sensor, an eye tracking device, and/or a motion sensor (e.g., a hand tracking device, a hand motion sensor), microphone for capturing voice commands or other audio input. In some embodiments, the computer system is in communication with a hand tracking device (e.g., one or more cameras, depth sensors, proximity sensors, touch sensors (e.g., a touch screen and/or trackpad)). In some embodiments, the hand tracking device is a wearable device, such as a smart glove. In some embodiments, the hand tracking device is a handheld input device, such as a remote control or stylus. In some embodiments, the controller device refers to a specialized hardware device that includes one or more mechanical input mechanisms (such as buttons, directional buttons, mechanical directional thumb sticks, and/or sliders) that when actuated by a user of the controller converts the mechanical input to an electronic signal that is then used by the first computer system to perform on or more operations that are associated with receiving inputs from the controller device. In some embodiments, the first computer system is in communication with a hand tracking device (e.g., one or more cameras, depth sensors, proximity sensors, and/or touch sensors (e.g., a touch screen, trackpad)).

In some embodiments, the first computer system detects (802), via the one or more input devices, a first event (e.g., including a sequence of one or more inputs) corresponding to interaction with a first representation of a three-dimensional virtual object on the first computer system, such as selection of transfer button 714 associated with first representation 750 illustrated in FIG. 7A. In some embodiments, the first representation of the three-dimensional virtual object on the first computer system is a representation of a virtual object having a bounding box (e.g., the smallest rectangular prism which entirely surrounds the representation of the three-dimensional virtual object) that includes a height, a length, and a depth. In some embodiments, the bounding box associated with the first representation of the three-dimensional virtual object is not displayed and/or is not visible. In some embodiments, the bounding box associated with the first representation of the virtual object is displayed and/or is visible. In some embodiments, the first representation of the three-dimensional virtual object is represented by three-dimensional object data that includes information regarding the height, width, depth, and/or other dimensions that the first computer system uses to display the first representation of the three-dimensional virtual object. In some embodiments, the first representation of the three-dimensional virtual object is represented by a plurality of vertex points. In some embodiments, the first representation of the three-dimensional virtual object includes one or more surfaces, with or without surface texture elements. In some embodiments, these three-dimensional object data represent one or more of the following: positions of each vertex of the object, texture coordinates, vertex normal, parameter space vertices, polygonal face elements, and line elements.

In some embodiments, the first representation of the three-dimensional virtual object is being displayed by the first computer system when the first event is detected. In some embodiments, the first representation of the three-dimensional virtual object is being displayed in a first three-dimensional environment which is visible on the first computer system, such as is depicted by the display of first representation 750 in FIG. 7A. In some embodiments, the first three-dimensional environment visible on the first computer system is different from a second three-dimensional environment which is visible on a second computer system.

In some embodiments, the first computer system includes one or more input devices for facilitating and/or detecting interaction with the first representation of the three-dimensional virtual object. In some embodiments, the interaction with the first representation of the three-dimensional virtual object includes a request to change one or more parameters or settings associated with the three-dimensional virtual object (e.g., a texture, a color, a size) such as is illustrated by edit menu 726 in FIG. 7H, a modification of the three-dimensional virtual object (e.g., a modification of a three-dimensional model through a CAD application), and/or a selection of an affordance associated with the three-dimensional virtual object (e.g., a button for transferring data associated with the three-dimensional virtual object to another computer system, such as transfer button 714 as depicted in FIG. 7H). In some embodiments, the first computer system includes one or more communication devices for transmitting data to another computer system via a wired or wireless connection. In some embodiments, the one or more communication devices includes one or more antenna for transmitting the data wirelessly. In some embodiments, the one or more communication devices includes a wired communication module (e.g., a module for sending data over USB, Ethernet, or RS232). In some embodiments, the first computer system detects a user input corresponding to the first representation of the three-dimensional virtual object being interacted with, and transmits the user input to a second computer system via the one or more communication devices.

In some embodiments, the first event corresponding to interaction with a first representation of the three-dimensional virtual object on the first computer system refers to the computer system detecting that a user input on the first computer system has been received, wherein the input corresponds to a request to transfer data associated with the first representation of the three-dimensional virtual object from the first computer system to a second computer system. In some embodiments, the input includes a button press, a keyboard entry, a mouse selection (e.g., a mouse click), or any other method of registering a user selection. In some embodiments, the first representation of the three-dimensional virtual object is displayed within an application on the first computer system, and the application includes a button, a keyboard selection, or selectable affordance, for receiving the user selection. In some embodiments, the first event corresponding to interaction with a representation of the three-dimensional virtual object on the first computer system comprises or further comprises a manipulation or modification of the three-dimensional virtual object at the first computer system. Exemplary manipulations or modifications include re-sizing the three-dimensional virtual object, modifying one or more parameters of the three-dimensional virtual object (e.g., color, material, texture), or rotating the three-dimensional virtual object. Additional, more substantial modifications to the three-dimensional virtual object (such as making structural changes through a CAD software application) are also examples of modifications of the three-dimensional virtual object. In some embodiments, the manipulations or modifications to the three-dimensional virtual object are stored in a memory along with the three-dimensional object data and transferred to the computer system when the first computer system detects the input corresponding to the request to transfer data.

In some embodiments, no separate user input is required to transfer data, and the data associated with the three-dimensional virtual object is continuously transferred to the computer system at certain intervals (e.g., every 0.1 seconds, 1 second, 3 seconds, 5 seconds, 1 minute, 10 minutes), or in response to a manipulation or modification of the first representation of the three-dimensional virtual object. In some embodiments, the continuous transferring of data allows for manipulation or modification to the first representation of the three-dimensional virtual object at the first computer system to be synchronized with a second computer system without manually transferring the three-dimensional object data after each modification or manipulation, such as if the modification of the color of first representation in FIGS. 7H and 7I were automatically transferred to HMD101 to modify the corresponding color of second representation 752.

In some embodiments, in response to detecting the first event (804), the first computer system initiates (806) a process to display a second representation of the three-dimensional virtual object via one or more head-mounted display generation components of a second computer system that is in communication with the first computer system, such as by initiating a display of second representation 752 on HMD 101 as illustrated in FIG. 7G. In some embodiments, while the three-dimensional virtual object is displayed via the one or more head-mounted display generation components, some information related to manipulation of the three-dimensional virtual object is synchronized between the first representation of the three-dimensional virtual object and the second representation of the three-dimensional object, such as a color, texture, and/or material as depicted in FIGS. 7H to 7J. In some embodiments, the second computer system includes a mobile device (e.g., a tablet, a smartphone, a media player, or a wearable device), or a computer or other electronic device. In some embodiments, the second computer system includes one or more communication devices for receiving a user input and/or data from the first computer system over a wired or wireless connection. In some embodiments, the one or more communication devices includes one or more antenna for receiving and/or transmitting data wirelessly. In some embodiments, the one or more communication devices include a wired communication module (e.g., a module for sending data over USB, Ethernet, or RS232). In some embodiments, a process to display the second representation of the three-dimensional virtual object via one or more head-mounted display generation components of the second computer system includes processing three-dimensional object data received from the first computer system and displaying the second representation of the three-dimensional virtual object corresponding to the three-dimensional object data via the one or more head-mounted display generation components of the second computer system. In some embodiments, initiating the process to display the second representation includes transmitting, by the first computer system, three-dimensional object data to the second computer system, and optionally transmitting a set of display instructions to the second computer system, where the set of display instructions provides additional parameters for displaying the three-dimensional object in a three-dimensional environment (e.g., size of the object, and/or where object should be placed in a three-dimensional environment). In some embodiments, a second three-dimensional environment is visible via the one or more head-mounted display generation components, and the second representation of the three-dimensional virtual object is displayed within the second three-dimensional environment. In some embodiments, the one or more head-mounted display generation components provide an augmented reality or virtual reality three-dimensional environment. In some embodiments, the process to display the second representation of the three-dimensional virtual object includes placing the second representation of the three-dimensional virtual object at a certain position, size, and orientation within the existing second three-dimensional environment.

In some embodiments, the second representation of the three-dimensional virtual object has one or more visual characteristics based on the first event. In some embodiments, the second representation of the three-dimensional virtual object is being displayed by the second computer system when the first event is detected, such as is depicted by the display of second representation 752 in FIG. 7J. In some embodiments, the second representation of the three-dimensional virtual object is not being displayed by the second computer system when the first representation of the three-dimensional virtual object is being displayed by the first computer system, such as is depicted by the lack of a second representation 752 in FIG. 7F. In some embodiments, the second representation of the three-dimensional virtual object is being displayed in a second three-dimensional environment which is visible via the one or more display generation components, such as three-dimensional environment 730 in FIGS. 7G to 7P and 7R. In some embodiments, the second three-dimensional environment visible via the one or more display generation components on the second computer system is different from a first three-dimensional environment which is visible on the first computer, such as three-dimensional environment 730 in FIGS. 7G to 7P and 7R.

In some embodiments, the first event includes a button selection on the first computer system, where the button is configured to initiate a display of the second representation of the three-dimensional virtual object displayed via the one or more display generation components of the second computer system, such as selection of transfer button 714 as depicted in FIG. 7J. In this way, a button selection is used to initiate a transfer a data between the first computer system and the second computer system. In some embodiments, the first event includes one or more user interface interactions (including e.g., a button, a toggle switch, or a user selection).

In some embodiments, the first event includes a modification to the three-dimensional virtual object on the first computer system. In this way, a modification to the three-dimensional virtual object or to the first representation of the three-dimensional virtual object on the first computer system optionally results result in corresponding changes to the second representation of the three-dimensional virtual object displayed via the one or more display generation components of the second computer system.

In some embodiments, a second three-dimensional environment is generated, displayed, or otherwise caused to be viewable by the second computer system. In some embodiments, the second three-dimensional environment, generated, displayed, or otherwise made viewable by the second computer system, is perceptible from the viewpoint of the user. For example, the second three-dimensional environment is optionally an extended reality (XR) environment, such as a virtual reality (VR) environment, a mixed reality (MR) environment, an augmented reality (AR) environment, or an augmented virtuality (AV) environment. In some embodiments, the second three-dimensional environment is a simulated and/or virtual three-dimensional environment. In some embodiments, the second three-dimensional environment includes a simulated and/or virtual three-dimensional environment that is displayed within the second three-dimensional environment, optionally instead of representations of a physical environment (e.g., full immersion) or optionally concurrently with a representation of the physical environment (e.g., partial immersion).

In some embodiments, the process to display the second representation of the three-dimensional virtual object in the second three-dimensional environment includes displaying the object within a virtual content window (e.g., within a user interface) via the one or more display generation components. In some embodiments, the process to display the second representation of the three-dimensional virtual object includes displaying the object within the second three-dimensional environment without displaying the second representation of the three-dimensional virtual object within a virtual content window (e.g., stand-alone). In some embodiments, when initially displayed by the second computer system, the object is displayed in the center of a current viewpoint of the user. In some embodiments, the object is displayed in a fixed location in the second three-dimensional environment, such that even if a user changes their viewpoint within the second three-dimensional environment, the object stays in same location in the second three-dimensional environment (e.g., the virtual object is environment-locked). In some embodiments, the object is displayed at a fixed position relative to the user's viewpoint and is moved by the second computer system accordingly in the second three-dimensional environment when the second computer system detects that the viewpoint of the user changes (e.g., the virtual object is viewpoint-locked).

In some embodiments, detecting the first event includes detecting a selection of a selectable affordance of an application on the first computer system, such as is shown by the selection of transfer button 714 in FIG. 7B. In some embodiments, the selectable affordance comprises a user interface element (e.g., a button or selectable icon) displayed on a user interface of the first computer system. In some embodiments, when the first computer system detects an input directed towards the selectable affordance, the computer system initiates a transfer of data from the first computer system to the second computer system. In some embodiments, the selection of the selectable affordance comprises a button press, a selection received by a mouse and/or trackpad, or a cursor being positioned over the selectable affordance. In some embodiments, the application on the first computer system is an application for displaying and/or manipulating three-dimensional models (e.g., a computer aided design, CAD, and/or application).

In some embodiments, in response to detecting the first event, the first computer system initiates a process to display a user interface element corresponding to the virtual object on the second computer system, such as the process initiated in response to detecting the user select the “accept” button on receive window 720 in FIG. 7F and illustrated in FIG. 7G. In some embodiments, the initiating the process to display the user interface element on the computer system comprises transferring data from the first computer system to the second computer system. In some embodiments, the user interface element is an alert or notification displayed on the second computer system. In some embodiments, the second computer system displays the alert or notification having one or more affordances (e.g., a “Accept” and/or “Decline” button) in response to the transfer of the data from the first computer system to the second computer system to confirm that the second computer system should display the data. In some embodiments, the user interface element comprises a selectable element (e.g., a button or selectable icon). In some embodiments, the user interface element comprises a preview of the three-dimensional virtual object. In some embodiments, the second computer system is configured to display the user interface element and detect one or more user inputs directed towards the user interface element. In some embodiments, the second computer system forgoes displaying the virtual object and/or forgoes receives data associated with the virtual object from the first computer system until the second computer system receives one or more inputs directed towards the user interface element. For example, before the first computer system transfers the three-dimensional virtual object from the first computer system to the second computer system, the first computer system sends a transfer request to the second computer system to establish a communication link between the first computer system and the second computer system. In response to this transfer request, the second computer system displays an alert to the user with one or more selectable affordances (e.g., “Accept”, “Decline”). In response to receiving a user selection to accept the transfer, the communication link between the first computer system and the second computer system is established and the first computer system transfers the data associated with the three-dimensional virtual object to the second computer system. In response to receiving a user selection to decline the transfer, the communication link between the first computer system and the second computer system is not established and the first computer system does not transfer the data associated with the three-dimensional virtual object to the second computer system. In some embodiments, the user interface element is the second representation of the three-dimensional virtual object. For example, the second computer system displays the representation of the virtual object without displaying any alert or notification for confirming the transfer of data between the first and second computer systems.

In some embodiments, detection of the first event by the first computer system occurs while the one or more head-mounted display generation components of the second computer system are being worn by a user of the second computer system, such as the user wearing HMD 101 when transfer button 714 is selected as depicted in FIG. 7J. In some embodiments, the second computer system is a wearable device (e.g., a head-mounted display, HMD) with one or more display generation components. In some embodiments, the second computer system is configured to turn on and/or activate one or more applications upon detecting that the user has put on the wearable device. In some embodiments, the one or more head-mounted display generation components second computer system are being worn when the first event is detected by the first computer system. In some embodiments, the first event corresponds to a user input by a first user, and the user of the second computer system is a second user, different from the first user. In other embodiments, the first event corresponds to a user input by a first user, and the user of the second computer system is also the first user (e.g., the same user is wearing the HMD as is interacting with the first computer system). For example, when a user is wearing an HMD and interacting with a first computer system (e.g., a computer or smart phone), a display of the computer is visible via the one or more display generation components of the HMD (e.g., when the HMD is operating in a pass-through mode). In some embodiments, the user operates the first computer system (e.g., supplies the user input corresponding to the first event) via the one or more display generation components of the second computer system.

In some embodiments, detection of the first event by the first computer system occurs while a virtual display of the first computer system is being displayed by the one or more head-mounted display generation components of the second computer system, such as the virtual display 702 being displayed by HMD 101 when transfer button 714 is selected as depicted in FIG. 7J. In some embodiments, the second computer system displays a virtual display associated with a display of the first computer system, wherein the virtual display mirrors one of the one or more display generation components of the first computer system. In some embodiments, initiating the process to display the second representation comprises displaying the second representation in the virtual display of the second computer system. In some embodiments, displaying the second representation in a virtual display shares one or more characteristics with displaying three-dimensional content in a virtual window according to method 1000.

In some embodiments, initiating the process to display the second representation comprises displaying the second representation at a location separate from the virtual display of the second computer system, such as is depicted by the location of second representation 752 in FIG. 7G. In some embodiments, the first event is detected by the first computer system via user interaction with one or more user interface elements on the virtual display. For example, when a user is wearing an HMD and interacting with a first computer system, the HMD displays a virtual display of the first computer system (e.g., a virtual display of the computer display or the smart phone display), such as is illustrated by virtual display 704 in FIGS. 7G to 7P. In this example, the HMD detects one or more user inputs directed towards the virtual display (e.g., a hand air gesture, such as a pinching gesture), and sends the user input to the first computer system so that the first computer system can detect the user input.

In some embodiments, the second computer system displays the virtual display at a first size within the three-dimensional environment. In some embodiments, the first size of the virtual display is smaller and/or bigger and/or the same size as the one or more display generation components (e.g., a physical monitor display) of the first computer system. In some embodiments, the second computer system receives one or more user inputs (e.g., a hand air gestured followed by a movement of the hand) directed towards the virtual display. In some embodiments, in response to receiving the one or more user inputs, the second computer system moves the virtual display from a first location to a second location in the three-dimensional environment. In some embodiments, in response to receiving the one or more user inputs, the second computer system updates the size of the virtual display from the first size to a second size, different from the first size.

In some embodiments, detection of the first event by the first computer system occurs while the one or more head-mounted display generation components of the second computer system are not being worn by a user such as the user not wearing HMD1 when transfer button 714 is selected as depicted in FIG. 7A. In some embodiments, initiating the process to display the second representation comprises: determining that the one or more head-mounted display generation components of the second computer system are being worn by the user, such as if laptop 700 as depicted in FIG. 7A receives information indicating that HMD1 is not being worn; and in response to determining that the one or more head-mounted display generation components of the second computer system are being worn by the user, initiating display of the second representation on the one more head-mounted displays, such as if laptop 700 in FIGS. 7F and 7G receives information that HMD 101 is being worn and initiates a display of second representation 752 on HMD 101 as depicted in FIG. 7G.

In some embodiments, the second computer system is a wearable device (e.g., a head-mounted display, HMD) with one or more head-mounted display generation components, such as HMD 101 depicted in FIGS. 7A to 7R. In some embodiments, the second computer system is configured to turn on and/or activate one or more applications upon detecting that the user has put on the wearable device, such as is depicted by HMD 101 being worn between FIGS. 7Q and 7R. In some embodiments, the one or more head-mounted display generation components second computer system is not being worn when the first event is detected by the first computer system, as is depicted by HMD 101 not being worn in FIG. 7Q. In some embodiments, one or more applications of the second computer system are not running when the first event is detected by the first computer system. In some embodiments, the second computer system is in an idle state (e.g., a sleep state) when the first event is detected.

In some embodiments, initiating the process to display the second representation includes the first computer system sending a transfer request to the HMD while the HMD is in an idle state. In some embodiments, upon determining that the one or more head-mounted display generation components are worn, the second computer system displays a request to accept the transfer (e.g., via one or more user interface elements) to the user. In some embodiments, in response to receiving an indication that the transfer is accepted, the HMD sends an acknowledgment to the first computer system. In response to receiving an acknowledgement of the transfer request, the first computer system transfers data associated with the three-dimensional virtual object to the HMD (e.g., initiates the process to display the second representation on the one or more head-mounted displays), such as is illustrated by the selection of transfer button 714 in FIG. 7J resulting in the transfer of data to modify the second representation.

In some embodiments, initiating the process to display the second representation includes the first computer system transferring data associated with the three-dimensional virtual object to the HMD while the HMD is in an idle state, such as is illustrated by HMD 101 in FIG. 7Q being in an idle state. In some embodiments, the HMD displays a representation of the three-dimensional virtual object automatically in response to the detection that the one or more head-mounted display generation components are being worn, such as is illustrated by HMD 101 displaying second representation 752 in FIG. 7R. In some embodiments, the process for initiating display of the second representation of the three-dimensional virtual object is not initiated until the one or more head-mounted display generation components of the HMD is detected (e.g., by the second computer system) as being worn.

For example, when a user is interacting with the first computer system, the computer system initiates a transfer of a three-dimensional virtual object to an HMD that is not being worn, in response to the user pressing a transfer button on the first computer system. In this example, the HMD receives a transfer request (or optionally the data associated with the three-dimensional virtual object).

When the user then puts on the HMD, one or more applications running on the HTD are activated. In one example, a notification is displayed to the user to allow the user to accept or decline the transfer of the data associated with the virtual object. As another example, a representation of the virtual object is displayed automatically (in response to the user wearing the one or more head-mounted display generation components) within the three-dimensional environment visible via the one or more display generation components of the HMD.

In some embodiments, the interaction with the first representation of the three-dimensional object occurs on a first application associated with the first computer system, such as CAD application 712 running on laptop 700 illustrated in FIGS. 7A and 7H to 7Q. In some embodiments, initiating the process to display the second representation of the three-dimensional virtual object via one or more head-mounted display generation components of the second computer system includes initiating a process to display the second representation via a respective process (e.g., an operating system interface or an application interface) of the second computer system, wherein the respective process is not an instance of the first application, such as is illustrated by the display of second representation 752 by HMD1 in FIGS. 7G and 7R, which is not displayed within the CAD application 712 running on laptop 700.

In some embodiments, the first computer system detects the interaction with the first representation of the three-dimensional object on a first application. In some embodiments, the first application is an application for displaying and/or manipulating three-dimensional models (e.g., a CAD application). In some embodiments, the second computer system includes the first application. In other embodiments, the second computer system does not include the first application. In some embodiments, the second computer system includes a respective process (e.g., an operating system interface) that is configured to display two dimensional or three-dimensional representations of virtual and/or real-world objects in a three-dimensional environment. In some embodiments, the respective process is not associated with the first application. In some embodiments, the respective process receives information regarding the second representation from the first application, but the respective process is executed by the second computer system, while the first application is being executed by the first computer system. In some embodiments, when the second computing device is an HMD that includes a respective process having a “quick look” functionality the three-dimensional virtual object can be rendered by the HMD via the “quick look” functionality in a preview interface, without requiring any additional application to be opened on the HMD to process the three-dimensional object file. In some embodiments, the second computer system displays content items received from a plurality of different applications via the respective process. In some embodiments, the second computer system detects a user input associated with moving a content item displayed via the respective process towards a user interface of a separate application that is not the respective process. In some embodiments, in response to detecting the user input associated with moving the content item, the second computer system displays the content item in the user interface of the separate application. In some embodiments, displaying the content item in the user interface of the separate application includes ceasing to display the content item via the respective process.

In some embodiments, while displaying, via the one or more display generation components, the first representation of the three-dimensional object at the first computer system a pose of the second representation is changed at the second computer system, such as is depicted via the re-orientation of second representation 752 in response to the gesture of the hand 760b in FIGS. 7L and 7M. In some embodiments, the first computer system maintains a displayed pose of the first representation of the three-dimensional object at the first computer system independent of the change in pose of the second representation at the second computer system, such as illustrated by the orientation of the first representation 750 in CAD application 712 not changing in response to the change of orientation of second representation 752 by HMD 101 in FIG. 7M.

In some embodiments, the first computer system forgoes changing a displayed pose of the first representation of the three-dimensional object in response to changes to a pose of the second representation, such as is illustrated by the first representation 750 not changing in response to a change in pose in the second representation 752 as illustrated in FIG. 7M. In some embodiments, the pose of the first representation includes an orientation of the first representation, a size of the first representation, and/or a location of the first representation within the first application.

In some embodiments, the second computer system sends synchronization data to the first computer system for interaction with the second representation by a user (e.g., a movement input, a rotation input, and a re-sizing input). In some embodiments, the first computer system processes the synchronization data and determines whether any changes to the first representation are necessary based on the synchronization data. In some embodiments, maintaining a displayed pose includes forgoing changing one or more display parameters of the first representation even when the one or more of the corresponding display parameters of the second representation are detected as being changed. For example, the first computer system receives data from the second computer system indicating that the second representation has been re-sized and re-oriented. Based on this, the first computer system re-sizes the first representation but forgoes re-orienting the first representation.

In some embodiments, the second computer system forgoes sending the one or more changes to the pose of the second representation to the first computer system (e.g., forgoes synchronizing the display of the first representation with the display of the second representation), such as is illustrated by the first representation 750 not changing in response to a change in pose in the second representation 752 as illustrated in FIG. 7M. In some embodiments, if the second computer system detects a change in a pose of the second representation (e.g., detecting that the user has provided an input to rotate the second representation within the three-dimensional environment), the second computer system determines whether such a change needs to be synchronized with the first computer system. In some embodiments, the second computer system forgoes transferring the synchronization data to the first computer system when the second representation is moved and/or rotated within the three-dimensional environment.

In some embodiments, the second computer system detects interaction with the second representation by detecting one or more user inputs directed towards the second representation or one or more affordances associated with the second representation (e.g., an air pinch gesture, a movement of a hand after selection of the second representation, a gaze input). For example, the second computer system detects that a user is modifying parameters of the second representation via providing one or more air pinches directed towards one or more menu items displayed adjacent to the second representation, such as is depicted by interaction with second edit menu 732 as displayed in FIG. 7O. In some embodiments, in response to detecting the one or more user inputs, the second computer system updates the display of the second representation in accordance with the detected user inputs (e.g., changing the pose of the object in accordance with a rotation of the user's hand after a selection of the second representation with a pinching gesture directed towards the second representation).

In some embodiments, the first computer system receives an indication of a modification of a first feature of the second representation of the three-dimensional virtual object at the second computer system, such as the modification of a color of second representation 752 in response to the user input as depicted in FIGS. 7O and 7P. (e.g., based on one or more inputs directed to the second representation of the virtual object at the second computer system that were detected via one or more input devices in communication with the second computer system). In some embodiments, in response to receiving the indication of the modification, the first computer system modifies the first feature of the first representation the first representation of the three-dimensional virtual object at the first computer system in accordance with the received indication of the modification, such as illustrated by the change of first representation 750 in FIG. 7P. In some embodiments, the first computer system receives synchronization data having an indication of a modification of a first feature of the second representation. In some embodiments, receiving the indication includes detecting a user input to synchronize the first and second representations (e.g., a user selecting a button at the first computer system) and transferring the synchronization data in response to detecting the user input. In some embodiments, receiving the indication includes the first computer system and/or second computer system detecting the modification of the first feature of the second representation (e.g., the second computer system detects the modification and automatically sends synchronization data in response to the modification). In some embodiments, receiving the indication includes receiving periodic data sent from the second computer system to the first computer system, the periodic data including a status of the second representation (e.g., the second computer system sends synchronization data every 0.1, 0.2, 0.5, 1, 5, 10, 30, 60, 120, or 240 seconds). In some embodiments, the first computer system modifies a feature of the first representation corresponding to the modified first feature to mirror the modification performed by the second computer system. In some embodiments, the modification of the first feature includes a change to one or more object parameters (e.g., a texture, a color, and/or a type of material). In some embodiments, the modification of the first feature includes a change to the shape of the virtual object. For example, a user wearing the second computer system (e.g., an HMD) can interact with the second representation of the virtual object and apply one or more modifications to the second representation (e.g., by navigating through one or more menu items for setting the object parameters, or by manipulating the shape of the second representation through one or more user inputs). For example, when a three-dimensional model of a vase is rendered within the three-dimensional environment of the HMD, a user can update the texture and/or color of the vase, and the second computer system transfers these changes to the first computer system. In some embodiments, the second computer system detects one or more user inputs for modifying the second representation of the virtual object and modifies the second representation in accordance with the one or more user inputs. In some embodiments, different user inputs detected by the second computer system result in different modifications to the second representation. In response, the first computer system updates display of the first representation to reflect the changes made in the second computer system. In some embodiments, the first computer system automatically updates the display of the first representation in response to receiving synchronization data from the second computer system. In some embodiments, the first computer system updates the display of the first representation in response to receiving a request from a user to update the display of the first representation.

In some embodiments, the first computer system detects, via the one or more input devices, a request to modify a first feature of the first representation of the three-dimensional virtual object at the first computer system, as illustrated by selection of a new color in edit menu 726 of FIG. 7H, and the resultant change in the first representation 750 in FIG. 7I. In some embodiments, in response to detecting the request to modify the first feature, the first computer system modifies display, via the one or more display generation components, of the first feature of the first representation at the first computer system in accordance with the detected request to modify the first feature, such as shown in FIG. 7I; and initiates a process to modify display of the second representation of the three-dimensional virtual object at the second computer system (e.g., via one or more display generation components that are in communication with the second computer system) based on the modified first feature, such as is shown in FIG. 7K (where the second representation 752 is updated to reflect the modified color) in response to a selection of transfer button 714 in FIG. 7J.

In some embodiments, the first computer system detects a request to modify a first feature of the first representation via the one or more user input devices of the first computer system, such as via interaction with edit menu 726 illustrated in FIG. 7H. In some embodiments, the request is received via one or more inputs received from a hardware input device of the one or more input devices (e.g., via a mouse selection or one or more entries on a keyboard). In some embodiments, the request to modify the first feature is received from one or more applications running on the computer system (e.g., a CAD application). In some embodiments, modifying the first feature comprises updating one or more parameters of the first feature (e.g., a shape, a material, a texture, and/or a size). For example, when the three-dimensional virtual object is being displayed within a CAD application running on the first computer system, the user interacts with the CAD application to modify the shape of the three-dimensional virtual object (e.g., by providing one or more values in a menu of the CAD application to set a chamfer radius). In response, the shape of the virtual object is updated within the CAD application in accordance with the new values.

In some embodiments, modifications performed on the first computer system are synchronized with the second computer system, such as is illustrated by selection of transfer button 714 in FIG. 7J. In some embodiments, the first computer system initiates a process to modify display of the second representation via transferring data from the first computer system to the second computer system associated with the respective modification. In some embodiments, the data transferred to the second computer system includes one or more instructions for displaying the respective modification. In some embodiments, initiating the process to modify display of the second representation includes transferring synchronization data from the first computer system to the second computer system. In some embodiments, initiating the process to modify display of the second representation includes initiating the process to modify display of the second representation automatically (e.g., transferring synchronization data without further user input). In some embodiments, initiating the process to modify display of the second representation includes initiating the process to modify display of the second representation after a pre-determined amount of time since the last modification of the display of the second representation (e.g., transferring synchronization data after 0.1, 0.2, 0.5, 1, 5, 10, 30, 60, 120, or 240 seconds after a modification). In some embodiments, the first computer system initiates the process to modify display of the second representation in response to receiving a request from a user to update the display of the second representation (e.g., the user selects a synchronization button on the first computer system), such as is illustrated by selection of transfer button 714 in FIG. 7J.

In some embodiments, initiating the process to modify display of the second representation of the three-dimensional virtual object at the second computer system occurs in response to detecting, via the one or more input devices, one or more inputs at the first computer system corresponding to a request to synchronize the modification of the first feature with the second representation displayed at the second computer system, such as illustrated by the selection of the transfer button 714 in FIG. 7J and the modification of the second representation in FIG. 7K. In some embodiments, the first computer system detects a request to synchronize the modification of the first feature. In some embodiments, the request to synchronize the modification is provided via one or more affordances within an application running on the first computer system (e.g., a “sync” button). In some embodiments, the first computer system forgoes transferring any data associated with the modification of the first feature to the second computer system until the request to synchronize is received. In some embodiments, the first computer system controls the availability of the one or more affordances associated with the request to synchronize (e.g., displaying/hiding and enabling/disabling a “sync” button). In some embodiments, the first computer system makes the one or more affordances available to the user after a connection between the first computer system and the second computer system is established and/or after the process to display the second representation of the three-dimensional virtual object is initiated. For example, the first computer system does not display a synchronization button before the first computer system shares data associated with the three-dimensional virtual object with the second computer system (and therefore this button is inaccessible and cannot be used to receive user input), and displays the synchronization button after the data is shared for the first time.

In some embodiments, detecting the first event includes detecting a request to share information associated with the three-dimensional virtual object with an external computer system, such as illustrated by the selection of transfer button 714 in FIG. 7A. In some embodiments, initiating the process to display the second representation of the three-dimensional virtual object comprises, in accordance with a determination that the first computer system has not previously initiated a process to display the second representation of the three-dimensional virtual object, displaying, via the one or more display generation components, a user interface that includes one or more options for selecting one or more computer systems to which to transmit the information associated with the three-dimensional virtual object, such as illustrated by the display of transfer window 716 on the laptop 700 in FIGS. 7B to 7D (and the transfer window 716 on the virtual display 704 in FIG. 7E).

In some embodiments transfer window 716 includes a selectable option (e.g., button 790) that enables connection to one or more other computer systems that are not represented in the transfer window 716 (e.g., computer systems that are not know to the computer system and/or are not associated with a same user account as the computer system). In some embodiments, the computer system detects a selection input (e.g., a press input 760b, an air tap, a button press, or an air pinch) while attention (e.g., based on gaze, head direction, or a location of a cursor) is directed to the selectable option and in response the computer system initiates a process to establish a connection with one or more other computer systems (e.g., by exchanging a code displayed by one computer system with another nearby computer system) as described in greater detail with reference to FIGS. 11A-1EE. Once the connection is established between the computer systems, the method described below continues, as described in FIGS. 7G-7R.

In some embodiments, initiating the process to display the second representation of the three-dimensional virtual object comprises, in accordance with a determination that the first computer system has previously initiated the process to display the second representation of the three-dimensional virtual object at the second computer system, transmitting the information associated with the three-dimensional virtual to the second computer system without displaying the user interface that includes one or more options for selecting one or more computer systems to which to transmit the information associated with the three-dimensional virtual object, such as illustrated in FIGS. 7J and 7K as a selection of transfer button 714 does not cause a transfer window 716 to be displayed and the second representation 752 is automatically updated in response to the selection of transfer button 714.

In some embodiments, the first computer system determines whether an initial connection between the first computer system and the second computer system is established before transferring data from between the respective computer systems. In some embodiments, the first computer system initiates a process to receive a selection of one or more computer system by displaying a user interface that includes one or more options for selecting one or more system. In some embodiments, the first computer system detects a selection at one or more affordances that are being displayed at the user interface of the first computer system (e.g., a “transfer” button within a CAD application). In some embodiments, the first computer system displays a list of one or more available computer systems to which to transmit the information associated with the three-dimensional virtual object (e.g., computer systems that are available to share the first representation with), and receives a user selection from the list of available computer systems. In some embodiments, in response to receiving the selection, the first computer system establishes a connection between the first computer system and the selected computer system. In some embodiments, the one or more computer systems that can receive data from the first computer system include one or more communication devices for communicating with the first computer system (e.g., Bluetooth, Wi-Fi).

In some embodiments, once the initial connection has been established, the first computer system sends subsequent data to the second computer system without requiring the connection to be re-established or re-verified. In some embodiments, the first computer system initiates a process to receive a selection of one or more computer systems that can receive data from the first computer system. In some embodiments, once the initial connection has been established, in order to change the destination external computer system (e.g., the second computer system), the first computer system receives a further user input to receive a new selection of one or more computer systems. For example, when the first computer system is in communication with the second computer system the user manually changes the destination computer system so that the first computer system is in communication with a third computer system.

In some embodiments, the process to receive the selection of the one or more computer systems excludes an option to select a computer system that is available nearby but is not able to display the second representation, such as illustrated by the absence of destination computer system icon 718d (associated with laptop 700b) in the transfer window 716 of FIG. 7B (as compared to FIG. 7C). In some embodiments, the computer system displays the list of the one or more available computer systems based on a determination of whether the one or more available computer systems are eligible to display the second representation. In some embodiments, in response to determining that a first set of eligible computer systems are available, the first device displays a first list of eligible devices. In some embodiments, in response to detecting that a second set of eligible computer systems, different from the first set. In some embodiments, the first computer system determines the eligibility of an available computer system by determining whether the available computer system has the functionality to display a three-dimensional image in a three-dimensional environment (e.g., AR or VR functionality). In some embodiments, the first computer system excludes any non-eligible computer systems from the list of computer systems displayed to the user. In some embodiments, the first computer system is configured to receive metadata associated with each external computer system and determine whether a respective external computer system is eligible to the display the three-dimensional image in a three-dimensional environment based on the received metadata (e.g., has the requisite hardware elements for displaying a three-dimensional image in a three-dimensional environment). In some embodiments, each external computer system broadcasts its respective metadata.

As one example, a non-eligible computer system includes a computer system without a display generation component for displaying a three-dimensional object. As another example, a non-eligible computer system includes a computer system without any camera or without any camera facing in the same direction as the viewpoint of the user when in use (e.g., a laptop computer without one or more cameras that face away the user that is unsuitable for AR). Accordingly, each non-eligible computer system broadcasts metadata to the first computer system indicating it is a non-eligible computer system. As a final example, an eligible computer system includes a smart phone having a display and a back-facing camera for taking pictures and/or videos in the same direction as the viewpoint of the user (e.g., a device which is suitable for AR). Accordingly, the eligible computer system broadcasts metadata to the first computer system indicating that it is an eligible computer system.

For example, in response to detecting that a user is interacting with a first computer system and selects a transfer button to send a three-dimensional virtual object to an external device for display, the first computer system displays a list of suitable devices. In this example, there are four devices which are capable of wireless communication with the first computer system (e.g., a smart phone, two HMDs, and a laptop computer). However, since the laptop computer in this example lacks any AR or VR capability, the laptop computer is ineligible to display the second representation. As a result, the eligible devices are displayed to the user as options for transferring the three-dimensional virtual object (e.g., the smart phone and the two HMDs) without displaying the one or more devices that are not able to display the three-dimensional virtual object.

In some embodiments, initiating the process to display the second representation of the three-dimensional virtual object via the one or more head-mounted display generated components of the second computer system comprises, displaying, via the one or more display generation components of the first computer system, a list of a plurality of computer systems that are available to display the second representation of the three-dimensional virtual object, including one or more devices that are not being actively used, such as the transfer window 716 that displays a list of a plurality of available computer systems as illustrated in FIGS. 7B and 7C.

In some embodiments, the first computer system displays a list of a plurality of computer systems that are available to display the second representation. In some embodiments, the first computer system selects computer systems for the displayed list based on the eligibility criteria described herein. In some embodiments, the first computer system detects one or more user inputs (e.g., a button press, a press on a mouse or trackpad, a keyboard entry, a location of a cursor) directed towards one of the computer systems in the list, and in response to the detection, selects a computer system in accordance with the one or more user inputs. In some embodiments, the list of the plurality of computer systems includes the second computer system. In some embodiments, the availability of a respective computer system is determined based on whether the computer system is turned on and/or capable of communication with the first computer system. In some embodiments, the first computer system receives availability information from the plurality of computer systems (e.g., each external computer system broadcasts a signal periodically to inform the first computer system as to its presence and availability). In some embodiments, the first computer system is configured to display one or more computer system in the list that are not being actively used. In some embodiments, the first computer system considers that a respective computer system is used when one or more of the following is met: the computer system is being worn or is interacted with by a user, one or more applications are running on the computer system, or a communication link was previously established between the computer system and the first computer system.

In some embodiments, initiating the process to display the second representation of the three-dimensional virtual object via the one or more head-mounted display generation components of the second computer system includes receiving a selection of the second computer system as a destination computer system (as discussed herein with regard to the process to receive a selection of one or more computer systems to which to transmit the information associated with the three-dimensional virtual object, e.g., receiving a further user input to receive a new selection of one or more computer systems), such as the selection of a destination computer system via transfer window 716 as is illustrated in FIGS. 7B to 7E. In some embodiments, after receiving the selection of the second computer system as the destination computer system, the first computer system detects, via the one or more input devices, a second event (e.g., including a sequence of one or more inputs) corresponding to interaction with the first representation of the three-dimensional virtual object on the first computer system, wherein the second event includes receiving, via the one or more input devices, an input (e.g., a button press, a press on a mouse or trackpad, a keyboard entry, a location of a cursor) directed toward a selectable sharing option associated with the first representation, such as is illustrated by selection of transfer button 714 in FIG. 7J.

In some embodiments, in response to receiving the input directed toward the selectable sharing option associated with the first representation, the computer system initiates a process to update the display of the second representation at the second computer system in accordance with second event, such as is illustrated by the modification of the second representation 752 in FIG. 7K in response to the selection of transfer button 714 in FIG. 7J. In some embodiments, the first computer system receives a selection of the second computer system as a destination computer system (e.g., by detecting one or more user inputs as discussed above). In some embodiments, the selection is received from a list of available devices as discussed above. In some embodiments, once a connection between the first computer system and the destination computer system is established, the first computer system shares subsequent updates of the first representation with the second computer system without the need to re-select the destination computer system and/or without initiating a process to select a destination for the session.

In some embodiments, the second event includes receiving an input at a selectable sharing option. In some embodiments, the selectable sharing option includes an affordance displayed within one or more applications (e.g., a CAD application) running on the first computer system. For example, when a user is interacting with a three-dimensional virtual object within a CAD application running on the first computer system, the first computer system detects a first input from the user, and in response causes the HMD to preview the three-dimensional virtual object in a three-dimensional environment displayed via the HMD. In this example, after previewing the virtual object on the HMD, the user modifies the three-dimensional virtual object on the first computer system. Once the modifications are made, the user presses a button (e.g., a virtual button/selectable affordance) to transfer the updated model to the HMD. In some embodiments, the process to update the display of the second representation includes transferring data associated with the current three-dimensional virtual object (e.g., the virtual object including any changes between detecting the first event and the second event) to the second computer system.

In some embodiments, in response to detecting the first event, in accordance with a determination that the first computer system is not engaged in an active communication session with an external computer system, and prior to initiating the process to display the second representation of the three-dimensional virtual object via the one or more head-mounted display generation components of the second computer system, the first computer system displays, via the one or more display generation components of the first computer system, a destination selection user interface, wherein the destination selection user interface includes one or more selectable options, the selectable options corresponding to different external computer systems that are available to display the second representation, such as the transfer window 716 as depicted in FIGS. 7B to 7E. In some embodiments, the computer system displayed the destination selection user interface in accordance with a determination that the first computer system has not previously initiated the process to display the second representation of the three-dimensional virtual object at the second computer system, as discussed herein. In some embodiments, the first computer system establishes an active communication session with an external computer system (e.g., the second computer system). In some embodiments, establishing an active communication session includes establishing and maintaining a communication link (optionally, a bi-directional communication link) between the first computer system and the external computer system. In some embodiments, the first computer system and the external computer system remain in an active communication session after the communication session is established until the first computer system and/or the external computer system terminates the communication session. In some embodiments, the first computer system sends a transfer request to the external computer system, optionally receives an acknowledgement from the external computer system, and establishes an active communication session in response to the acknowledgement. In some embodiments, data associated with the first representation of the three-dimensional virtual object is transmitted to the external computer system over the active communication session (as discussed herein with regard to the process to receive a selection of one or more computer systems to which to transmit the information associated with the three-dimensional virtual object, e.g., receiving a further user input to receive a new selection of one or more computer systems).

In some embodiments, the first computer system detects a first event (e.g., a selection of an affordance associated with the first representation for transferring data associated with the first representation to an external computer system), such as transfer button 714 depicted in FIG. 7J. In some embodiments, when the first event is received before the first computer system has established communication with any external computer system (e.g., no previous communication link or session has been established), the first computer system provides a selection user interface for allowing selection of the external computer system, such as transfer window 716 as illustrated in FIG. 7B or 7C. In some embodiments, the destination selection user interface includes a list of destinations (e.g., displayed as one or more selectable options), as is displayed by destination computer system icons 718a to 718d in FIG. 7B or 7C. In some embodiments, the destination selection user interface includes one or more affordances associated with the one or more selectable options (e.g., the destination selection user interface is a window displayed within an application running on the first computer system and includes a list of external computer systems that can be selected and a “confirm” button to establish a connection with the selected external computer system). For example, when a user interacts with a three-dimensional model of a lamp in a CAD software application and selects a “transfer” or “preview” for the first time (e.g., no second computer system has been selected), a separate interface is displayed to select the destination computer system for the model to be previewed on. Once the first computer system receives the selection from the user regarding the desired external computer system, the first computer system continues to initiate the process to display the second representation on the second computer system.

In some embodiments, in response to detecting the first event, in accordance with a determination that the first computer system is not engaged in an active communication session with an external computer system, and prior to initiating the process to display the second representation of the three-dimensional virtual object via the one or more head-mounted display generation components of the second computer system: the first computer system receives, via the one or more input devices, a sequence of one or more inputs that correspond to a selection directed toward the destination selection user interface corresponding to a selection of the second computer system, wherein initiating the process to display the second representation of the three-dimensional virtual object via the one or more head-mounted display generation components of the second computer system occurs in response to receiving the sequence of one or more inputs that corresponds to the selection directed toward the destination selection user interface, such as the selection of a destination computer system via transfer window 716 as is illustrated in FIGS. 7B to 7E. In some embodiments, the selection includes one or more of the following inputs: a button press (e.g., virtual button and/or a mechanical button), a keyboard entry, and/or a mouse selection (e.g., a mouse click) received by the first computer system. In some embodiments, the selection user interface includes a list of destination computer systems, with one or more selectable affordances. In some embodiments, the list includes an affordance associated with the second computer system, and receiving the selection includes detecting a user input directed towards the affordance associated with the second computer system.

In some embodiments, in response to detecting the first event, and in accordance with a determination that the first computer system is engaged in an active communication session with the second computer system, the first computer system initiates the process to display the second representation of the three-dimensional virtual object via the one or more head-mounted display generation components of the second computer system without displaying the destination selection user interface, such as is shown by the absence of a transfer window 716 when the transfer button 714 is pressed in FIG. 7J before the second representation 752 is updated in FIG. 7K.

In some embodiments, when the first event is received after the first computer system has previously established communication with the second computer system, the first computer system forgoes providing a selection user interface and transfers the data associated with the first representation to the second computer system over the established communication link. In some embodiments, the first computer system determines whether the first computer system is in an active communication session with any external computer systems (e.g., based on whether the first computer system is paired with an HMD). In some embodiments, when the first computer system has determined that the first computer system is in an active communication system with an external computer system a third computer system different from the second computer system, in response to receiving the first event, the first computer system forgoes providing a selection user interface and transfers the data associated with the first representation to the third computer system over the established communication link. For example, when a user interacts with a three-dimensional model of a lamp in a CAD software application and selects a “transfer” or “preview” for the second time, it is no longer necessary to query the user for a destination computer system as the first computer system remembers the second computer system in part due to the established communication link.

In some embodiments, after initiating the process to display the second representation of the three-dimensional virtual object at the second computer system, the first computer system detects, via the one or more input devices, a second event (e.g., including a sequence of one or more inputs, optionally a button press, a press on a mouse or trackpad, a location of a cursor) corresponding to interaction with the first representation of the three-dimensional virtual object on the first computer system, such as the selection of transfer button 714 as depicted in FIG. 7J. In some embodiments, the second event shares one or more characteristics with the first event described herein. For example, the second event includes a selection of an affordance associated with the first representation for transferring data associated with the first representation to an external computer system. In some embodiments, the affordance associated with the second event is the same affordance associated with the first event.

In some embodiments, after initiating the process to display the second representation of the three-dimensional virtual object at the second computer system, in response to detecting the second event, and in accordance with a determination that the second event includes a first type of input, at the first computer system, the first computer system initiates a process to display a third representation of the three-dimensional virtual object via one or more head-mounted display generation components of the second computer system, such as if the second representation 752 shown in FIG. 7K were a different representation of the three-dimensional virtual object. In some embodiments, after initiating the process to display the second representation of the three-dimensional virtual object at the second computer system, in response to detecting the second event, and in accordance with a determination that the second event includes a second type of input, different from the first type of input, that includes a selection of a third computer system, different from the second computer system, the first computer system initiates a process to display the third representation of the three-dimensional virtual object via one or more head-mounted display generation components of the third computer system, such as if the transfer window 716 as is illustrated in FIG. 7B to 7E were displayed in response to a second type of input directed towards the transfer button 714 in FIG. 7J.

In some embodiments, the second event is detected after the first event is detected. In some embodiments, the second event shares one or more characteristics with the first event. In some embodiments, the second event corresponds to interaction with the first representation of the three-dimensional virtual object on the first computer system, such as a second selection of transfer button 714 as illustrated in FIG. 7J. In some embodiments, the second event refers to the computer system detecting that a second user input on the first computer system has been received, wherein the second user input corresponds to a request to transfer data associated with the first representation of the three-dimensional virtual object from the first computer system to the second computer system. In some embodiments, the input includes a button press (e.g., virtual button and/or a mechanical button), a keyboard entry, and/or a mouse selection. As one example, both the first event and the second event are selections of a same affordance on the first computer system (e.g., selection of a “transfer” or “preview” button within a CAD application).

In some embodiments, the first computer system is configured to determine a type of input of the second event. In some embodiments, the type of input corresponds to a different user interaction with a same affordance. For example, the first type of input corresponds to user selecting a button (e.g., pushing a button and immediately releasing the button), whereas the second type of input corresponds to the user holding the same button for a duration of time (e.g., a long press, where the button is held for 0.3, 0.5, 1, 2, 3, or 5 seconds).

In some embodiments, when the first computer system detects the second event including the first type of input, the first computer system initiates a process to display a third representation of the three-dimensional virtual object via one or more head-mounted display generation components of the second computer system, such as if the second representation 752 shown in FIG. 7K were a different representation of the three-dimensional virtual object. In some embodiments, the third representation displayed in response to the first type of input shares one or more characteristics with the second representation described above.

In some embodiments, when the first computer system detects the second event including the second type of input, the first computer system changes the external computer system destination for the first representation. As such, the first computer system initiates a process to display a third representation of the three-dimensional virtual object via one or more head-mounted display generation components of a third computer system, such as if the second representation 752 shown in FIG. 7K were a different representation of the three-dimensional virtual object. In some embodiments, the third representation displayed in response to the first type of input shares one or more characteristics with the second representation described above. In some embodiments, the third computer system shares one or more characteristics with the second computer system described above.

In some embodiments, the first computer system selects the third computer system in response to detecting the second event that includes the second type of input. In some embodiments, in response to detecting the second event that includes the second type of input, the first computer system displays a destination selection user interface, such as a transfer window 716 as illustrated in FIG. 7B or 7C, that includes one or more selectable options corresponding to available computer devices for sharing the first representation with (e.g., as described herein). In some embodiments, the first computer system receives, via the one or more input devices, a selection at the destination selection user interface corresponding to a selection of the third computer system. For example, upon receiving a long press directed towards a transfer button, the first computer system recognizes that the user wishes to change the destination computer system for previewing the virtual object and displays a new destination selection user interface, regardless of the fact that a previous communication link has been established with the second computer system.

In some embodiments, after initiating the process to display the second representation of the three-dimensional virtual object via the one or more head-mounted display generation components of the second computer system, the first computer system detects, via the one or more input devices, a second event (e.g., including a sequence of one or more inputs, optionally a button press, a press on a mouse or trackpad, a keyboard entry, a location of a cursor) (as discussed above, and which optionally shares one or more characteristics with the first event described herein) corresponding to interaction with a representation of a respective virtual object on the first computer system, such as the selection of transfer button 714 in FIG. 7J.

In some embodiments, in response to detecting the second event, in accordance with a determination that the representation of the respective virtual object is the first representation of the three-dimensional virtual object, the first computer system initiates a process to replace the display of the second representation of the three-dimensional virtual object with display of a third representation of the three-dimensional virtual object on the second computer system (such as is shown in FIG. 7K). In some embodiments, if the computer system detects that the second event corresponds to the first representation, the computer system transmits information/commands to the second computer system to replace the displayed second representation with a third representation, wherein the third representation is a modified version of the second representation (e.g., corresponding changes that were made to the first representation at the first computer system). In some embodiments, the third representation is modified in accordance with the second event as discussed herein (e.g., interaction with the first representation of the three-dimensional virtual object on the first computer system). In some embodiments, the process of modifying the second representation (e.g., displaying the third representation) in accordance with detected modification to the first representation share one or more characteristics with the process for synchronizing modifications to the first representation between the first computer system and the second computer described herein. In some embodiments, the first computer system determines whether the second representation is currently being displayed by the second computer system. In some embodiments, the second representation of the three-dimensional virtual object corresponds to the first representation of the three-dimensional virtual object at the time the first event is detected, and the third representation of the three-dimensional virtual object corresponds to the first representation of the three-dimensional object at the time the second event is detected.

In some embodiments, in response to detecting the second event, and in accordance with a determination that the representation of the respective virtual object is not the first representation of the three-dimensional virtual object, the first computer system initiates a process to display a first representation of the respective virtual object concurrently with the second representation of the three-dimensional virtual object via the one or more head-mounted display generation components of the second computer system that is in communication with the first computer system (such as if an additional representation were displayed concurrently and alongside representation 752 in FIG. 7K).

In embodiments, if the representation of the respective virtual object (e.g., a second three-dimensional virtual object) is not the first representation of the three-dimensional virtual object, the second computer system displays the second representation of the three-dimensional virtual object concurrently with the first representation of the respective virtual object (e.g., the second three-dimensional virtual object). In some embodiments, initiating the process to display the first representation of the respective virtual object concurrently with the second representation of the three-dimensional virtual object includes displaying the first representation of the respective virtual object at a location with respect to the second representation of the three-dimensional virtual object (e.g., within 0.05, 0.1, 0.2, 0.5, 1, 3, 5, or 10 meters of the second representation of the three-dimensional virtual object). In some embodiments, the size of the first representation of the respective virtual object is larger than, smaller than, or equal in size to the size of the second representation of the three-dimensional virtual object. In some embodiments, when the second computer system concurrently displays the first representation of the respective virtual object with the second representation of the three-dimensional virtual object, the first representation of the respective virtual object is updated in response to changes to a representation of the respective virtual object on the first computer system. In some embodiments, when the second computer system concurrently displays the first representation of the respective virtual object with the second representation of the three-dimensional virtual object, the second representation of the three-dimensional virtual object is updated in response to changes to the first representation of the three-dimensional virtual object on the first computer system.

For example, when the computer system is displaying a three-dimensional model of a vase in a CAD application running on the first computer system, the computer system detects a user input directed towards a “preview” button. In this example, when the preview button is selected, the computer system transfers data associated with the three-dimensional model of the vase so that it is previewed on the HMD. However, in this example, the user modifies the three-dimensional model of the vase after the HMD displays the preview, and then re-selects the “preview” button. In this example, although the user has changed the model of the vase, the vase is still considered to be a first representation of the three-dimensional virtual object. In this case, when the user selects the “preview” button, the computer system transfers data associated with the updated first representation of the three-dimensional virtual object to the second computer system, and in response the second computer system replaces the previously displayed second representation with a third representation corresponding to the updated first representation (e.g., replacing the single vase in the HMD preview with an updated vase).

As another example, after the vase is displayed by the second computer system, the first computer system displays a new virtual object (e.g., a three-dimensional model of a lamp). After interacting with the three-dimensional model of the lamp, the user selects the “preview” button to transfer to the HMD. However, in this case, because the lamp and the vase are different virtual objects, the second computer system does not remove the display of the vase and instead displays representations of both the vase and the lamp concurrently.

In some embodiments, after initiating the process to display the second representation of the three-dimensional virtual object via the one or more head-mounted display generation components of the second computer system, the first computer system detects, via the one or more input devices, a second event (e.g., including a sequence of one or more inputs, such as a button press, a press on a mouse or trackpad, a keyboard entry, a location of a cursor, as discussed herein) corresponding to interaction with the first representation of the three-dimensional virtual object on the first computer system, such as if the transfer button 714 were selected a second time, similar to the selection of the transfer button 714 depicted in FIG. 7J.

In some embodiments, in response to detecting the second event, the first computer system initiates a process to modify display of the second representation of the three-dimensional virtual object at the second computer system, such as by initiating a display of second representation 752 on HMD 101 as illustrated in FIG. 7K.

In some embodiments, in response to detecting the second event, the first computer system transmits information representing one or more changes made to the first representation of the three-dimensional virtual object to the second computer, that causes the second computer system modifies display of the second representation by replacing respective portions of the second representation corresponding to the transmitted one or more changes made to the first representation, such as if the display of the second representation 752 depicted in FIG. 7K was modified by the second computer system 101 based only on the change in color, as opposed to re-displaying the entire second representation 752. In some embodiments, the first computer system initially transfers data associated with the first representation of the three-dimensional virtual object to the second computer system. In some embodiments, for subsequent transfers (e.g., second events) associated with the same first representation of the three-dimensional virtual object, the first computer system transfers a subset of the data associated with the first representation. In some embodiments, the first computer system determines one or more changes made to the first representation of the three-dimensional object in accordance with the second event. In some embodiments, the subset of the data corresponds to only portions of the data that have changed in response to detected modifications to the first representation without portions of the data that have not changed. In some embodiments, the first computer system forgoes transmitting data about portions of the first representation that did not change in response to the second event. In some embodiments, the first computer system is configured to track one or more changes to the first representation after the first event is detected. In some embodiments, the first computer system transfers the one or more changes to the second computer system, without transferring the entire data associated with the first representation of the three-dimensional virtual object. In some embodiments, the second computer system forgoes changing the portions of the second representation that do not correspond to the transmitted one or more changes.

For example, when the three-dimensional virtual object is a table, the user interacts with the first representation of the table on the first computer system and transfers data associated with the table to the second computer system to preview the table. Afterwards, the first computer system receives one or more user inputs to modify the table on the first computer system. In one example, the user changes the legs of the table and saves the changes. Upon selecting the transfer button again, the first computer system recognizes that this is the same virtual object was previously transferred to the second computer system and sends the necessary data corresponding to the updated table legs to the second computer system without sending other data that the second computer system already has. In response, the second computer system updates its preview of the table model to replace the legs of the second representation.

In some embodiments, initiating the process to display the second representation of the three-dimensional virtual object via the one or more head-mounted display generation components of the second computer system comprises, in accordance with a determination that the first computer system and the second computer system are not associated with the same user account, initiating a process on the second computer system to request approval to display the three-dimensional virtual object received from the first computer system at the second computer system (such as is illustrated in FIG. 7F), and in accordance with a determination that the first computer system and the second computer system are associated with the same user account, initiating the process to display the second representation of the three-dimensional virtual object without requesting approval to display the three-dimensional virtual object received from the first computer system at the second computer system (such as if the receive window 720 in FIG. 7F were not displayed and the second representation 752 is displayed as illustrated in FIG. 7G automatically, in response to detecting that the laptop 700 and HMD 101 share a same user account).

In some embodiments, the first computer system and second computer system are both associated with user accounts. In some embodiments, the user account associated with a respective computer system is associated with one or more user credentials (e.g., a user ID and password) entered on the respective computer system. In some embodiments, the respective computer system is associated with a user account when the user account is active on the respective computer system (e.g., when a user is logged in on the computer system). In some embodiments, a respective computer system is logged into a server using a certain set of account credentials (e.g., a user ID and password). In some embodiments, two computer systems associated with the same user account are both logged into the server with the same set of account credentials (e.g., the same user ID and the same password). In some embodiments, when two computer systems are not associated with the same set of account credentials, the two computer systems are not logged into the server with the same credentials. In some embodiments, a computer system being logged into a server with a given set of account credentials provides access to one or more functionalities provided by the server to the computer system, the one or more functionalities being associated with the given set of account credentials.

In some embodiments, the first computer system determines a user account associated with the first computer system (e.g., which user account is currently logged in to the first computer system). In some embodiments, the first computer system determines a user account currently associated with a second computer system (e.g., which user account is currently logged in to the HMD). In some embodiments, the server associated with the first computer system and/or second computer system determines a user account currently associated with first computer system and/or the second computer system. In some embodiments, the second computer system determines a user account associated with the first computer system and/or a user account associated with the second computer system. In some embodiments, the first computer system receives an indication of the user account currently associated with the second computer system from the second computer system and/or the server. In some embodiments, the first computer system compares the user account associated with the first computer system with the user account associated with the second computer system (e.g., as received in the indication from the second computer system). In some embodiments, if the user account on each computer system is the same, the first computer system transfers data from the first computer system to the second computer system without requiring further authentication of the communication link. In some embodiments, if the user account on each computer system is not the same (e.g., different users are logged into the computer systems), the first computer system requires further authentication between the first computer system and the second computer system (e.g., requiring an acknowledgement from the second computer system that the communication link has been accepted) before transferring data from the first computer system to the second computer system.

For example, user A has logged into the first computer system and user A has also logged into the second computer system. When the user selects a transfer button on the first computer system for previewing the first representation of the three-dimensional virtual object on the second computer system, the first computer system recognizes that user A is logged into the second computer system and automatically transfers the data associated with the first representation without prompting user A for additional verification.

As another example, user A has logged into the first computer system and user B has logged into the second computer system. In this case, when the user selects the transfer button on the first computer system for previewing the first representation of the three-dimensional virtual object on the second computer system, the first computer system recognizes that user A is not logged into the second computer system and sends a transfer request to the second computer system before transferring the data. In response to the transfer request, the second computer displays one or more prompts for requesting approval to display the three-dimensional virtual object (e.g., accepting or declining the transfer on the second computer system such as “accept” or “decline” buttons. Once the user selects the accept button on the second computer system, the second computer sends the acknowledgement to the first computer system and the first computer system transfers the data associated with the first representation to the second computer system in response to the acknowledgement. In some embodiments, if the user declines the transfer (e.g., selects the decline button in the above example), the first computer system forgoes transferring the data associated with the first representation to the second computer system.

In some embodiments, the process to display the second representation of the three-dimensional virtual object via the one or more head-mounted display generation components of the second computer system initiated by the first computer system comprises: in accordance with a determination that a virtual display (which optionally shares one or more characteristics with the virtual display described herein, and/or with respect to method 1000) of an external device (e.g., the first computer system, or a different computer system) is being displayed via the one or more head-mounted display generation components of the second computer system, displaying the second representation of the three-dimensional virtual object (e.g., via the one or more display generation components of the second computer system) within a threshold distance (e.g., 10 cm, 50 cm, or 1 m) of the virtual display, such as is illustrated by the proximity of second representation 752 to virtual display 704 in FIG. 7G.

In some embodiments, the second computer system is configured to display a virtual display of an external device (e.g., a computer, a laptop, a smart phone). In some embodiments, the virtual display mirrors a display of the external device within the three-dimensional environment. In some embodiments, the virtual display is located at a first location within the three-dimensional environment. In some embodiments, the virtual display is associated with the first computer system. In some embodiments, the virtual display is a virtual monitor (e.g., and/or a virtual display generation component) for the first computer system. In some embodiments, the virtual window includes content that is displayed, controlled, and/or defined by the first computer system. In some embodiments, the first computer system displays content corresponding to what is displayed in the virtual window. In some embodiments, the first computer system at least temporarily does not display (e.g., forgoes display) of the content corresponding to what is displayed in the virtual window. For example, the first computer system optionally does not display content via a physical screen or physical projector. In some embodiments, the virtual display corresponds to a user interface that is the same as and/or is based on a user interface displayed at the first computer system via one or more display generation components that are different from the one or more display generation components of the second computer system. Additionally or alternatively, the virtual display corresponds to a plurality of user interfaces displayed at the first computer system. For example, the virtual window optionally includes an operating system user interface including wallpaper media, a system tray, notifications, and/or icons for applications and optionally further includes one or more user interfaces overlaying portions of the operating system user interface. The overlaying user interfaces, for example, optionally include an internet browsing user interface, a content creation user interface for two-dimensional or three-dimensional models and/or media, and/or a shopping application including pictures, media, and/or graphics depicting prospective purchases. Concurrently, the first computer system optionally displays the same operating system user interface and/or the same one or more overlaying user interfaces.

In some embodiments, the first computer system provides instructions to the second computer system regarding a desired location of the second representation within the three-dimensional environment (e.g., within a threshold distance of the virtual display). In some embodiments, the second computer system defaults the display of the second representation to a location within the three-dimensional environment (e.g., within a threshold distance of the virtual display).

For example, when the user is wearing the HMD, the HMD displays a virtual display of the first computer system. In this example, the user interacts with the virtual display of the first computer system to interact with the first representation. Upon selecting a transfer button on the virtual display to transfer the first representation to the HMD (e.g., a three-dimensional model of a lamp), the HMD displays the lamp in proximity to the virtual display.

In some embodiments, the threshold distance is a fixed distance from the virtual display (e.g., 10 cm, 50 cm, or 1 m). In other embodiments, the threshold distance is a distance which is based on the size of the second representation. For example, a table lamp that is 30 cm tall is displayed within 30 cm of the virtual display, whereas a floor lamp that is 1.5 m tall is displayed within 1 m of the virtual display. In some embodiments, if the second computer system is not displaying a virtual display, the second representation is displayed at a default location within the three-dimensional environment (e.g., directly in front of the viewpoint of the user) and/or at a location based on a set of display instructions, as described herein.

In some embodiments, the process to display the second representation of the three-dimensional virtual object via the one or more head-mounted display generation components of the second computer system initiated by the first computer system comprises displaying the second representation of the three-dimensional virtual object within a three-dimensional environment that is visible via the one or more head-mounted display generation components of the second computer system, such as is illustrated by the second representation 752 within three-dimensional environment 730 in FIGS. 7G to 7P and 7R.

As discussed above, in some embodiments, the second representation is displayed within a three-dimensional environment that is visible via the one or more head-mounted display generation components. In some embodiments, initiating the process to display the second representation of the three-dimensional virtual object via one or more head-mounted display generation components of the second computer system comprises in accordance with a determination that a first location parameter is specified at the first computer system for displaying the second representation of the three-dimensional virtual object, the second representation of the three-dimensional virtual object is displayed (e.g., via the head-mounted display generation component) at a first location in the three-dimensional environment that is visible via the one or more head-mounted display generation components of the second computer system, such as is depicted by the display of second representation 752 at the location shown in FIG. 7G).

In some embodiments, initiating the process to display the second representation of the three-dimensional virtual object via one or more head-mounted display generation components of the second computer system comprises: in accordance with a determination that a second location parameter, different from the first location parameter, is specified at the first computer system for displaying the second representation of the three-dimensional virtual object, the second representation of the three-dimensional virtual object is displayed (e.g., via the head-mounted display generation component) at a second location, different from the first location, in the three-dimensional environment that is visible via the one or more head-mounted display generation components of the second computer system, such as if the second representation 752 in FIG. 7G were at a different location within the three-dimensional environment 730.

In some embodiments, the first computer system specifies a first location parameter for the three-dimensional virtual object, the first representation, and/or the second representation. In some embodiments, the first computer system receives the first location parameter from one or more user inputs, received via the one or more input devices of the first computer system. In some embodiments, the first location parameter is associated with one or more portions of the three-dimensional virtual object (e.g., to align a certain portion of the three-dimensional virtual object to a surface type in a three-dimensional environment). For example, the user can select one or more criteria within a CAD application to define the positioning of the three-dimensional virtual object when rendered in a three-dimensional environment. In some embodiments, the first location parameter corresponds to positional requirements within a three-dimensional environment (e.g., that the second representation should be rendered a certain minimum distance away from certain objects or surfaces). In some embodiments, the first location parameter is pre-defined by a developer of one or more applications running on the first computer system.

In some embodiments, the first computer system transfers the first location parameter to the second computer system along with the data associated with the first representation of the virtual object. In some embodiments, when the first computer system forgoes transferring a first location parameter or does not specify a first location parameter, the second computer system displays the second representation at a default location (e.g., floating directly in front of a viewpoint of a user at a fixed distance).

In some embodiments, displaying the second representation of the three-dimensional virtual object at the first location in the three-dimensional environment that is visible via the one or more head-mounted display generation components of the second computer system comprises: in accordance with a determination that an application associated with the first representation provides a first anchoring suggestion, displaying the second representation of the three-dimensional virtual object at the first location with a first anchoring is based on an anchoring suggestion provided by an application (optionally on the first computer system) associated with the three-dimensional virtual object, such as the second representation 752 being pinned to the table as illustrated in FIG. 7G.

In some embodiments, displaying the second representation of the three-dimensional virtual object at the first location in the three-dimensional environment that is visible via the one or more head-mounted display generation components of the second computer system comprises: in accordance with a determination that an application associated with the first representation provides a second anchoring suggestion, different from the first anchoring suggestion, displaying the second representation of the three-dimensional virtual object at the first location with a second anchoring, different from the first anchoring, such as if the second representation 752 in FIG. 7G were a representation of poster pinned to a wall in the three-dimensional virtual environment 730).

In some embodiments, an anchoring suggestion (e.g., a first anchoring suggestion and/or a second anchoring suggestion) includes one or more anchoring instructions to align one or more portions of the three-dimensional virtual object to one or more surfaces in the three-dimensional environment (e.g., a horizontal surface). In some embodiments, the anchoring suggestion specifies a type of surface that the second representation of the virtual object should be snapped to (e.g., a horizontal surface or a vertical surface). In some embodiments, the anchoring suggestion is based on a type of object that the virtual object is (e.g., a lamp will be associated with an anchoring suggestion to snap the object to the floor, and a poster frame will be associated with an anchoring suggestion to snap the object to a wall). In some embodiments, the second computer system applies a respective anchoring (e.g., a first anchoring and/or a second anchoring) to the second representation of the three-dimensional virtual object based on the respective anchoring suggestion by snapping the object to a surface in the three-dimensional environment (e.g., by bringing one or more portions of the second representation into alignment with the surface). In some embodiments, the first computer system transfers the respective anchoring suggestion, along with the data associated with the first representation of the three-dimensional virtual object, to the second computer system. In some embodiments, the application is an application running on the first computer system for displaying the first representation (e.g., a CAD application).

In some embodiments, the second location parameter includes respective anchoring suggestion to align one or more portions of the three-dimensional virtual object to one or more surfaces in the three-dimensional environment (e.g., a vertical surface). In some embodiments, the first location parameter includes instructions for snapping the second representation to a first type of surface, and the second location parameter includes instructions for snapping the second representation to a second type of surface, different from the first type of surface. In some embodiments, the second location parameter does not include any anchoring instructions (e.g., the second computer system displays the second representation based on the second location parameter directly in front of the viewpoint of the user, floating within the three-dimensional environment).

For example, when the three-dimensional virtual object is a floor lamp, the first computer system transfers instructions to align a base of the lamp to the floor of the three-dimensional environment. As another example, when the three-dimensional virtual object is a table lamp, the first computer system transfers instructions to align a base of the lamp to a table (or other horizontal surface) within the three-dimensional environment. In accordance with receiving the instructions, the second computer system positions the table lamp onto a table in the three-dimensional environment in accordance with the instructions to align the base of the lamp to a table. As a further example, when the three-dimensional virtual object is a poster frame, the first computer system transfers instructions to align a back of the poster frame to a wall (or, optionally, another vertical surface) within the three-dimensional environment. In accordance with receiving the instructions, the second computer system positions the poster frame onto a wall in the three-dimensional environment, in accordance with the instructions to align the poster frame to the wall. Accordingly, the table lamp and the poster frame are positioned at different locations in the three-dimensional environment in accordance with the respective anchoring suggestions received from the first computer system.

In some embodiments, the second computer system is configured to display a plurality of representations of three-dimensional virtual objects provided by a plurality of different software applications, such as if multiple second representations 752 were displayed in FIGS. 7G to 7P (optionally on the first computer system and/or other computer systems other than the second computer system). In some embodiments, the second computer system is configured to receive data and preview three-dimensional virtual objects transferred from different software applications (e.g., a CAD application and a 3D-model viewer application). In some embodiments, the first computer system is configured to detect the first event from different software applications and initiate the process to display the second representation accordingly. In some embodiments, initiating the process to display the second representation from a respective software application shares one or more characteristics with initiating the process to display the second representation as discussed herein.

In some embodiments, in response to detecting, via the one or more input devices, a second event (e.g., including a sequence of one or more inputs, optionally a button press, a press on a mouse or trackpad, a keyboard entry, a location of a cursor) corresponding to further interaction with the first representation of the three-dimensional virtual object on the first computer system (e.g., as described herein in relation to a second event corresponding to interaction with the first representation of the three-dimensional virtual object on the first computer system), and in accordance with a determination that the second event corresponds to a first type of interaction, the first computer system forgoes initiating a process to synchronize display of the second representation of the three-dimensional virtual at the second computer system with the first representation of the three-dimensional object at the first computer system, such as if a change in orientation of the first representation were applied to the first representation in FIG. 7G.

In some embodiments, in response to detecting, via the one or more input devices, a second event corresponding to further interaction with the first representation of the three-dimensional virtual object on the first computer system: in accordance with a determination that the second event corresponds to a second type of interaction, different from the first type of interaction, the first computer system initiates the process to synchronize display the second representation of the three-dimensional virtual object via the one or more head-mounted display generation components of the second computer system, such as a change in color of the first representation 750 being reflected in the second representation 752 by selection of transfer button 714 as depicted in FIG. 7H to 7K.

In some embodiments, the second event shares one or more characteristics with the first event (e.g., the first event is an initial transfer of data, and the second event includes a further transfer of data associated with synchronization data between the first computer system and second computer system). In some embodiments, a first type of interaction is not synchronized between the first computer system and the second computer system, and a second type of interaction is not synchronized between the first computer system and the second computer system.

In some embodiments, the first type of interaction includes modifications to an orientation or pose of the first representation of the three-dimensional virtual object. In some embodiments, the second type of interaction includes modifications to a shape, size, color, or texture of the first representation of the three-dimensional virtual object. Therefore, in some embodiments, changes in pose do not cause the second computer system to change how the second representation of the three-dimensional virtual object is displayed, but the above mentioned modifications associated with a second type of interaction do cause the second computer system to change how the second representation of the three-dimensional virtual object is displayed (e.g., displayed in accordance with said modifications).

It should be understood that the particular order in which the operations in method 800 have been described is merely exemplary and is not intended to indicate that the described order is the only order in which the operations could be performed. One of ordinary skill in the art would recognize various ways to reorder the operations described herein. In some embodiments, aspects/operations of method 800 may be interchanged, substituted, and/or added between these methods. For example, various object manipulation techniques and/or object movement techniques of method 800 is optionally interchanged, substituted, and/or added between these methods. For brevity, these details are not repeated here.

FIGS. 9A-9O illustrate examples of a computer system displaying virtual windows and three-dimensional content in accordance with some embodiments, as described in greater detail with reference to method 1000. FIG. 9A illustrates a computer system 101 (e.g., an electronic device) displaying, via a display generation component (e.g., display generation component 120 of FIG. 1A and/or display generation components 1-122a and 1-122b of FIG. 1C), a three-dimensional environment 900 from a viewpoint of a user 926 of the computer system 101. In some embodiments, computer system 101 corresponds to a first computer system as described with reference to method 1000. In some embodiments, computer system 101 is a head-mounted device, such as first HMD device 100 and/or second HMD 101 described with reference to FIGS. 7A through 7Q.

FIG. 9A further illustrates another computer system 922, such as a laptop and/or a desktop computer, in three-dimensional environment 900. In some embodiments, computer system corresponds to a second computer system that is different from computer system 101, as described with reference to method 1000. In some embodiments, computer system 922 has one or more characteristics similar to, or the same as laptop 700 described with reference to FIGS. 7A through 7Q. For example, computer system 101 is configured to display content corresponding to a three-dimensional model on a two-dimensional display. Additionally or alternatively, computer system 101 is optionally configured with one or more display generation components, such as display generation component 120, to display three-dimensional content, as described with reference to FIG. 9C.

In FIG. 9A, the display generation component 120 includes one or more internal image sensors 114a oriented towards the face of the user (e.g., eye tracking cameras 540 described with reference to FIG. 5). In some embodiments, internal image sensors 114a are used for eye tracking (e.g., detecting a gaze of the user). Internal image sensors 114a are optionally arranged on the left and right portions of display generation component 120 to enable eye tracking of the user's left and right eyes. Display generation component 120 also includes external image sensors 114b and 114c facing outwards from the user to detect and/or capture the physical environment and/or movements of the user's hands.

As shown in FIG. 9A, computer system 101 captures one or more images of the physical environment around computer system 101 (e.g., operating environment 100 of FIG. 1A), including one or more objects in the physical environment around computer system 101. In some embodiments, computer system 101 displays representations of the physical environment in three-dimensional environment 900. For example, three-dimensional environment 900 potentially includes representations of a physical window and/or a lamp in a room in which the computer system 101 is located. In some embodiments, the computer system 101 displays the three-dimensional environment 900 from a viewpoint of a user 926 (e.g., facing the back wall of the physical environment in which computer system 101 is located, as shown in overhead view (e.g., “Top-Down View”) of the three-dimensional environment 900). In the overhead view, the position and/or orientation of user 926, virtual object 902, and/or computer system 922 in three-dimensional environment 900 are illustrated.

As discussed in greater detail below, in FIG. 9A, display generation component 120 is illustrated as displaying one or more virtual objects in the three-dimensional environment 900. In some embodiments, the one or more virtual objects are displayed by a single display (e.g., display 510 of FIG. 5) included in display generation component 120. In some embodiments, display generation component 120 includes two or more displays (e.g., left and right display panels for the left and right eyes of the user, respectively, as described with reference to FIG. 5) having displayed outputs that are merged (e.g., by the user's brain) to create the view of the virtual objects shown in FIGS. 9A-9O.

Display generation component 120 has a field of view (e.g., a field of view captured by external image sensors 114b and 114c and/or visible to the user via display generation component 120) that corresponds to the virtual objects shown in FIG. 9A. Because display generation component 120 is optionally a head-mounted device, the field of view of display generation component 120 is optionally the same as or similar to the field of view of the user.

In some embodiments, a user interface illustrated and described below could also be implemented on a head-mounted display that includes the display generation component 120 that displays the user interface or three-dimensional environment to the user, and sensors to detect the physical environment and/or movements of the user's hands (e.g., external sensors facing outwards from the user), and/or attention (e.g., gaze) of the user (e.g., internal sensors facing inwards towards the face of the user) such as movements that are interpreted by the computer system as gestures such as air gestures. Additionally, in some embodiments, input to computer system 101 is provided via air gestures from hand (e.g., hand 406 of FIG. 4) and/or attention of the user (e.g., as described in more detail with reference to method(s) 800, 1000, and/or 1200), or via a trackpad from hand 406, and inputs described herein are optionally received via the trackpad or via air gestures/attention.

In some embodiments, computer system 101 is in communication with one or more input devices. For example, in FIG. 9A, computer system 101 is in wired or wireless communication with trackpad 918. In some embodiments, computer system 101 is in communication with one or more additional or alternative input devices such as controller 944 as shown in FIG. 9C. In some embodiments, one or more input devices that are in communication with computer system 101 is not in communication with computer system 922. In some embodiments, one or more of the input devices that are in communication with computer system 101 are also in communication with computer system 922 (e.g., directly via a wired or wireless connection, and/or by proxy via computer system 101). In some embodiments, input directed to trackpad 918 is indicated by computer system 101, such as by the display and/or movement of focus selector 910 in virtual object 902, as shown in FIG. 9A.

As described with reference to method 1000, computer system 101 optionally detects a sequence of one or more inputs corresponding to or included in a “request.” In some embodiments, the request is directed to a user interface included in virtual object 902, as described above. In this way, computer system 101 optionally detects a sequence of one or more inputs included in a request, and in response, optionally performs one or more operations in accordance with the one or more inputs (e.g., displaying content, ceasing display of content, changing settings, and/or otherwise manipulating and/or interacting with content).

In FIG. 9A, three-dimensional environment 900 includes a plurality of virtual objects, such as graphical user interfaces included in virtual object 902. In some embodiments, computer system 101 is able to communicate with computer system 922 to share content. For example, virtual object 902 corresponds to a virtual monitor which includes content that is based on or the same as one or more user interfaces displayed by computer system 922 (e.g., described in greater detail with reference to methods 800, 1000, and/or 1200, and not displayed in FIG. 9A due to computer system 922 being outside the viewport of the user 926). In FIG. 9A, virtual object 902 is a two-dimensional virtual object, such as a virtual window described with reference to method 1000. In some embodiments, three-dimensional environment 900 includes additional or alternative virtual objects, such as volumetric virtual objects that occupy three dimensions of three-dimensional environment 900. As described with reference to methods 800 and/or 1000, computer system 101 and/or computer system 922 are optionally configured to share information (e.g., transmit and/or receive information) via one or more communication sessions in which indications of inputs and/or updates to content are optionally exchanged. For example, computer system 101 in FIG. 9A displays virtual object 902 based on information streamed from computer system 922, corresponding to a user interface 904 corresponding to a video game user interface concurrently displayed at second computer system 922. In some embodiments, computer system 922 streams information and/or displays one or more user interfaces that are reproduced by computer system 101, such as the user interface 904 included in virtual object 902 in FIG. 9A. In this way, the virtual window corresponding to virtual object 902 is optionally a virtual display for computer system 922. It is understood that such a user interface is merely exemplary, and that other user interface are optionally shared and/or displayed by computer system 101 such as a virtual modelling user interface and/or a content editing user interface.

In FIG. 9A, virtual object 902 includes a plurality of selectable options. For example, virtual object 902 in FIG. 9A includes selectable option 906, selectable option 908, and selectable option 912. In some embodiments, selectable option 906, selectable option 908, and selectable option 912 are respectively selectable to perform one or more operations associated with the selected selectable option. As described at least with reference to method 1000, a selectable option being “selectable” optionally corresponds to embodiments in which computer system 101 detects input directed to the selectable option, and in response, performs one or more operations corresponding to the selectable option. For example, the computer system 101 detects an air tap, an air pinch, attention (e.g., based on gaze and/or a focus selector position such as a cursor), a voice command, and/or selection of a physical button on a controller directed to the selectable option, and in response, initiates display of a menu, plays back content, initiates movement of the virtual object, and/or performs some other operation related to the selected selectable option.

In FIG. 9A, selectable option 906 is included in user interface 904 for the video game. In particular, selectable option 906 is selectable to initiate a new save file for the video game. In FIG. 9A, selectable option 908 is selectable to select and/or load a save file stored in memory (e.g., at computer system 922). In FIG. 9A, selectable option 912 is selectable to display three-dimensional content (e.g., as described with reference to method 1000) in three-dimensional environment 900. In FIG. 9A, focus selector 910 is displayed overlaying and/or corresponding to selectable option 912 when computer system 101 detects the tapping of hand 920 on trackpad 918, or receives an indication of the detected tapping from trackpad 918.

In some embodiments, computer system 101 displays one or more controls for managing a position and/or configuration of virtual object 902 as shown in FIG. 9A. For example, selectable option 914 is selectable to initiate movement of the virtual object 902. Additionally or alternatively, selectable option 916 is selectable to cease display of virtual object 902. In some embodiments, as the position and/or orientation of virtual object 902 changes, computer system 101 changes the position of selectable option 914 and selectable option 916 to maintain a spatial relationship (e.g., a position, orientation, and/or size) between virtual object 902, selectable option 914, and selectable option 916.

In FIG. 9B, computer system 101 displays a collection of selectable options associated with display three-dimensional content. For example, in response to detecting the input including the tapping of hand 920 on trackpad 918 as shown in FIG. 9A, computer system 101 display menu 924 as shown in FIG. 9B. In some embodiments, menu 924 is associated with (e.g., solely controlled by) computer system 101 and not by computer system 922. For example, computer system 922 does not display (e.g., forgoes display) of menu 924 in response to the trackpad input directed from computer system 922.

Menu 924 includes a plurality of selectable options, such as selectable option 928, selectable option 930, and selectable option 932. In some embodiments, selectable option 928 is selectable to display three-dimensional content corresponding to the video game user interface 904 in three-dimensional environment 900 concurrently with virtual object 902. In some embodiments, selectable option 930 is selectable to display three-dimensional content corresponding to the video game user interface 904 in three-dimensional environment 900 and to cease display of virtual object 902. In some embodiments, selectable option 932 is selectable to forgo display of the three-dimensional content and/or maintain display of virtual object 902. As shown in the overhead view of three-dimensional environment 900, menu 924 is displayed closer to the viewpoint of user 926 than the virtual object 902.

In FIG. 9B, a plurality of different possible positions of a focus selector are depicted. For example, focus selector 910a is positioned corresponding to selectable option 928, focus selector 910b is positioned corresponding to selectable option 930, and focus selector 910c is positioned corresponding to selectable option 932. It is understood that focus selectors 910a through 910c are optionally alternatives, and that a single focus selector of focus selectors 910a through 910c is optionally displayed while the other focus selectors are not displayed. In response to detecting tapping of hand 920 on trackpad 918 as shown in FIG. 9B, computer system 101 optionally initiates one or more operations corresponding to the particular selectable option of selectable options 928 through 932 that the focus selector (e.g., one or focus selectors 910a through 910c) is overlaying. FIG. 9C, for example, corresponds to the computer system 101 detecting the trackpad input while focus selector 910a is displayed overlaying selectable option 928. Additionally, in response to detecting the tapping of hand 920 on trackpad 918 while focus selector 910b is displayed as shown in FIG. 9B, computer system 101 optionally displays the three-dimensional content described below, such as shown in FIG. 9I. Additionally, in response to detecting the tapping of hand 920 on trackpad 918 while focus selector 910c is displayed as shown in FIG. 9B, computer system 101 optionally forgoes display of the three-dimensional content described herein, and/or optionally displays the virtual object 902 as shown in FIG. 9A. In some embodiments, regardless of which of the focus selectors 910a through 910c shown in FIG. 9B is displayed, computer system 101 ceases display of menu 924 in response to detecting the input shown in FIG. 9B.

Turning back to FIG. 9C, computer system 101 displays three-dimensional content concurrently with a virtual monitor. For example, in response to detecting the input shown in FIG. 9B, computer system 101 displays three-dimensional content 936 concurrently with virtual object 902 as shown in FIG. 9C. In FIG. 9C, virtual object 902 retains some or all of the content illustrated in previous figures, such as the “Load” selectable option 940 and “New” selectable option 942. In FIG. 9C, computer system 101 displays virtual object 902 with a size that is reduced from the virtual object 902 shown in FIG. 9B. In some embodiments, computer system 101 additionally moves virtual object 902 in response to the input described with reference to FIG. 9B to 9C, such as moving virtual object 902 in a depth direction, a vertical direction, and/or a perceived lateral direction relative to the viewpoint of user 926.

Three-dimensional content 936 optionally corresponds to virtual content displayed occupying three dimensions in three-dimensional environment, as indicated by the content 936 occupying space in a depth direction in the overhead view of three-dimensional environment 900 and the perceived vertical and/or lateral directions of three-dimensional environment 900 displayed via display generation component 120. In FIG. 9C, three-dimensional environment content 936 is optionally a splash screen for the video game corresponding to user interface 904 described with reference to FIG. 9A. In FIG. 9C, three-dimensional content 936 includes a title for the video game and an avatar that user 926 is able to control while playing the video game.

As described further with reference to method 1000, immersion includes the degree to which virtual content consumes portions of the three-dimensional environment 900. For example, as shown in FIG. 9C, physical portions of the three-dimensional environment 900 that would otherwise be presented via display generation component 120 absent the three-dimensional content 936 are not visible, due to the display of the three-dimensional content 936 overlaying the physical portions of three-dimensional environment 900.

In some embodiments, three-dimensional environment content 936 is constrained to the dimensions of an immersion portal 934. In some embodiments, the immersion portal 934 corresponds to a volumetric section of three-dimensional environment 900 (e.g., defined by a projection of one or more rays from computer system 101 into three-dimensional environment 900), as though user 926 is able to peer, via a fictious portal, into a physical equivalent of a world corresponding to three-dimensional content 936.

In some embodiments, the level of immersion of the immersion portal 934 defines the extent to which three-dimensional content 936 occupies three-dimensional environment 900 (e.g., fills the space of three-dimensional environment 900 with respect to the viewpoint of the user). For example, in accordance with a determination that the level of immersion is a first level of immersion, three-dimensional content 936 is displayed occupying a first range of angles relative to the viewpoint of user 926. In accordance with a determination that the level of immersion is a second, different level of immersion, three-dimensional content 936 is displayed occupying a second range of angles relative to the viewpoint of user 926, different from the first range of angles (e.g., wider, taller, narrower, and/or a shorter portal).

In FIG. 9C, computer system 101 detects input directed to controller 944 and/or detects and indication of such an input from controller 944. For example, in FIG. 9C, the input corresponds to movement of a joystick in a downward direction. In response to detecting the input in FIG. 9C, computer system 101 moves the focus selector from selectable option 940 to selectable option 942, as shown in FIG. 9D. In FIG. 9D, computer system 101 detects selection input directed to controller 944 such as pressing of a button and/or detects an indication of such an input from controller 944.

In FIG. 9E, computer system 101 displays an avatar 948 that user 926 is able to edit. In response, for example, to detecting the selection input in FIG. 9D, computer system 101 optionally transmits an indication of the selection input to computer system 922. Computer system 922, which optionally is hosting and/or streaming the video game, receives the indication of the selection input, and selects the “New” selectable option, initiating display of a character creation user interface at computer system 922. Additionally or alternatively, computer system 922 optionally transmits an updated view of the video game user interface to computer system 101, such that as shown in FIG. 9E, computer system 101 displays the avatar 948 which is optionally displayed concurrently at computer system 922.

Additionally or alternatively, computer system 101 updates virtual object 902 to include menu 946 as shown in FIG. 9E (e.g., in response to detecting the input described with reference to FIG. 9D). In some embodiments, the menu 946 is displayed concurrently at second computer system 922. In this way, computer system 101 can detect requests and/or inputs directed to the user interface(s) included in virtual object 902, which cause computer system 101 and/or computer system 922 to modify display of three-dimensional content 936 and/or corresponding content displayed at computer system 922. Additionally or alternatively, computer system 922 and/or computer system 101 are optionally able to automatically update display of content displayed at a respective computer system without detecting input from an input device in direct communication with the respective computer system (e.g., by receiving an indication of such an input and/or a command or request to update displayed content from the other computer system).

In FIG. 9F, computer system 101 detects an input directed to the three-dimensional content. For example, in FIG. 9F, computer system 101 detects an air pinch gesture formed by hand 920 while attention 950 is directed to three-dimensional content 936. In some embodiments, in response to detecting input directed to three-dimensional content 936 and/or immersion portal 934, computer system 101 displays one or more controls associated with the three-dimensional content 936. For example, computer system 101 displays controls 952 in FIG. 9G in response to detecting the input shown in FIG. 9F.

In FIG. 9G, computer system 101 displays controls for the three-dimensional content 936, as shown in the overhead view of three-dimensional environment 900 in front of immersion portal 934 relative to the viewpoint of user 926. For example, controls 952 in 9G include a plurality of selectable options (e.g., corresponding to a plurality of controls). For example, controls 952 include selectable option 952a, which is a selectable option that is selectable to cease display of three-dimensional content. Additionally or alternatively, controls 952 include selectable option 952b, which is a selectable option that is selectable to display one or more settings for three-dimensional content 936, such as changing the dimensions of immersion portal 934 and/or displaying a brightness of three-dimensional content 936. Additionally or alternatively, controls 952 include selectable option 952c, which is a selectable option that is selectable to display one or more audio related controls, such as a volume slider, a volume knob, a volume level selector, and/or some other type of audio control such as an audio language selector. In FIG. 9G, computer system 101 detects attention 950 directed to selectable option 952a while hand 920 forms an air pinch, corresponding to a selection input directed to selectable option 952a. In response to detecting the selection input in FIG. 9G, computer system 101 ceases display of the three-dimensional content 936.

In FIG. 9H, computer system 101 displays the virtual object 902, corresponding to a virtual window as described above. As described above with reference to FIG. 9G, computer system 101 optionally displays the virtual object 902 as shown in FIG. 9H in response to detecting the input shown in FIG. 9G (e.g., enlarging and/or moving the virtual object 938 from FIG. 9G in three-dimensional environment 900, turning into virtual object 902 in FIG. 9H). Additionally, from FIG. 9G to FIG. 9H, computer system 101 ceases display of immersion portal 934 and three-dimensional content 936 in response to detecting the input shown in FIG. 9G. In this way, the input shown in FIG. 9G causes computer system 101 to cease display of three-dimensional content, pushing the contents from three-dimensional content (e.g., avatar 948 in FIG. 9G) back into the virtual window corresponding to virtual object 902.

In FIG. 9I, computer system 101 displays three-dimensional content 936 within immersion portal 934. For example, as described above, computer system 101 optionally displays the three-dimensional content 936 as shown in FIG. 9I in response to detecting the tapping of hand 920 on trackpad 918 while focus selector 910b is displayed as shown in FIG. 9B. Because the selectable option in FIG. 9B that is selected optionally corresponds to a request to display three-dimensional content without a virtual monitor, computer system 101 displays the three-dimensional content 936 and forgoes display of the virtual monitor (e.g., virtual object 902 from FIG. 9B).

FIGS. 9J through 90 illustrate computer system 101 facilitating interaction with a user interface and three-dimensional content and updating of the user interface and/or the three-dimensional content based on the interaction. For example, computer system 101 is able to stream information to interact with a virtual model that is displayed at computer system. In some embodiments, the virtual model is displayed based on information streamed from another computer, different from computer system 101, that is running an application such as a modelling application for the virtual model.

FIG. 9J illustrates computer system 101, which is displaying virtual object 902 concurrently while displaying three-dimensional content 960. As described with reference to methods 800 and/or 1000, computer system 101 displays three-dimensional content 960 based on information from another computer system (e.g., computer system 922 as shown in FIG. 9A). Three-dimensional content 960 is a volumetric virtual object, and in particular, is a model of a virtual pencil. Model 958, included in virtual object 902, illustrates the view of the pencil object as presented at the other computer system. In this way, model 958 and virtual object 902 present to the user of computer system 101 the view of a two-dimensional display corresponding to the other computer system described above. In FIG. 9J, virtual object 902 includes a plurality of selectable options corresponding to different tools that are available for application to model 958, such as selectable option 956a corresponding to a color or pattern filling tool, selectable option 956b corresponding to a tool for cutting model 958 into different pieces, and selectable option 956c corresponding to a tool for moving model 958 throughout the user interface within which model 958 is displayed.

In some embodiments, computer system 101 displays one or more visual indications to indicate how requests directed to the virtual monitor (e.g., virtual object 902) potentially will impact three-dimensional content 960. For example, computer system 101 in FIG. 9J displays cursor 962, which corresponds to a cursor for interacting with the model 958. In some embodiments, cursor 962 is displayed and/or moved based on inputs directed to the computer system that is streaming information for model 958 to computer system 101 (and not based on trackpad 918 in communication with computer system 101). To indicate the position of the cursor 962 relative to model 958, computer system 101 displays the cursor 964 overlaying three-dimensional content 960. The position and/or orientation of cursor 964 relative to three-dimensional content 960 in FIG. 9J is synchronized with the position of cursor 962 relative to model 958, and in this way, computer system 101 how requests directed to the user interface in virtual object 902 will potentially impact three-dimensional content 960.

In FIG. 9J, computer system 101 detects input including hand 920 tapping trackpad 918 while cursor 962 is directed to model 958 (e.g., input selecting model 958). In response to the input shown in FIG. 9J, computer system 101 optionally applies the fill tool to model 958. Accordingly, computer system 101 updates the fill pattern of model 958 as indicated by the hatching of model 958 in FIG. 9K. Concurrently, computer system 101 updates three-dimensional content 960 to include the same fill pattern as model 958, as indicated by the same fill pattern in FIG. 9K. As described with reference to method 1000, computer system 101 optionally detects the input shown in FIG. 9J, and in response, transmits an indication of the input to the computer system that is streaming information to display model 958 and/or three-dimensional content 960. In response to receiving the indication, the other computer system optionally applies one or more manipulations or interactions based on the indication (e.g., applying a fill pattern) and transmits information back to computer system 101 to cause computer system to update model 958 and three-dimensional content 960.

In FIG. 9L, computer system 101 detects hand 920 and hand 972 interacting with three-dimensional content 960. In FIG. 9L, computer system 101 displays visual indications in virtual object 902 to indicate where the hands of the user are interacting with three-dimensional content 960, as reflected by cursor 970a (e.g., an upper, left side of model 958 indicative of the interaction from hand 920) and as reflected by cursor 970b (e.g., a lower, right side of model 958 indicative of the interaction from hand 972).

From FIG. 9L to FIG. 9M, computer system 101 detects movement of hand 920 and hand 972. In response to detecting the movement (and additional or alternative input specifying the severing of three-dimensional content 960), computer system 101 separates three-dimensional content 960 (from FIG. 9L) into portion 974a and portion 974b. In FIG. 9M, in response to detecting the interaction by hand 920 and hand 972, computer system 101 also displays a severing of model 958 from FIG. 9L into portion 958a and portion 958b at virtual object 902 in FIG. 9M.

In FIG. 9N computer system 101 detects hand 920 form an air pinch gesture while the index finger and thumb are virtually grasping first portion 974a of the three-dimensional content (e.g., the three-dimensional pencil). Concurrently, computer system 101 displays cursor 970b to indicate the presence of the air pinch relative to the model of the pencil in virtual object 902. From FIG. 9N to FIG. 9O, computer system 101 detects a rotating of hand 920, and in response, rotates the three-dimensional content corresponding to the virtual pencil. For example, computer system 101 changes the portion 974a and portion 974b from the orientations FIG. 9M to the orientations in FIG. 9O by amounts that are based on, or the same as the rotation of hand 920 from FIG. 9N to FIG. 9O. Because the rotating of the portion 974a and portion 974b are directed to the three-dimensional model of the virtual pencil (and not directed to the two-dimensional equivalent displayed in the virtual object 902), computer system 101 forgoes the rotation of portions 958a and 958b. In this way, some interactions with three-dimensional content are not reflected in the equivalent model displayed in a virtual model, as described with reference to methods 800 and/or 1000.

FIG. 10 is a flowchart illustrating a method 1000 in which a computer system displays virtual windows and three-dimensional content, in accordance with some embodiments. In some embodiments, the method 1000 is performed at a computer system (e.g., computer system 101 in FIG. 1A such as a tablet, smartphone, wearable computer, or head-mounted device) including a display generation component (e.g., display generation component 120 in FIGS. 1, 3, and 4) (e.g., a heads-up display, a display, a touchscreen, and/or a projector) and one or more cameras (e.g., a camera (e.g., color sensors, infrared sensors, and other depth-sensing cameras) that points downward at a user's hand or a camera that points forward from the user's head). In some embodiments, the method 1000 is governed by instructions that are stored in a non-transitory computer-readable storage medium and that are executed by one or more processors of a computer system, such as the one or more processors 202 of computer system 101 (e.g., control unit 110 in FIG. 1A). Some operations in method 1000 are, optionally, combined and/or the order of some operations is, optionally, changed.

The devices, methods, and/or computer-readable storage mediums described below enhance the operability of the device and makes the user-device interface more efficient (e.g., by helping the user to provide proper inputs and reducing user mistakes when operating/interacting with the device) which, additionally, reduces power usage and/or improves battery life of the device by enabling the user to use the device more quickly and efficiently. Displaying user interface elements (such as by the three-dimensional content in the three-dimensional environment in addition to or in the alternative to in a virtual window, as described below) with different appearances at different times helps to avoid image persistence or burn in effects that can occur with some display technologies when the same object is displayed with the same appearance at the same location repeatedly or for a long period of time and can facilitate additional levels of detail of inspection of and/or interaction with such user interface elements. Performing an operation when a set of conditions has been met without requiring further user input (such as by displaying and/or ceasing display of three-dimensional content and/or a virtual window) enhances the operability of the device by reducing unnecessary inputs and/or steps to navigate through different user interfaces or sets of controls, reducing energy usage by the device and prolonging battery life of the device. Displaying user interface elements (such as by displaying three-dimensional content in an immersion portal) with different appearances at different times helps to avoid image persistence or burn in effects that can occur with some display technologies when the same object is displayed with the same appearance at the same location repeatedly or for a long period of time. Reducing the number of inputs needed to perform an operation (such as by detecting requests directed to user interface and performing operations based on such requests) enhances the operability of the device by reducing the number of inputs and time required to perform a particular operation, reducing energy usage by the device and prolonging battery life of the device.

In some embodiments, a first computer system in communication with one or more input devices and one or more display generation components performs a method 1000, such as computer system 101 in communication with one or more internal image sensors 114a, external image sensors 114b and 114c, and/or display generation component 120. For example, the first computer system optionally has one or more characteristics similar to, the same as, and/or that correspond to one or more characteristics of the first computer system, the second computer system, and/or additional or alternative computer systems described with reference to methods 800 and/or 1200. In some embodiments, the one or more input devices and/or the one or more display generation components have one or more characteristics similar to, the same as, and/or that correspond to one or more characteristics of the one or more input devices and/or the one or more display generation components described with reference to methods 800 and/or 1200.

In some embodiments, the first computer system displays (1002), via the one or more display generation components, a virtual window in a three-dimensional environment, such as virtual object 902 as shown in FIG. 9A. In some embodiments, the virtual window corresponds to a second computer system that is different from the first computer system (1004), such as second computer system 922 as shown in FIG. 9A. In some embodiments, the second computer system is in communication with the first computer system (1006), such as the communication between computer system 101 and computer system 922 as shown in FIG. 9A to facilitate display of the contents of virtual object 902.

In some embodiments, while displaying the virtual window in the three-dimensional environment, the first computer system detects (1008), via one or more input devices that are in communication with the first computer system or the second computer system, a sequence of one or more inputs that correspond to a first request directed to a first user interface included in the virtual window to display three-dimensional content associated with the first user interface in the three-dimensional environment, such as input including hand 920 tapping on trackpad 918 as shown in FIG. 9A. For example, the virtual window optionally corresponds to a user interface that is displayed on and/or is received from the second computer system, similarly to or the same as described with reference to method 800. In some embodiments, the three-dimensional environment has one or more characteristics similar to, the same as, and/or that correspond to one or more characteristics of the three-dimensional environment(s) described with reference to method 800. In some embodiments, the virtual window is a virtual monitor (e.g., and/or a virtual display generation component) for the second computer system. In some embodiments, the virtual window includes content that is displayed, controlled, and/or defined by the second computer system. In some embodiments, the second computer system displays content corresponding to what is displayed in the virtual window. In some embodiments, the second computer system at least temporarily does not display (e.g., forgoes display) of the content corresponding to what is displayed in the virtual window. For example, the second computer system optionally does not display content via a physical screen or physical projector. In some embodiments, the virtual window corresponds to a user interface that is the same as and/or is based on a user interface displayed at the second computer system via one or more display generation components that are different from the one or more display generation components. Additionally or alternatively, the virtual window corresponds to a plurality of user interfaces displayed at the second computer system. For example, the virtual window optionally includes an operating system user interface including wallpaper media, a system tray, notifications, and/or icons for applications and optionally further includes one or more user interfaces overlaying portions of the operating system user interface. The overlaying user interfaces, for example, optionally include an internet browsing user interface, a content creation user interface for two-dimensional or three-dimensional models and/or media, and/or a shopping application including pictures, media, and/or graphics depicting prospective purchases. Concurrently, the second computer system optionally displays the same operating system user interface and/or the same one or more overlaying user interfaces. In some embodiments, the position, size, and/or orientation of content is synchronized and/or is the same between the virtual window and the user interfaces displayed by the second computer system relative to dimensions of the virtual window and/or dimensions of the one or more display generation components. For example, the aspect ratio of the virtual window is optionally the same as an aspect ratio of the one or more display generation components. In some embodiments, the aspect ratios of the virtual window and the one or more display generation components are different, and the first computer system displays content that is synchronized between the virtual window and displays the second computer system with a spatial arrangement that is similar to, the same as, and/or based on the spatial arrangement presented via the second computer system. Additionally or alternatively, in accordance with a determination that an overlaying user interface displayed via the second computer system corresponds to a first position, size, and/or orientation having a first spatial arrangement relative to the one or more generation components, the first computer system optionally displays an analogous or same user interface at a second position, size, and/or orientation (e.g., based on and/or the same as the first position size and/or orientation) relative to the virtual window having the first spatial arrangement of the virtual window.

In some embodiments, detecting the first request directed to the first user interface included in the virtual window includes detecting an indication of an input directed to a second user interface, that corresponds to (e.g., is similar to, the same as, and/or is the basis for) the first user interface, that is received from the second computer system in response to the second computer system detecting the input, such as an input that would be directed to second computer system 922 in FIG. 9A. In some embodiments, the first computer system detects user input corresponding to the first request directed to the virtual window (e.g., a sequence of one or more inputs), and in response, performs one or more operations in accordance with the user input and/or communicates an indication of the user input to the second computer system. In response to receiving the indication of the user input, the second computer system optionally performs one or more operations based on the user input, as described further below. It is understood that description of the first request, a second request, and additional or alternative request optionally includes a sequence of one or more inputs described herein. In some embodiments, the first request corresponds to interaction with the second user interface, such as a sequence of one or more inputs including touching of a trackpad or non-touch sensitive surface, selection of one or more buttons, a voice command, typing of text, drawings of text, and/or one or more air gestures (e.g., one or more inputs as described with reference to methods 800 and/or 1200, directed to the second user interface and/or detected by the second computer system). In some embodiments, detecting the first request includes not detecting an input directed to the first computer system. For example, the first request optionally corresponds to an input directed to the second computer system as described above. In such an example, the first computer system optionally performs operations, such as described below, without detecting intervening input that otherwise requests display of the virtual content. Additionally or alternatively, the first request optionally includes input directed to an input device in communication with the first computer system but not the second computer system, an input device in communication with the second computer system but not the first computer system, and/or an input device in communication with the first computer system and the second computer system. For example, the request optionally includes contacting of a trackpad, movement of a joystick, pressing of one or more keys on a keyboard, squeezing of a housing of an input device, turning of one or more rotational components like a mouse wheel, and/or some combination thereof. The first request optionally includes the input directed to the input device that is wirelessly or directly connected to the second computer system (e.g., but not the first computer system, or vice-versa).

In some embodiments, the virtual window from the second computer system corresponds to a virtual instance of the second computer system, such as virtual object 902 as shown in FIG. 9A. For example, the second computer system optionally initiates the virtual instance of the second computer system, and communicates one or more indications and/or information about the virtual instance with the first computer system, such that the second computer system controls and/or directs, via data transmitted by the second computer system to the first computer system, the display of the virtual instance, including the content displayed with and/or included within the virtual instance. Alternatively, in some embodiments, the first computer system initiates the virtual instance of the second computer system. The first computer system is optionally authorized to display, interact with, and/or modify the virtual instance of the second computer system. For example, data accessible on the second computer system is optionally accessible on the first computer system via the virtual instance of the second computer system displayed via the one or more display generation components of the first computer system.

In some embodiments, the second computer system is a remotely controlled computer system by the first computer system. For example, the first computer system is optionally able to access the data, functionalities, and/or network of the second computer system. Interaction with the second computer system optionally includes interaction with the virtual instance of the second computer system (e.g., detected by the first computer system) that causes the second computer system to perform one or more actions in response to receiving an indication of the interaction from the first computer system. In some embodiments, in response to detecting selection and/or interaction with the representation of content from the second computer system displayed via the one or more display generation components of the first computer system, the first computer system transmits data indicative of the selection and/or interaction to the second computer system. The second computer system, in response to receiving and/or processing the data transmitted by the first computer system, optionally responds as if the selection and/or interaction happened at the second computer system. Such response optionally includes the second computer system transmitting, to the first computer system, instructions for updating display of the representation of content from the second computer system on the first computer system in response to the interaction.

In some embodiments, in response to detecting the sequence of one or more inputs that correspond to the first request, the first computer system displays (1010), via the one or more display generation components in communication with the first computer system, the three-dimensional content associated with the first user interface in the three-dimensional environment, such as three-dimensional content 936 as shown in FIG. 9C. For example, the first computer system optionally displays a volumetric virtual object in the three-dimensional environment, similar to, the same as, and/or corresponding to as described with reference to method 800. In some embodiments, the three-dimensional content is not displayed by the first computer system prior to detecting the first request. In some embodiments, the three-dimensional content is not stored at the first computer system. For example, the second computer system optionally generates one or more indications and/or parameters that dictate display of the virtual content and optionally transmits the indications and/or parameters to the first computer system. In response to receiving the indications and/or the parameters, the first computer system optionally displays the virtual content based on the indications and/or parameters, optionally without storing the indications and/or parameters. In some embodiments, files dictating the indications and/or parameters are stored at the second computer system and/or are not stored at the first computer system. In some embodiments, a size of the three-dimensional content relative to the three-dimensional environment is different from, is independent of, and/or is the same as a size of a representation (e.g., a two-dimensional image or three-dimensional model) displayed via the second computer system and/or in the virtual window. For example, the first computer system optionally displays a volumetric model of a three-dimensional object with a first size that is concurrently displayed with a corresponding model of the three-dimensional object having a second size in the three-dimensional environment displayed in the virtual window and/or at the second computer system (e.g., the size being greater than, less than, or the same as the first size). In some embodiments, the first computer system displays a plurality of three-dimensional content concurrently, each of which corresponds to content included in the virtual window and/or performs one or more operations described with reference to the three-dimensional content above in accordance with requests directed to the user interface.

In some embodiments, the first computer system is able to display portions of the three-dimensional content that are not displayed at the second computer system and/or in the virtual window and/or are not able to be displayed at the second computer system and/or in the virtual window. For example, while displaying the virtual window including a first view of a model and while displaying the three-dimensional content at a position in the three-dimensional environment which corresponds to the model, the first computer system optionally detects a change in viewpoint of the user of the first computer system. In response to detecting the change in viewpoint, such as including a rotation of the viewpoint around the three-dimensional content while facing the three-dimensional content, the first computer system optionally displays new surfaces and/or portions of the three-dimensional content that were not displayed prior to detecting the change in viewpoint (e.g., while maintaining the position of the three-dimensional content in the three-dimensional environment). Concurrently, the first computer system and/or the second computer system optionally maintain display of the first view of the model (e.g., forgoing rotating of the model). In this way, the first computer system is optionally able to present aspects of three-dimensional content that are typically not visible in the virtual window and/or at the second computer system without requesting rotation of a model displayed in the virtual window and/or at the second computer system.

In some embodiments, the three-dimensional content is displayed concurrently with the virtual monitor in response to detecting the first request, such as three-dimensional content 936 displayed concurrently with virtual object 902 as shown in FIG. 9C. For example, the first computer system optionally displays the three-dimensional content and the virtual monitor at the same time in the three-dimensional environment. In some embodiments, the first computer system maintains the concurrent display of the three-dimensional content and the virtual monitor at least temporarily until one or more inputs are detected requesting ceasing display of the three-dimensional content and/or the virtual monitor, as described in greater detail below. In some embodiments, displaying the three-dimensional content and the virtual monitor concurrently includes synchronizing opacity of the three-dimensional content and the virtual monitor. For example, in response to detecting an event associated with changing opacity of the three-dimensional content and/or the virtual window, and in accordance with a determination that the three-dimensional content (and/or the virtual monitor) is to be displayed with a first level of opacity, the first computer system optionally displays the virtual monitor (and/or the three-dimensional content) with the first level of opacity. In response to detecting an event associated with changing opacity of the three-dimensional content and/or the virtual window, and in accordance with a determination that the three-dimensional content (and/or the virtual monitor) is to be displayed with a second level of opacity, different from the first level of opacity, the first computer system optionally displays the virtual monitor (and/or the three-dimensional content) with the second level of opacity. In some embodiments, the first computer system changes one or more values of one or more visual characteristics concurrently and/or in succession in a manner that is the same as or is based on the manner of change of the level of opacity described above. In some embodiments, the one or more visual characteristics include brightness, a level of a blurring effect, saturation, and/or contrast.

In some embodiments, prior to displaying the three-dimensional content in the three-dimensional environment, the virtual window is displayed with a first spatial arrangement relative to the three-dimensional environment (and/or relative to a viewpoint of the user of the first computer system), such as the spatial arrangement between virtual object 902 and the viewpoint of user 926 as shown in FIG. 9A. For example, a spatial arrangement optionally includes a position and/or orientation of a virtual object in the three-dimensional environment relative to a viewpoint that the first computer system is within. Additionally or alternatively, the spatial arrangement optionally includes a position and/or orientation of the virtual object relative to the viewpoint of the user of the first computer system. In some embodiments, before the first request is detected and/or when the first request is detected, the virtual window has the first spatial arrangement relative to the three-dimensional environment and/or the viewpoint of the user of the first computer system. For example, the virtual window is displayed at a first position and/or with a first orientation in the three-dimensional environment.

In some embodiments, displaying the three-dimensional content associated with the first user interface in the three-dimensional environment includes displaying the virtual window with a second spatial arrangement, different from the first spatial arrangement, relative to the three-dimensional environment (and/or relative to the viewpoint of the user of the first computer system), such as the spatial arrangement between virtual object 902 and the viewpoint of user 926 as shown in FIG. 9C. For example, in response to detecting the first request as described herein and/or without detecting input at the first computer system, the first computer system optionally ceases display of the virtual window at the first position and/or with the first orientation and/or displays the virtual window at a second position, different from the first position, and/or with a second orientation, different from the first orientation, in the three-dimensional environment. In some embodiments, the viewpoint of the user relative to the three-dimensional environment is maintained while the first requested is detected and/or while the virtual window changes from being displayed with the first spatial arrangement to being displayed with the second spatial arrangement (e.g., the first computer system displays the virtual window without detecting a change in the viewpoint of the user). In this way, the first computer system optionally rearranges the position and/or orientation of the virtual window to visually accommodate the three-dimensional content, facilitating concurrent visibility and/or interaction with the three-dimensional content and the virtual window.

In some embodiments, the ceasing and/or displaying includes a gradual or instantaneous decreasing in opacity of the virtual window displayed with the first spatial arrangement and/or a gradual or increasing in opacity of the virtual window with the second spatial arrangement. In some embodiments, the ceasing and/or displaying includes an animating of the virtual window moving from having the first spatial arrangement to having the second spatial arrangement (e.g., without ceasing display and/or decreasing opacity of the virtual window). Some embodiments described herein reference displaying the virtual window and/or the three-dimensional content with a spatial arrangement that is defined relative to the three-dimensional environment; it is understood that the spatial arrangement is optionally defined relative to the viewpoint of the user. For example, the first position and/or orientation are optionally defined as a distance and/or one or more angles of orientation of the virtual window relative to where the viewpoint of the user is oriented when the first request is detected. Similarly, the second position and/or orientation are optionally defined as a different distance and/or one or more angles of orientation of the virtual window relative to where the viewpoint of the user is located.

In some embodiments, displaying the three-dimensional content associated with the first user interface in the three-dimensional environment includes ceasing display of the virtual window, such as three-dimensional content 936 displayed in FIG. 9I without virtual object 902 (e.g., shown in FIG. 9A). For example, the first computer system optionally maintains display of the three-dimensional content and ceases display of the virtual window in response to detecting the first request. In some embodiments, the ceasing of display includes a gradual or instantaneous decrease in opacity of the virtual window (e.g. until the virtual window is no longer visible/displayed and/or over a period of time (e.g., 0.1, 0.5, 1, 2, 3, 5, or 10 seconds)), as described above with reference to displaying the virtual object with the first spatial arrangement and/or the second spatial arrangement. It is understood that embodiments described further below which include ceasing display of the virtual window and/or the three-dimensional content and/or displaying the virtual window and/or the three-dimensional content optionally are based on the embodiments described above with reference to displaying the virtual object with the first spatial arrangement and/or the second spatial arrangement (e.g., include gradually or instantaneously increasing and/or decreasing opacity). In some embodiments, after ceasing display of the virtual window and until an additional request is detected, the first computer system continues to forgo display of the virtual window. In some embodiments, in response to detecting the first request, the second computer system continues to display a user interface that corresponds to the virtual window and/or the three-dimensional content that is displayed prior to detecting the first request. For example, the second computer system continues to display a content editing user interface and/or a video user interface while the first computer forgoes display of the virtual window that includes the same user interface.

In some embodiments, while displaying the three-dimensional content in the three-dimensional environment, and while the virtual window is not displayed (e.g., as described herein with respect to automatically ceasing display of the virtual window when the three-dimensional content is displayed), the first computer system detects, via one or more input devices that are in communication with the first computer system or the second computer system, a sequence of one or more inputs that correspond to a second request to cease display of the three-dimensional content such as attention 950 detected by computer system 101 while hand 920 forms an air pinch gesture as shown in FIG. 9G. For example, the first computer system and/or the second computer system detect one or more inputs directed to the first user interface, directed to one or more controls displayed near the virtual window, a voice command, and/or an air gesture (e.g., including curling of one or more fingers, a waving of the one or more fingers, and/or a change in orientation of the one or more fingers). In some embodiments, the second request shares one or more characteristics with the first request described herein (e.g., includes a sequence of one or more inputs).

In some embodiments, in response to detecting the sequence of one or more inputs that correspond to the second request, the first computer system ceases display of the three-dimensional content, such as ceasing display of three-dimensional content from immersion portal 934 as shown in FIG. 9G. For example, in response to detecting the one or more inputs, the first computer system optionally hides or closes the three-dimensional content.

In some embodiments, in response to detecting the sequence of one or more inputs that correspond to the second request, displays, via the one or more display generation components, the virtual window in the three-dimensional environment, such as virtual object displayed in FIG. 9H in response to detecting the input shown in FIG. 9G. For example, the first computer system re-displays the virtual window. In some embodiments, the virtual window is re-displayed without detecting input at the first computer system, other than the second request. In some embodiments, the virtual window is re-displayed with a size that is the same as or is different from the size of the virtual window that existed before detecting the second request and/or when the first computer system ceased display of the virtual window. In some embodiments, the second computer system displays one or more user interfaces that correspond to the virtual window irrespective of whether the virtual window is displayed by the first computer system, as described above. In some embodiments, the second computer system maintains the size of the one or more user interfaces and/or user interface elements included in the one or more user interfaces in response to detecting an indication of the second request that is received from the first computer system or in response to detecting the second request via the second computer system. In some embodiments, the second computer system maintains the spatial relationship between the one or more user interfaces and/or user interface elements in response to detecting the indication of the second request from the first computer system and/or in response to detecting the second request at the first computer system.

In some embodiments, a spatial arrangement of the virtual window relative to three-dimensional environment (and/or a viewpoint of a user of the first computer system) before detecting the first request is a first spatial arrangement, such as the spatial arrangement between virtual object 902 and the viewpoint of user 926 as shown in FIG. 9A. For example, the first computer system displays the virtual window with a first size, position, and/or orientation in the three-dimensional environment when the first request is detected.

In some embodiments, the spatial arrangement of the virtual window relative to the three-dimensional environment (and/or a viewpoint of a user of the first computer system) in response to detecting the sequence of one or more inputs that correspond to the second request is the first spatial arrangement, such as maintaining the spatial arrangement between virtual object 902 and the viewpoint of user 926 as shown in FIG. 9A in response to detecting the input from hand 920 directed to trackpad 918 in FIGS. 9A and/or 9B. For example, the first computer system optionally displays the virtual window in response to detecting the second request at the first size, position, and/or orientation in the three-dimensional environment (e.g., with the same spatial arrangement that the virtual window had relative to the three-dimensional environment prior to the first request). In this way, the first computer system optionally stores the spatial relationship in memory and/or re-displays the virtual window to restore the spatial relationship based on the second request. Additionally or alternatively, the first spatial arrangement and/or the second spatial arrangement are defined relative to the viewpoint of the user. For example, the virtual window is displayed at a first size, position, and/or orientation relative to the viewpoint of the user when the first request is detected. In some embodiments, the first computer system detects the viewpoint of the user change or be maintained relative to the three-dimensional environment and detects the second request while the viewpoint is changed or maintained relative to when the first request was detected. In some embodiments, the first computer system displays the virtual window having the first size, position, and/or orientation relative to the viewpoint of the user in response to detecting the second request, irrespective of whether the viewpoint of the user is different from when the first request was detected or is the same as when the first request was detected.

In some embodiments, while displaying the three-dimensional content, the first computer system detects, via the one or more input devices that are in communication with the first computer system or the second computer system, a sequence of one or more inputs that correspond to a second request to cease display of the three-dimensional content associated with the first user interface, such as input directed to a button included in computer system 101 causing display of a home user interface (e.g., that computer system is able display in three-dimensional environment 900) as shown in FIG. 9D. For example, the first computer system and/or the second computer system detect one or more inputs via one or more input devices in communication with the first computer system and/or the second computer system requesting closing or hiding of the three-dimensional content. In some embodiments, the second request corresponds to a sequence of one or more inputs described above, such as one or more air gestures, interactions with a trackpad, keyboard, and/or controller, and/or a voice command. For example, the second request optionally includes the first computer system detecting a pressing of a button (e.g., physical button on the first computer system or a virtual button that is part of a user interface). In some embodiments, in response to detecting the button being pressed, the first computer system displays a home user interface including a plurality of representation of applications that, when selected, cause the first computer system to display a user interface for the selected application. In some embodiments, the button, when rotated (e.g., as described below) changes a level of immersion of a three-dimensional environment and/or the three-dimensional content. In some embodiments, the second request includes selection of a button to cease display of the three-dimensional content, such as an air tapping on such a button. In some embodiments, the second request includes detecting an orientation of one or more portions of the body of the user of the first computer system assuming an air pose, such as a palm facing toward the first computer system and/or a splaying of fingers while the knuckles of a hand faces the first computer system. In some embodiments, the second request additionally includes detecting of an air gesture, such as an air pinch including contacting of a plurality of fingers after detecting the air pose. In some embodiments, the second request includes one or more inputs selecting and/or navigating an application user interface for an application that is different from a respective application associated with (e.g., used to display content in) the virtual window. In some embodiments, the second request includes detecting input selecting, hiding, and/or launching one or more application user interfaces and/or files at the second computer system and/or receiving an indication of such input at the first computer system. In some embodiments, the second request includes a turning of a button and/or another mechanical input changing a level of immersion of three-dimensional content (e.g., the degree to which virtual content consumes portions of the three-dimensional environment). For example, the second request optionally includes changing (e.g., reducing) the level of immersion of the three-dimensional content and/or other immersive-type content such as immersive virtual environments from a first level of immersion (e.g., 50, 60, 70, 80, 90, or 100% immersion) to a second level of immersion (0, 1, 2, 3, 5, or 10% immersion).

In some embodiments, in response to detecting the sequence of one or more inputs that correspond to the second request, ceases display of the three-dimensional content associated with the first user interface, such as ceasing display of three-dimensional content 936, as shown in FIG. 9C. For example, the first computer system optionally hides or closes the three-dimensional content and/or optionally maintains display (e.g., and/or ceases display) of the virtual window. In some embodiments, the ceasing of display includes a gradual or instantaneous decrease in opacity of the three-dimensional content (e.g. until the virtual window is no longer visible/displayed and/or over a period of time (e.g., 0.1, 0.5, 1, 2, 3, 5, or 10 seconds))

In some embodiments, the level of immersion includes the percentage of the viewport of the first computer system that is occupied by the immersive content and/or the length, width, and/or height where the immersive content consumes the three-dimensional environment. In some embodiments, the second request corresponds to a request to display content other than the virtual window and/or the three-dimensional content. In response to detecting the second request, the first computer system optionally displays a user interface corresponding to a system user interface including representations of applications stored at the first computer system. While displaying the representations of applications, the first computer system optionally detects one or more inputs selecting a representation, and optionally displays a user interface for the selected representation (e.g., a first user interface for a first application when the selection corresponds to a first representation or a second user interface for a second application when the selection corresponds to a second representation).

In some embodiments, while displaying the three-dimensional content associated with the first user interface in response to detecting the first request, the first computer system detects, via the one or more input devices in communication with the first computer system, a sequence of one or more inputs that correspond to a third request directed to the three-dimensional content to display one or more controls for controlling the three-dimensional content presented by the first computer system, such as detecting attention 950 and an air pinch formed by hand 920 directed to immersion portal 934 as shown in FIG. 9F. For example, while the three-dimensional content is displayed, the first computer system optionally detects a sequence of one or more inputs to display a user interface for one or more controls associated with content presented by the first computer system. In some embodiments, the one or more inputs include some or all of the inputs described above. For example, while displaying the respective first user interface, the first computer system optionally detects an air gesture such as an air pinch while attention is directed to the respective first user interface. In response to detecting the air gesture, the first computer system optionally displays a user interface including a plurality of selectable options that are individually selectable to display perform functions associated with the three-dimensional content. In some embodiments, the first computer system detects the one or more inputs directed to the three-dimensional content, and in response, displays the one or more controls.

In some embodiments, the user interface is a system user interface displayed by the first computer system. For example, the system user interface is separate from the three-dimensional content, is not displayed at the second computer system, is displayed within a user interface for an operating system for the first computer system, and/or is displayed at a position that is outside of where the three-dimensional content exists. Additionally or alternatively, the visual appearance of the one or more controls (e.g., fill pattern, text size, font, shape, and/or corner bevel) is optionally similar to or the same as other controls displayed by the first computer system included in the user interface for the operating system.

In some embodiments, in response to detecting the sequence of one or more inputs that correspond to the third request, the first computer system displays, via the one or more display generation components in communication with the first computer system, the one or more controls for controlling the three-dimensional content such as controls 952 as shown in FIG. 9G. For example, the user interface optionally includes selectable options for controlling presentation of content, such as music and/or other audio of a video game and/or content editing application, videos, live video, and/or some combination of such media. In some embodiments, the first computer system displays text and/or a graphic representative of a title of a video game corresponding to the three-dimensional content, a name of a file corresponding to the three-dimensional content, and/or a picture of artwork corresponding to the video game and/or the file.

In some embodiments, while displaying the one or more controls, the first computer system detects, via the one or more input devices in communication with the first computer system, a sequence of one or more inputs that correspond to a fourth request, different from the third request, directed to a first control included in the one or more controls, such as an input including attention 950 while hand 920 forms the air gesture directed to selectable option 952a, as shown in FIG. 9G. In some embodiments, in response to detecting the sequence of one or more inputs that correspond to the fourth request, the first computer system performs one or more operations associated with the first control, such as ceasing display of immersion portal 934 from as shown in FIG. 9G to the lack of the immersion portal as shown in FIG. 9H. In some embodiments, in response to detecting input such as an air gesture while attention is directed to an audio slider included in the user interface (e.g., the fourth request), the first computer system changes the level of the audio corresponding to the content in accordance with the input (e.g., decreasing the audio or increasing the audio based on a direction of the input and/or by an amount that is based on or the same as the distance of movement included in the input). In some embodiments, the one or more controls include a selectable option for ceasing display of the three-dimensional content in the three-dimensional environment and/or forgoing re-displaying of the three-dimensional environment if the three-dimensional content is temporarily hidden (e.g., based on the second request described above). For example, while displaying the selectable option and the three-dimensional content, the first computer system detects input directed to the selectable option (e.g., the fourth request), and in response, ceases display of the three-dimensional content and/or re-displays virtual window (e.g., if the virtual window was not displayed when the input was detected).

In some embodiments, in response to (e.g., after) detecting the sequence of one or more inputs that correspond to the second request, the first computer system maintains display, via the one or more display generation components, of the virtual monitor in the three-dimensional environment, such as computer system 101 maintaining display of virtual object 902 from as shown in FIG. 9B to as shown in FIG. 9C in response to detecting the input as shown in FIG. 9B. For example, in response to detecting and after detecting the second request, the first computer system optionally maintains display of the virtual monitor and/or ceases display of the three-dimensional content. In this way, the first computer system optionally hides or closes the three-dimensional content and displays the virtual monitor in response to detect the second request. In some embodiments, the virtual monitor represents a communication session that is active between the first computer system and the second computer system. Thus, the communication session optionally remains ongoing even if the three-dimensional content which is being shared via the communication session is not being displayed by the first computer system.

In some embodiments, in response to detecting the sequence of one or more inputs that correspond to the first request, the first computer system ceases display of the virtual window, such as ceasing display of virtual object 902 as shown in FIG. 9B. For example, in response to detecting and after detecting the first request, the first computer system optionally closes or hides the virtual monitor and/or displays the three-dimensional content in a manner similar to or based on the operations described herein.

In some embodiments, in response to detecting the sequence of one or more inputs that correspond to the second request, the first computer system displays, via the one or more display generation components, the virtual window, such as displaying virtual object as shown in FIG. 9H. For example, in response to detecting and/or after detecting the second request, the first computer system optionally re-displays the virtual monitor and/or ceases display of the three-dimensional content. In some embodiments, the virtual monitor is displayed with a spatial arrangement that matches the spatial arrangement of the virtual monitor that existed when the first request is detected, as described above with reference to the first spatial arrangement and/or the second spatial arrangement. In some embodiments, the ceasing display of the virtual window in response to the first request and/or the displaying of the virtual window in response to the second request are performed automatically, without detecting an input at the first computer system.

In some embodiments, displaying the three-dimensional content includes constraining the three-dimensional content to an immersion portal that controls a level of immersion of the three-dimensional content, such as immersion portal 934 as shown in FIG. 9C. In some embodiments, the three-dimensional content is any content displayed by the first computer system that does not exist in a physical environment of the user of the first computer system. In some embodiments, the portal (and thus the content within the portal) is moveable in the three-dimensional environment in response to movement input directed to it. In some embodiments, the portal is not moveable in the three-dimensional environment in response to movement input directed to it. In some embodiments, the three-dimensional content is constrained to the immersion portal, such that portions of the three-dimensional content that would correspond to positions in the three-dimensional environment beyond one or more edges of the immersion portal are not displayed (e.g., the first computer system forgoes display of such portions of the three-dimensional content).

In some embodiments, the portal is displayed within a representation of a physical environment of the user that is visible via the one or more display generation components of the first computer system in a three-dimensional environment. In some embodiments, the portal is displayed within a virtual environment that is optionally part of the three-dimensional environment. In some embodiments, the three-dimensional environment includes a virtual environment that is displayed within the three-dimensional environment, optionally instead of the representation of the physical environment (e.g., full immersion) or optionally concurrently with the representation of the physical environment (e.g., partial immersion). Some examples of a virtual environment include a lake environment, a mountain environment, a sunset scene, a sunrise scene, a nighttime environment, a grassland environment, a concert scene or another simulated physical space. In some embodiments, a virtual environment is based on a real physical location, such as a museum, and/or an aquarium. In some embodiments, a virtual environment is an artist-designed location.

In some embodiments the portal is a portal or view into the three-dimensional content (e.g., analogous to how a glass window in a building is a portal or view into the three-dimensional, physical world outside of the glass window), such as three-dimensional content as shown in FIG. 9C. As will be described in greater detail below, the size and/or shape of the portal optionally determines how much and/or which portion of the respective virtual content is visible and/or displayed through the portal. For example, when the respective virtual content is 180-degree content or 360-degree content, the available field of view of the respective virtual content is 180 or 360 degrees, and optionally only a portion of that available content is visible through the portal, such as an angular range less than 180-degrees or 360 degrees, such as 9, 15, 20, 45, 50, 60 degrees, 100 degrees, or another angular range less than 180-degrees or 360 degrees, or could be 180-degrees or 360 degrees. In some embodiments, the user can explore the extent of the available field of view of the content by moving the viewpoint of the user relative to the portal (e.g., moving and/or rotating the user's head and thus the display generation components, such as if the display generation components are part of a head-mounted AR/VR display system being worn on the user). For example, the first computer system optionally detects movement of the viewpoint of the user, and in response the first computer system optionally displays a different portion of the available field of view of the content through the portal based on the movement of the viewport of the user (e.g., different portions for different directions of movement, more of the content if the movement is towards the portal, and/or less of the content if the movement is away from the portal). In some embodiments, the size and/or shape of the portal is based on a level of immersion at the first computer system.

In some embodiments, a level of immersion of three-dimensional content (e.g., the portal and/or the content displayed within and/or via the portal) corresponds to an associated degree to which the portal displayed by the first computer system obscures background content (e.g., the three-dimensional environment and/or a virtual environment) around/behind the portal, optionally including the number of items of background content displayed and the visual characteristics (e.g., colors, contrast, and/or opacity) with which the background content is displayed, and/or the angular range of content displayed via the one or more display generation components (e.g., 60 degrees of content displayed at a low level of immersion, 120 degrees of content displayed at medium immersion, or 180 degrees of content displayed at a high level of immersion), and/or the proportion of the available field of view of the one or more display generation components consumed by the portal (e.g., 33% of the field of view consumed by the portal at low immersion, 66% of the field of view consumed by the portal at medium immersion, or 100% of the field of view consumed by the portal at high immersion). In some embodiments, at a first (e.g., high) level of immersion, the background, virtual and/or real objects around/behind the portal are displayed in a fully- or nearly fully-obscured manner. For example, a portal with a high level of immersion is displayed without concurrently displaying the background content (e.g., in a full screen or fully immersive mode). In some embodiments, at a second (e.g., low) level of immersion, the background, virtual and/or real objects are displayed in a less obscured manner (e.g., dimmed, blurred, and/or removed from display). For example, a portal with a low level of immersion is optionally displayed concurrently with the background content, which is optionally displayed with full brightness, color, and/or translucency. As another example, a portal displayed with a medium level of immersion is optionally displayed concurrently with darkened, blurred, or otherwise de-emphasized background content. In some embodiments, the visual characteristics of the background objects vary among the background objects. For example, at a particular immersion level, one or more first background objects are visually de-emphasized (e.g., dimmed, blurred, and/or displayed with increased transparency) more than one or more second background objects, and one or more third background objects cease to be displayed. In some embodiments, the level of immersion of the portal is controllable via a hardware input element (e.g., a rotatable button or dial, where rotation of the hardware input element increases or decreases the level of immersion based on the direction and magnitude of rotation). In some embodiments, the portal is displayed at a respective level of immersion in the three-dimensional environment. In some embodiments, while displaying the portal at the respective level of immersion in the three-dimensional environment, the first computer system detects an input corresponding to a request to increase or decrease the level of immersion of the portal, such as via interaction with (e.g., a rotation of) the hardware input element above. In some embodiments, in response to detecting the input, the first computer system increases or decreases the level of immersion of the portal from the respective level of immersion.

In some embodiments, the first computer system detects a first event and in response, displays the portal with a level of immersion based on characteristics of the first event. In some embodiments, the first event is or includes detecting, via the one or more input devices, user input (e.g., user input interacting with the experience, such as selecting a portion of content displayed by an experience in the portal, providing movement input (e.g., via a controller) for moving through the content of the experience (e.g., moving through a video game), or user input requesting display of a certain type of content (e.g., a menu, a character, or other graphical object of the experience and/or video game) in the portal). In some embodiments, the level of immersion of the portal defines or controls the size and/or shape of the portal, and the size and/or shape of the portal optionally determines how much and/or which portion of the three-dimensional content of the experience is visible and/or displayed through the portal. In some embodiments, the content that is displayed in response to detecting the first event was not displayed by the experience within and/or via the portal before and/or when the first event was detected. In some embodiments, when the first event was detected, the experience was displaying other content within and/or via the portal, and in response to detecting the first event, the first computer system displays and/or outputs the first event-triggered content (optionally different from the other content) in addition to or alternatively to the other content within and/or via the portal. In some embodiments, if the first event had not been detected, the first computer system would have continued displaying the other content within and/or via the portal without displaying and/or outputting the first event-triggered content within and/or via the portal.

in some embodiments, in accordance with a determination that the immersion portal is set to a first level of immersion, the first computer system displays the three-dimensional content (e.g., within the immersion portal) with the first level of immersion, such as immersion portal 934 displayed with a first level of immersion as shown in FIG. 9C. For example, the first computer system displays a first portion of the three-dimensional content, such as a virtual beach including a campfire.

In some embodiments, in accordance with a determination that the immersion portal is set to a second level of immersion, different from the first level of immersion, the first computer system displays the three-dimensional content (e.g., within the immersion portal) with the second level of immersion such as immersion portal 934 displayed with a second level of immersion, different from the level of immersion as shown in FIG. 9C. For example, the second level of immersion is greater than the first level of immersion, and the first computer system displays a second portion in addition to the first portion of the three-dimensional content, such as the virtual beach including the campfire and additional chairs at positions in the three-dimensional environment that were not consumed by the three-dimensional content displayed with the first level of immersion. In this way, the extent to which the three-dimensional is visible and/or displayed optionally corresponds to the level of immersion of the immersion portal, a term described further below. For example, the first and second levels of immersion respectively correspond to different angular ranges with which the three-dimensional content is displayed, such as with 5, 25, 50, 75, 90, 120, 180, 270, or 360 degrees of separation between a vector extending from the first computer system to a first edge (e.g., a perceived lateral or vertical edge) of the immersion portal and between a vector extending from the first computer system to a second edge, opposite the first edge, of the immersion portal. As described in greater detail herein, the first computer system optionally changes the level of immersion in accordance with input, such as rotation of a button that is selectable to display a home user interface (e.g., described above). In some embodiments, the level of immersion of the immersion portal, and thereby the three-dimensional content, is controlled by the first computer system and/or not by the second computer system. For example, the first computer system optionally forgoes changing (e.g., maintains) the level of immersion of the three-dimensional content corresponding to a video game in response to receiving an indication that a level of immersion (or two-dimensional equivalent, such as a field-of-view) of a video game displayed at the second computer system has changed.

In some embodiments, the first user interface includes one or more selectable options, (e.g., the first computer system displays the first user interface and the second computer system does not display the first user interface), such as selectable options 928, 930 and/or 932 included in menu 924 as shown in FIG. 9B. In some embodiments, while displaying the one or more selectable options, the first computer system detects, via the one or more input devices in communication with the first computer system, a first input directed to a respective selectable option included in the one or more selectable options, wherein the first input is included in the sequence of one or more inputs, such as input including hand 920 directed to trackpad 918 while at least one of focus selectors 910a, 910b, and/or 910c is displayed. For example, as described in greater detail below, the first computer system (and/or the second computer system) detect a sequence of one or more inputs directed to one or more selectable options included in the first user interface. For example, the first computer system optionally detects a first input that is included in the sequence of one or more inputs described with reference to method 1000, such as including an air gesture concurrent with attention directed to the first selectable option. Additionally or alternatively, the second computer system optionally detects: trackpad contact, movement of the contact, and/or tapping on the trackpad while a cursor is directed to the first selectable option that is displayed via a display generation component included in the second computer system, and/or the first computer system detects a portion of a body of a user of the first computer system move within a threshold distance (e.g., 0, 0.05, 0.1, 0.2, 0.3, 0.4, or 0.5 m) of the first selectable option.

In some embodiments, in response to detecting the first input (e.g., automatically, optionally without detecting input at the first computer system and/or the second computer system), in accordance with a determination that the respective selectable option is a first selectable option, such as selectable option 928 as shown in FIG. 9B, the first computer system displays, via the one or more display generation components in communication with the first computer system, the three-dimensional content concurrently with the virtual window, such as three-dimensional content 936 displayed with virtual object 902 as shown in FIG. 9C In response to detecting one or more of such inputs including the first input, the first computer system optionally configures the three-dimensional content and/or the virtual window to be displayed concurrently, as described in greater detail herein. Additionally or alternatively, in response to detecting the one or more inputs, the first computer system optionally displays the three-dimensional content concurrently with the virtual window, in a manner that is the same as or based on the concurrent display of such user interface elements described above. In this way, the first selectable option is “selectable” to perform one or more operations. It is understood that other selectable options and/or user interface elements are optionally selectable, and that description of the sequence of detecting a request and perform operation(s) in response to the request, as described with reference to the first selectable option above, optionally applies to the selection of the other selectable options and/or user interface elements (e.g., the first and/or second computer system detect a request, and in response, perform operations according to the request). In some embodiments, the first selectable option includes text, graphics, media, and/or some combination thereof to indicate the functionality of the first selectable option. Additionally or alternatively, the first selectable option is a toggle that is optionally enabled or disabled in response to detecting the second request.

In some embodiments, in response to detecting the first input (e.g., automatically, optionally without detecting input at the first computer system and/or the second computer system), in accordance with a determination that the respective selectable option is a second selectable option, different from the first selectable option, such as selectable option 930 as shown in FIG. 9B, the first computer system forgoes display of the virtual window, such as the lack of the virtual window as shown in FIG. 9I. For example, the second selectable option shares one or more characteristics with the first selectable option, such as the information that indicates functionality of the second selectable option. In some embodiments, in response to detecting the first input and/or a sequence of one or more inputs directed to the second selectable option, the first computer system configures the three-dimensional content and/or the virtual window to be displayed separately. Additionally or alternatively, in response to detecting the second request, the first computer system optionally displays or maintains display of the three-dimensional content and ceases display and/or forgoes display of the virtual window, in a manner that is the same as or based on the separate display of such user interface elements described above.

In some embodiments, in response to detecting the sequence of one or more inputs that correspond to the first request, the first computer system displays, via the one or more display generation components, a second user interface, different from the first user interface, such as menu 924 as shown in FIG. 9B. For example, the first computer system displays the second user interface which includes one or more selectable options to display the three-dimensional content without the virtual monitor and/or with the virtual monitor. In some embodiments, the second user interface includes text, graphics, and/or media indicating titles of settings and/or options, current setting configurations, and/or illustrations of the function of the selectable option(s).

In some embodiments, the second user interface includes a first selectable option that is selectable to display the virtual window concurrently with the three-dimensional content, such as selectable option 930 as shown in FIG. 9B. For example, in response to detecting input selecting the first selectable option, the first computer system optionally maintains display or displays the virtual window and/or maintains display (or initiates display) of the three-dimensional content.

In some embodiments, the second user interface includes a second selectable option that is selectable to cease display of the virtual window when the three-dimensional content is displayed in the three-dimensional environment, such as selectable option 928 as shown in FIG. 9B. For example, in response to detecting input selecting the second selectable option, the first computer system optionally ceases display of the virtual window and/or maintains display (or initiates display) of the three-dimensional content. In some embodiments, the first computer system changes a configuration of the virtual window without changing the display of the virtual window in response to detecting selection of the first and/or the second selectable option. For example, the first computer system optionally forgoes ceasing display of the virtual window and/or displaying virtual window in response to detecting a request corresponding to the selection. In some embodiments, the first computer system detects additional or alternative input confirming their selection(s) and/or dismissing the second user interface, and in response to detecting the additional or alternative input, maintains display of, displays, and/or ceases of display of the virtual window in accordance with the input directed to the first selectable option and/or second selectable option.

In some embodiments, while displaying second user interface including the first selectable option and the second selectable option, the first computer system detects, via the one or more input devices, input directed to a respective selectable option included in the second user interface (e.g., as described above) such as input including hand 920 contacting trackpad 918 as shown in FIG. 9B. In some embodiments, in response to detecting the input directed to the respective selectable option (e.g., the first selectable option, the second selectable option, and/or another selectable option in the second user interface), in accordance with a determination that the respective selectable option is the first selectable option, the first computer system displays, via the one or more display generation components in communication with the first computer system, the three-dimensional content concurrently with the virtual window, such as virtual object 902 and three-dimensional content displayed concurrently as shown in FIG. 9C. For example, the first computer system displays the three-dimensional content in a manner that is similar to or the same as described in greater detail herein, such as with a level of immersion and/or as a virtual model that is within the three-dimensional environment of the first computer system.

In some embodiments, in response to detecting the input directed to the respective selectable option (e.g., the first selectable option, the second selectable option, and/or another selectable option in the second user interface), in accordance with a determination that the respective selectable option is the second selectable option, the first computer system displays, via the one or more display generation components in communication with the first computer system, the three-dimensional content without displaying the virtual window (e.g., ceasing display of the virtual window in the three-dimensional environment), such as three-dimensional content 936 displayed in three-dimensional environment 900 as shown in FIG. 9I, without a virtual window. For example, the first computer system optionally does not display (e.g., ceases display) of the virtual window.

In some embodiments, the second user interface includes a third selectable option, different from the first selectable option and the second selectable option, that is selectable to cancel display of the three-dimensional content, such as selectable option 932 as shown in FIG. 9B. In some embodiments, in response to detecting the input directed to the respective selectable option, and in accordance with a determination that the respective selectable option is the second selectable option, the first computer system forgoes displaying the three-dimensional content, such as forgoing display of three-dimensional content (e.g., from FIG. 9C), and/or the display of virtual object 902 without three-dimensional content as shown in FIG. 9A. For example, the third selectable option optionally shares one or more characteristics described above with reference to the first selectable option and/or the second selectable option. In some embodiments, in response to detecting one or more inputs ceasing display of the second user interface such as a selection of a “x” icon to close the second user interface and/or an interaction with the three-dimensional environment outside of where the second user interface is displayed, the first computer system displays or cancels display of the three-dimensional content based on a configuration of the third selectable and/or the last input directed to the third selectable option. For example, while displaying the third selectable option, the first computer system optionally detects a request (e.g., sharing one or more characteristics of the first request described above) toggling the third selectable option to an on position and/or otherwise affirming the cancellation of the display of the three-dimensional content. In response to detecting the request, the first computer system optionally forgoes display of the three-dimensional content, and/or configures the three-dimensional content to not be displayed (e.g., when the second user interface will be closed in the future). In the event the three-dimensional content is configured to not be displayed, in response to detecting a request corresponding to input ceasing display of the second user interface described above, the first computer system optionally forgoes display of the three-dimensional content.

In some embodiments, the second user interface is displayed in the virtual window, such as a user interface displayed in virtual object 902, as shown in FIG. 9C. For example, the second user interface is displayed inside a border defined by the edges of the virtual window. In some embodiments, the second user interface is at least partially controlled by the second computer system. For example, in response to detecting, via one or more input devices in communication with the second computer system and/or not in communication with the first computer system, input directed to the second user interface, the second computer system displays virtual content in an equivalent of second user interface displayed at the second computer system. Additionally or alternatively, the second computer optionally transmits an indication of the input to the first computer system. In response to receiving the indication, the first computer system displays the virtual content, or a reproduction of the virtual content (e.g., having a different size to account for differences between the one or more display generation components of the first computer system and the one or more display generation components of the second computer system).

In some embodiments, the second user interface is displayed outside of the virtual window in the three-dimensional environment such as if the user interface displayed in virtual object 902, as shown in FIG. 9B, were outside of virtual object 902. For example, the second user interface is displayed outside of a border defined by the edges of the virtual window within the three-dimensional environment. In some embodiments, the position of the second user interface corresponds to the position of the virtual window. For example, the virtual window and the second user interface are optionally center-aligned with respect to a perceived lateral, vertical, and/or depth axis relative to the viewpoint of the user. In some embodiments, the second user interface is displayed at a depth relative to the viewpoint of the user that is extruded away from a front surface of the second user interface (e.g., 0.001, 0.01, 0.1, 0.2, 0.3, 0.4, or 0.5 m). In some embodiments, the second user interface is laterally offset from the virtual window in a perceived lateral direction (e.g., relative to the viewpoint of the user). In some embodiments, the virtual window and the second user interface include front surfaces upon which content are displayed, and the virtual window and the second user interface front surfaces are parallel to one another in the three-dimensional environment. In some embodiments, the second user interface is controlled at least partially by the first computer system. For example, in response to detecting input directed to the second user interface while displayed outside of the virtual window, the first computer system detects input directed to the second user interface. In response to detecting the input, the first computer system optionally updates the virtual window to include changes requested by the input (e.g., launching of an application, hiding of a window, and/or changing of a setting).

In some embodiments, in response to detecting one or more inputs moving the virtual window in the three-dimensional environment, the first computer system moves the second user interface and the virtual window maintaining a spatial arrangement between the second user interface and the virtual window. For example, the first computer system optionally detects input as described with reference to methods 800, 1000, and/or 1200 directed to a “grabber” selectable option displayed underneath the virtual window, which optionally shares one or more characteristics of the inputs described above (e.g., an air gesture with attention, a trackpad input, and/or a controller input). In response to detecting the input, the first computer system optionally moves the second user interface and/or the virtual window by similar or same amount and in similar or same directions, based on the amount and/or direction of movement included in the input (e.g., direction of movement of an air gesture, trackpad contact, tilting of a joystick, and/or the like). In some embodiments, the movement includes maintain orientation between the front surface of the virtual window and/or the second user interface (e.g., maintain a parallel orientation of the front surface of each user interface element), and/or otherwise maintaining the position and/or orientation of the virtual window and/or the second user interface relative to each other while moving in the three-dimensional environment.

In some embodiments, while displaying, via the one or more display generation components in communication with the first computer system, the three-dimensional content in the three-dimensional environment, the first computer system detects, via the one or more input devices that are in communication with the first computer system or the second computer system, a sequence of one or more inputs that corresponds to a second request, different from the first request, directed to the first user interface included in the virtual window, such as hand 920 tapping trackpad 918 as shown in FIG. 9J (e.g., input selecting model 958). For example, the second request optionally has one or more characteristics described with reference to the first request (e.g., a sequence of one or more inputs are detected by the first computer system and/or a sequence of one or more inputs are detected by the second computer system, and the second computer system transmits an indication of the sequence of one or more inputs to the first computer system) described herein, and/or one or more characteristics described with reference to method 800. In some embodiments, the second request includes one or more air gestures directed to one or more portions of the first user interface including an air pointing, an air pinching of a plurality of fingers, and an air spreading apart of a plurality of fingers, a sequence of one or more air poses, and/or one or more of the air gestures described above. In some embodiments, the second request includes input directed to a controller, such as a wearable controller and/or a handheld gaming controller including one or more joysticks, one or more physical buttons, one or more touch-sensitive and/or pressure sensitive surfaces, and/or some combination thereof. In some embodiments, the second request includes input directed to a controller, such as a wearable controller and/or a handheld gaming controller including one or more joysticks, one or more physical buttons, one or more touch-sensitive and/or pressure sensitive surfaces, and/or some combination thereof. In some embodiments, the second request includes input directed to a mouse, a physical keyboard, and/or a trackpad. In some embodiments, the second request is directed to the first user interface by virtue of moving within a threshold distance of the first user interface (e.g., 0, 0.001, 0.005, 0.01, 0.05, 0.1, 0.2, 0.3, or 0.5 m), a cursor being directed to the first user interface, attention (e.g., based on gaze and/or cursor direction) being directed to the user interface, the first user interface being in a selected state (e.g., the first computer system detects input selecting the first user interface and enables the selected state), and/or some combination of such factors.

In some embodiments, the second request directed to the first user interface includes interaction with content included in the first user interface. For example, the interaction optionally corresponds to manipulation of content in a video game, where the video game user interface is and/or is included in the first user interface, such as movement of a character, changing of one or more settings, and/or launching of one or more applications or levels. Additionally or alternatively, the interaction optionally includes interaction with a three-dimensional modelling application user interface. For example, the interaction includes defining a structure of a three-dimensional model (e.g., the three-dimensional content), removing or adding surfaces, removing or adding colors, removing or adding textures, changing the dimensions of the three-dimensional model, breaking the three-dimensional model, fusing pieces together to form the three-dimensional model, and/or changing a displayed view (e.g., a wireframe, a wireframe with texture overlays, and/or a display and/or ceasing display of a plurality of layers) of the three-dimensional mode.

In some embodiments, the interaction includes editing of content displayed by the first computer system. For example, the first user interface optionally corresponds to a content editing user interface for media such as two-dimensional pictures or video, spatial video, immersive three-dimensional environments for animation and/or computer-generated imagery (CGI) environments. In some embodiments, the interaction includes input requesting creation of a new library of files or a project, organizing media, importing media, moving clips of media relative to a timeline, trimming clips of media, adding or removing audio streams, adding animations, removing animations, adding transitions, correcting colors, adjusting volume levels, exporting media, adjusting a field of view of an immersive virtual experience such as an environment, stitching and/or synchronizing cameras together, adding or removing graphics, adding, removing, and/or otherwise editing spatial audio, and/or one or more of such inputs.

In some embodiments, in response to detecting the sequence of one or more inputs that corresponds to the second request, the first computer system performs an operation on the three-dimensional content in the three-dimensional environment in accordance with the sequence of one or more inputs that corresponds to the second request, such as the filling of virtual model and three-dimensional content as shown in FIG. 9K. For example, the second computer system optionally updates the three-dimensional content and/or the virtual window to reflect the operation requested by the second request. In some embodiments, the first computer system and/or second computer system detect the second request (and/or an indication of the second request) and in response perform the interaction with the video game user interface. In some embodiments, the first computer system and the second computer system perform the same operations in response to detecting the second request. For example, in response to detecting the second request, the first computer system and/or the second computer system optionally move characters, move a camera, load levels, and/or change settings. Additionally or alternatively, in response to detecting the second request, the first computer system and/or the second computer system optionally edit a three-dimensional model (e.g., the three-dimensional content in the three-dimensional environment and a reproduction of the model at the second computer system) to include different colors, textures, to change spatially, and/or to add or remove pieces based on the input. Additionally or alternatively, in response to detecting the second request, the first computer system and/or the second computer system optionally edit content including editing a timeline, adding audio streams, displaying animations, removing animations, changing camera angles, changing a field of view of a virtual experience, and/or changing the level of immersion of the three-dimensional. In some embodiments, the operations performed by the first and/or the second computer system directed to the three-dimensional content include one or more characteristics of similar operations described with reference to method 800.

In some embodiments, the first computer system and/or second computer system detect input directed to the three-dimensional content, update the three-dimensional content based on the input, and/or transmit an indication that when received by the other computer system, causes the other computer system to update the three-dimensional content (or the equivalent) displayed at the other computer system concurrently, or in rapid succession. For example, the first computer system optionally detects input directed to a trackpad in communication with the first computer system modifying the three-dimensional content. In response to detecting the input, the first computer system optionally updates the three-dimensional content as described further above. Additionally, in response to detecting the input, the first computer system transmits (e.g., via a wired or wireless communication channel) an indication of the input to the second computer system. In some embodiments, the second computer system, receives the indication and, without detecting input, updates an image and/or model displayed at the second computer system based on the indication such that the model displayed at the second computer system mirrors the three-dimensional content with respect to the request indicated by the indication. It understood that the second computer system optionally performs operations similar to those described to the first computer system (e.g., detecting input, updating a model, and transmitting an indication of the model to the first computer system, which causes the first computer system to update the three-dimensional content without detecting respective input).

In some embodiments, while displaying, via the one or more display generation components in communication with the first computer system, the three-dimensional content in the three-dimensional environment, the first computer system detects, via the one or more input devices that are in communication with the first computer system, a sequence of one or more inputs that corresponds to a second request, different from the first request, directed a second user interface, different from the first user interface, displayed outside of the virtual window in the three-dimensional environment, such as hand 920 forming an air pinch while attention 950 is directed to one of controls 952 as shown in FIG. 9G. For example, the second request optionally has one or more characteristics described with reference to the first request and/or the second request described above. In some embodiments, the second request includes a sequence of one or more inputs, such as input directed to the three-dimensional content and/or an air gesture (e.g., an air pinch, an air pointing of a finger, and/or an air curling of one or more fingers). In some embodiments, the second request includes input that is maintained for a period of time greater than a threshold period of time (e.g., contact on a trackpad, an air pose, and/or a pressing of a button maintained for greater than 0.01, 0.1, 0.2, 0.3, 0.5, 1, 1.5, or 3 seconds). In some embodiments, the second request includes detecting a portion of a body of the user move within a threshold distance (e.g., 0, 1, 2, 3, 5, 10, 25, 50, 100, 300, or 500 cm) of the three-dimensional content. In some embodiments, the second request includes detecting a voice command directed to the three-dimensional content. In some embodiments, the second user interface is displayed in a direction that is vertically below the three-dimensional content (e.g., relative to a ground of the three-dimensional environment). In some embodiments, the second user interface is displayed with a depth relative to a viewpoint of the user of the first computer system that is different from a depth of the three-dimensional content (e.g., is closer to the viewpoint than the three-dimensional content). In some embodiments, while the second user interface is displayed outside of the virtual window, the first computer system detects the second request in a manner that is the same as, or is based upon, detecting a second request while the first user interface is displayed in the virtual window as described above. In some embodiments, the second user interface shares some or all of the characteristics described above with reference to the second user interface that includes one or more controls. In some embodiments, the second user interface is an operating system user interface for interacting with and/or controlling aspects of the three-dimensional content. In some embodiments, the second user interface includes one or more controls that are respectively selectable to perform operations related to the three-dimensional content (e.g., adjust a volume, adjust a playback position in a scrubber bar, seek forward or backward through media content, mute audio corresponding to the three-dimensional content, cease display of the three-dimensional content in the three-dimensional environment, and/or display settings for an immersion portal (e.g., described further herein) that constrains the three-dimensional content).

In some embodiments, in response to detecting the sequence of one or more inputs that corresponds to the second request, the first computer system performs an operation on the three-dimensional content in the three-dimensional environment in accordance with the second request, such as one or more operations corresponding to selectable options 952a through 952c (e.g., ceasing display of three-dimensional content, changing volume, and/or displaying settings). For example, the first computer system and/or the second computer system optionally perform the operations as described with reference to the first request and/or the second request described herein in response to detecting the second request that is detected while the first user interface is displayed outside of the virtual window. For example, in response to detecting a selection of a position on a scrubber bar, the first computer system and/or the second computer system optionally update media content included in the three-dimensional content (e.g., displayed in an immersion portal) to correspond to the selected position on the scrubber bar. In some embodiments, in response to detecting a selection of an audio icon, the first computer system displays a volume slider and/or knob. In response to detecting movement of the slider and/or knob, the first computer system optionally increases or decreases the volume of audio played concurrent with the media content in the three-dimensional content (e.g., louder if the input is in a first direction or softer if the movement is in a second direction, different from the first direction). In some embodiments, in response to detecting a selection of a seek forward or a seek backward button, the first computer system and/or the second computer system move the playback position of the media content in the three-dimensional content by a predetermined amount forward or backward, based on whether the selection input is directed to the forward or the seek backward button, respectively.

In some embodiments, while displaying, via the one or more display generation components, the three-dimensional content in the three-dimensional environment (e.g., and/or while displaying a reproduction of the three-dimensional content at the second computer system), such as three-dimensional content 960 as shown in FIG. 9J, the first computer system detects, via the one or more input devices of the first computer system, an input directed to the displayed three-dimensional content, such as hand 920 and hand 972 directed to three-dimensional content 960 as shown in FIG. 9L. For example, the input directed to the three-dimensional content optionally has one or more characteristics of the first request and/or second requests described above, and optionally does not include detecting an indication of a respective input from the second computer system. Additionally or alternatively, the second computer system optionally detects input directed to the second computer system (e.g., without detecting an indication of the respective input from the first computer system). In some embodiments, the input includes a directing of attention (e.g., based on gaze and/or cursor position) of the user to the three-dimensional content, and/or one or more air gestures performed by the hands of the user that are directed to the three-dimensional content.

In some embodiments, in response to detecting the input directed to the displayed three-dimensional content, the first computer system transmits an indication of the input to the second computer system, such as an indication of communication to computer system 922 (e.g., shown in FIG. 9A). In some embodiments, after transmitting the indication of the input to the second computer system, the first computer system updates display of the three-dimensional content based on the input directed to the displayed three-dimensional content, such as the manipulation of three-dimensional content 960 in FIG. 9M to portion 974a and portion 974b as shown in FIG. 9N. For example, the first computer system optionally transmits an indication of the input to the second computer system (e.g., via a wired or wireless connection). In some embodiments, the inputs include passive interactions with respect to the three-dimensional content, such as the user gazing at the three-dimensional content, moving attention (e.g., based on gaze and/or a cursor), and/or moving hands or other portions of the body near the three-dimensional content. In some embodiments, the inputs include passive and/or active interaction, such as air tapping, air pinching, air grasping, and/or air pushing of the three-dimensional content. In some embodiments, the second computer system updates the three-dimensional content (or its equivalent displayed at the second computer system) in response to receiving the indication of input from the first computer system. For example, the second computer system updates the size, shape, spatial profile, color, and/or additional or alternative visual characteristics described further herein of a virtual model. Additionally or alternatively, in response to receiving the indication, the second computer system optionally transmits updates to the model to the first computer system. In some embodiments, the first computer system updates the three-dimensional content based on the updates received from the first virtual object in response to receiving such updates.

In some embodiments, in response to detecting the indication of the input from the first computer system, the second computer system displays one or more visual indications corresponding to the input, such as one or more visual indications that are similar to, or the same as cursors 970a and 970b as shown in FIG. 9M at computer system 922 (e.g., as shown in FIG. 9I in the overhead view of three-dimensional environment 900). For example, the second computer system optionally displays one or more cursors overlaying a reproduction of the three-dimensional content (e.g., on a two-dimensional display) having positions and/or orientations that correspond to the positions and/or orientations of the input relative to the three-dimensional content. In some embodiments, the appearance of the one or more cursors corresponds to the type of input. For example, a first cursor is optionally displayed by the second computer system with a first appearance (e.g., a circle, an eye, and/or some geometric shape) to indicate attention of the user is being directed to the three-dimensional content. In some embodiments, the cursor is displayed by the second computer system with a second appearance, different from the first appearance to indicate that one or more air gestures are detected. For example, the second computer system optionally displays a hand, a colored amorphous shape indicating a left hand or a right hand, and/or some other geometric shape unique to the hand-based cursor such as a volumetric shape.

In some embodiments, the position of the input relative to the three-dimensional content is visually indicated at the second computer system, without detecting input at the second computer system, such as the position of hand 920 relative to portion 974a, corresponding to the position of a visual indication that is similar to, or the same as cursors 970b as shown in FIG. 9M at computer system 922 (e.g., as shown in FIG. 9I in the overhead view of three-dimensional environment 900). For example, in accordance with a determination that the input is directed to one or more first positions having one or more first spatial relationships to the three-dimensional content, the second computer system displays one or more visual indications at one or more respective first positions which have one or more respective first spatial relationships to a reproduction of the three-dimensional content at the second computer system, in which the one or more respective first spatial relationships are optionally the same as and/or are based on the one or more first spatial relationships. Thus, the second computer system optionally does not detect input, but optionally displays the visual indication based on receipt of an indication of the input from the first computer system. In some embodiments, in accordance with a determination that the input is directed to one or more second positions, different from the one or more first positions, having one or more second spatial relationships to the three-dimensional content, different from the one or more first spatial relationships, the second computer system displays the one or more visual indications at one or more respective second positions which have one or more respective second spatial relationships to a reproduction of the three-dimensional content at the second computer system, in which the one or more respective second spatial relationships are the same as and/or are based on the one or more second spatial relationships, and/or the one or more respective second spatial relationships are different from the one or more respective first spatial relationships.

In some embodiments, the first computer system displays a visual indication of interaction with the reproduction of the three-dimensional content displayed at the second computer system, such as cursor 970b as shown in FIG. 9N. In some embodiments, the position of the interaction relative to the reproduction of the three-dimensional content is visually indicated at the first computer system, without detecting input at the first computer system. For example, the second computer system optionally detects a mouse move a cursor, a controller joystick move the cursor, and/or tapping on a trackpad to select and/or highlight portions of the reproduction. In response to detecting the interaction, the second computer system optionally displays the cursor moving and/or highlighting a portion of a user interface near and/or surrounding the reproduction, and/or optionally transmits an indication of the interaction to the first computer system. In response to receiving the indication of the interaction (and/or without detecting input at the first computer system), the first computer system optionally displays a visual indication in the three-dimensional environment representing the interaction. For example, the position and/or orientation of the visual indication is displayed at a position relative to the three-dimensional content that is the same as or is based on the position of the cursor and/or highlighting relative to the reproduction displayed at the second computer system (e.g., in a manner that is based on the synchronization of the air gesture and/or attention position at the first computer system and the visual indication displayed at the second computer system as described above).

It should be understood that the particular order in which the operations in method 1000 have been described is merely exemplary and is not intended to indicate that the described order is the only order in which the operations could be performed. One of ordinary skill in the art would recognize various ways to reorder the operations described herein. In some embodiments, aspects/operations of method 1000 may be interchanged, substituted, and/or added between these methods. For example, various object manipulation techniques and/or object movement techniques of method 1000 are optionally interchanged, substituted, and/or added between these methods. For brevity, these details are not repeated here.

FIGS. 11A-11EE illustrate examples of code sharing to enable content sharing between electronic devices (e.g., a first electronic device and a second electronic device). The embodiments in these figures are used to illustrate the processes described below, including the processes described with reference to FIG. 12. Although FIGS. 11A-11EE illustrate various examples of ways an electronic device is able to perform the processes described below with respect to FIG. 12, it should be understood that these examples are not meant to be limiting, and the electronic device is able to perform one or more processes described below with reference to FIG. 12 in ways not expressly described with reference to FIGS. 11A-11EE.

FIG. 11A illustrates a first electronic device 500a (e.g., Emily's device) displaying a first user interface (e.g., shareable content 1105) on a display 504a of the first electronic device 500a. In some embodiments, shareable content 1105 is a webpage that is being displayed on a web browser user interface. In FIG. 11A, the first electronic device 500a displays shareable content including one or more images, videos, e-mails, electronic messages, contacts, notes, and documents on display 504a. In some embodiments, the first electronic device 500a displays a first sharing button 1101a that when first electronic device 500a detects selection of first sharing button 1101, initiates a sharing process (e.g., described in greater detail herein, and with respect to method 800). In FIG. 11A, the first electronic device 500a detects an input 1111a directed to the first sharing button 1101a from a user of the electronic device. In some embodiments, input 1111a includes a tactile input provided by a hand of a user of the first electronic device 500a. In some embodiments, input 1111a includes an input provided by a user of the device to one or more external input devices (e.g., a mouse, a stylus, a keyboard) that are communicatively connected to the first electronic device 500a.

In FIG. 11A, a second electronic device 500b (e.g., John's device) displays a second user interface on a display 504b of the second electronic device 500b. In some embodiments, the second electronic device 500b displays a lock screen interface. In some embodiments, the second electronic device 500b and the first electronic device 500a are the same device type (e.g., a phone, a tablet, a laptop, a head-mounted display). In some embodiments, the second electronic device 500b and the first electronic device 500a are different device types.

In response to detecting input 1111a directed to first sharing button 1101a in FIG. 11A, the first electronic device 500a displays a first sharing user interface 1114a that includes one or more sharing buttons 1108a-d, as illustrated in FIG. 11B. In some embodiments, the first sharing user interface 1114a is overlaid on the shareable content 1105a. In some embodiments, the one or more sharing buttons 1108a-d includes buttons associated with sharing content directly with another device. In some embodiments, first electronic device 500a detects an input directed to an airdrop button 1108a of the one or more sharing buttons 1108a-d. In some embodiments, the first electronic device 500a detects an input directed to a known text message contact 1106a (e.g., “Jane”) and in response to the input, the first electronic device 500a shares the shareable content 1105a with Jane. In some embodiments, the first electronic device 500a detects an input directed to a “Messages” application 1108b, and in response, the first electronic device 500a launches the Messages application with the shareable content 1105a as an attachment. In some embodiments, the first electronic device 500a detects an input directed to a “Mail” application 1108c, and in response, the first electronic device 500a launches the Mail application with the shareable content 1105a as an attachment. In some embodiments, the first sharing user interface 1114a includes one or more system icons 1110a-d. In some embodiments, the first electronic device 500a performs one or more actions associated with a respective system icon, in response to detecting an input direct to the one or more system icons 1110a-d. For example, in response to detecting an input directed to a “Copy” system icon 1110a, the first electronic device 500a copies the shareable content 1105a to a persistent clipboard of the first electronic device 500a, such that the shareable content 1105a can be pasted in another application. In some embodiments, and as illustrated in FIG. 11B, the second electronic device 500b detects an input 1112a directed to an upper portion of display 504b. In some embodiments, the input 1112a directed to the upper portion of display 504b includes a touch and drag towards a lower portion of display 504b.

FIG. 11C illustrates an exemplary user interface that is displayed by first electronic device 500a, in response to detecting an input 1111a directed to the airdrop button 1108a (in FIG. 11B). As illustrated in FIG. 11C, the first electronic device 500a displays a second sharing user interface 1114b that includes a find people button 1101b, a user indicator 1142a, and share buttons 1107a-c. In some embodiments, the user indicator 1142 indicates what the first electronic device 500a will appear as to other nearby devices. In some embodiments, the first electronic device 500a shares shareable content 1105a with devices and/or users associated with devices, in response to detecting an input 1111b directed to a respective share button of share buttons 1107a-c. In FIG. 11C, the find people button 1101b is a selectable button on the second sharing user interface 1114b that a user of the first electronic device 500a selects when the user of the first electronic device 500a attempts to share shareable content 1105a with a device and/or user of a device, not displayed by share buttons 1107a-c and who are within a threshold distance from the first electronic device 500a as described with respect to method 800. In some embodiments, the first electronic device 500a detects an input 1111a directed to the find people button 1101b. In some embodiments, in response to detecting the input 1111a directed to the upper portion of the display 504b, the second electronic device 500b displays a control center user interface 1116.

In FIG. 11D, in response to detecting an input 1111a directed to the find people button 1101b (illustrated in FIG. 11C), the first electronic device 500a displays a third sharing user interface 1114c. In some embodiments, the third sharing user interface 1114c includes a code 1118a that can be input into an unspecified device to enable content sharing. In some embodiments, the third sharing user interface 1114c includes sharing instructions 1120a that includes instructions associated with the code 1118a to enable content sharing with an unspecified device. In some embodiments, the sharing instructions 1120a are specific to a device type. In some embodiments, the sharing instructions 1120a include a graphic that illustrates one or more interfaces of a device to input a code. In some embodiments, a selection 1122 of a device type changes the sharing instructions 1120a. For example, in response to the detecting an input 1112b directed to “tablet” or “laptop,” the first electronic device 500a displays sharing instructions corresponding to the respective device type. In some embodiments, the second electronic device 500b displays a enter code button 1101c in response to an indication transmitted by the first electronic device 500a that is made in response to detecting the input 1111a directed to the find people button 1101b. In some embodiments, in response to the first electronic device 500a detecting the input 1111a directed to the find people button 1101b, the first electronic device 500a becomes available to establish a connection to share content by entering a code. In some embodiments, the second electronic device 500b detects an input 1112a directed to the enter code button 1101c.

In FIG. 11E, the first electronic device 500a maintains display of the third sharing user interface 1114c. In some embodiments, in response to detecting an input 1112a directed to the enter code button 1101c, the second electronic device 500b displays an input field 1126a and a keyboard 1128a. In FIG. 11E, the input field includes a number of blank entry spots that matches the number of characters in the code 1118a. In some embodiments, the second electronic device 500b detects a series of inputs 1112a directed to the keyboard 1128a to fill-in the blank entry spots in the input field 1126a. In some embodiments, a user of the first electronic device 500a communicates the code 1118a to input into input field 1126a (e.g., verbally or written). In some embodiments, the code 111a is visible to a user of the second electronic device 500b for input into input field 1126a.

In FIG. 11F, the first electronic device 500a maintains display of the third sharing user interface 1114c. In some embodiments, in response to detecting the series of inputs 1112a directed to the keyboard 1128a to fill-in the blank entry spots in the input field 1126a, the second electronic device 500b displays the input field 1126a filled with code 1118a. In some embodiments, in accordance with a determination that inputs to input field 1126a do not match code 1118a, the second electronic device 500b clears the input and displays the input field 1126a with blank entry spots, as shown in FIG. 11E.

In FIG. 11G, in accordance with a determination that the code 1118a is input into input field 1126a correctly, the first electronic device 500a displays a first connected user interface 1130a and the second electronic device 500b displays a second connected user interface 1130b, both indicating that the content can now be shared between the first electronic device 500a and the second electronic device 500b. In FIG. 11G, the first connected interface 1131a and the second connected interface 1131b included indications, both graphical and textual, that indicate that which two entities content sharing is enabled between. In some embodiments, the first electronic device 500a receives information associated with the second electronic device 500b (e.g., a name of a user associated with the second electronic device 500b) when the code 1118a is input into input field 1126a correctly. In some embodiments, when the code 1118a is input into input field 1126a correctly, information associated with the second electronic device 500b is shared with the first electronic device 500a, such that an identity of the second electronic device 500b is known to the first electronic device 500a. In FIG. 11G, the first electronic device 500a detects an input 1111a directed to a done button 1123a on the first connected user interface 1130a. In some embodiments, the second electronic device 500b detects an input 1112a directed to a done button 1123b on the second connected user interface 1130b. In some embodiments, the second connected user interface 1130b includes an enter another code button 1121 that allows the user of the second electronic device 500b to input another sharing code from an additional device, different than the first electronic device 500a, and enable sharing between the additional device and the second electronic device 500b.

In some embodiments, once a sharing session has been initiated by two devices as described above, the devices can subsequently share content without requiring the code entering process as illustrated in the examples of FIG. 11H-11J. In FIG. 11H, in response to detecting an input 1111a directed to a done button on the first connected user interface 1130a, the first electronic device 500a displays the first sharing user interface 1114a. In some embodiments, the first electronic device 500a detects an input 1111a directed to an airdrop button 1108a. In FIG. 11H, in response to detecting an input 1111a directed to a done button on the second connected user interface 1130b, the second electronic device 500b displays the lock screen interface, as shown in FIG. 11A.

In FIG. 11I, in response to the first electronic device 500a detecting an input 1111a directed the airdrop button 1108a, the first electronic device 500a displays the second sharing user interface 1114b with a share button 1107d associated with the user of the second electronic device 500b. The first electronic device 500a displays now displays share button 1107d on the second sharing user interface 1114b because content sharing is enabled between the first electronic device 500a and the second electronic device 500b, as described above. As such, an input 1111a directed to the share button 1107d will initiate a sharing process between the first electronic device 500a and the second electronic device 500b. In some embodiments, the first electronic device 500a detects an input 1111a directed to the selectable icon 1132a. In some embodiments, the second electronic device 500b maintains display of the lock screen interface.

In FIG. 11J, in response to first electronic device 500a detecting an input 1111a directed to the selectable icon 1132a, the first electronic device 500a transmits the shareable content 1105a to the second electronic device 500b because content sharing between the first electronic device 500a and the second electronic device 500b is now enabled due to the code sharing process described above. In FIG. 11J, in response to detecting the input 1111a directed to the selectable icon 1132a, the first electronic device 500a displays a “Waiting . . . ” indication below selectable icon 1132a. In some embodiments, the second electronic device 500b displays a content sharing prompt 1134 that indicates that the first electronic device 500a has transmitted shareable content 1105a to the second electronic device 500b. In FIG. 11J, the content sharing prompt 1134 includes a decline option 1134a that cancels a sharing process between the first electronic device 500a and the second electronic device 500b and an accept option 1134b that completes a sharing process between the first electronic device 500a and the second electronic device 500b (e.g., allows the shareable content 1105a to be received from the first electronic device 500a). In some embodiments, the second electronic device 500b detects an input 1111a directed to the accept option 1134b.

In FIG. 11K, in some embodiments, in response to the second electronic device 500b detecting the input 1111a directed to the accept option on the content sharing prompt 1134, the first electronic device 500a displays a “Sent” indication below selectable icon 1132a. Additionally, in response to the second electronic device 500b detecting the input 1111a directed to the accept option on the content sharing prompt 1134, the second electronic device 500b displays the first shareable content 1105a that was shared by first electronic device 500a.

In some embodiments, the exemplary sharing process described above requires a sharing code be generated at a first electronic device 500a for input at a second electronic device 500b (e.g., as described in FIGS. 11A-11K). However, in some instances, a sharing process requires a sharing code to be generated at a second electronic device 500b for input at the first electronic device 500a (e.g., a process described in FIGS. 11L-11R).

In some embodiments, the code sharing process described above can be implemented such that the recipient device generates the code for sharing, while the sending device requires that the code be entered in order to initiate a sharing session as illustrated in the examples of FIGS. 11L-11R. In FIG. 11L, in some embodiments, the first electronic device 500a displays first shareable content 1105a. In some embodiments, the first electronic device 500a detects an input 1111a directed to the first sharing button 1101a. In some embodiments, the second electronic device 500b displays a lock screen interface.

In FIG. 11M, in response to detecting input 1111a directed to first sharing button 1101a, the first electronic device 500a displays a first sharing user interface 1114a. In some embodiments, the first electronic device 500a detects an input 1111a directed to the airdrop button 1108a. In some embodiments, the second electronic device 500b displays a lock screen interface.

In FIG. 11N, in response to detecting an input 1111a directed to the airdrop button 1108a, the first electronic device 500a displays the second sharing user interface 1114b. In some embodiments, the first electronic device 500a detects an input 1111a directed to the find people button 1101b. In some embodiments, the second electronic device 500b displays the lock screen interface.

In FIG. 11O, in response to the first electronic device 500a detecting the input 1111a directed to the find people button 1101b, the first electronic device 500a displays a fourth sharing user interface 1114d including sharing instructions 1120b that provide instructions to a user of an unspecified device (e.g., the second electronic device 500b) on how to generate a code to enable content sharing between the first electronic device 500a and the unspecified device. In FIG. 11O, sharing instructions 1120b include a graphic that illustrates instructions with one or more interfaces of a device on how to generate a code to enable sharing with the first electronic device 500a. In some embodiments, a selection 1122 of a device type changes the sharing instructions 1120b. For example, in response to the detecting an input 1112b directed to “tablet” or “laptop,” the first electronic device 500a displays sharing instructions corresponding to the respective device type. In some embodiments, the second electronic device 500b detects an input 1111a directed to an upper portion of display 504b. In some embodiments, the input 1111a directed to the upper portion of display 504b includes a touch and drag towards a lower portion of display 504b.

In FIG. 11P, the first electronic device 500a displays a fourth sharing user interface 1114d including sharing instructions 1120b. In some embodiments, in response to detecting the input 1111a directed to the upper portion of the display 504b, the second electronic device 500b displays a control center user interface 1116. In some embodiments, the control center user interface 1116 includes a get code button 1101d that is displayed by second electronic device 500b in response to an indication from the first electronic device 500a indicating a request to initiate a sharing session. In In FIG. 11P, the second electronic device 500b detects an input 1111a directed to the get code button 1101d. In some embodiments, in response to the first electronic device 500a detecting the input 1111a directed to the find people button 1101b, the first electronic device 500a becomes available to establish a connection to share content by generating a code, such that the get code button 1101d appears in the control center user interface 1116.

In FIG. 11Q, in response to the second electronic device 500b detecting the input directed to the get code button 1101d, the second electronic device 500b displays a fifth sharing user interface 1114e that includes code 1118b and sharing instructions 1120c. In some embodiments, fifth sharing user interface 1114e displays a selection 1122 of a device type and the sharing instructions 1120c. In some embodiments, in response to the second electronic device 500b detecting the input directed to the get code button 1101d, the second electronic device 500b broadcast that the second electronic device 500b is available to enable content sharing. As such, the first electronic device 500a displays an input field 1126b and a keyboard 1128b to enable content sharing between the first electronic device 500a and the second electronic device 500b. In FIG. 11Q, the input field includes a number of blank entry spots that matches the number of characters in the code 1118b. In some embodiment, the second electronic device 500b detects a series of inputs 1112a directed to the keyboard 1128b to fill-in the blank entry spots in the input field 1126b.

In FIG. 11R, the second electronic device 500b maintains fifth sharing user interface 1114e. In some embodiments, in response to detecting the series of inputs 1112a directed to the keyboard 1128b to fill-in the blank entry spots in the input field 1126b, the second electronic device 500b displays the input field 1126b filled with code 1118b. In some embodiments, a user of the second electronic device 500b communicates the code 1118b to input into input field 1126b. In some embodiments, the code 1118b is visible to a user of the first electronic device 500a for input into input field 1126b. In some embodiments, in accordance with a determination that inputs to input field 1126b do not match code 1118b, the first electronic device 500a clears the input and displays the input field 1126b with blank entry spots.

In FIG. 11S, in accordance with a determination that the code 1118b is input into input field 1126b correctly, the first electronic device 500a displays the first connected user interface 1130a and the second electronic device 500b displays a second connected user interface 1130b, both indicating that the content can now be shared between the first electronic device 500a and the second electronic device 500b. In FIG. 11S, the first electronic device 500a detects an input 1111a directed to a done button on the first connected user interface 1130a. In some embodiments, the second electronic device 500b detects an input 1111b directed to a done button on the second connected user interface 1130b. In some embodiments, in response to detecting an input directed to the done button on the first connected user interface 1130a and the second connected user interface 1130b, the first electronic device 500a returns to displaying the shareable content 1105a while the second electronic device 500b returns to the lock screen interface. Additionally, the respective connected user interfaces indicate that the sharing is enabled and that the first electronic device 500a and the second electronic device 500b can share content, as shown in FIGS. 11H-11K.

FIGS. 11T-11EE illustrate examples of code sharing to enable content sharing between electronic devices via a third-party application. The embodiments in these figures are used to illustrate the processes described below, including the processes described with reference to FIG. 12.

In FIG. 11T, a first electronic device 500a (e.g., Emily's device) displays a first user interface on a display 504a of the first electronic device 500a. In some embodiments, the first electronic device 500a displays shareable content 1105b (e.g., photos). In some embodiments, the first electronic device 500a displays shareable content including one or more images, videos, e-mails, electronic messages, contacts, notes, and documents on display 504a. In FIG. 11T, the first electronic device 500a detects an input 1111a directed to an icon 1108e associated with a first application 1109a. In some embodiments, the first application 1109a is a third-party application that includes functionality relating to sharing content, such as a messaging application or a photos application. In some embodiments, the first application 1109a is non-native (e.g., an application installed from an application store). In some embodiments, a second electronic device 500b, (e.g., John's device) displays a first home screen with a first arrangement of applications including a first application 1109a. In some embodiments, the second electronic device 500b detects an input 1111a directed to the first application 1109a. In some embodiments, a third electronic device 500c, (e.g., Mark's device) displays a second home screen with a second arrangement of applications including a first application 1109a. In some embodiments, the second electronic device 500b detects an input 1111a directed to the first application 1109a.

In FIG. 11U, in response to detecting an input 1111a directed to icon 1101f, the first electronic device 500a launches the first application 1109a. In some embodiments, in response to launching the first application 1109a, the first electronic device 500a displays a first application interface 1140a. In some embodiments, the first application interface 1140a includes a user indicator 1142a that displays what first electronic device 500a will appear as to other electronic devices. In FIG. 11U, the first electronic device 500a displays known contacts 1144a that the first electronic device 500a has previously shared content with. In some embodiments, the first application interface 1140a includes a find people nearby button 1146a (e.g., a selectable button that a user of the first electronic device 500a selects when the user of the first electronic device 500a attempts to share shareable content 1105b with a device and/or user of a device, not displayed by known contacts 1144a.)

In FIG. 11U, in response to detecting an input 1111a directed to the first application 1109a, the second electronic device 500b launches the first application 1109a and displays a second application interface 1140b including one or more recent chats. In some embodiments, the second application interface 1140b includes a settings option 1148a. In some embodiments, the second electronic device 500b detects an input 1111a directed to the settings option 1148a. In FIG. 11U, in response to detecting an input 1111a directed to the first application 1109a, the second electronic device 500b launches the first application 1109a and displays a third application interface 1140c including one or more recent chats. In some embodiments, the third application interface 1140c includes a settings option 1148b. In some embodiments, the second electronic device 500b detects an input 1111a directed to the settings option 1148b.

In FIG. 11V, the first electronic device 500a detects an input 1111a directed to the find people nearby button 1146a. In some embodiments, the first application interface 1140a includes an edit button 1143a displayed proximal to the user indicator 1142a. In FIG. 11V, the first electronic device 500a detects an input 1112b directed to the edit button 1143a that enables a user of the first electronic device 500a to modify the user indicator 1142a. In FIG. 11V, in some embodiments, in response to detecting the input 1112a directed to the settings option 1148a, the second electronic device 500b displays a fourth application interface 1140d including a find people nearby button 1146b. In some embodiments, the second electronic device 500b detects an input 1112a directed to the find people nearby button 1146b. In some embodiments, in response to detecting the input 1113a directed to the settings option 1148b, the third electronic device 500c displays a fifth application interface 1140e including a find people nearby button 1146c. In FIG. 11V, the third electronic device 500c detects an input 1113a directed to the find people nearby button 1146c.

In FIG. 11W, in some embodiments, the first electronic device 500a displays known contacts 1144a and a connect portion 1141a of the sixth application interface 1140f. In some embodiments, the known contacts 1144a include one or more contacts (e.g., devices and/or users associated with devices) that content sharing is enabled with. In FIG. 11W, the connect portion 1141a includes one or more selectable options associated with initiating a sharing process. For example, in response to an input directed to one or more selectable options in the connecting portion 1141a, the first electronic device 500a displays a code that is communicated to a user of the device associated with the one or more selectable options that the input was directed to.

In some embodiments, in response to detecting an input 1111a directed to the find people nearby button 1146b, the second electronic device 500b displays a popup window 1150a that indicates what the second electronic device 500b will appear as to the other electronic devices during a content sharing process. In FIG. 11W, the second electronic device 500b detects an input 1111a directed to a continue button displayed on the popup window 1150a. In some embodiments, in response to detecting an input 1111a directed to the find people nearby button 1146c, the second electronic device 500b displays a popup window 1150b that indicates what the second electronic device 500b will appear as to the other electronic devices during a content sharing process. In FIG. 11W, the second electronic device 500b detects an input 1111a directed to a continue button displayed on the popup window 1150b.

In FIG. 11X, in response to the second electronic device 500b detecting an input directed to the continue button on the popup window 1150a, the first electronic device 500a displays a selectable option 1132b in the connect portion 1141a of the sixth application interface 1140f. In some embodiments, the first electronic device 500a detects an input 1111a directed to the selectable option 1132b. In some embodiments, in response to the second electronic device 500b detecting an input directed to the continue button on the popup window 1150a, the second electronic device 500b displays a selectable option 1132c and a selectable option 1132d in a connect portion 1141b of a seventh application interface 1140g. In FIG. 11X, the second electronic device 500b detects an input 1112b directed to an edit button 1143b, displayed proximal to the user indicator 1142b, that enables a user of the first electronic device 500a to modify the user indicator 1142b. In some embodiments, in response to the second electronic device 500b detecting an input directed to the continue button on the popup window 1150a, the second electronic device 500b displays a selectable option 1132e in a connect portion 1141c of an eighth application interface 1140h. In FIG. 11X, the second electronic device 500b detects an input 1112b directed to an edit button 1143c, displayed proximal to the user indicator 1142c, that enables a user of the first electronic device 500a to modify the user indicator 1142c. In some embodiments, the second electronic device 500b detects an input directed to selectable option 1132e.

In FIG. 11Y, in response to the first electronic device 500a detecting an input 1111a directed to the selectable option 1132b, the first electronic device 500a displays code 1118c and sharing information 1120d. In some embodiments, a selection 1122 of a device type changes the sharing information 1120d. For example, in response to the detecting an input 1112ab directed to “tablet” or “laptop,” the first electronic device 500a displays sharing instructions corresponding to the selected device type. In some embodiments, the third electronic device 500c displays code 1118d and sharing information 1120e in response to initiating a sharing process between the third electronic device 500c and the second electronic device 500b. In some embodiments, in response to detecting an input 1111c directed to selectable option 1132e, the third electronic device 500c becomes discoverable by other devices and displays a code 1118d. In some embodiments, a selection 1122 of a device type changes the sharing information 1120e. For example, in response to the detecting an input 1112b directed to “tablet” or “laptop,” the first electronic device 500a displays sharing instructions corresponding to the respective device type.

In some embodiments, in response to the first electronic device 500a and the second electronic device 500b selecting the selectable option 1132b and selectable option 1132e, respectively, the second electronic device 500b displays a request section 1141d including selectable option 1132f and selectable option 1132g. In some embodiments, the selectable option and 1132f and the selectable option 1132g are associated with a code entering process on the second electronic device 500b. For example, in some embodiments, once the first electronic device 500a selects selectable option 1132b, the first electronic device 500a becomes discoverable (e.g., available for connecting to share content) by the second electronic device 500b, as indicated by selectable option 1132c. In some embodiments, once the third electronic device 500c selects selectable option 1132e, the third electronic device 500c becomes discoverable (e.g., available for connecting to share content) by the second electronic device 500b, as indicated by selectable option 1132d. In FIG. 11Y, the second electronic device 500b detects an input 111b directed to the selectable option 1132f.

In FIG. 11Z, the first electronic device 500a maintains the display of the code 1118c and sharing information 1120d. In some embodiments, the second electronic device 500b maintains the display of the code 1118d and sharing information 1120e. In FIG. 11Z, in response to the second electronic device 500b detecting an input 1112a directed to the selectable option 1132f, the second electronic device 500b displays input field 1126c (e.g., the selectable option 1132f expands and displays input field 1126c) while the selectable option 1132g remains collapsed on second electronic device 500b. In some embodiments, the second electronic device 500b detects an input 1112b directed to selectable option 1132g, and in response to detecting the input 1112b directed to selectable option 1132g, the second electronic device 500b collapses input field 1126c (and selectable option 1132f) and displays an input field corresponding to selectable option 1132g.

In FIG. 11AA, the first electronic device 500a maintains the display of the code 1118c and sharing information 1120d. In some embodiments, second electronic device 500b maintains the display of the code 1118d and sharing information 1120e. In some embodiments, the second electronic device 500b detects a series of inputs 1112a directed to the keyboard 1128c to fill-in the blank entry spots in the input field 1126c with code 1118c. In some embodiments, a user of the first electronic device 500a communicates the code 1118c to input into input field 1126c. In some embodiments, the code 1118c is visible to a user of the first electronic device 500a for input into input field 1126c.

In FIG. 11BB, in response to the second electronic device 500b detecting the code 1118c being input correctly into input field, the first electronic device 500a displays a ninth user interface 11401 including known contacts 1144b that indicates one or more contacts that content sharing is enabled with. In some embodiments, second electronic device 500b maintains the display of the code 1118d and sharing information 1120e. In FIG. 11BB, in response to the second electronic device 500b detecting the code 1118c being input correctly into input field, the second electronic device 500b displays selectable option 1132i associated with the first electronic device 500a as a known contact (e.g., “Emily” is now displayed as a known contact). In some embodiments, the second electronic device 500b detects an input 1112b directed to the selectable option 1132g. In some embodiments, the input includes a touch and drag from right to left. In some embodiments, in response to the input 1112b directed to selectable option 1132g the second electronic device 500b ignores the selectable option 1132g (e.g., canceling a sharing process between the second electronic device 500b and the third electronic device 500c).

In FIG. 11CC, the first electronic device 500a displays a ninth user interface 1140i including known contacts 1144b that indicates one or more contacts that content sharing is enabled with. For example, the ninth user interface 1140i includes selectable option 1132h that is associated with the second electronic device 500b because sharing is enabled between the first electronic device 500a and the second electronic device 500b. That is, content (e.g., shareable content 1105b) can be shared between the first electronic device 500a and the second electronic device 500b. In FIG. 11CC, the third electronic device 500c maintains the display of the code 1118d and sharing information 1120e. In some embodiments, in response to the second electronic device 500b detecting an input 1111a directed to the selectable options 1132g, the second electronic device 500b displays the selectable option 1132i as an “ignore” option. In FIG. 11CC, the second electronic device 500b detects an input 1112a directed to the selectable option 1132i. In some embodiments, in response to detecting the input 1112a directed to the selectable option 1132i, the second electronic device 500b declines an attempt to enable sharing between the second electronic device 500b and the third electronic device 500c and the second electronic device 500b re-displays the selectable option 1132g in a connect portion 1141e, such that another attempt to connect the second electronic device 500b and the third electronic device 500c can be initiated.

In FIG. 11DD, the first electronic device 500a displays a ninth user interface 11401 including known contacts 1144b that indicates one or more contacts that content sharing is enabled with. In some embodiments, the first electronic device 500a detects an input directed to selectable option 1132h. In FIG. 11DD, in response to detecting an input 1111a directed to the selectable option 1132i, the second electronic device 500b displays a tenth application interface 1140j that includes a connect portion 1141e that include selectable options 1132g. In some embodiments, in response to detecting an input 1111a directed to the selectable option 1132i, the second electronic device 500b displays the eighth application interface 1140h that includes selectable option 1132e in connect portion 1141c.

In FIG. 11EE, the second electronic device 500b maintains display of eighth application interface 1140h. In some embodiments, in response to detecting an input directed to selectable option 1132h, the first electronic device 500a completes a share process by transmitting shareable content 1105b with second electronic device 500b, as indicated by popup window 1150c. In FIG. 11EE, in response to the se detecting an input directed to selectable option 1132h, the second electronic device 500b completes the share process by receiving shareable content 1105b from first electronic device 500a, as indicated by popup window 1150d.

FIG. 12 illustrates a flow diagram illustrating a method 1200 in which a first electronic device displays a user interface associated with sharing information in accordance with some embodiments of the disclosure. In some embodiments, the method 1200 is performed at a computer system (e.g., computer system 101 in FIG. 1A such as a tablet, smartphone, wearable computer, or head-mounted device) including a display generation component (e.g., display generation component 120 in FIGS. 1, 3, and 4) (e.g., a heads-up display, a display, a touchscreen, and/or a projector) and one or more cameras (e.g., a camera (e.g., color sensors, infrared sensors, and other depth-sensing cameras) that points downward at a user's hand or a camera that points forward from the user's head). In some embodiments, the method 1200 is governed by instructions that are stored in a non-transitory computer-readable storage medium and that are executed by one or more processors of a computer system, such as the one or more processors 202 of computer system 101 (e.g., control unit 110 in FIG. 1A). Some operations in method 1200 are, optionally, combined and/or the order of some operations is, optionally, changed.

The devices, methods, and/or computer-readable storage mediums described below enhance the operability of the device and makes the user-device interface more efficient (e.g., by helping the user to provide proper inputs and reducing user mistakes when operating/interacting with the device) which, additionally, reduces power usage and/or improves battery life of the device by enabling the user to use the device more quickly and efficiently. Restricting access to potentially sensitive information and/or compartmentalizing the information to specific devices and processes (such as by requiring a user to input a code in order to share content with an unknown electronic device) improves privacy and security by limiting the manner in which that potentially sensitive information can be accessed.

In some embodiments, a method 1200 is performed at a first electronic device, such as first electronic device 500a in FIG. 11A, in communication with one or more input devices and one or more display generation components, such as display 504a in FIG. 11A. For example, the first electronic device system optionally has one or more characteristics similar to, the same as, and/or that correspond to one or more characteristics of the first electronic device, the second electronic device, and/or additional or alternative electronic devices described with reference to methods 800 and/or 1000. In some embodiments, the one or more input devices and/or the one or more display generation components have one or more characteristics similar to, the same as, and/or that correspond to one or more characteristics of the one or more input devices and/or the one or more display generation components described with reference to methods 800 and/or 1000.

In some embodiments, while displaying, via the one or more display generation components, a first user interface, the first electronic device detects (1202) a first event corresponding to a request to display an updated user interface, such as input 1111a directed to the first sharing button 1101a as shown in FIG. 11A (e.g., a second user interface that is different from the first user interface or an updated version of the first user interface). In some embodiments, the first user interface is a user interface that is displayed by the computer system in response to receiving/detecting an indication to share content. For instance, while viewing a photo on a photo application, the computer system detects that the user has selected a selectable affordance to share the photo with one or more external devices and in response displays the first user interface. In some embodiments, the first user interface includes a plurality of selectable affordances that when selected, initiate a process to share the content with an external device. In some embodiments, detecting the first event corresponds to detecting a selection of one or more of the selectable affordances at the first user interface.

In some embodiments, in response to detecting the first event, the computer system displays (1204), via the one or more display generation components, the updated user interface, such as first user interface 1114a shown in FIG. 11B. In some embodiments, in accordance with a determination that an unidentified nearby device is prepared to initiate a sharing session with the first electronic device, the first electronic device displays (1206), via the one or more display generation components, the updated user interface with sharing information that enables sharing of content between the first electronic device and a second electronic device that is an unidentified nearby device, such as sharing instructions 1120a displayed on a third sharing user interface 1114c as shown in FIG. 11D.

In some embodiments, in accordance with a determination that there is not an unidentified nearby device that is prepared to initiate a sharing session for sharing files with the first device, the first electronic device displays (1208), via the one or more display generation components, the updated user interface without displaying the sharing information that enables sharing of content between the first electronic device and an unidentified nearby electronic device, such as if sharing instructions 1120a was not displayed on the third sharing user interface 1114c shown in FIG. 11D in response to determining that there was not an unidentified nearby device.

In some embodiments, detecting the first event includes detecting that the user has provided an input to a first user interface that corresponds to a request to share one or more files with one or more unspecified devices. In some embodiments, in addition to displaying a list of known and specific devices to share a content with at the first user interface, the device also displays a selectable option to “Find people nearby” that when selected initiates a process to share content with one or more devices that are unknown to the first electronic device. In some embodiments, an unspecified device refers to a device that is not specifically selected for sharing by a user of the first electronic device but instead is selected for sharing based on one or more attributes/criteria that the device satisfies. As an example, while interacting with a photo on a photo application, the first electronic device detects that the user has initiated a process to share the photo with an external device. In response to detecting the request, the electronic device optionally displays a selectable affordance that when selected by the user of the electronic device, enables the device to initiate a process to share the content with one or more or any device that is within a threshold distance of the first electronic device. For example, the first electronic device optionally discovers/determines other electronic devices are available based on them being within a threshold distance (e.g., 0.5 m, 1 m, 3 m, 5 m, or 10 m) from the first electronic device, which optionally corresponds to an operational range of a wireless communication protocol used for identification of devices and/or sharing with devices. In some embodiments, other devices outside the threshold distance are not discoverable by the electronic device. In some embodiments, the electronic device optionally discovers/determines other electronic devices that are available via one or more communication protocols (e.g., WiFi, Bluetooth, and/or RFID). In some embodiments, the share event further includes receiving a selection from the user (e.g., by detecting selection of one of the selectable affordances) of a device or multiple devices. In some embodiments, the user of the first electronic device, thus, does not provide input specifying a specific device to share with, but instead initiates a process to identify and potentially share content with one or more unspecified and/or unknown devices that are within the threshold distance of the first electronic device, such as a user providing input 1111a directed to the find people button 1101b, as shown in FIG. 11C.

In some embodiments, the second electronic device is unknown to the first electronic device. For example, in some embodiments, the first electronic device and second electronic device have not previously shared content and/or the user of the second electronic device is not a contact of the user of the first electronic device, and the user of the first electronic device is not a contact of the user of the second electronic device.

In some embodiments, displaying sharing information includes displaying a user interface at the first electronic device that includes a numerical code that the user of the second device is to enter in a user interface displayed at the second electronic device that when entered initiates a relationship between the first electronic device and the second electronic device, and/or initiates the sharing of content between the first electronic device (e.g., from the first electronic device) and the second electronic device (e.g., to the second electronic device). In some embodiments, the numerical code is generated by a pseudo-random number generation. Additionally or alternatively, the numerical code is generated by a deterministic process. In some embodiments, the sharing information includes instructions for sharing the numerical code with the second electronic device. For instance, the sharing information includes text-based instructions instructing the user of the first electronic device to provide the user of the second electronic device with the generated numerical code, such as sharing instructions 1120a displayed on display 504a of the first electronic device 500a as shown in FIG. 11E.

In some embodiments, displaying sharing information includes displaying a user interface at the first electronic device that includes a numerical entry field for entering a numerical code that is received from a user of the second electronic device that when entered at the first electronic device initiates a relationship between the first electronic device and the second electronic device, and/or enables the first electronic device to transmit/share content with the second electronic device. In some embodiments, and in the example where the sharing information displayed on the first electronic device includes the numerical entry field, the first electronic device displays instructions for entering a numerical code into the numerical entry field. For instance, the instructions include text-based instructions instructing the user of the first electronic device to ask the user of the second electronic device for a numerical code that is displayed on the second electronic device, and to enter the receive code in the numerical entry field. In some embodiments, in accordance with a determination that the second electronic device is known with respect to the first device, the first electronic device forgoes displaying the sharing information, and initiates sharing of the content with the second electronic device, such as a sharing process initiated by input 1111a directed to share button 1107d as shown in FIG. 11I.

In some embodiments, the first electronic device is associated with a first user, such as a user indicator 1142a displayed on the second user interface 1114b as shown in FIG. 1 IC. In some embodiments, the second electronic device is associated with a second user, different from the first user, such as user indicator 1142b as shown in FIG. 11X. For example, the first electronic device is associated with a first account that is associated with the first user, while the second electronic device is associated with a second account that is associated with the second user. In some embodiments, the first account that the first electronic device is registered with is also associated with one or more devices, different than the second electronic device. In some embodiments, the first account and the second account are unrelated to one another (e.g., the first account and the second account are not part of the same group account such as a family account). In some embodiments, a device being associated with an account refers to the user account being logged into the device.

In some embodiments, the updated user interface is a user interface of an operating system of the first electronic device, such as second user interface 1114b as shown in FIG. 11C. In some embodiments, the sharing process is executed and/or operated by an operating system associated with the first electronic device. Thus, in some embodiments, the updated user interface is a user interface that is generated by the operating system of the first electronic device. In some embodiments, even though the content is being shared within an application (e.g., such as a web browser, a photo application, and/or a messaging application) the updated user interface is generated by a process that originates from the operating system of the first electronic device and not the application associated with the content being shared. In some embodiment, the updated user interface is displayed in response to detecting an input at a user interface that is associated with a sharing process of the operating system. For instance, the user interface includes one or more selectable affordances corresponding to different methods of sharing the content such as through a messaging application, and/or one or more third-party applications. In some embodiments, the user interface is displayed in response to an input detected in a user interface associated with an application from which the content is to be shared (e.g., a web browser, a photo application, and/or a messaging application).

In some embodiments, the sharing information includes a code to be entered at the second electronic device to enable sharing of content between the first electronic device and the second electronic device, such as code 1118a displayed on the third sharing user interface 1114c as shown in FIG. 11F. In some embodiments, the code includes one or more alphanumeric characters. In some embodiments, the code includes one or more special characters. In some embodiments, the code displayed on the first electronic device is specific to the second electronic device (e.g., the code is generated specifically for sharing with the second device). For example, in response to detecting the first event, and in accordance with the second electronic device being prepared to initiate a sharing session with the first electronic device, the first electronic device displays the code to be input into the second electronic device. In some embodiments, the code is generated for use by multiple devices. For example, in response to detecting the first event, the first electronic device generates that code that is to be used by any unidentified nearby device to initiate a sharing session with the first electronic device. In some embodiments, the code generated by the first electronic device expires after a threshold amount of time (e.g., 0.1, 0.5, 1, 5, 10, or 30 minutes) has expired. That is, in accordance with a determination that the code expires, the electronic device will not initiate a sharing session in response to detecting an indication that the user of the second electronic device has entered the code. In some embodiments, the first electronic device receives an indication from the second electronic device that a code that was entered at the second electronic device and compares the received code to the code generated at the first electronic device. In some embodiments, in accordance with a determination that the code received from the second electronic device matches the code generated at the first electronic device, the first electronic device initiates the sharing session with the second electronic device. In some embodiments, when the sharing session between the first electronic device and the second electronic device is active (e.g., sharing has been enabled) the first electronic device and the second electronic device are able to share content items without having to engage in the code sharing process that was performed when the initiate connect was established.

In some embodiments, the code, such as code 1118a displayed on the third sharing user interface 1114c, that is part of the sharing information enables sharing of content between the first electronic device and a plurality of electronic devices (e.g., unspecified devices) including the second electronic device, such as if code 1118a in FIG. 11F were also used to share content with a third electronic device, in addition to being used to share with the second electronic device. In some embodiments, the code that is provided by the first electronic device is a code that is specific to the first electronic device, and is used by the first electronic device whenever the first electronic device is called upon to provide a code to initiate a sharing session with one or more unknown devices (e.g., device that are unknown to the first electronic device). In some embodiments, the first electronic device uses the same code to share content with multiple devices that are unknown to the first device. For instance, if multiple devices are determined to be prepared to initiate a sharing session for sharing files with the first device, the multiple devices use the same code generated by the first electronic device to initiate the sharing session between each device of the multiple devices and the first electronic device. In some embodiments, the code that is provided by the first electronic device is periodically changed after a threshold amount of time (e.g., every hour, every day, once a week, once a month) such that each time the first electronic device is required to provide a code to initiate a sharing session with an unknown device, a new code is used if the previous code has expired due to it having been active over the threshold amount of time.

In some embodiments, the sharing information includes an input field for entering a code that is provided by the second electronic device to enable sharing of content between the first electronic device and the second electronic device, such as input field 1126b as shown in FIG. 11Q. In some embodiments, a code that enables sharing between the first electronic device and the second electronic device is generated by the second electronic device, while the first electronic device displays an input field for inputting the code that is generated by the second electronic device. In some embodiments, the first electronic device detects an input at the first electronic device indicating that a code has been entered at the first electronic device. In response, the first electronic device optionally transmits the entered code to the second electronic device, and the second electronic device checks the transmitted entered code to verify that the code matches the code generated at the second electronic device. In some embodiments, the first electronic device receives an indication from the second electronic device that the code entered at the first electronic device matches the code generated at the second electronic device, and in response the first electronic device initiates a sharing session with the second electronic device. In some embodiments, the code generated by the second electronic device shares one or more characteristics with the codes described herein. In some embodiments, once the first electronic device initiates the sharing session with the second electronic device, the first electronic device and the second electronic device subsequently share content without requiring the sharing information process described herein.

In some embodiments, while displaying the sharing information including the input field for entering the code that is provided by the second electronic device, the first electronic device detects, via the one or more input devices, a sequence of one or more inputs corresponding to entry of the code at the input field, such as input 1111a directed to keyboard 1128b as shown in FIG. 11Q. In some embodiments, in response to detecting entry of the code at the input field, in accordance with a determination that the entered code matches a code associated with the second electronic device, sharing of content between the first electronic device and the second electronic device is enabled, as shown by first connected user interface 1131 in FIG. 11S. In some embodiments, the first electronic device receives an indication of a code generated at the second electronic device and compares the received indication to the code entered at the first electronic device. In some embodiments, in response to detecting entry of the code at the input field, in accordance with a determination that the code generated at the second electronic device matches the code entered at the first electronic device, the first electronic device enables sharing of content between the first electronic device and the second electronic device. In some embodiments, detecting entry of the code at the input fields includes detecting a sequence of one or more inputs provided by a hand of a user of the first electronic device. In some embodiments, the sequence of one or more inputs are provided by one or more external input devices communicatively connected to the first electronic device. For example, the sequence of one or more inputs are provided by a stylus communicatively connected to the first electronic device. In some embodiments, once sharing has been enabled the first electronic device and the second electronic device share content without requiring the code sharing process described herein.

In some embodiments, the code is displayed by the second electronic device after the input field is displayed at the first electronic device, such as code 1118b displayed on fifth user interface as shown in FIG. 11Q (and/or in response to the input field being displayed at the first electronic device or in response to an input at the first electronic device that causes the input field to be displayed at the second electronic device). In some embodiments, the code is provided to the first electronic device in response to the first electronic device displaying the input field. In some embodiments, a user of the second electronic device provides a user of the first electronic device with the code, in response to the first electronic device displaying the input field for the code (e.g., the user of the second electronic device verbally tells the user of the first electronic device what the code generated at the second electronic device is). In some embodiments, in accordance with a determination that the code is not entered at the first electronic device within a threshold amount of time (e.g., 1, 3, 5, 10, 30, 60, 120, or 240 seconds)) after the first electronic device displays the input field for the code, the first electronic device forgoes initiating the sharing session with the second electronic device. In some embodiments, in response to detecting that the input field has been displayed for longer than a threshold amount of time (e.g., 1, 3, 5, 10, 30, 60, 120, or 240 seconds) without having a correct code entered, the first electronic device ceases to display the input field for the code. In some embodiments, the first electronic device detects one or more inputs to the input field provided by the user of the first electronic device. In some embodiments, the one or more inputs provided to the input field include tactile inputs provided by a hand of the user. In some embodiments, the one or more inputs provided to the input field include inputs from one or more external devices communicatively connected to the first electronic device (e.g., a keyboard, mouse, and/or trackpad). In some embodiments, in response to displaying the input field at the first electronic device, the first electronic device initiates a process to display a code at the second electronic device.

In some embodiments, the first electronic device displays the updated user interface including instructions for displaying, at the second electronic device, the code to enable sharing of content between the first electronic device and the second electronic device, such as sharing instructions 1120b displayed on the fourth user interface 1114d as shown in FIG. 11P. In some embodiments, the first electronic device displays graphical and textual instructions to enable sharing of content between the first electronic device and the second electronic device. For example, in accordance with a determination that the second electronic device (e.g., an unidentified nearby device) is prepared to share content with the first electronic device, the first electronic device displays, on the updated user interface, instructions for displaying a code at the second electronic device. In some embodiments, the instructions include one or more graphical and/or textual instructions indicating how to display the code at the second electronic device (e.g., instructions for navigating to a user interface on the second electronic device that displays the code to be entered at the first electronic device). In some embodiments, the first electronic device displays the updated user interface including one or more selectable options associated with different types of devices as described in further detail herein. In some embodiments, the first electronic device displays different instructions on the updated user interface based on which selectable option is selected.

In some embodiments, the first electronic device displays the updated user interface including a first selectable affordance associated with a first device type and a second selectable affordance with a second device type, different from the first device type, such as the selectable options pertaining to “iPhone,” “iPad,” “Macbook” and “VP” on third sharing user interface 1114c in FIG. 11D. In some embodiments, while displaying the updated user interface, the first electronic device detects a first input (e.g., a touch contact detected at the first selectable affordance), via the one or more input devices, at the first selectable affordance, such as selection 1122 as shown in FIG. 11D.

In some embodiments, in response to detecting the first input at the first selectable affordance, displaying, via the one or more display generation components, a first set of instructions for displaying the code at an electronic device of the first device type in the updated user interface, such as sharing instructions 1120a displayed on the third sharing user interface 1114c as shown in FIG. 11D. In some embodiments, while displaying the first set of instructions, the first electronic device detects a second input (e.g., a touch contact detected at the second selectable affordance), via the one or more input devices, at the second selectable affordance, such as input 1111b directed to different device types, as shown in FIG. 11D.

In some embodiments, in response to detecting the second input at the second selectable affordance, displaying, via the one or more display generation components a second set of instructions, different from the first set of instructions for displaying the code at an electronic device of the second device type in the updated user interface, such as sharing instructions 1120a that include a graphic corresponding to the device type selected, similar to the graphic shown in FIG. 11D. In some embodiments, the first electronic device displays the updated user interface including one or more selectable affordances associated with respective device types (e.g., a phone, a table, a computer, and/or a head-mounted device). In some embodiments, in response to detecting a selection of a first selectable affordance of the one or more selectable affordances, the first electronic device displays sharing information that include a first set of instructions for displaying a sharing code at the second electronic device. For example, if the first selectable affordance corresponds to a tablet computer, the displayed first set of instructions includes instruction to instruct the user of the second device to navigate to a user interface that includes sharing information for initiating the sharing session. For instance, in an example where the code is generated at the first electronic device, the first set of instructions include instructions instructing the user of the second electronic device to navigate to a user interface that includes an input field for inputting the code. In an example where the first electronic device displays an input field, the first set of instructions include instructions instructing the user of the second electronic device to navigate to a user interface that includes a displayed code, that is to be entered at the first electronic device to initiate the sharing session. In some embodiments, in response to detecting a selection of a second selectable affordance of the one or more selectable affordances, the first electronic device, displays sharing information including a second set of instructions, based on a device type of the second electronic device. In some embodiments, the first set of instructions and the second set of instructions include graphical representations illustrating a process of generating a code at the second electronic device. For example, the first set of instructions is associated with a first type of device (e.g., a mobile phone) includes the graphical representations that illustrates one or more inputs and user interfaces to navigate at the second electronic device to display a code to enable sharing of content between the first electronic device and the second electronic device. In some embodiments, the first set of instructions and the second set of instructions include different graphical representations and/or instructions to display a code to enable sharing of content between the first electronic device and the second electronic device. In some embodiments, while the first electronic device displays the first set of instructions, the first electronic device detects a selection of the second selectable affordance, and in response to detecting the selection of the second selectable affordance, the first electronic device displays the second set of instructions, different than the first set instructions. In some embodiments, the first set of instructions and/or the second set of instructions include instructions for navigating to the same type of interfaces on multiple different devices. For example, the first set of instructions and/or the second set of instructions include instructions for navigating to a control center user interface on a second electronic device and a control center user interface on a third electronic device.

In some embodiments, in response to detecting the first event and in accordance with the determination that an unidentified nearby device is prepared to initiate a sharing session with the first electronic device, the first electronic device initiates a process to provide, at a plurality of electronic devices, different from the first electronic device, sharing information that enables sharing of content between the first electronic device and the plurality of electronic devices, such as input 1111a directed to the find people button 1106b in FIG. 11N. In some embodiments, the first electronic device transmits a communication to a plurality of electronic devices that are unknown to the first electronic device instructing the devices to display a set of instructions for a plurality of electronic devices to initiate a sharing session with the first electronic device (e.g., sharing information). For instance, in the example where the code is generated at the first electronic device, the sharing information includes information for displaying an input field to input the code generated at the first electronic device. In the example where the input field is displayed at the first electronic device, the sharing information includes instructions for displaying a code at the plurality of electronic device to initiate a sharing session with the first electronic device. In some embodiments, each device of the plurality of devices initiates a distinct process to enable connection with the first electronic device. For example, a first device of the plurality of devices with a first device type initiates a first process (e.g., based on a first set of instructions displayed on the first device) to enable a connection with the first electronic device and a second device of the plurality of devices with a second device type initiates a second process (e.g., based on a second set of instructions displayed on the first device).

In some embodiments, in accordance with a determination that a first set of two of more electronic devices are nearby, the plurality of electronic devices includes electronic devices of the first set of electronic devices that are unknown to the first electronic device, and the plurality of electronic device does not include one or more electronic devices of the first set of electronic devices that are known to the first electronic device, such as shown with known people 1144a portion of the sixth user interface 1140f and a connect portion1141a of the sixth user interface 1140f. In some embodiments, the electronic device of the first set of electronic devices that are not known by the first electronic device share one or more characteristics with the unknown device described herein. For example, the unknown devices of the first set have not previously shared content with first electronic device. In some embodiments, the respective user accounts associated with the electronic devices of the first set that are unknown to the first electronic device. For example, a first user account information associated with a respective electronic device of the plurality electronic devices is not stored at the first electronic device. In some embodiments, if the first set of electronic devices include a second electronic device that, a third electronic device, and a fourth electronic device, and the second and third electronic device are unknown to the first electronic device while the fourth electronic device is known the first electronic device, then the second and third electronic devices are devices of the plurality of devices, while the fourth electronic device is not a device of the plurality of devices. Alternatively, if the second electronic device is known to the first electronic device, while the third and fourth electronic devices are unknown to the electronic device, the second electronic device is not a device of the plurality of devices, while the third and fourth device are devices that are part of the plurality of devices.

In some embodiments, displaying the updated user interface includes displaying an indication of an identifier associated with a user of the first electronic device, such as user indicator 1142a as shown in FIG. 11U. In some embodiments, after the determination that the unidentified nearby device is prepared to initiate the sharing session with the first device, and after displaying the updated sharing information that enables sharing of content between the first electronic device and the second electronic device, the first electronic device detects an event corresponding to enablement of the sharing of content between the first electronic device and the second electronic device, such as input 1111a directed to selectable option 1132b as shown in FIG. 11X. In some embodiments, detecting an enablement of the sharing of content between the first electronic device and the second electronic device includes selecting one or more selectable affordances displayed on the updated user interface for initiating the process to share content between the first electronic device and the device. For instance, once the first electronic device determines that the code generated at the first electronic device is entered at the second electronic device, the first electronic device displays the one or more selectable affordance for initiating the process to share content between the first electronic device and the second device.

In some embodiments, in response to detecting the event corresponding to enablement of the sharing of content between the first electronic device and the second electronic device, the first electronic device enables the sharing of content between the first electronic device and the second electronic device without sharing content before the first electronic device and the second electronic device, wherein enabling the sharing of content between the first electronic device and the second electronic device includes initiating a process to share the identifier with the second electronic device, such as selectable option 1132h displayed in a known people 1144a portion of the ninth user interface 1140i and selectable option 1132j in a known contacts 1144b portion of the display on the second electronic device 500b as shown FIG. 11BB. In some embodiments, the indication of an identifier refers to a graphical and/or textual name pertaining to the user of the first electronic device, that will be displayed on the second electronic device as part of the sharing session with the second electronic device to identify the user of the first electronic device. In some embodiments, the first electronic device displays an indication of the identifier of the user of the first electronic device that will appear to unknown devices (e.g., the second electronic device) differently than an indication of the identifier of the user of the first electronic device that will appear to known devices. In some embodiments, the first electronic device displays an indication of an identifier of a user of the first electronic device, that is to be shared with the second electronic device, that is manually input into the first electronic device by the user of the first electronic device, In some embodiments, the indication of the identifier of the user of the first electronic device that will be shared with a third electronic device is different than the indication of the identity of the user of the first electronic device that will be shared with the second electronic device. For example, the indication of the identifier of the user of the first electronic device that will be shared with the third electronic device includes a manually input alternative name of the user of the first electronic device while the indication of the identifier of the user of the first electronic device that will be shared with the second electronic device includes a name of the user of the first electronic device associated with a registration of the first electronic device (e.g., an profile stored at the first electronic device that is associated with the registered owner of the first electronic device.). In some embodiments, the process to share the identifier occurs before content is shared between the first and second electronic device. Alternatively, the process to share the identifier occurs simultaneously with the sharing of content.

In some embodiments, after the determination that the unidentified nearby device is prepared to initiate the sharing session with the first device, and after the first electronic device displays the updated sharing information that enables sharing of content between the first electronic device and the second electronic device, such as input 1111a directed to airdrop button 1108a as shown in FIG. 11H.

In some embodiments, after the determination that the unidentified nearby device is prepare to initiate the sharing session with the first device, and after the first electronic device display the updated sharing information that enables sharing of content between the first electronic device and the second electronic device, the first electronic device detects an event corresponding to enablement of the sharing of content between the first electronic device and the second electronic device, such as input 1111a directed to share button 1107d as shown in FIG. 11I. In some embodiments, detecting an enablement of the sharing of content between the first electronic device and the second electronic device includes selecting one or more selectable affordances displayed on the updated user interface for initiating the process to share content between the first electronic device and the device. For instance, once the first electronic device determines that the code generated at the first electronic device is entered at the second electronic device, the first electronic device displays the one or more selectable affordance for initiating the process to share content between the first electronic device and the second device.

In some embodiments, after the determination that the unidentified nearby device is prepare to initiate the sharing session with the first device, and after the first electronic device display the updated sharing information that enables sharing of content between the first electronic device and the second electronic device, in response to detecting the event corresponding to enablement of the sharing of content between the first electronic device and the second electronic device, the first electronic device enables the sharing of content between the first electronic device and the second electronic device without sharing content between the first electronic device and the second electronic device, such as the enablement of sharing between first electronic device 500a and the second electronic device 500b illustrated in FIG. 11S. In some embodiments, enabling the sharing of content between the first electronic device and the second electronic device includes establishing a communication link between the first electronic device and the second electronic device prior to sharing content between the first and second electronic devices. In some embodiment, and as described herein, enabling the sharing of content includes transmitting identifiers (e.g., as described herein) between the first electronic device and the second electronic device.

In some embodiments, after the determination that the unidentified nearby device is prepare to initiate the sharing session with the first device, and after the first electronic device display the updated sharing information that enables sharing of content between the first electronic device and the second electronic device, while sharing of content between the first electronic device and the second electronic device is enabled, the first electronic device detects an event corresponding to sharing of content between the first electronic device and the second electronic device, such as input 1111a directed to sharing button 1107d as shown in FIG. 11I. In some embodiments, the event corresponding to sharing of content between the first electronic device and the second electronic device includes receiving an input (e.g., a touch input, air gesture, button press, and/or voice input) directed to the updated user interface (e.g., at a selectable affordance displayed on the updated user interface or while attention is directed to the selectable affordance) to initiate the sharing of content between the first electronic device and the second electronic device.

In some embodiments, after the determination that the unidentified nearby device is prepare to initiate the sharing session with the first device, and after the first electronic device display the updated sharing information that enables sharing of content between the first electronic device and the second electronic device, in response to detecting the event corresponding to sharing of content between the first electronic device and the second electronic device, the first electronic device initiates a process to share content between the first electronic device and the second electronic device, such as illustrated with displaying a “Waiting . . . ” indicator below share button 1107d in response to detecting input 1111a directed to the share button 1107 as shown in FIG. 11J. In some embodiments, in response to the input directed to the updated user interface, sharing of content between the first electronic device and a second electronic device is initiated. For example, in response to detecting an input to a selectable affordance displayed on the updated user interface, the first electronic device transmits shareable content (e.g., a photo, a video, a webpage) the second electronic device.

In some embodiments, the determination that the second electronic device that is an unidentified nearby device is prepared to initiate the sharing session with the first device includes determining that the second electronic device is within a threshold distance of the first electronic device, such as the first electronic device 500a and the second electronic device 500b being within the same room. In some embodiments, in order to determine that a device (e.g., such as the second electronic device) to be prepared for sharing the first electronic device must be within a threshold distance (0.1 m, 0.5 m, 1 m, 2 m, or 5 m) of the second electronic device to initiate a process to sharing content or within wireless communication range such as a range of Bluetooth or peer to peer wireless communication. For example, if the first electronic device determines that the second electronic device is within the threshold distance of and content sharing between the first electronic device and the second electronic device is enabled (e.g., as described herein), then a process to share content is initiated. However, if the first electronic device is not within the threshold distance of the second electronic device and content sharing between the first electronic device and the second electronic device is enabled, then a process to share content is not initiated. In some embodiments, if the first electronic device determines that the second electronic device is farther than the threshold distance, then the second electronic device is not prepared to initiate a sharing session with the first electronic device.

In some embodiments, the updated user interface is associated with a first application, such as the first application interface 1140a as shown in FIG. 11U. In some embodiments, the determination that the second electronic that is an unidentified device is prepared to initiate the sharing session with the first device includes determining that the second electronic device is currently executing (and/or displaying a user interface of) the first application, such as the second application interface 1140b as shown in FIG. 11U. In some embodiments, the first application is a third-party application (e.g., an application that is downloaded on the first electronic device and/or is not native to the first electronic device and/or is associated with an entity other than an entity that created the operating system of the first electronic device). In some embodiments, the first application is a messaging application, a photo application, and/or media content application. In some embodiments, the first application includes a process for sharing content between devices. In some embodiments, the first application does not include a process for sharing content between devices. Instead the process for sharing content is optionally native to the first electronic device (e.g., as part of an operating system of the first electronic device). In some embodiments, the first electronic device determines that the second electronic device is executing the first application (e.g., is running the first application) as part of determining that the second electronic device is prepared to initiate the sharing session with the first device. In some embodiments, if the second electronic device is not executing the first application (e.g., executing/displaying a different application from the first application), then the second electronic device is not prepared to share content with the first electronic device as described herein.

In some embodiments, the first electronic device displays the updated user interface including, in accordance with a determination that the first electronic device has received a first request associated with sharing from the second electronic device, and a second request associated with sharing from a third electronic device, other than the second electronic device, the first electronic device displays (e.g., concurrently displaying), via the one or more display generation components, a first element corresponding to the request for content sharing with the second electronic device, and a second element corresponding to a request for content sharing with the third electronic device, such as if request section 1141d, as shown in FIG. 11Y, was displayed on display 504a of the first electronic device 500a. In some embodiments, the first request and the second request are transmitted to the first electronic device in response to the first event described herein. In some embodiments, both the first element and the second element are displayed in response to the determination that an unidentified nearby device is prepared to initiate a sharing session with the first device. In some embodiments, the first element is displayed at the updated user interface in response to determining that the second electronic device is prepared to initiate a sharing session with the first device. In some embodiments, the second element is displayed at the updated user interface in response to determining that third electronic device is prepared to initiate a sharing session with the first device. In some embodiments, determining that the second and third electronic devices are prepared to initiate a sharing session with the first device is made in response to detecting the first event. In some embodiments, the first element and the second element include identifying information about the second electronic device and third electronic device respectively, including but not limited to: an identifier associated with the user of the device, and/or an identifier associated with the device itself (e.g., the type of device). In some embodiments, the first electronic device displays the first element and the second element on the updated interface simultaneously. For example, the first electronic device displays the first element on the updated user interface and the first electronic device displays the first element positioned above the second element, on the updated user interface. In some embodiments, the first element and the second element are selectable affordances that when selected showing expanded sharing information (e.g., as described herein). In some embodiments, in response to detecting a selection of the first element, a sharing process is initiated between the first electronic device and the second electronic device. In some embodiments, in response to detecting a selection of the second element, a sharing process is initiated between the first electronic device and the third electronic device. In some embodiments, displaying the updated user interface with the first request and the second request is displayed with the updated user interface is associated with a third-party application (e.g., a non-native application) that is being executed on the first electronic device as described herein. In some embodiments, in response to detecting selection of the first element, the first electronic device initiates a process to enable sharing with the second electronic device. In some embodiments, in response to detecting selection of the second element, the first electronic device initiates a process to enable sharing with the third electronic device.

In some embodiments, while displaying the updated user interface with the first element and the second element, the first electronic device detects, via the one or more input devices, a selection input directed to a respective element, such as input 1112a directed to selectable option 1132f as shown in FIG. 11Y. In some embodiments, the selection input includes detecting attention of the user (e.g., based on gaze, touch location, and/or a cursor, such as a mouse pointer, located at a location on the updated user interface associated with the first element), and detecting a selection input (e.g., a tap input, an air tap gesture, a button press, or mouse selection) while the attention is directed to the location associated with the first element. In some embodiments, the selection input includes detecting a tactile input (e.g., a finger press provided by a user of the first electronic device) directed to a location on the updated user interface associated with the first element.

In some embodiments, in response to detecting the selection input directed to the respective element and in accordance with a determination that the respective element is the first element and the second element is expanded (such as if selectable icon 1132a were expanded in FIG. 11Y), in response to detecting the selection input directed to the respective element, the first electronic device expands display of the first element, including displaying, via the one or more display generation components, information associated with sharing between the first electronic device and the second electronic device, such as displaying input field 1112b as shown in FIG. 11Z (e.g., information that was not previously display prior to the first element being expanded).

In some embodiments, in response to detecting the selection input directed to the respective element, the first electronic device collapses display of the second element, such as ceasing to display input field 1126c as shown in FIG. 11Y (e.g., ceasing display of information that was previously displayed when the second element was expanded).

In some embodiments, in response to detecting the selection input directed to the respective element, in accordance with a determination that the respective element is the second element and the first element is expanded, the first electronic device expands a display of the second element, such as displaying an input field similar to FIG. 11Y (e.g., displaying information that was not previously displayed prior to expanding the second element). In some embodiments, the first electronic device displays, via the one or more display generation components, information associated with sharing between the first electronic device and the third electronic device. In some embodiments, in response to detecting the selection input directed to the respective element, the first electronic device collapses display of the first element, such as displaying an input field associated with selectable option 1132g while ceasing to display input field 1126c. (e.g., ceasing display of information that was displayed when the first element was expanded). In some embodiments, expanding display of the first element includes displaying sharing information to enable content sharing between the first electronic device and the second electronic (e.g., such as the code, input field, and/or instructions described herein). In some embodiments, in response to displaying sharing information associated with a sharing process between the first electronic device and the second electronic device, the first electronic device occludes the display of the second element (e.g., collapses display of the second element). For example, while displaying sharing information associated with a sharing process between the first electronic device and the second electronic device, a portion of the second element is not visible by the user of the first electronic device. In some embodiments, while displaying sharing information associated with a sharing process between the first electronic device and the second electronic device, the entire second element is not visible by the user of the first electronic device. Alternatively, in some embodiments, collapsing display of the second element refers to displaying the second element in a reduced manner (e.g., smaller in size, less text, and/or with less information).

In some embodiments, the information associated with sharing between the first electronic device and the second electronic device includes sharing information that enables sharing of content between the first electronic device and the second electronic device, such as input field 1126c as shown in FIG. 11Z. In some embodiments, the information associated with sharing between the first electronic device and the third electronic device includes sharing information that enables sharing of content between the first electronic device and the third electronic device, such as code 1118c being input to input field 1126c as shown in FIG. 11AA. In some embodiments, in response to detecting an input directed to the first element, the first electronic device displays the first element in an expanded form that includes displaying sharing information to initiate a sharing process between the first electronic device and the second electronic device on the updated user interface. In some embodiments, the sharing information displayed on the updated user interface includes an input field for entering a code provided by the second electronic device as described herein. In some embodiments, the sharing information displayed on the updated user interface includes a code to be provided to the second electronic device as described herein. In some embodiments, in response to detecting an input directed to the second element, the first electronic device displays the second element in an expanded form that includes displaying sharing information to initiate a sharing process between the first electronic device and the third electronic device on the updated user interface.

In some embodiments, after displaying the updated user interface with the first element and the second element, the first electronic device detects an event corresponding to dismissal of a sharing request from a respective electronic device, such as input 1112a directed to selectable option 1132g as shown in FIG. 11BB. In some embodiments, the event corresponding to the dismissal of the sharing request from the respective electronic device includes detecting an input at selectable affordance displayed on the updated user interface corresponding to ignoring a request from the respective electronic device. Alternatively, the event corresponding to dismissal of the sharing request includes determining that the sharing request has been pending for longer than as threshold amount of time (e.g., 5, 10, 30, 60, 120, 240, 300, or 1000 seconds) without being accepted at the first electronic device.

In some embodiments, after detecting the event corresponding to dismissal of the sharing request from the respective electronic device, the first electronic device displays the updated user interface (e.g. as described herein in response to the first event), such as selectable option 1132i as shown in FIG. 11CC. In some embodiments, in accordance with a determination that the respective electronic device is the second electronic device, the first electronic device displays, via the one or more display generation components, the updated user interface including the second element without including the first element, such as tenth user interface 1140j as shown in FIG. 11DD. In some embodiments, in accordance with a determination that the respective electronic device is the third electronic device, the first electronic device, via the one or more display generation components, displays the updated user interface including the first element without including the second element, such as tenth user interface 1140j as shown in FIG. 11DD. In some embodiments, an ignore input refers to one or more inputs that provide an indication to the first electronic device that the user of the electronic device does not wish to connect with a device associated with the first element (e.g., the second electronic device). In some embodiments, the first electronic device detects an ignore input directed to the first element. In some embodiments, the ignore input directed to the second element includes a swipe. In response to detecting the first input directed to the first element, the updated user interface displays an ignore selectable option. In some embodiments, the first electronic device detects an input directed to the ignore selectable option. For example, the first electronic device detects a swipe input directed to the second element, and in response to detecting the swipe input, the first electronic device displays an ignore selectable option in place of the first element. In some embodiments, in response to detecting the second input directed to the ignore selectable option, the first electronic device ceases to display the ignore option. In some embodiments, in response to the first electronic device ceasing to display the ignore option, the first electronic device displays the updated user interface including the second element but not the first element, thus content sharing between first electronic device and the second electronic device is not enabled.

In some embodiments, the first electronic device displays, via the one or more display generation components, an identifier selection user interface configured to receive an input from the user of the first electronic device selecting an alias to be advertised to the second electronic device when sharing content between the first electronic device and the second electronic device, such as user indicator 1142a as shown in FIG. 11U. In some embodiments, while displaying the identifier selection user interface, the first electronic device detects, via the one or more input devices, an input (e.g., a tap and/or touch) directed to the identifier selection user interface, corresponding to definition of an identifier to use during the sharing session with the second electronic device, such as input 1111a directed to edit button1143a as shown in FIG. 11V.

In some embodiments, in response to detecting the input directed towards the identifier selection user interface, the first electronic device initiates a process to share the defined identifier with the second electronic device, such as input 1111a directed to the find people nearby button 1146a as shown in FIG. 11V. In some embodiments, the identifier selection user interface refers to an user interface that is displayed as part of the updated user interface or separately from the updated user interface that is configured to allow the user of the first electronic device to select an identifier to be displayed at the second electronic device when sharing content with the second electronic device, wherein the identifier identifies the content as coming from the user of the first electronic device. For instance, in some embodiments, the user of the first electronic device inputs (e.g., via typing, handwriting and/or voice input), into the first electronic device, an identifier that will appear to unknown devices such as “Cupcake,” whereas the indication of the identity of the user of the first electronic device that will appear to known devices include a common name associated with the user of the first electronic device, such as “Emily.” In some embodiments, the identifier selection user interface includes alphanumerical characters, special characters, emoticons, and/or emojis, that are selected individually or in combination, to form the identifier to be advertised to the second electronic device. In some embodiments, the second electronic device is identified using an identifier selected at the second electronic device before sharing between the first electronic device and the second electronic device is enabled. In some embodiments, the second electronic device is advertised with an identifier prior to content sharing being enabled between the first electronic device and the second electronic device. For example, in accordance with a determination that the second electronic device is prepared to initiate a sharing session with the first electronic device, the first electronic device displays an alias of the second electronic device on the updated user interface of the first electronic device.

In some embodiments, the first event includes detecting selection of a first selectable option displayed at the first user interface corresponding to an option to enable sharing with an unidentified nearby device, such as input 1111a directed to the find people nearby button 1146a as shown in FIG. 11V. In some embodiments, the first electronic device detects a selection of a selectable option that enables content sharing with unknown devices. In some embodiments, the selection includes a touch input directed to the first selectable option. In some embodiments, the selection includes an input provided by one or more external devices associated with the first electronic device. In some embodiments, the first selectable option includes a selectable affordance labeled as “Find nearby device” or with other similar phrasing to indicate that when selected the first electronic device will initiate a process to determine that an unidentified nearby device is prepared to initiate a sharing session with the first device as described herein.

In some embodiments, the first user interface includes a second selectable option corresponding to an option to initiate sharing with one or more known devices, such as the ninth user interface 1140i as shown in FIG. 11DD. In some embodiments, while displaying the first user interface, the first electronic device detects, via the one or more input devices, an input directed to the second selectable option, such as selectable option 1132h as shown in FIG. 11DD. In some embodiments, in response to detecting the input directed to the second selectable option, the first electronic device initiates sharing with a known device of the one or more known devices, as shown by popup window 1150c in FIG. 11EE (optionally without displaying the sharing information described herein, and optionally without the need for further input to share content with the known device). In some embodiments, the input directed to the second selectable option includes detecting attention of the user (e.g., based on gaze, touch location, and/or a cursor, such as a mouse pointer, located at a location on the first user interface associated with the second selectable option, and detecting a selection input (e.g., a tap input, an air tap gesture, a button press, or mouse selection) while attention is directed to the location associated with the second selectable option. In some embodiments, the input directed to the second selectable option includes detecting a tactile input (e.g., a finger press provided by a user of the first electronic device) directed to a location on the first user interface associated with the second selectable option. In some embodiments, the second selectable option corresponds to an option to initiate a process to share with one or more known devices. In some embodiments, known devices include one or more devices that content sharing is already enabled with. For example, known devices include one or more devices associated with respective user account information that is stored at the first electronic device (e.g., known contacts). In some embodiments, the known devices include devices that are not contacts stored on the first electronic device but that the first electronic device has previously shared content with. In some embodiments, the first user interface includes a third selectable option corresponding to an option to initiate sharing with another known device (e.g., second known device) of the one or more known devices, and in response to detecting an input directed to the third selectable option, the first electronic device initiates a process to share content with the second known device, optionally without initiating a process to share content with other known devices.

In some embodiments, the first user interface further includes instructions for sharing with an unidentified nearby device based on physical proximity with the unidentified nearby device, such as if user interface 1114b included instructions for sharing content by tapping or bringing two device close together in FIG. 11N. In some embodiments, the first selectable option includes instructions for initiating a sharing process with an unidentified device (e.g., the second electronic device). In some embodiments, the instructions include graphical and/or textual instructions that instruct the user of the first electronic device to bring the first electronic device close to another electronic device in order to initiate a sharing session with the device. In some embodiments, the graphical instructions include a picture or animation showing two electronic devices coming into proximity with one another. In some embodiments, physical proximity refers to the first electronic device being within a threshold distance of the unidentified device (e.g., 1 cm, 2 cm, 5 cm, or 10 cm). However, the distance between the first electronic device and the unidentified device, while using a code to enable content sharing, exceeds the threshold distance (e.g., 1 cm, 2 cm, 5 cm, or 10 cm) between the first electronic device and the unidentified device. In some embodiments, in accordance with a determination that the second electronic device is within the threshold distance, the first electronic device enables sharing with the second electronic device without displaying the updated user interface and/or the sharing information and without enabling sharing with other unidentified device. In some embodiments, in accordance with a determination that a third electronic device, different than the second electronic device is within the threshold distance, the first electronic device enables sharing with the third electronic device without displaying the updated user interface and/or the sharing information and without enabling sharing with other unidentified devices.

In some embodiments, the first user interface is associated with a content sharing process of the first electronic device, such user interface 1114a as shown in FIG. 11B. In some embodiments, before displaying the first user interface, the first electronic device detects an input, via the one or more input devices, to initiate sharing of a first content item, such as input 1111a directed to first sharing button 1101a. In some embodiments, the input includes detecting attention of the user (e.g., based on gaze, touch location, and/or cursor, such as a mouse pointer) at a location located at the first user interface associated with a share affordance of the first user interface, and detecting a selection input (e.g., a tap input, an air tap gesture, a button press, or mouse selection) while the attention is directed to the location associated with the share affordance. In some embodiments, the selection input includes a tactile input (e.g., a finger press provided by a hand of the user of the first electronic device) directed to the share affordance. In some embodiments, the selection input includes an input provided by one or more external input devices (e.g., a stylus) directed to the share affordance. In some embodiments, in response to detecting the input, the first electronic device initiates the content sharing process including displaying the first user interface, such user interface 1114a as shown in FIG. 11B. In some embodiments, the content sharing process of the first electronic device refers to a content sharing process that is native (e.g., that originates from an operating system of the electronic device). In some embodiments, the first user interface is displayed in response to the first electronic device detecting an indication made at the first electronic device to share content with other external electronic devices. For example, while displaying photos as part of a photo application, the first electronic device displays a share affordance along with the photos. In some embodiment, the first electronic device detects a selection of the share affordance and initiates a sharing process that includes displaying the first user interface. In some embodiments, the selection input includes a tactile input (e.g., a finger press provided by a hand of the user of the first electronic device) directed to the share affordance. In some embodiments, the selection input includes an input provided by one or more external input devices (e.g., a stylus) directed to the share affordance. In some embodiments, in response to detecting selection of the share affordance, the first electronic device displays the first user interface which includes a plurality of selectable options for sharing the content using various alternative methods including but not limited to using a messaging application, a mail application, and/or a wireless transfer application. In some embodiments, in response to detecting user selection of the wireless transfer application, the first electronic device displays the first user interface.

In some embodiments, the first user interface includes a first selectable option corresponding to a first previous connection of the first electronic device with a third electronic device, such as sharing buttons 1108a-d, as shown in FIG. 11B. In some embodiments, while displaying the first user interface, the first electronic device detects an input, via the one or more input devices, directed to the first selectable option corresponding to the first previous connection (e.g., a touch input, air gesture, or button press directed to the first respective selectable option), such as input 1111b directed to sharing button 1108a as shown in FIG. 11B.

In some embodiments, in response to detecting the input directed to the first selectable option corresponding to the first previous connection, the first electronic device initiates a sharing process with the third electronic device, such as launching a text messaging application with the shareable content 1105a as attachment and a user associated with sharing button 1108a as the recipient (optionally without displaying sharing information with respect to the third electronic device, such as a code or an input field, and optionally without the need for further input to share the content with the third electronic device). In some embodiments, the first user interface includes information corresponding to previously established content sharing connections established by the first electronic device. In some embodiments, the previously established content sharing connections are displayed in order of most recently shared with. For example, the first electronic device displays the most recent connection that the first electronic device has established on a left most portion of the first user interface. In some embodiments, the previously established content sharing connections are ordered (e.g., from left to right) based on a frequency of content sharing. For example, the first electronic device displays the connection with the most content shares that the first electronic device has established on a left most portion of the first user interface. In some embodiments, the sharing process with the third electronic device includes wirelessly transferring content to the third electronic without requiring sharing of a code as described herein. In some embodiments, the first user interface includes a second respective selectable option corresponding to a second previous connection of the first electronic device with a fourth electronic device, different from the third electronic device. In some embodiments, in response to detecting an input directed to the second respective selectable option, the first electronic device initiates a sharing process with the fourth electronic device instead of the third electronic device.

In some embodiments, after the determination that the unidentified nearby device is prepared to initiate the sharing session with the first device, and after displaying the updated user interface with the sharing information that enables sharing of content between the first electronic device and the second electronic device, the first electronic device detects an event corresponding to enablement of the sharing of content between the first electronic device and the second electronic device, such as input 1111a directed to the find people button 1106b as shown in FIG. 11C. In some embodiments, the enablement shares one or more characteristics of the enablement described herein. In some embodiments, the event corresponding to enablement of the sharing of content between the first electronic device and the second electronic includes detecting a sequence of one or more inputs applied to an input device that is communicatively coupled to the electronic device, such as a touch input received at a touch sensitive display, a trackpad input, a keyboard/mouse input, and/or a stylus input. In some embodiments, the event corresponding to enablement of the sharing of content includes detecting, at the first electronic device, a sequence of one or more inputs associated with a code generated by the second electronic device. In some embodiments, the event corresponding to enablement of the sharing of content includes generating a code, at the first electronic device, to share to the second electronic device that enables sharing of content between the first electronic device and the second electronic device. In some embodiments, the event corresponding to enablement of the sharing of content includes navigating to a third-party application (e.g., a non-native application to the first electronic device) to initiate a sharing of content between the first electronic device and the second electronic device.

In some embodiments, in response to detecting the event corresponding to enablement of the sharing of content between the first electronic device and the second electronic device, the first electronic device shares of content between the first electronic device and the second electronic device is enabled, as indicated by first connected interface 1131a as shown in FIG. 11G. In some embodiments, after enabling the sharing of content between the first electronic device and the second electronic device and in accordance with a determination that a duration of time since a reference time related to enabling sharing of content between the first electronic device and the second electronic device is less than a predefined duration of time, the first electronic device maintains enablement of the sharing of content between the first electronic device and the second electronic device, such as displaying share button 1107d in response to detecting a share event as shown in FIG. 11I. In some embodiments, the reference time refers to a time at which the connection between the first electronic device and the second electronic device was initially established. Additionally and/or alternatively the reference time refers to a time that the first electronic device and the second electronic device last shared content. In some embodiments, maintaining enablement of the sharing of content between the first electronic device and the second electronic device includes sharing content between the first electronic device and the second electronic device without displaying sharing information and/or using a code to enable the sharing of the content between the first electronic device and the second electronic device.

In some embodiments, after enabling the sharing of content between the first electronic device and the second electronic device and in accordance with a determination that the duration of time since the reference time is greater than the predefined duration of time, the first electronic device disables the sharing of content between the first electronic device and the second electronic device, such as if share button 1107d was no longer displayed in FIG. 11I after a predefined period of time had elapsed. In some embodiments, in accordance with a determination that a connection between the first electronic device and the second electronic device is established, the first electronic device maintains the connection for a predefined duration of time (e.g., 1 hour, 3 hours, 12 hours, 1 day, or 1 week). In some embodiments, the connection established between the first electronic device and the second electronic device persists for the predefined duration of time and then the connection is terminated (e.g., the first electronic device is no longer able to share content with the second electronic device unless a new connection is established). In some embodiments, the termination of the connection is automatic, and the connection is terminated after the predefined duration of time expires without requiring further user input, and the maintaining of the connection is automatic (e.g., without requiring further user input). In some embodiments, if the connection is termination after the predefined duration of time has been exceeded, the first electronic device and the second electronic device will perform the sharing information process described herein to establish a new sharing session.

It should be understood that the particular order in which the operations in method 1200 have been described is merely exemplary and is not intended to indicate that the described order is the only order in which the operations could be performed. One of ordinary skill in the art would recognize various ways to reorder the operations described herein. In some embodiments, aspects/operations of method 1200 may be interchanged, substituted, and/or added between these methods. For example, various user inputs and/or user interfaces of method 1200 are optionally interchanged, substituted, and/or added between these methods. For brevity, these details are not repeated here.

In some embodiments, aspects/operations of methods 800, 1000, and/or 1200, may be interchanged, substituted, and/or added between these methods. For example, the virtual objects of methods 800 and/or 1000, the three-dimensional environments of methods 800 and/or 1000, the detecting of sequences of one or more inputs of method 1000, the ceasing of display of virtual windows of method 1000, the sharing information of method 1200, and/or the identification of devices of method 1200, are optionally interchanged, substituted, and/or added between these methods. For brevity, these details are not repeated here.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best use the invention and various described embodiments with various modifications as are suited to the particular use contemplated.

As described above, one aspect of the present technology is the gathering and use of data available from various sources to improve XR experiences of users. The present disclosure contemplates that in some instances, this gathered data may include personal information data that uniquely identifies or can be used to contact or locate a specific person. Such personal information data can include demographic data, location-based data, telephone numbers, email addresses, social media IDs, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to improve an XR experience of a user. Further, other uses for personal information data that benefit the user are also contemplated by the present disclosure.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of XR experiences, the present technology can be configured to allow users to select to “opt in” or “opt out” of participation in the collection of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, an XR experience can be generated by inferring preferences based on non-personal information data or a bare minimum amount of personal information, such as the content being requested by the device associated with a user, other non-personal information available to the service, or publicly available information.

1. A method comprising:
at a first computer system in communication with one or more display generation components and one or more input devices:
detecting, via the one or more input devices, a first event corresponding to interaction with a first representation of a three-dimensional virtual object on the first computer system; and
in response to detecting the first event, initiating a process to display a second representation of the three-dimensional virtual object via one or more head-mounted display generation components of a second computer system that is in communication with the first computer system, wherein, while the three-dimensional virtual object is displayed via the one or more head-mounted display generation components, some information related to manipulation of the three-dimensional virtual object is synchronized between the first representation of the three-dimensional virtual object and the second representation of the three-dimensional object.

2. The method of claim 1, wherein detecting the first event includes detecting a selection of a selectable affordance of an application on the first computer system.

3. The method of claim 1, further comprising, in response to detecting the first event, initiating a process to display a user interface element corresponding to the virtual object on the second computer system.

4. The method of claim 3, wherein detection of the first event occurs while the one or more head-mounted display generation components of the second computer system are being worn by a user of the second computer system.

5. The method of claim 3, wherein detection of the first event occurs while a virtual display of the first computer system is being displayed by the one or more head-mounted display generation components of the second computer system.

6. The method of claim 1,
wherein detection of the first event occurs while the one or more head-mounted display generation components of the second computer system are not being worn by a user, and
wherein initiating the process to display the second representation comprises:
determining that the one or more head-mounted display generation components of the second computer system are being worn by the user; and
in response to determining that the one or more head-mounted display generation components of the second computer system are being worn by the user, initiating display of the second representation on the one more head-mounted displays.

7. The method of claim 1, wherein:
the interaction with the first representation of the three-dimensional object occurs on a first application associated with the first computer system; and
initiating the process to display the second representation of the three-dimensional virtual object via one or more head-mounted display generation components of the second computer system includes initiating a process to display the second representation via a respective process of the second computer system, wherein the respective process is not an instance of the first application.

8. The method of claim 1, wherein:
while displaying, via the one or more display generation components, the first representation of the three-dimensional object at the first computer system, a pose of the second representation is changed at the second computer system; and
the method includes, maintaining a displayed pose of the first representation of the three-dimensional object at the first computer system independent of the change in pose of the second representation at the second computer system.

9. The method of claim 1, further comprising:
receiving an indication of a modification of a first feature of the second representation of the three-dimensional virtual object at the second computer system; and
in response to receiving the indication of the modification:
modifying the first feature of the first representation the first representation of the three-dimensional virtual object at the first computer system in accordance with the received indication of the modification.

10. The method of claim 1, further comprising:
detecting, via the one or more input devices, a request to modify a first feature of the first representation of the three-dimensional virtual object at the first computer system, and
in response to detecting the request to modify the first feature:
modifying display, via the one or more display generation components, of the first feature of the first representation at the first computer system in accordance with the detected request to modify the first feature; and
initiating a process to modify display of the second representation of the three-dimensional virtual object at the second computer system based on the modified first feature.

11. The method of claim 10, wherein initiating the process to modify display of the second representation of the three-dimensional virtual object at the second computer system occurs in response to detecting, via the one or more input devices, one or more inputs at the first computer system corresponding to a request to synchronize the modification of the first feature with the second representation displayed at the second computer system.

12. The method of claim 1, wherein:
detecting the first event includes detecting a request to share information associated with the three-dimensional virtual object with an external computer system; and
initiating the process to display the second representation of the three-dimensional virtual object comprises:
in accordance with a determination that the first computer system has not previously initiated a process to display the second representation of the three-dimensional virtual object, displaying, via the one or more display generation components, a user interface that includes one or more options for selecting one or more computer systems to which to transmit the information associated with the three-dimensional virtual object; and
in accordance with a determination that the first computer system has previously initiated the process to display the second representation of the three-dimensional virtual object at the second computer system, transmitting the information associated with the three-dimensional virtual to the second computer system without displaying the user interface that includes one or more options for selecting one or more computer systems to which to transmit the information associated with the three-dimensional virtual object.

13. The method of claim 12, wherein the process to receive the selection of the one or more computer systems excludes an option to select a computer system that is available nearby but is not able to display the second representation.

14. The method of claim 1, wherein initiating the process to display the second representation of the three-dimensional virtual object via the one or more head-mounted display generated components of the second computer system comprises:
displaying, via the one or more display generation components of the first computer system, a list of a plurality of computer systems that are available to display the second representation of the three-dimensional virtual object, including one or more devices that are not being actively used.

15. The method of claim 1, wherein initiating the process to display the second representation of the three-dimensional virtual object via the one or more head mounted display generation components of the second computer system includes receiving a selection of the second computer system as a destination computer system, the method further comprising:
after receiving the selection of the second computer system as the destination computer system, detecting, via the one or more input devices, a second event corresponding to interaction with the first representation of the three-dimensional virtual object on the first computer device, wherein the second event includes receiving, via the one or more input devices, an input directed toward a selectable sharing option associated with the first representation; and
in response to receiving the input directed toward the selectable sharing option associated with the first representation, initiating a process to update the display of the second representation at the second computer system in accordance with second event.

16. The method of claim 1, further comprising
in response to detecting the first event:
in accordance with a determination that the first computer system is not engaged in an active communication session with an external computer system, and prior to initiating the process to display the second representation of the three-dimensional virtual object via the one or more head-mounted display generation components of the second computer system:
displaying, via the one or more display generation components of the first computer system, a destination selection user interface, wherein the destination selection user interface includes one or more selectable options, the selectable options corresponding to different external computer systems that are available to display the second representation; and
receiving, via the one or more input devices, a sequence of one or more inputs that correspond to a selection directed toward the destination selection user interface corresponding to a selection of the second computer system, wherein initiating the process to display the second representation of the three-dimensional virtual object via the one or more head-mounted display generation components of the second computer system occurs in response to receiving the sequence of one or more inputs that corresponds to the selection directed toward the destination selection user interface; and
in accordance with a determination that the first computer system is engaged in an active communication session with the second computer system, initiating the process to display the second representation of the three-dimensional virtual object via the one or more head-mounted display generation components of the second computer system without displaying the destination selection user interface.

17. The method of claim 1, further comprising:
after initiating the process to display the second representation of the three-dimensional virtual object at the second computer system:
detecting, via the one or more input devices, a second event corresponding to interaction with the first representation of the three-dimensional virtual object on the first computer system;
in response to detecting the second event:
in accordance with a determination that the second event includes a first type of input, at the first computer system, initiating a process to display a third representation of the three-dimensional virtual object via one or more head-mounted display generation components of the second computer system; and
in accordance with a determination that the second event includes a second type of input, different from the first type of input, that includes a selection of a third computer system, different from the second computer system, initiating a process to display the third representation of the three-dimensional virtual object via one or more head-mounted display generation components of the third computer system.

18. The method of claim 1, further comprising:
after initiating the process to display the second representation of the three-dimensional virtual object via the one or more head mounted display generation components of the second computer system, detecting, via the one or more input devices, a second event corresponding to interaction with a representation of a respective virtual object on the first computer system; and
in response to detecting the second event:
in accordance with a determination that the representation of the respective virtual object is the first representation of the three-dimensional virtual object, initiating a process to replace the display of the second representation of the three-dimensional virtual object with display of a third representation of the three-dimensional virtual object on the second computer system; and
in accordance with a determination that the representation of the respective virtual object is not the first representation of the three-dimensional virtual object, initiating a process to display a first representation of the respective virtual object concurrently with the second representation of the three-dimensional virtual object via the one or more head-mounted display generation components of the second computer system that is in communication with the first computer system.

19. The method of claim 1, further comprising:
after initiating the process to display the second representation of the three-dimensional virtual object via the one or more head mounted display generation components of the second computer system, detecting, via the one or more input devices, a second event corresponding to interaction with the first representation of the three-dimensional virtual object on the first computer system; and
in response to detecting the second event:
initiating a process to modify display of the second representation of the three-dimensional virtual object at the second computer system, wherein initiating the process includes:
transmitting information representing one or more changes made to the first representation of the three-dimensional virtual object to the second computer, that causes the second computer system modifies display of the second representation by replacing respective portions of the second representation corresponding to the transmitted one or more changes made to the first representation.

20. The method of claim 1, wherein initiating the process to display the second representation of the three-dimensional virtual object via the one or more head mounted display generation components of the second computer system comprises:
in accordance with a determination that the first computer system and the second computer system are not associated with the same user account, initiating a process on the second computer system to request approval to display the three-dimensional virtual object received from the first computer system at the second computer system; and
in accordance with a determination that the first computer system and the second computer system are associated with the same user account, initiating the process to display the second representation of the three-dimensional virtual object without requesting approval to display the three-dimensional virtual object received from the first computer system at the second computer system.

21. The method of claim 1, wherein the process to display the second representation of the three-dimensional virtual object via the one or more head-mounted display generation components of the second computer system initiated by the first computer system comprises:
in accordance with a determination that a virtual display of an external device is being displayed via the one or more head-mounted display generation components of the second computer system:
displaying the second representation of the three-dimensional virtual object within a threshold distance of the virtual display.

22. The method of claim 1, wherein the process to display the second representation of the three-dimensional virtual object via the one or more head-mounted display generation components of the second computer system initiated by the first computer system comprises:
displaying the second representation of the three-dimensional virtual object within a three-dimensional environment that is visible via the one or more head-mounted display generation components of the second computer system.

23. The method of claim 22, wherein initiating the process to display the second representation of the three-dimensional virtual object via one or more head-mounted display generation components of the second computer system comprises:
in accordance with a determination that a first location parameter is specified at the first computer system for displaying the second representation of the three-dimensional virtual object, the second representation of the three-dimensional virtual object is displayed at a first location in the three-dimensional environment that is visible via the one or more head-mounted display generation components of the second computer system; and
in accordance with a determination that a second location parameter, different from the first location parameter, is specified at the first computer system for displaying the second representation of the three-dimensional virtual object, the second representation of the three-dimensional virtual object is displayed at a second location, different from the first location, in the three-dimensional environment that is visible via the one or more head-mounted display generation components of the second computer system.

24. The method of claim 23, wherein displaying the second representation of the three-dimensional virtual object at the first location in the three-dimensional environment that is visible via the one or more head-mounted display generation components of the second computer system comprises:
in accordance with a determination that an application associated with the first representation provides a first anchoring suggestion, displaying the second representation of the three-dimensional virtual object at the first location with a first anchoring;
in accordance with a determination that an application associated with the first representation provides a second anchoring suggestion, different from the first anchoring suggestion, displaying the second representation of the three-dimensional virtual object at the first location with a second anchoring, different from the first anchoring.

25. The method of claim 1, wherein the second computer system is configured to display a plurality of representations of three-dimensional virtual objects provided by a plurality of different software applications.

26. The method of claim 1, further comprising:
in response to detecting, via the one or more input devices, a second event corresponding to further interaction with the first representation of the three-dimensional virtual object on the first computer system:
in accordance with a determination that the second event corresponds to a first type of interaction, forgoing initiating a process to synchronize display of the second representation of the three-dimensional virtual at the second computer system with the first representation of the three-dimensional object at the first computer system; and
in accordance with a determination that the second event corresponds to a second type of interaction, different from the first type of interaction, initiating the process to synchronize display the second representation of the three-dimensional virtual object via the one or more head-mounted display generation components of the second computer system.

27. A first computer system that is in communication with one or more display generation components and one or more input devices, the first computer system comprising:
one or more processors;
memory; and
one or more programs, wherein the one or more programs are stored in the memory and configured to be executed by the one or more processors, the one or more programs including instructions for:
detecting, via the one or more input devices, a first event corresponding to interaction with a first representation of a three-dimensional virtual object on the first computer system; and
in response to detecting the first event, initiating a process to display a second representation of the three-dimensional virtual object via one or more head-mounted display generation components of a second computer system that is in communication with the first computer system, wherein, while the three-dimensional virtual object is displayed via the one or more head-mounted display generation components, some information related to manipulation of the three-dimensional virtual object is synchronized between the first representation of the three-dimensional virtual object and the second representation of the three-dimensional object.

28. A non-transitory computer readable storage medium storing one or more programs, the one or more programs comprising instructions, which when executed by one or more processors of a first computer system that is in communication with one or more display generation components and one or more input devices, cause the first computer system to perform a method comprising:
detecting, via the one or more input devices, a first event corresponding to interaction with a first representation of a three-dimensional virtual object on the first computer system; and
in response to detecting the first event, initiating a process to display a second representation of the three-dimensional virtual object via one or more head-mounted display generation components of a second computer system that is in communication with the first computer system, wherein, while the three-dimensional virtual object is displayed via the one or more head-mounted display generation components, some information related to manipulation of the three-dimensional virtual object is synchronized between the first representation of the three-dimensional virtual object and the second representation of the three-dimensional object.

29-89. (canceled)
